(19) United States
(12) Patent Application Publication
(10) Pub. No.: US 2013/0184082 A1
(43) Pub. Date: Jul. 18, 2013

(54) Multi-Level Competition / Game, Talent, and Award Show Production Systems, Methods, and Apparatus

(71) Applicant: Jeffrey Allen PATCHEN, Oakland, CA (US)

(72) Inventor: Jeffrey Allen PATCHEN, Oakland, CA (US)

(21) Appl. No.: 13/788,985

(22) Filed: Mar. 7, 2013

Related U.S. Application Data
(63) Continuation of application No. 13/153,734, filed on Jun. 6, 2011, now abandoned.
(60) Provisional application No. 61/352,382, filed on Jun. 7, 2010.

(51) Int. Cl. A63F 13/12

(52) U.S. Cl. CPC A63F 13/12
USPC 463/42

(57) ABSTRACT

A multi-level competition includes a competition between on-stage competition content, a competition between off-stage judges, and a competition between at-home players. The competition content (e.g., multiple television advertisements, singing contestants, etc.) is provided to at-home players, who provide a rating for each content offering and rank the content offerings. At a later time, a group of off-stage judges view the competition content, provide a rating for each content offering, and rank the content offerings. One or more accurate responses are identified by a control which may be, for example, a target demographic. A winning content offering is identified based on the one or more accurate responses. The off-stage judges and at-home players are ranked based on whether their ratings/rankings are in sync with the control. Winners may be selected from each of the group of off-stage judges and the group of at-home players.

### CROSS REFERENCE TO RELATED APPLICATIONS

This patent application claims benefit as a continuation to pending U.S. patent application Ser. No. 13/153,734 filed Jun. 6, 2011, entitled “Multi-Level Competition/Game, Talent, and Award Show Production Systems, Methods, and Apparatus,” which claims benefit to U.S. Provisional Patent Application No. 61/352,382 filed on Jun. 7, 2010, entitled “Multi-Level Competition/Game, Talent, and Award Show Production Systems, Methods, and Apparatus,” both applications incorporated by reference herein in their entirety.

### FIELD

Embodiments of the present invention generally relate to multi-level competition/game systems and methods.

### BACKGROUND

Over the past several years, various voting events have been offered in order to drive/entice participation while offering no opportunity for consideration other than an occasional sweepstake offering.

However, in spite of the extraordinary effort that has been expended in developing new voting formats, no production has been able to provide consumers opportunities to achieve true power and dignity.

In particular, viewers of, for example, of some reality-based television, are able only to participate as a respondent with no opportunity to receive anything more than being listed on a leader board or at best entered into a drawing based not on how they responded but just responding. For example, viewers of “American Idol” are asked to vote for their favorite contestant as many times as humanly possible and are offered nothing, but a chance to see which contestant has a fan based that is willing to place a highest number of votes. A lady by the name of Betty Williams once said that if someone votes 6 times for one of the final two contestants she didn't vote for she canceled out their 6 votes because she votes 7 times for the other contestant. Another example is when FOX news reported that an owner of a telemarketing company in Texas voted for Kelly Clarkson over 3 million times by using technology available to his company. Furthermore, dialing repeaters are accessible to the public for just this type of multiple voting method. Consider, for example, the “American Idol” judges. The three judges in essence are self appointed America representatives due to the fact that the three judges make the final decision on which contestants are presented for American to vote on. Do did these individuals qualify to represent America?

Consumer information and behavioral characteristics are factors in determining the costs and effectiveness of all media. A primary target demographic for producers and advertisers is the 18-49 age group. The Nielsen rating system, however, has come under criticism from industry sources questioning its accuracy and effectiveness of demographic targeting for purposes of determining advertising revenues.

Further, existing market research services and measurement procedures can, at best, be characterized as being inadequate for capturing accurate and detailing viewer patterns and preferences.

Prior art systems have also been characterized by the lack of sample information, sample size, biases in selecting marketing research samples and errors in data interpretation.

Cable television, satellite, terrestrial broadcast, and Internet systems afford viewers a multiplicity of Programming material.

With such a broad range of content, broadcasters and producers attempt to “attract eyeballs” in order to generate advertising revenue. The goal of broadcasters and producers is to attract and maintain an audience in order to identify and number eyeballs in order to provide current and potential advertisers or revenue providers with a viewership metric.

In order to attract new viewers, broadcasters are attempting to introduce various genres of programming such as interactive events and series with and without viewer participation. When a genre proves to be popular, other programmers are generally compelled to duplicate one or more aspects of the genre or program type.

Further, video recording equipment, such as some digital video recorders, for example, may allow deletion of advertising messages. A survey by one digital recorder manufacturer indicates that 84 percent of customers skip advertisements.

Broadcasters employ metrics of how many viewers watch each program in order to attract advertisers and to set advertising rates.

An exact count of the number of viewers of a program is difficult to establish, in contrast to newspaper or magazine publications.

An information service commonly employed is the Nielsen ratings from Nielsen Media Research, Inc headquartered at 299 Park Avenue New York, N.Y. 10171. Nielsen Media Research typically asks viewing habit questions to a small sample of approximately 5000 households. From this sampling, Nielsen generates a measure of how many people watched a particular program or advertisement. The above attempts at measuring and retaining an audience is shown by the embodiments of invented material described herein is poor at best and proves the new methods and system are soon to be embraced by future licensees and businesses associated of the inventor.

There is a high percentage of improperly cast elements for productions.

Consumers/viewers are represented by unqualified individuals and teams determining which elements are to be incorporated into audio and visual events and series.

Events and series that generate revenues based at least in part on a number of viewers generally provide little or no consideration to viewers.

Currently, various types of un-novel and obvious element response periods are conducted within all industries. Most notably are the entertainment, manufacturing and service industries. Whenever elements are provided to the public for entertainment, consumption, or service, the elements are a result of one or more of the element response periods.

### Example 1

A product/element is provided to the public for consumption. The element is a result of an element response period whereby a generally unknown element controller is presented with a plurality of elements. The controller determines which element from the plurality of elements is most suitable for public consumption. In essence, the controller is more often than not a self company appointed consumer representative.

### Example 2

An entertainer/element is presented to the public for entertainment. The element is a result of an element response period whereby a generally unknown element controller is presented with a plurality of elements. The controller determines which element form the plurality of elements is most suitable or appealing for entertainment purposes. Therefore, the controller is a self or company appointed viewer representative.

### Example 3

Contestants/elements are provided to the public for interactive entertainment. The elements are a result of an element response period whereby a generally unknown element controller is presented with a plurality of elements. The controller determines one or more elements form the plurality of elements that are most suitable for viewer interaction. The element controller is self or company appointed viewer representative.

Every so often a consumer or viewer representative may get it right which is truly unacceptable.

Therefore, a need exists for businesses to identify and engage viewer and consumer representatives with a proven innate ability to consistently identify elements that are most appealing and suitable to viewers and consumers.

Orchestrating an emotional connection is key for consumers to embrace their brands, but also key is taking this connection to an experiential level. For successful brand building, a company has to start with the consumer, find out when and where they will be, and establish an emotional connection that ultimately creates harmony between the consumer, brand, and product.

### SUMMARY

In an embodiment, a method of conducting a multi-level competition includes: providing competition content to a focus group, wherein the competition content includes a plurality of content offerings and the focus group includes a plurality of participants; receiving rating and ranking information from each participant in the focus group for each content offering in the competition content; providing the competition content to a judging group, wherein the judging group includes a plurality of judges; receiving rating and ranking information from each judge in the judging group for each content offering in the competition content; receiving one or more control responses from a control; selecting a winning content offering from the competition content based on the one or more control responses; ranking each judge in the judging group by comparing the ranking information received from each judge with the one or more control responses; ranking one or more participants from the focus group by comparing the ranking information received from each participant with the one or more control responses; and selecting one or more winners from the focus group based on the ranking of the one or more participants.

In an embodiment, a system thr conducting a multi-level competition includes: a web server configured to provide competition content to a focus group over an electronic network and receive rating and ranking information over the electronic network from each participant in the focus group for each content offering in the competition content, wherein the competition content includes a plurality of content offerings and the focus group includes a plurality of participants; a viewing apparatus configured to provide the competition content to a judging group, wherein the judging group includes a plurality of judges; and a scoring module configured to receive rating and ranking information from each judge in the judging group for each content offering in the competition content; receive one or more control responses from a control; receive the rating and ranking information from each participant in the focus group from the web server; select a winning content offering from the competition content based on the one or more control responses; rank each judge in the judging group by comparing the ranking information received from each judge with the one or more control responses; rank one or more participants from the focus group by comparing the ranking information received from each participant with the one or more control responses; and a selection module configured to select one or more winners from the focus group based on the ranking of the one or more participants.

In an embodiment, a system for conducting a multi-level competition includes: an interactive website configured to provide competition content to a focus group over an electronic network and receive scoring information over the electronic network from each participant in the focus group, wherein the competition content includes a plurality of content offerings and the focus group includes a plurality of participants; a scoring apparatus configured to receive scoring information for each content offering from a set of judges and the plurality of participants, receive one or more control responses from a control, and compare the one or more control responses with the scoring information to produce a set of judge scores and a set of participant scores; and a selection apparatus configured to select a winning content offering from the competition content based on the one or more control responses, rank each judge in the judging group based on the judge scores, and rank one or more participants from the focus group.

In an embodiment, a multi-level competition includes: a focus group element wherein a plurality of participants receive competition content and rank content offerings within the competition content; a judging element wherein a plurality of judges receive the competition content and rank the content offerings; and a reveal element, wherein a winner among the content offerings is determined based on a selection made by a control; a winner among the plurality of judges is determined based on a comparison of each judge's rank of the content offerings to the selection made by the control; and a winner among the plurality of participants is determined based on a comparison of each participant's rank of the content offerings to the selection made by the control.

In an embodiment, a multi-level competition includes: a focus group element wherein a plurality of participants receive competition content and rank content offerings within the competition content; a judging element wherein a plurality of judges receive the competition content and rank the content offerings; and a reveal element, wherein control answers determined by a control group are revealed and compared with the rankings from the plurality of participants and the rankings from the plurality of judges.

In an embodiment, a multi-level reality television production includes: a content competition among a plurality of competition content offerings; a judging competition among a plurality of judges receiving the plurality of competition content offerings; and a participant competition among a plurality of participants receiving the plurality of competition content offerings.

In an embodiment, a method of advertising includes: providing a plurality of competition content sets to a plurality of participants in a focus group, wherein the plurality of competition content sets includes an attraction content set and an advertisement content set; receiving ranking information from each participant in the focus group, wherein the ranking information from each participant includes a ranking of each attraction in the attraction content set and a rating of each advertisement in the advertisement content set; receiving a control ranking for each attraction ire the attraction content set and for each advertisement in the advertisement content set; providing the plurality of competition content sets to a plurality of judges; receiving ranking information from each judge, wherein the ranking information from each judge includes a ranking of each attraction in the attraction content set and a rating of each advertisement in the advertisement content set; comparing the ranking information from each judge with the control rankings to determine one or more winning judges; and comparing the ranking information from each participant with the control rankings to determine one or more winning participants.

In an embodiment, a method of conducting a multi-level competition includes: providing one or more content sets to a plurality of participants, each content set including a plurality of related content offerings; selecting, by each participant in the plurality of participants, a favorite content offering in each content set; providing the one or more content sets to a plurality of judges; selecting, by each judge in the plurality of judges, a favorite content offering in each content set; receiving, from a control, the control's favorite content offering in each content set; awarding points to each participant in the plurality of participants based on how well the participant's favorite content offering in each content set matches the control's favorite content offering in each content set; awarding points to each judge in the plurality of judges based on how well the judge's favorite content offering in each content set matches the control's favorite content offering in each content set; identifying one or more winning judges based on the points awarded to each judge; identifying one or more winning participants in the plurality of participants based on the points awarded to each participant; and identifying one or more winning content offerings in one or more of the content sets based on the control's favorite content offering in the content set.

In an embodiment, a method of enabling an advertiser to pilot test content includes: providing a set of advertisements from the advertiser to a plurality of participants in a focus group; receiving ranking information from each participant in the focus group, wherein the ranking information from each participant identifies the participant's favorite advertisement in the set of advertisements; receiving ranking information from a control for each advertisement in the set of advertisements, wherein the control is a target selected by the advertiser and the ranking information identifies the control's favorite advertisement in the set of advertisements; providing the set of advertisements to a plurality of judges; receiving ranking information from each judge, wherein the ranking information from each judge identifies the judge's favorite advertisement in the set of advertisements; comparing the ranking information from each judge with the ranking information from the control to determine one or more winning judges; and comparing the ranking information from each participant with the control rankings to determine one or more winning participants.

In an embodiment, a method of conducting a multi-level competition includes: providing a first set of competition content to users of social media sites, wherein each user is identified as associated with a particular social media site and the first set of competition content includes a plurality of content offerings; receiving rating and ranking information from each user for each content offering in the first set of competition content; receiving one or more control responses from a control; and selecting a user from each social media site whose rating and ranking information is most similar to the one or more control responses from the control to be a judge in a multi-level competition.

Embodiments described herein enable event and series producers and broadcasters, advertisers, sponsors, and those seeking consumer data with tools to provide viewers/participants/consumers with a time worthy, socially satisfying, and empowering experience with a potentially unlimited number of platforms to achieve this experiential (phenomenal) result.

Embodiments allow the elimination of in your face advertising often time resulting in a bad rap for the brand.

Many television networks do not consider a sitcom to be a television program format offering a great opportunity for interactive applications. Many consider sporting events and reality shows as offering better formats. A television network that uses an embodiment described herein may be able to incorporate interactive applications to all types of past, present, and future programming not only sporting events and so-called reality shows. They may even choose to incorporate interactive applications into classic re-runs made available on broadcast Television or DVD.

Embodiments create a period producer to viewer/consumer synergy by not only allowing viewer/consumer to control elements presented during a period but to also control/determine which elements are presented.

Embodiments also create a consumer to revenue provider synergy whereas the revenue provider offers frame and fortune opportunities to participants identified as in sync with one or more controllers of the primary period theme elements and revenue provider's elements.

A plurality of contestant (primary element) options may be presented and two or more contestant options may be selected to become contestants. The two or more contestants are generally then evaluated and at least one may be selected to become a finalist. An entity or entities controlling the process of determining which contestant (primary element) options and competition or audition activity (attachment or influence element or tailored attachment or influence element) options are to be made available for viewer selection, with respect to an embodiment of the invention, is generally a competition or audition provider or associate. A designated controller of each subsequent selection process is generally a highest number of all participating viewers. A designated controller may also be a highest number of a segment of participating viewers.

Objects of embodiments of the invention include:

Identify and possibly reward and/or engage participating viewers with an ability to evaluate, identify, and select a number of primary elements from a plurality of primary element options that are most viable, suitable, qualified, and/or talented according to a highest number of participating viewers.

Identify and possibly reward and/or engage participating viewers with an ability to evaluate, identify, and choose a number of influence or attachment or tailored influence or attachment elements from a plurality of influence or attachment or tailored influence or attachment element options that are most viable, suitable or best for pre-selected or viewer selected primary elements to perform, be attached to, or be influenced by during a competition or audition according to a highest number of participating viewers.

Identify and possibly reward and/or engage participating viewers with an ability to evaluate, identify, and select a number of competition or audition finalists from a plurality of competing or auditioning primary elements that are most viable, suitable, qualified, and/or talented according to a highest number of participating viewers.

Embodiments allow participating viewers comprising a majority of participating or a majority of a segment of participating viewers controlling the fate/future of primary element options, competition or audition attachment, influence, or tailored attachment or influence options, and finalists to receive point values for providing correct responses to elements. A correct response is determined by an element controller be it a highest number of all participating viewers or a highest number of a segment of participating viewers.

Generally, participating viewers receiving a highest point total for one or more response categories may be identified as in sync with the controller or having the pulse of the people with respect to the one or more categories, Participants in sync with a majority of viewers/consumers over a period of time may be considered to have a skill or an ability that may be required or most suitable to become a viewer/consumer representative or leader. Therefore, consideration may and should be offered to those with this rare skill or ability. A participating viewer with a highest point total may even be a highly suitable employee or executive for businesses targeting viewers or consumers to which the skilled viewer is in sync. Also, viewers in sync with the likes and dislike of a majority of viewers may be most suited to represent viewers during a production preparation process as an element (contestant option, competition activity option, Interactive and placement product option) casting director or become a star during a future production as a celebrity judge with a proven track record of having the pulse of the people.

By allowing viewers that are proven to be in sync with a majority of viewers or a majority of a target demographic to participate in a production preparation process for future interactive events and series the stage is set for future “Totally Viewer/Consumer Controlled” productions.

Producers of future reality TV programming may utilize embodiments of the invention to provide fans and soon to be fans with opportunities to receive consideration for correctly auditioning and casting contestants for the future programming.

Those utilizing embodiments of the invention may and most likely will attract record breaking numbers of viewers when compared to current conventional programming providing little or no empowerment and no opportunities for ultimate consideration.

The producers of different types of shows, such as survival-based reality shows, shows with contestants living in group houses, singing competition shows, shows where a single person selects from different potential mates, shows where a competitors compete to be hired, and beauty pageants, to name a few, may utilize embodiments of the invention to cast highly recognizable contestants and participants and to attract and maintain a massive and committed audience base.

Producers of various types of productions requiring a host or celebrity judge may utilize the systems and methods to allow potential viewers or at home participants to audition and cast a host or celebrity judge for a future production.

Another basic concept of embodiments of the invention is to allow viewers to participate in competitions and auditions as if they were casting directors, celebrity judges, and/or production executives.

Accordingly, it is an object of embodiments of the present inventions to provide systems and methods for capturing and storing information pertaining to entities comprising element response period element controllers element response test and game element controllers, and element response test participants.

It is another object of embodiments of the present inventions to provide systems and methods for monitoring television viewer or user behavior with regards to, and in response to, televised programs, commercial advertisements as well as elements incorporated into the programs and advertisements.

It is yet another object of embodiments of the present inventions to provide systems and methods for monitoring and storing information pertaining to a element controllers responses to elements with respect to controlling each elements fate and determining which responses and to which elements are correct responses for test participants.

Further objects of embodiments of the present invention include:

Generate consumer anticipation and excitement with respect to element presentations. More specifically, create consumer anticipation and excitement with respect to being presented with productions, products, and services.

Enable element controllers to determine which consumables options from a plurality of consumable options presented by an element response period provider and/or element response period revenue provider during an element response period are most suitable to be consumed during or after an element response period.

Enable element response period revenue providers to develop and maintain a direct marketing relationship with consumers from one or more societies or one or more segments of one or more societies designated to controller the future or fate of element response options or response elements presented during the period.

Enable element response period and element response test providers to develop a direct marketing relationship with consumers from one or more societies or one or more segments of one or more societies designated to controller the future or fate of element response options or response elements presented during the period.

Enable element response period and test providers to identify and engage period and test participants most qualified to assist or represent one or more controllers of elements incorporated into a period or test by the period or test provider.

Enable element response period and test revenue providers to identify and engage period and test participants most qualified to assist or represent one or more controllers of elements incorporated into a period or test by the period or test revenue provider.

Enable element response period or test providers to incentivize members of one or more societies to access and/or consume elements presented during a period or test.

Initiate and maintain a synergy between element response period and test viewers and participants, period and test providers, and revenue providers.

Enable element response period and test providers to utilize all possible element observation and evaluation platforms and medias.

Enable element response period and test providers to utilize all possible element response platforms.

Provide element response period viewers and element response test participants with electronic, wireless, and printed element response point self assignment and element response point total calculation systems.

Enable producers and manufacturers to generate revenues during the process of advertising and marketing productions and consumables.

A test provider's objective may be to allow a highest number of participants to be considered as most qualified to represent a controller. This may be accomplished by designating a majority of participants as an element controller and provide only two elements to respond to. If all participants respond to the same element, all participants may be in sync with the element controller for the one response. This may happen if the two elements are diverse. When the two elements are similar, the number of participants in sync with the controller will be far less than 100% and may be closer to 50%. When three elements are similar, the number of participants that will be in sync with the controller is generally be far less than 50%. A test provider may wish to bring an unmanageable number of participants down to a manageable number by utilizing this method.

A function of an element response period may be to allow one or more element controllers to determine which elements from a plurality of elements presented before and/or during the period are most or least suitable or most or least qualified when compared to other elements within the period or within an element category within the period, wherein suitability or qualification is defined by the period provider.

An element response test generally functions in the same capacity as an element response period and will have at least one other function. The at least one other function may be to identify participants most in sync with the one or more element controllers. When a one or a plurality of participants are identified as most in sync with a controller various methods may be applied to accomplish the identification process.

Identify one or more participants in sync with one or more element controllers.

Identify an entity or entities comprising one or more element controllers in sync with one or more participants.

Identify an entity or entities comprising one or more element controllers in sync with an entity comprising another element controller.

Identify an entity or entities comprising one or more element controllers in sync with a majority of entities comprising another element controller.

Enable one or more element controllers to determine the late or future of one or more elements made available to receive at least one response during a period.

Enable viewers and entities comprising one or more element controllers to participate in one or more element response games or tests ancillary to an element response period or primary element response test or game.

Enable an element response period provider to allow one or more period revenue providers to incorporate element response options into a period in order to allow one or core element controllers designated by the period provider to determine the fate of elements incorporated into the period by the period provider to also determine the fate of elements incorporated into the period by the revenue provider.

Enable an element response period provider to directly or indirectly generate revenues from a revenue provider for allowing the revenue provider to incorporate elements into a period in return for the revenue providers receiving responses from game or test participants when a game or test exists and responses from entities comprising one or more element controllers when the one or more element controllers are comprising of members of one or more societies.

Enable an element response period provider to allow a period revenue provider to designate their own one or more element controllers to determine the fate or future of elements they incorporated into a period

Enable an element response period provider and period revenue provider, when a period revenue provider exists, to capture and utilize data from ancillary game and/or test participants when one or more ancillary game and/or tests exits and data from the one or more games and/or tests is accessible.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention. The patent or application file contains at least one drawing executed in color. Copies of this patent or patent application publication with color drawing(s) will be provided by the Office upon request and payment of the necessary fee.

FIG. 1 shows a game producer's game element ranking system prepared for a player to begin a response game process, according to an embodiment of the present invention.

FIG. 2 shows the game producer's game element evaluation system and the results of a player providing an initial element evaluation, according to an embodiment of the present invention.

FIG. 3 shows the game producer's game element ranking system and the results of the player completing an evaluation process, according to an embodiment of the present invention.

FIG. 4 shows the game producer's game element ranking system and the results of the player completing a game element rating and ranking process, according to an embodiment of the present invention.

FIG. 5 shows the player's rated and ranked game elements transferred to a response point assignment and calculation system resulting form the player submitted rated and ranked producer's game elements, according to an embodiment of the present invention.

FIG. 6 shows a game sponsor's game element ranking system, according to an embodiment of the present invention.

FIG. 7 shows the game sponsor's game element evaluation system and the results of an element evaluation, according to an embodiment of the present invention.

FIG. 8 shows the game sponsor's game element ranking system and the results of the game sponsor's game element evaluation process, according to an embodiment of the present invention.

FIG. 9 shows the game sponsor's game element ranking system and the results of the game producer's game element rating and ranking process, according to an embodiment of the present invention.

FIG. 10 shows the game sponsor's rated and ranked game elements transferred to a response point assignment and calculation system resulting form the sponsor's game element rating and ranking submission process, according to an embodiment of the present invention.

FIG. 11 shows the response point assignment and calculation system assigning, calculating and totaling response points resulting from a posting of a response point controller's rated and ranked producer's and sponsor's game elements, according to an embodiment of the present invention.

FIG. 12 shows a response point assignment and calculation system assigning, calculating and totaling response points based on a participants submitting responses within a proximity range from a response point controller's responses, according to an embodiment of the present invention.

FIG. 13A shows a game element vote-out system enabling participants to provide a vote-out response, according to an embodiment of the present invention.

FIG. 13B show a game element response point assignment and calculation system associated with the game element vote-out system enabling participants to receive a response point value, according to an embodiment of the present invention.

FIG. 14A shows a game element choose system enabling participants to provide a choose response to an element in relation to another element, according to an embodiment of the present invention.

FIG. 14B shows a game element response point assignment and calculation system associated with the game element choose system allowing players to receive response point values, according to an embodiment of the present invention.

FIG. 15A shows a game element select system enabling participants to provide a select response to a plurality of elements, according to an embodiment of the present invention.

FIG. 15B shows a game element response point assignment and calculation system associated with the game element select system allowing players to receive response point values, according to an embodiment of the present invention.

FIG. 16 shows a response game player's response point controller selection system, according to an embodiment of the present invention.

FIG. 17 shows a response game producer's and sponsor's over and under game element voting system with an integrated producer's and sponsor's response point assignment and calculation system, according to an embodiment of the present invention.

FIG. 18 shows an over and under response game system enabling a participant to vote-out a least favorite producer's element (e.g., a survival-based reality show) and rank favorite sponsor's game elements, according to an embodiment of the present invention.

FIG. 19 shows an over and under game element ranking system utilizing two proximity response point assignment systems, according to an embodiment of the present invention.

FIG. 20A shows a printed card A of a two (2) card one (1) ticket response game system, according to an embodiment of the present invention.

FIG. 20B shows a printed card B of a two (2) card one (1) ticket response game system, according to an embodiment of the present invention.

FIG. 20C shows a printed card B ticket of a two (2) card one (1) ticket response game system, according to an embodiment of the present invention.

FIG. 21 shows an over and under printed player scratch response and a response point controller input response card game system, according to an embodiment of the present invention.

FIG. 22 shows a printed player scratch response and a response point controller scratch response card game system, according to an embodiment of the present invention.

FIG. 23 shows page 1 of a printed response game system fold-out enabling a participant to manually record a response game producer's game element evaluations and rankings, according to an embodiment of the present invention.

FIG. 24 shows page 2 of a printed response game system fold-out enabling a participant to manually record a response game sponsor's game element evaluations and rankings, according to an embodiment of the present invention.

FIG. 25 shows page 3 of a printed response game system fold-out enabling a participants to manually record ranked producer's and sponsor's game elements, self assign response point values for correct responses, calculate a period point total, and input an award qualifying point total/value, according to an embodiment of the present invention.

FIG. 26 shows a response game show in-studio response point assignment and calculation system, according to an embodiment of the present invention.

FIG. 27 shows a response game show studio environment, according to an embodiment of the present invention.

FIG. 28 illustrates an in-studio system for a control, according to an embodiment of the present invention.

FIG. 29 illustrates an embodiment of a graphical representation of an in-studio system, according to an embodiment of the present invention.

FIGS. 30-52 describe embodiments of a muiti-level competition.

FIGS. 53-91 depict embodiments of a particular level of a multi-level competition.

FIGS. 92-106 depict a tie-breaking round in accordance with embodiments of the present invention.

FIG. 107 illustrates exemplary content offerings to be included in each game, according to an embodiment of the present invention.

FIG. 108 illustrates an exemplary interface for an interactive website interface, according to an embodiment of the present invention.

FIGS. 109-110 illustrate exemplary interfaces for a mobile device, according to an embodiment of the present invention.

FIG. 111 illustrates a partner website game console, according to an embodiment of the present invention.

FIG. 112 illustrates an exemplary game card, according to an embodiment of the present invention.

FIG. 113 illustrates an exemplary format for results data provided to a control room, according to an embodiment of the present invention.

FIG. 114-127 illustrate exemplary interactions between each of the competitions in a multi-level competition, according to embodiments of the present invention.

FIG. 128 illustrates an exemplary game card, according to an embodiment of the present invention.

FIGS. 129A-B show a flowchart illustrating a method of conducting a multi-level competition, according to an embodiment of the invention.

FIG. 130 depicts a sample computer system that may be used to implement an embodiment.

### DETAILED DESCRIPTION

### Introduction

Multi-level competitions and game show productions enable a production company and its licensees to sell, develop, produce, and distribute, both domestically and internationally, productions that incorporate multiple related competitions. Each multi-level competition/game show production may include one or more phases. Each phase generally includes two related competitions. For example, during a first phase, referred to herein as Phase 1, at-home participants rate and rank on-stage competition content offerings. Participants receive a point value each time they submit a rating or ranking that matches a control's rating or ranking. A control may include one or more participants. One or more participants receiving a highest point total are identified as being most in-sync with the control, and may be case to compete on a future television game show production as off-stage judges. A competition content offering receiving a highest rating and/or ranking by the control is identified as a winning competition content offering. One or more winning content offerings may be revealed after a rating and ranking submission deadline. Alternatively, when a second phase, referred to herein as Phase 2, exists, the one or more winning content offerings may not be revealed until after completion of Phase 2. Phase 1, an at-home participant competition relating to a competition between content offerings (e.g.; an on-stage competition) is a type of multi-level competition production.

In an embodiment, Phase 2 is a television game show production where off-stage judges rate and rank on-stage competition content offerings Which were previously rated and ranked by at-home participants and/or a control. Judges receive a point value each time they submit a rating or ranking that matches the control's rating or ranking. One or more judges receiving a highest point total are identified as most in-sync with the control and n ay remain on the television game show as off-stage judges. A competition content offering receiving a highest rating and/or ranking by the control is revealed as a winning competition content offering during the television game show. When the control does not include competing at-home participants, this production is a type of multi-level competition/game show production wherein off-stage judges are participating in a competition that relates to the on-stage game show competition content offerings which were previously rated and ranked by a non-competing control.

### Multi-Level Competition

In a typical competition (e.g., American Idol), a group of contestants compete for votes. The contestant with the most votes moves forward to the next round and/or wins the competition. In this typical format, the competitors are judged by a set of offstage judges, and votes are cast by an audience, such as at-home viewers.

In contrast, a multi-level competition according to an embodiment of the present invention includes not only a competition between contestants or other competition content, but also includes a competition among the participants and/or a competition among the judges.

One of the competitions in a multi-level competition is a competition between different content offerings. The group of content offerings is referred to herein as competition content. For example, multiple performers may compete to see who is the participants' favorite. In this example, each performer is a different content offering. In another example, a single performer can showcase multiple performances to determine which is the participants' favorite. For example, a famous singer can perform three songs, and the song receiving the highest ranking may be selected to be the famous singer's next single. In this example, each song is a different content offering.

Content offerings need not be human performers or performances. Rather, competition content includes anything that may be voted on. Content offerings can include, for example and without limitation, advertisements (e.g., television advertisements, print advertisements, etc.), style selections for a cover model, and vacation destinations for a family, just to name a few. In an advertising example, an advertiser may submit different versions of commercials as the different content offerings. In this example, participants can then vote on the different commercials to determine which commercial should be selected for the advertiser's next ad campaign. For the content provider, the competition provides a platform for pilot testing their content in a manner accessible to a massive focus group of participants.

For the competition between content offerings, a plurality of content offerings (i.e., the competition content) is provided to one or more players, referred to herein as participants. As will be described in further detail below, the participants select a winning content offering. In an embodiment, the selection is made by ranking the content offerings from favorite to least-favorite. In another embodiment, the selection is made by assigning a rating to each content offering on a numerical scale, e.g., 1-10. In yet another embodiment, the selection is made using a combination of rankings and ratings.

In addition to the competition between content offerings, the participants also compete among themselves to determine who among the participants is most in sync with a control. The control may be, for example, a demographic group. In an example, the control is television viewers between the ages of 25-39. In another example, the control is a single person, such as a famous celebrity. In a farther example, the control is a random control. In an embodiment, the control is a subset of the participants. In another embodiment, the control is separate from the participants. In the participant competition, each participant assigns a ranking and/or a rating to each content offering in the competition content. Each participant is then awarded a point total based on the similarity between the participant's rankings and/or ratings and the control's rankings and/or ratings.

Finally, in addition to the competition between content offerings and the competition between participants, the judges also compete among a group of judges (also referred to herein as a judging group) to remain as judges and/or to be a lead judge. Similarly to the participant competition, each judge assigns a ranking and/or a rating to each content offering in the competition content. Each judge is then awarded a point total based on the similarity between the judge's rankings and/or ratings and the control's rankings and/or ratings.

By providing competition content to the participants, the participants act as a massive focus group for the competition content. Any type of content that can benefit from focus group feedback can be used as competition content. One example of content that benefits from focus group feedback is advertising content.

Advertisers are continuously looking for new ways to entice people to consider their product and for platforms where they can pilot test their products or marketing techniques. For example, television advertisers may create television advertisements in an effort to pique the interest of their target demographic. However, many television viewers may try to avoid advertisements. For example, when watching a television show which was previously recorded, many viewers skip through the commercials and view only the portion of the recording relevant to the show that was recorded. As a result, the value of commercial time between segments of a television show may decrease. In-show product placements are a possibility for some advertisers, but not all products are suited for in-show display; similarly, not all television shows provide sufficient product placement opportunities.

According to embodiments of the present invention, the multi-level competition described offers a new type of advertising opportunity to bring advertising content directly to a wide range of people (including the target demographic) in a way that makes the advertisements the primary point of interest. By offering advertisements as competition content to participants, the participants act as a massive focus group for the advertisements. At the same time, advertisers can build brand loyalty among the participants and garner participant interest in the outcome of the focus group testing.

Advertising content is only one example of content that can be tested by the massive focus group resulting from a multi-level competition according to embodiments of the invention. The format can be used to pilot test movie trailers, new television programs, electronic gadget features, and any other content that could benefit from focus group testing.

An example multi-level competition incorporating advertising content is now described in accordance with an embodiment of the present invention.

To entice people to participate in a competition, the opportunity to view advertising content alone may not provide sufficient motivation to play a game associated with the competition. Therefore, in accordance with an embodiment of the invention, two types of content offerings are included in each game. One type of offering is an attraction offering, which is sufficiently interesting to a potential participant such that the participant will play the game. Another type of offering is an advertisement offering, also referred to herein as a brand/sponsor offering.

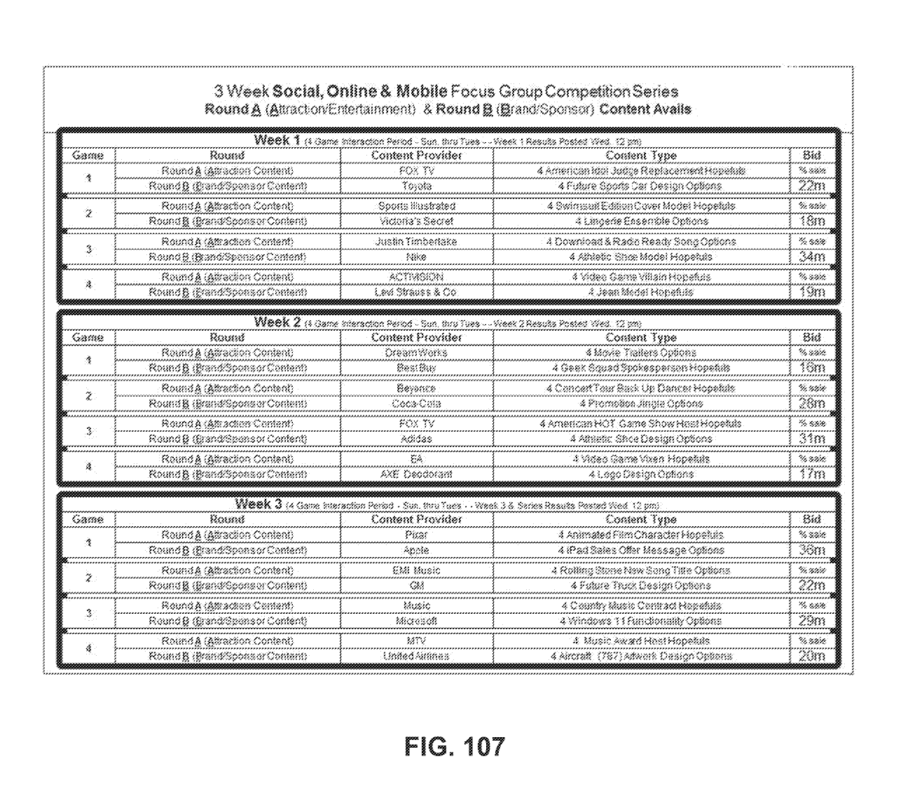

FIG. 107 illustrates exemplary content offerings to be included in each game. In the example of FIG. 107, different competition content is available each week, and each week's competition content includes four (4) games. Each game includes a set of attraction content offerings and a set of advertisement content offerings. The attraction content offerings may have some relation to the advertisement content offerings, although such a relation is not necessary. The portion of the game related to the attraction content offerings will be referred to herein as the attraction round; the portion of the game related to the advertisement content offerings will be referred to herein as the brand round. The attraction content offerings may also be adverting/marketing opportunities themselves, but which generally hold more interest to a participant than the content in the brand round.

In the example of FIG. 107, Week 1 includes Games 1-4. In Game 1, the attraction round includes as content offerings four (4) singing competition judge replacement hopefuls. In this round, participants may receive, for example, video and/or audio audition clips for people hoping to obtain a role as a judge on the singing competition show. The brand round includes as content offerings for future sports car design offerings submitted by a car company. In this round, participants may receive, for example, images and/or video designs the car company is considering for their next sport car.

In Game 2 of Week 1, the attraction round includes as content offerings for a sports magazine, four (4) swimsuit edition cover model hopefuls. In this round, participants may receive, for example, audition clips or images of models hoping to be featured on the swimsuit edition of the sports magazine. The brand round includes as content offerings for lingerie ensemble options proposed by a lingerie company. In this round, participants may receive, for example, video or images of new products to be incorporated into a new clothing line from the lingerie company.

In Game 3 of Week 1, the attraction round includes as content offerings four (4) new radio-ready songs by a famous singer. In this round, participants may receive, for example, audio and/or video clips of each of the new songs. The brand round includes as content offerings four (4) athletic shoe models being considered by a a shoe company. In this round, participants may receive, for example, video or images of new products to be sold by the shoe company.

In Game 4 of Week 1, the attraction round includes as content offerings four (4) video game villain hopefuls for an upcoming video game. In this round, participants may receive, for example, video clips of each game villain. The brand round includes as content offerings four (4) jean model hopefuls. In this round, participants may receive, for example, audition clips for models hoping to be featured in the next jeans company advertising campaign.

In each game, the content providers (e.g., advertisers, promoters, artists, etc.) are able to use the participants as a massive focus group, while at the same time garnering participant interest in the outcome of the focus group testing. For example, if participants are involved in selecting the next sports magazine swimsuit issue cover model, more participants may be motivated to purchase the magazine issue than would otherwise be expected, because the participants feel an emotional connection with the winner. Similarly, by providing content to many more participants than would be available in the typical focus group, the content provider (e.g., the sports magazine) is ensuring that a large number of people are exposed to their product/brand.

In addition to Week 1's games, FIG. 107 also provides exemplary games for Weeks 2 and 3 of a multi-level competition. In Game 1 of Week 2, the attraction round includes four (4) potential trailers for the next summer blockbuster as content offerings. The brand round includes four (4) spokesperson hopefuls for a major corporation as content offerings.

In Game 2 of Week 2, the attraction round includes four (4) backup dancers who are hoping to win a job on a major singer's next concert tour. The brand round includes four (4) options for a soda company's next advertisement jingle.

In Game 3 of Week 2, the attraction round includes four (4) contestants hoping to win a job as the next game show host for a new television show. The brand round includes four (4) design options for a shoe company's next athletic shoe.

In Game 4 of Week 2, the attraction round includes four (4) potential video game vixens for a video game. The brand round includes four (4) design options for a deodorant next logo.

In Game 1 of Week 3, the attraction round includes four (4) animated character options for an upcoming animated film. The brand round includes four (4) potential sales message options for a new electronic device.

In Game 2 of Week 3, the attraction round includes four (4) title options for the a rock group's new song. The brand round includes four (4) design options for an automobile company's next truck.

In Game 3 of Week 3, the attraction round includes four (4) country music performers hoping to win a new contract, The brand round metudes four (4) new functionality options to include in the next operating system update by a software company.

In Game 4 of Week 3, the attraction round includes four (4) potential hosts for a music awards show. The brand round includes four (4) design options for aircraft artwork for an airline.

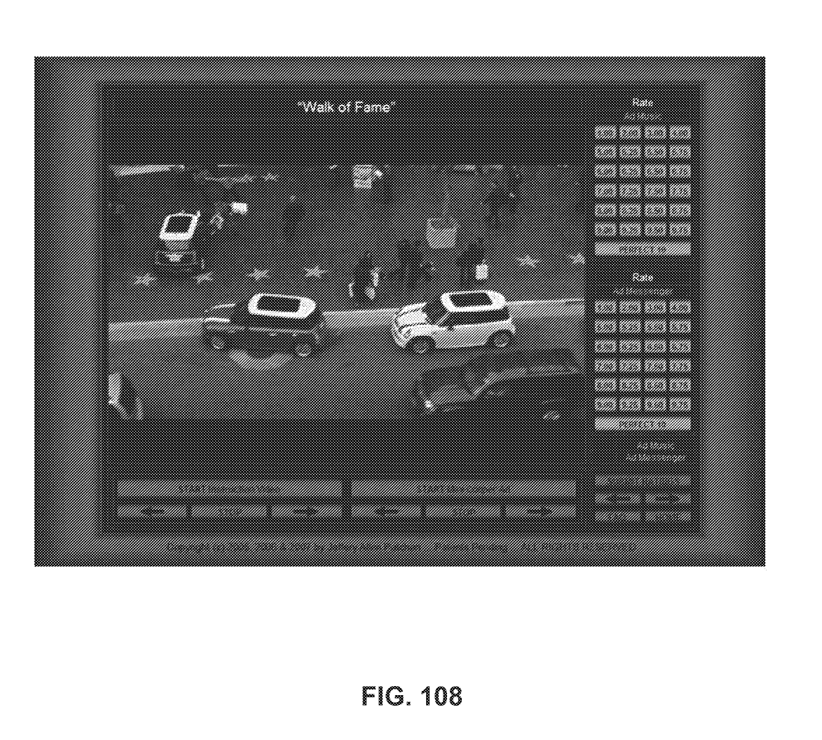

Each week, the content offerings available in each game are provided to the participants. The participants can access the content offerings in a variety of ways. In one embodiment, a participant can access the content offerings via an interactive website. An exemplary interface for an interactive website is illustrated in FIG. 108.

FIG. 108 illustrates an exemplary interactive website interface that includes a viewing area, a control panel, a ratings area, and a submissions area. In this example, the content offering is an advertisement for an automobile, and is shown in the viewing area. The control panel includes buttons which can be selected by a participant to start and stop playing the advertisement. The control panel also includes a button which can be selected by a participant to play an instruction video, if the participant is unsure how to play the game. In this example, two ratings may be provided in the ratings area. A participant is asked to rate both the ad music and the ad messenger (i.e., the voice-over). Buttons ranging from 1-10 are provided for each rating question. Once a participant has selected the number corresponding to the participant's rating, the participant may select the “submit ratings” button in the submissions area of the interactive website. It will be understood by one of skill in the art that other interfaces for an interactive website may be provided without departing from the spirit and scope of the present invention.

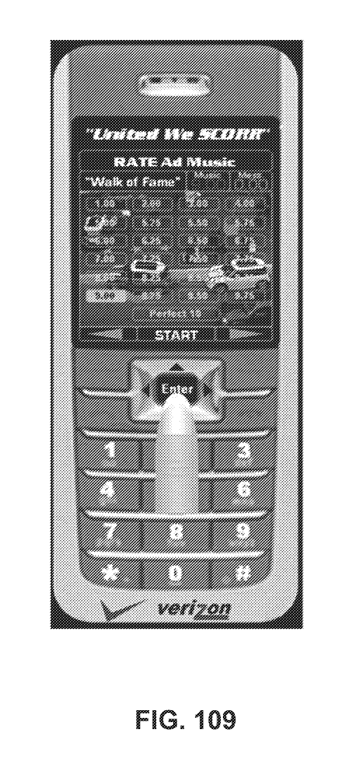

In another embodiment, a participant can access the content offerings via a mobile device (also referred to herein as a mobile interface unit). A mobile telephone and a tablet PC are examples of a different mobile devices. An exemplary interface for a mobile device is illustrated in FIG. 109. The interface in FIG. 109 illustrates a viewing area overlaid by a ratings area. The ratings area may appear during the playback of the content offering, or it may appear after playback of the content offering is complete. When multiple ratings are requested, the ratings panels may appear sequentially on the screen of the mobile device. If the mobile device is not equipped with a touch screen, a participant can use the keypad of the mobile device to navigate through the interface. For example, the participant may select a rating for the displayed content offering using the navigation keys on the mobile device, or using the numerical keypad. Once the participant has selected a rating, the participant may, in one embodiment, press an “enter” key on the participant's mobile device in order to submit the rating.

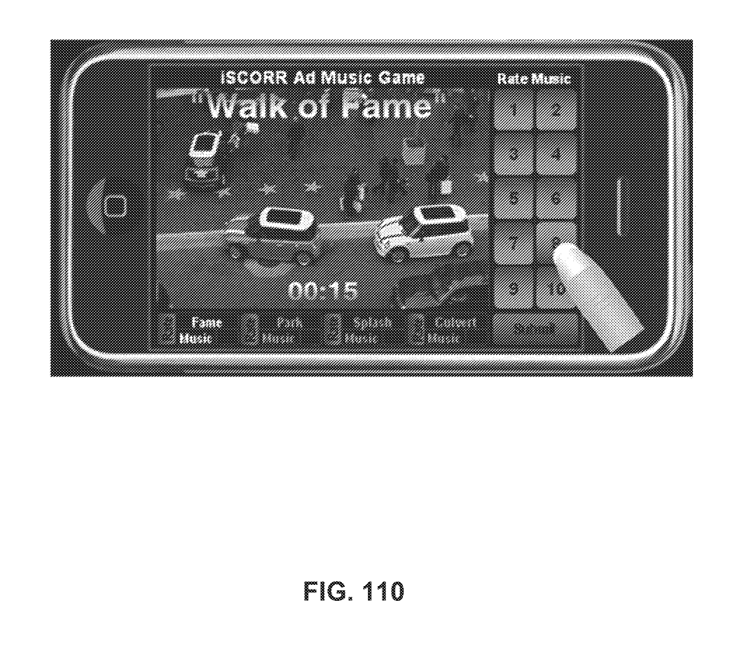

Another exemplary interface for a mobile device is illustrated in FIG. 110. The interface in FIG. 110 illustrates a viewing area, a control area, and a ratings area. When multiple ratings are requested, the ratings panels may appear sequentially on the screen of the mobile device. In the example of FIG. 110, the mobile device includes a touch screen. The participant selects a rating by pressing the number associated with the participant's rating. Once the participant has selected a rating, the participant presses a “submit” button on the interface in order to submit the rating. The control area allows the participant to toggle between the different content offerings.

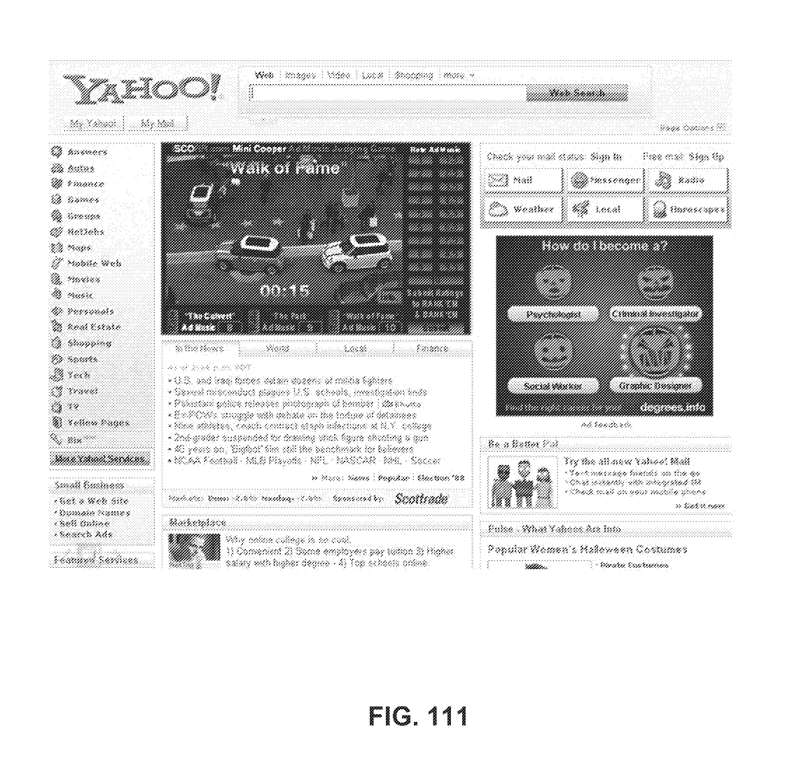

In an embodiment, a participant may have to sign in to an interactive website. In another embodiment, as illustrated in FIG. 111, game play is offered directly through a partner website game console.

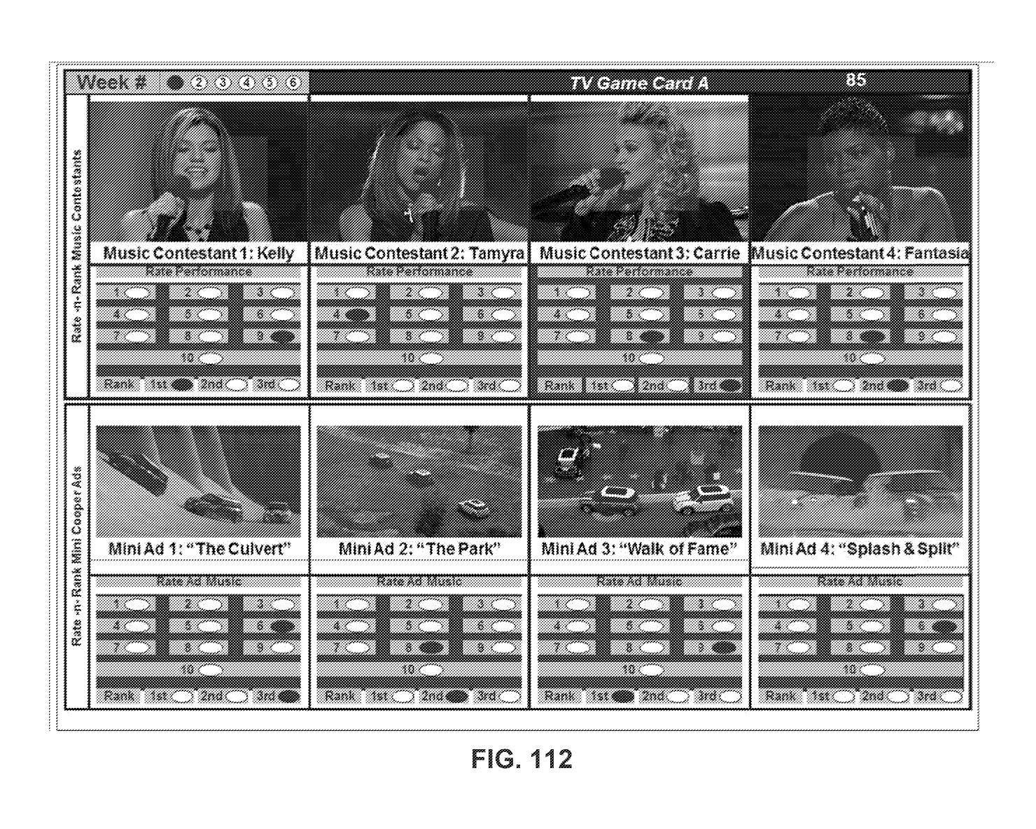

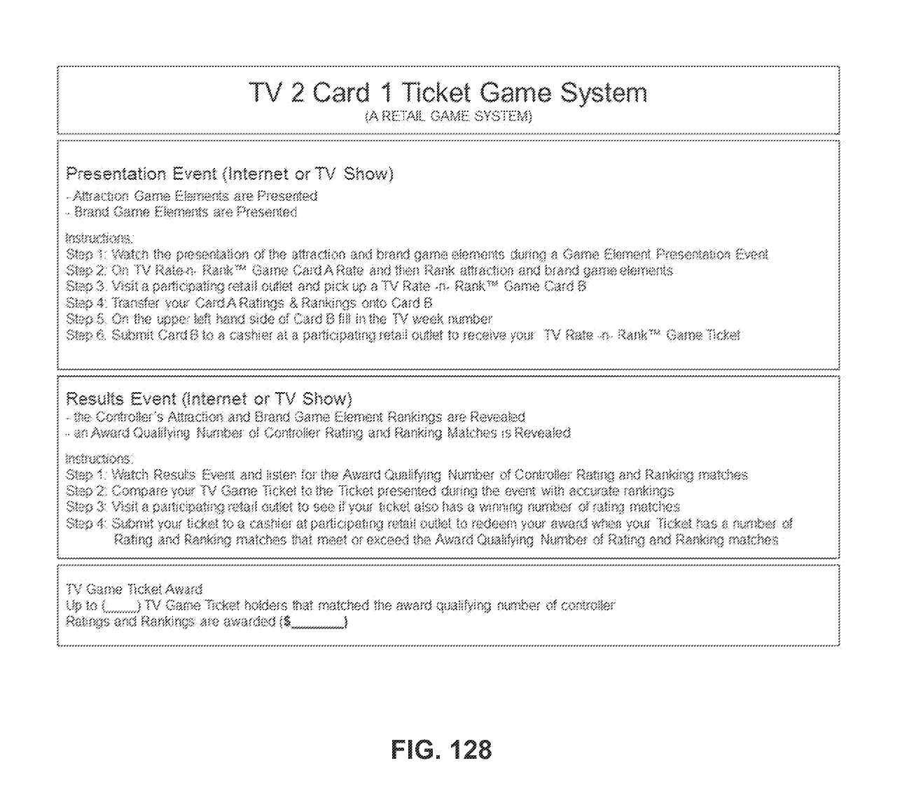

In another embodiment, printed game cards may be made available through participating retail outlets or electronically for printing. FIGS. 112 and 128 illustrate an exemplary game card. FIG. 128 represents an “instruction” side of the game card. A participant is invited to watch a presentation of the content offerings (e.g., attraction content offerings and brand content offerings) during a presentation event. The presentation event may be available at a specific time through any medium, such as the Internet, television, or in-store display. Alternatively, the presentation event may be available on demand through any appropriate medium, such as the Internet, an on-demand television channel, or an in-store display. FIG. 112 represents a scorecard side of the game card. After watching the content offerings, the participant can fill in that participants rating and ranking selections. The game card can then be submitted at a participating retail outlet in exchange for a game ticket. Once the winning competition content has been revealed and points are awarded to each participant, the game ticket can be submitted at a participating retail outlet in exchange for rewards. In an example, the game ticket may be exchanged for rewards when the ticket has a number of rating and ranking matches that meet or exceed an award qualifying number of rating and ranking matches.

During game play, the participants may also be asked to rank the content offerings in order from, for example, favorite to least-favorite. In an interactive website embodiment, the content offerings may appear on-screen at the same time, allowing the participant to quickly make a ranking selection. In a mobile device display embodiment, the content offerings may appear on-screen at the same time, if the screen is large enough. Alternatively, the content offerings may appear sequentially, allowing the participant to make a ranking selection for each content offering.

In order for the participant rankings and ratings to be used as the results of a massive focus group testing, demographic information regarding the participants likely needs to be known. In an embodiment, a participant may be required to register before receiving the content offerings. During registration, the participant may be required to provide some personal information, such as age, residence location, gender, and/or race. Such information allows the participants to be grouped with others having similar demographic information.

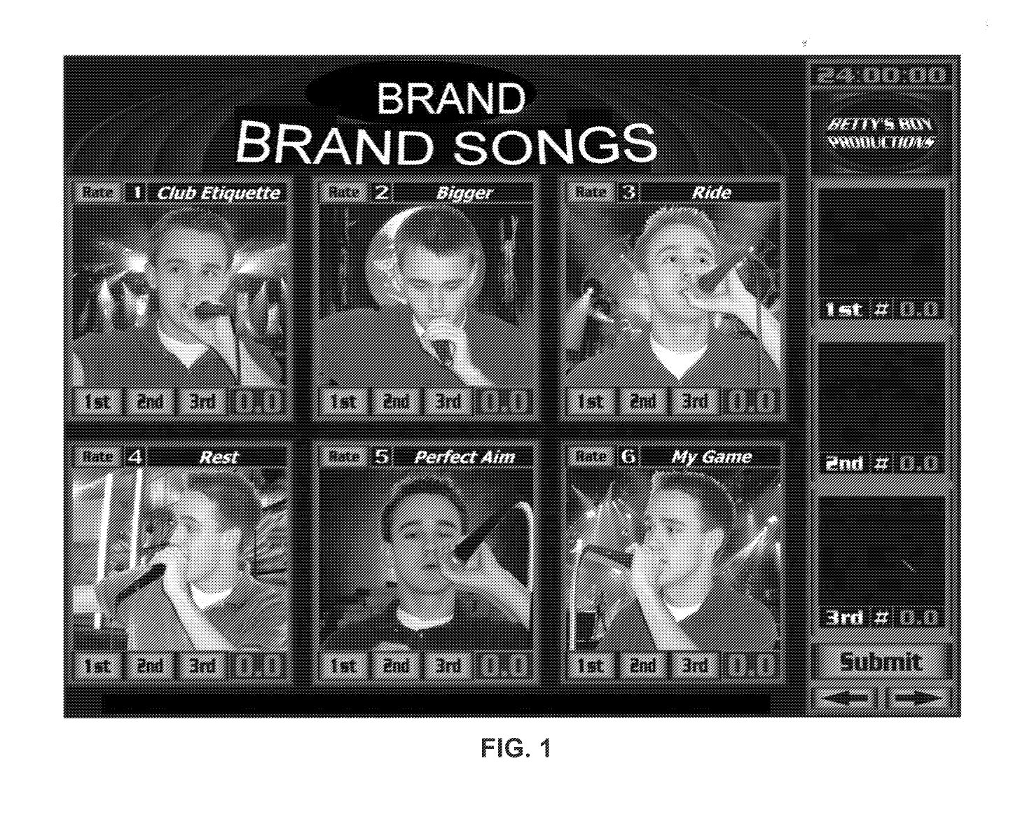

An exemplary rating and ranking system for use in the present invention will be described below with respect to FIGS. 1-27.

In an embodiment, the content offerings are provided to the massive focus group participants prior to a reveal event. A submission deadline may be implemented, such that participants will not be allowed to submit their ranking and/or rating selections after the submission deadline has passed. For example, on a weekly basis, the content offerings may be available for the participants to access at their leisure on Sunday, Monday, and Tuesday of the week. A submission deadline may be implemented at, for example, 11:59 pm Tuesday night. The reveal event may then take place on, for example, Wednesday.

During the participant submission timeframe, the control may not be identified to the participants. For example, the control may be the 18-24 age demographic, but may not be disclosed to the participants. This is so that the participants will not skew their answers based on knowledge of the control. In another embodiment, the control may be identified to the participants prior to the participant's ranking and rating. In another embodiment, the control may be identified to a participant after the participant has submitted their rating and ranking information, but before the submission deadline.

If the control is unknown to the participants at the time the ranking and rating information is submitted, the reveal event may include a reveal of the control. As mentioned above, the control may take one of many forms.

Ranking and/or rating information for the content offerings in the competition content is also received from the control. If the control is separate from the participants in the focus group, then the control selections may be identified before, during, or after the submission by the participants. If the control is selected from among the participants in the focus group, for example if the control includes all participants between the ages of 25 and 39, then the control selections may not be identified until after submission by the participants is complete.

Once the control and/or the control's selections are revealed, each participant in the focus group may be awarded points based on the similarity between that participant's rankings/ratings and the control's rankings/ratings. In an example, a participant whose rankings/ratings are most in sync with the control's rankings/ratings will be awarded a higher point total than a participant whose rankings/ratings are not as in sync with those of the control. The participants may be ranked based on their point values. Top-ranked participants may be eligible for special rewards. For example, participants having a weekly points total higher than a given number may be awarded with cash and/or prizes. Very highly ranked participants may be given the opportunity to participate in the competition as a judge (described below). In an embodiment, participants' points are evaluated on a weekly basis. In another embodiment, participants' points may accumulate over several weeks, with the participants having high accumulated point values being considered as highly ranked participants and given the opportunity to participate in the competition as a judge.

In an embodiment, judges are representatives of social media groups. Competition content may be provided to users of social media websites, where each user is identified as associated with a particular social media site. For example, a user may be associated with one or more social medial sites. Two example social media sites are referred to herein as Social Media Site #1 and Social Media Site #2. The users for a particular social media site compete against other users of that particular social media site. That is, Social Media Site #1 users compete against other Social Media Site #1 users, etc. In such an example, the user having the highest point total for a particular social media site may be selected as a judge to represent that social media site in an in-studio portion of the competition.

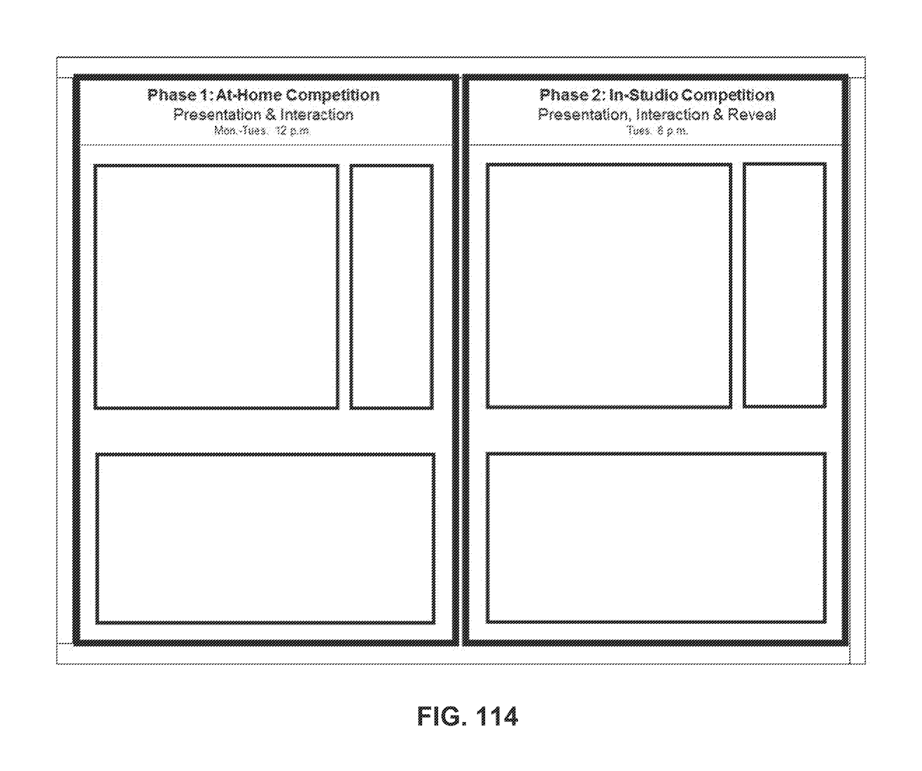

An exemplary interaction between each of the competitions in a multi-level competition will now be described according to an embodiment of the present invention. FIG. 114 indicates that an at-home portion of a multi-level competition, referred to herein as Phase 1, will take place from Monday until Tuesday at 12:00 pm. Although Phase 1 will be referred to herein as the “at-home competition,” one of skill in the art will recognize that a participant in the at-home competition does not necessarily have to be at their home; rather, any participant competing outside of the in-studio competition may be considered an at-home participant. In this example, Phase 1 includes a presentation component and an interaction component. FIG. 114 further indicates that an in-studio portion of a multi-level competition, referred to herein as Phase 2, will take place on Tuesday at 8:00 pm. In this example, Phase 2 includes a presentation component, an interaction component, and a reveal component.

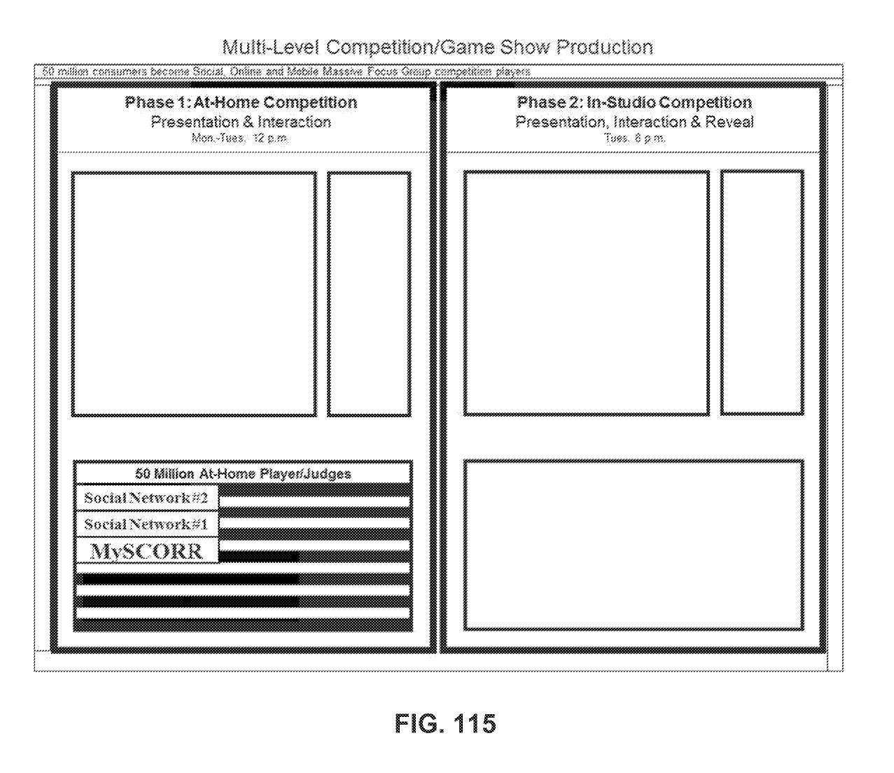

FIG. 115 indicates that 50 million participants Competed in Phase 1 of the multi-level competition. In other words, 50 million consumers became social, online, and mobile massive focus group competition players.

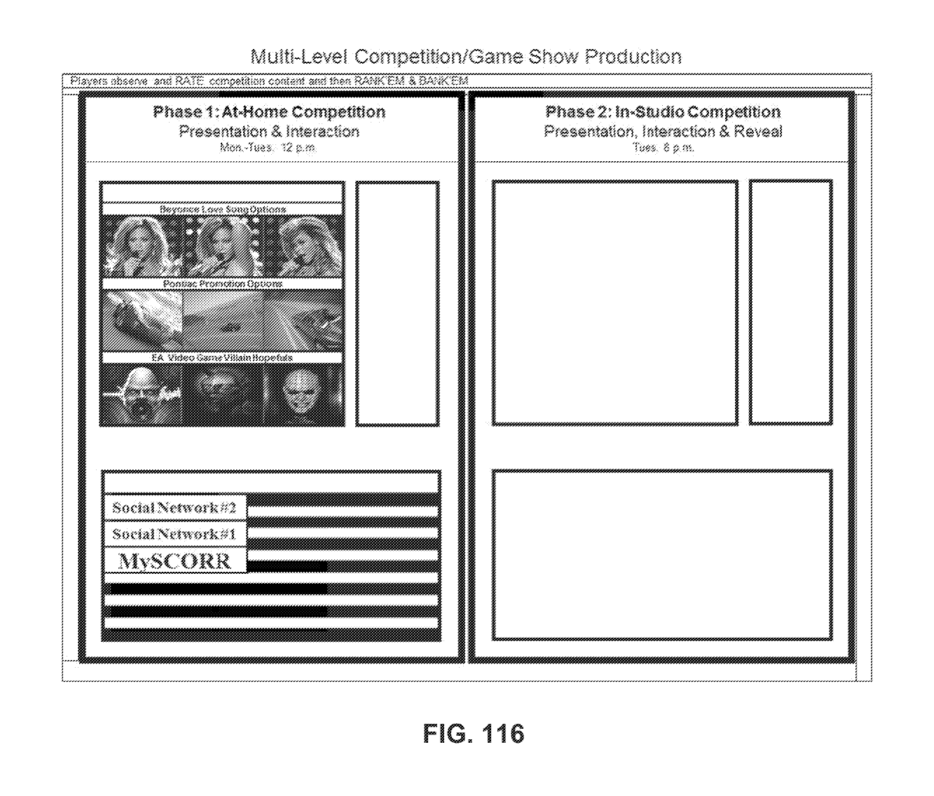

FIG. 116 shows the competition content that was available to the participants during Phase 1 of the multi-level competition. The first competition content set included three love song options from a particular artist as content offerings. The second competition content set included three Pontiac promotion options as content offerings. The third competition content set included three EA video game villain hopefuls as content offerings. During Phase 1, participants observe, rate, and/or rank each content offering in the competition content. Once a participant's rating and/or ranking is selected, the participant then submits the ratings and/or rankings (e.g., RATE 'EM, RANK 'EM, and BANK 'EM).

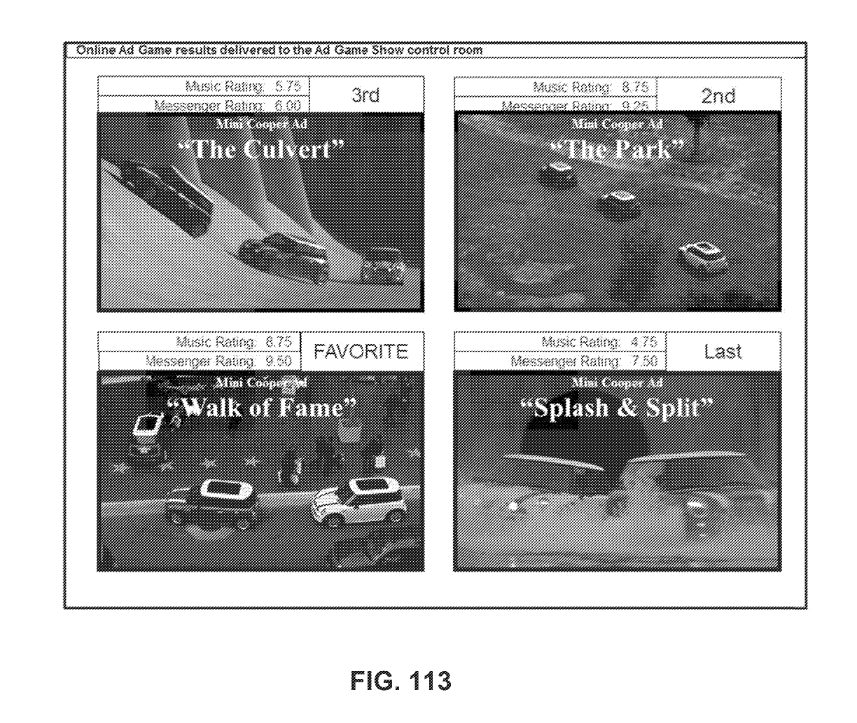

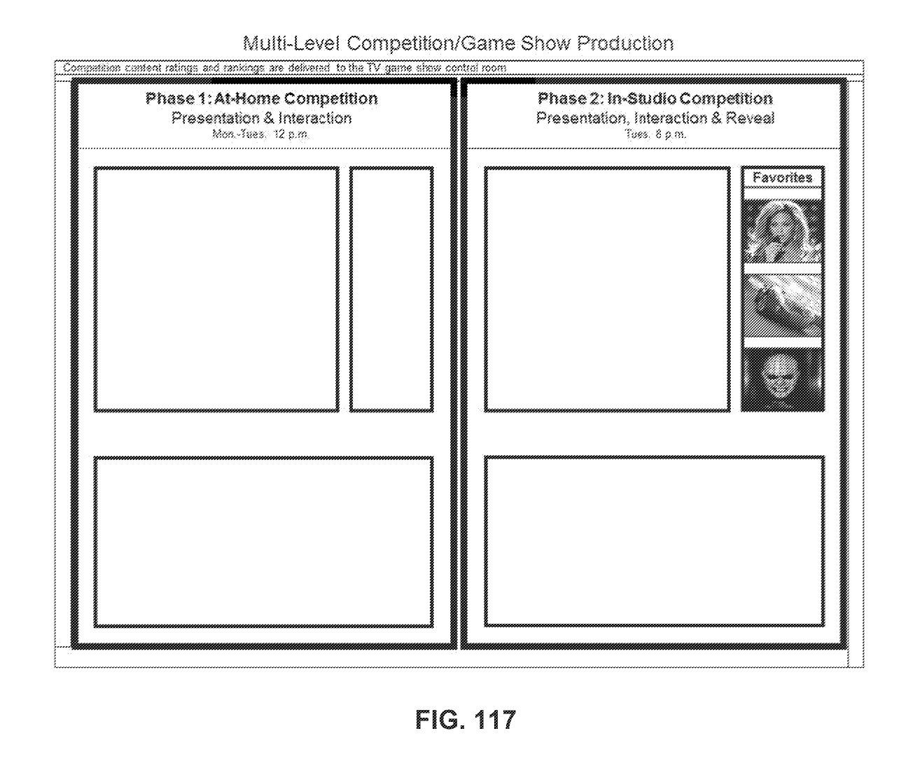

In FIG. 117, the competition content ratings and rankings are delivered to the television game show control room in Phase 2 of the multi-level competition. The ratings and rankings are used to identify the favorite content offerings within each competition content set. In an example where the Phase 1 participants represent American consumers, the favorite content offerings may be referred to as “America's favorites.” An exemplary format for the type of results data that can be captured from an online game and delivered to an Ad Game Show television or Internet studio control room is shown in FIG. 113, The ratings provided to each content offering (e.g., advertisement) is shown, as is the ranking of each content offering. In an embodiment, the ratings and rankings are averaged across all participants. In an embodiment, the ratings and rankings are averaged across all members of a control group. The favorite content offering (e.g., “America's favorite”) is identified.

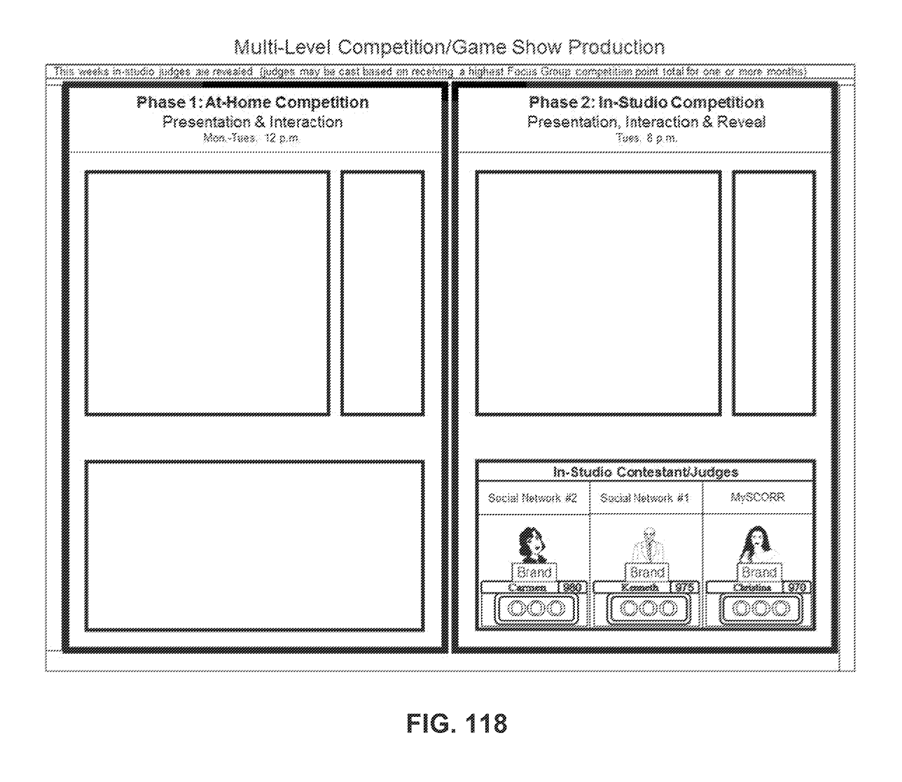

In FIG. 118, the week's in-studio judges are revealed, The judges may have been cast based on their receiving a highest focus group competition point total for one or more time periods (e.g., a month). The scores of the week's in-studio judges may also be revealed. In this example, the judge representing Social Media Site #2 has a point total of 980, the judge representing Social Media Site #1 has a point total of 975, and the judge representing an exemplary social media site referred to herein as “MySCORR” has a point total of 970.

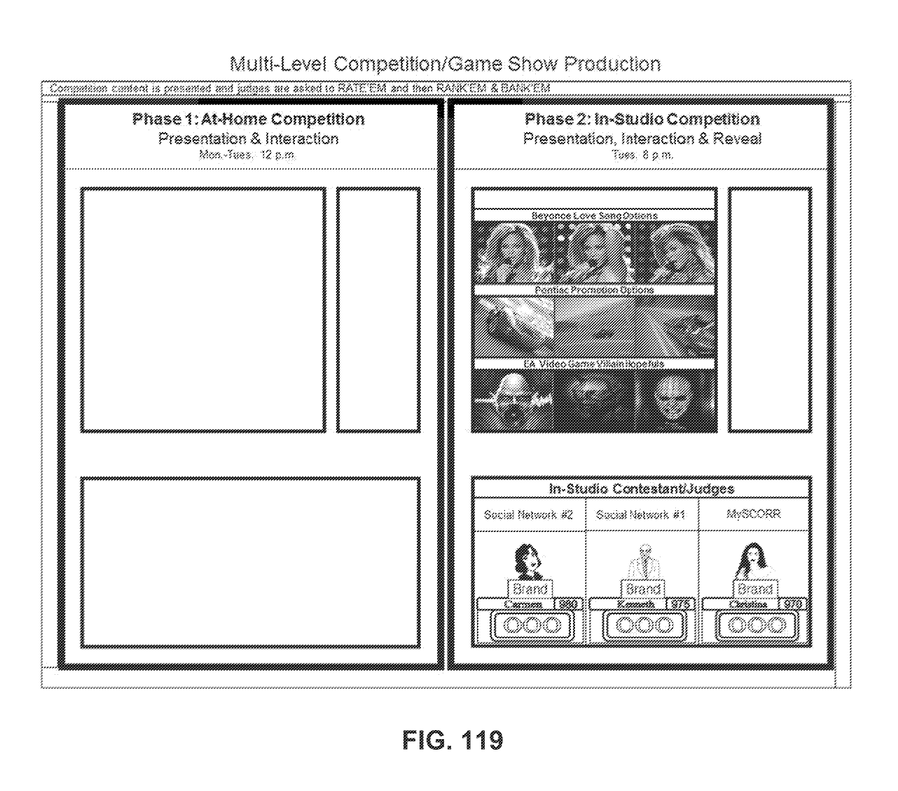

In FIG. 119, competition content is presented to the judges. The judges are asked to rate and rank each content offering in the competition content, and to submit their ratings/rankings (e.g., RATE 'EM, RANK 'EM, AND BANK 'EM).

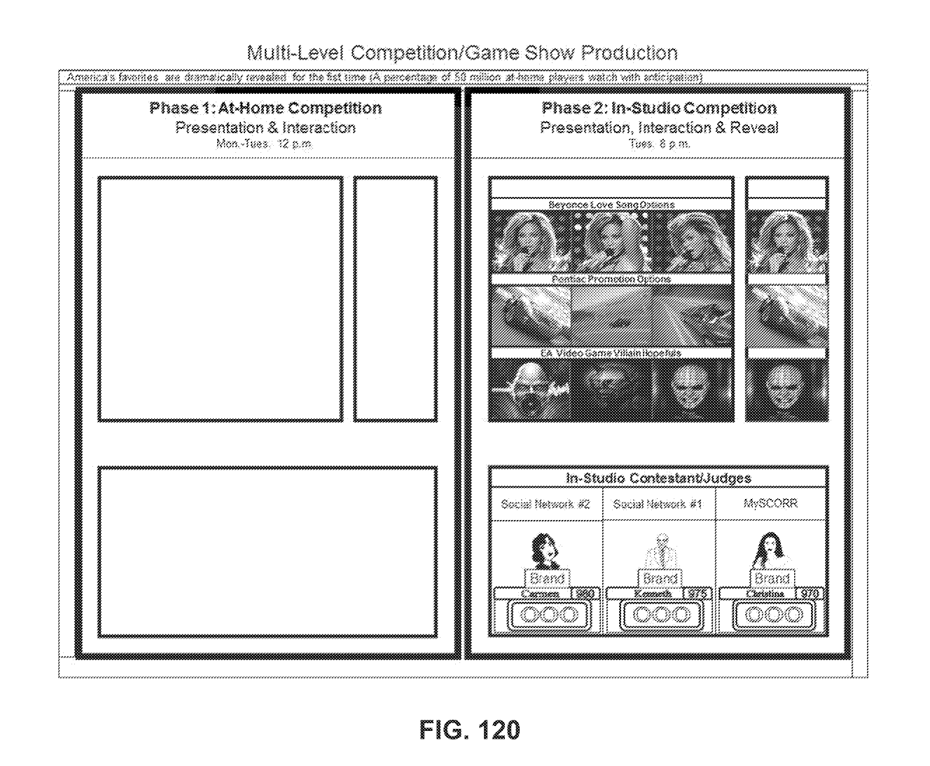

In FIG. 120, the favorite content offerings (e.g., “America's favorites”) within each competition content set are dramatically revealed to the public for the first time. Presumably, a percentage of the 50 million at-home players from Phase 1 are watching the show with anticipation as to whether they successfully matched the favorite content offerings.

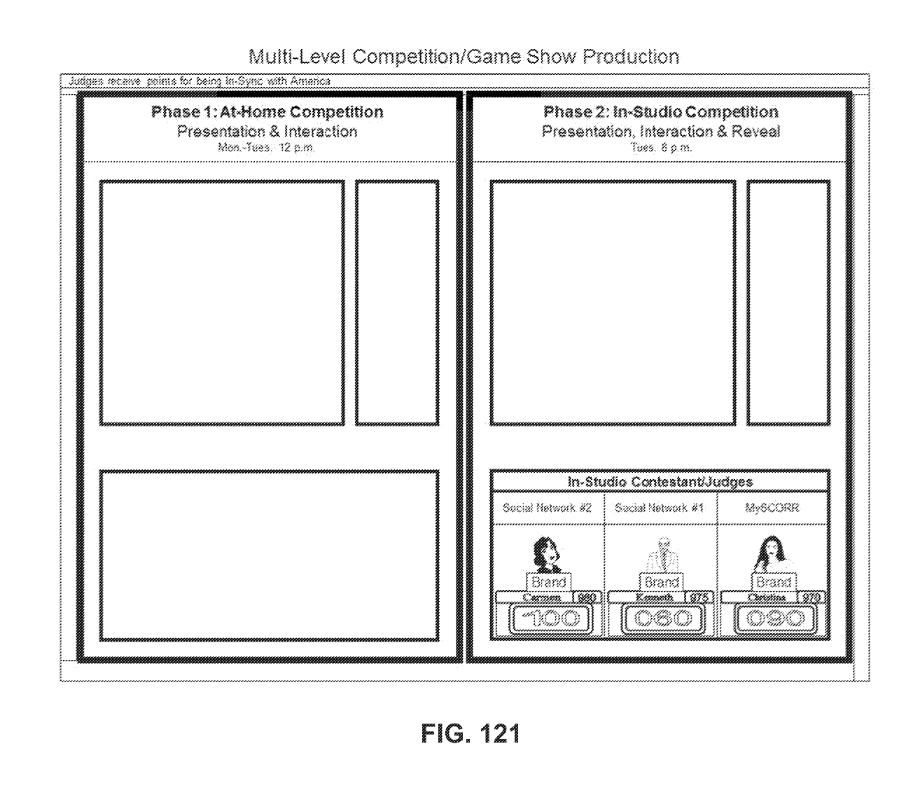

In FIG. 121, each judge is awarded a point total based on whether that judge's selections were in sync with the favorite content offerings revealed in FIG. 120 (e.g., in sync with America).

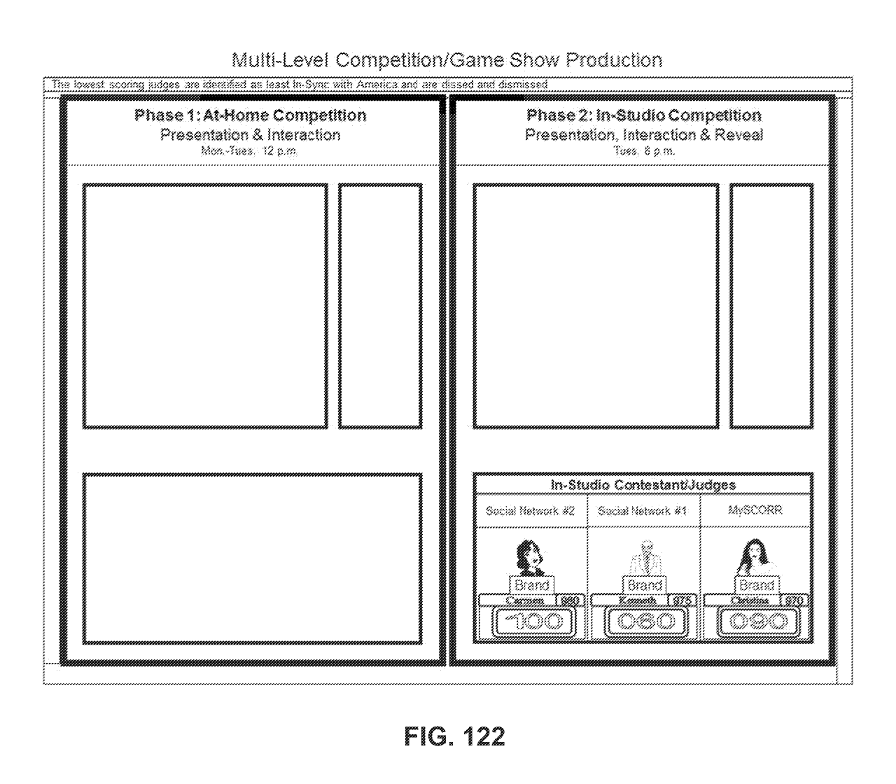

In FIG. 122, the lowest scoring judges are identified as least in sync with the favorite content offerings revealed in FIG. 120 (e.g., least in sync with America). One or more of the lowest scoring judges may then be dismissed.

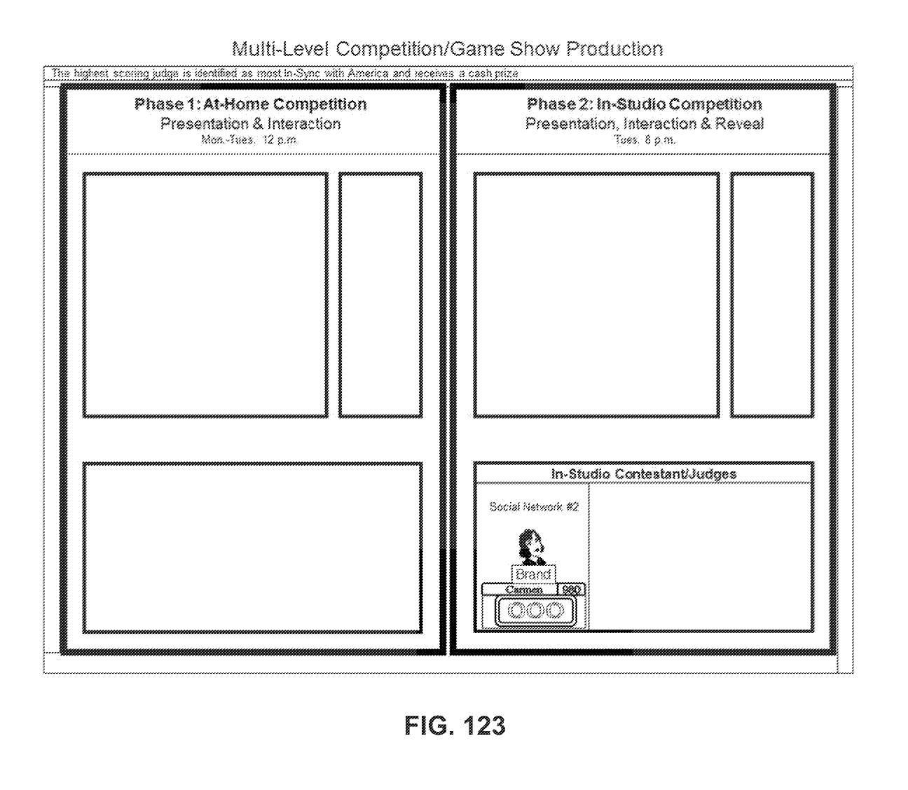

In FIG. 123, the highest scoring judge is identified as most in sync with the favorite content offerings revealed in FIG. 120 (e.g., most in sync with America). In an embodiment, the highest scoring judge receives a cash prize.

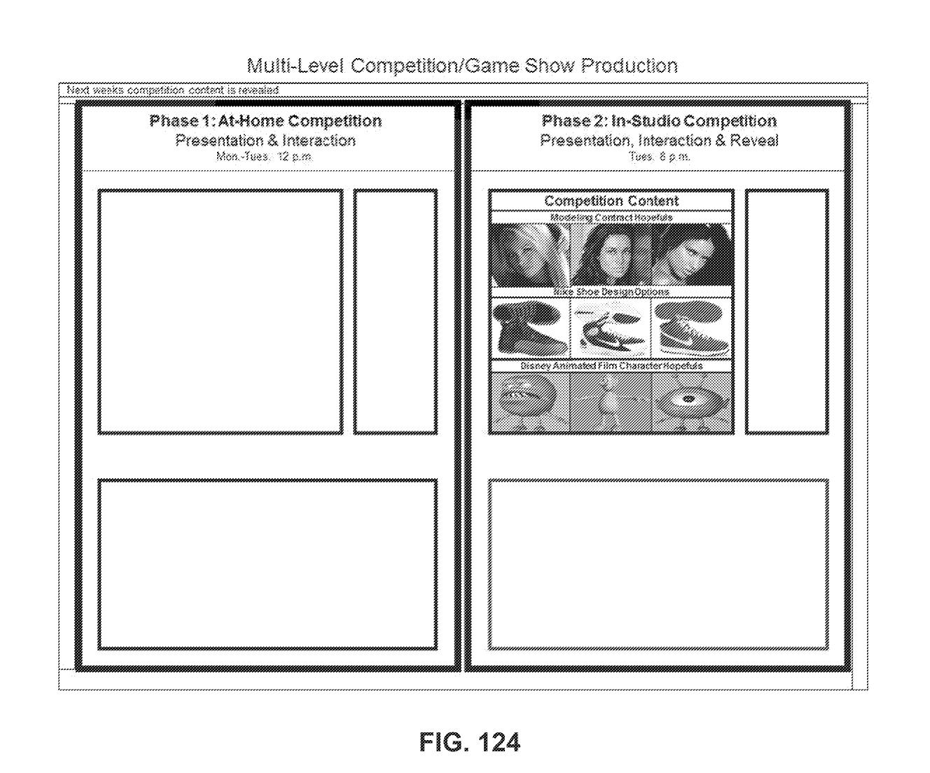

Its FIG. 124, the competition content for the following week is revealed. In the example of FIG. 124, the following week's competition content includes a set of modeling contract hopefuls, a set of shoe design options, and a set of animated film character hopefuls. The reveal of the competition content for the following week may occur during the same television broadcast as the in-studio competition. Alternatively, the reveal of the competition content for the following week may occur at a later time, and/or may occur in other formats, such as via an interactive website.

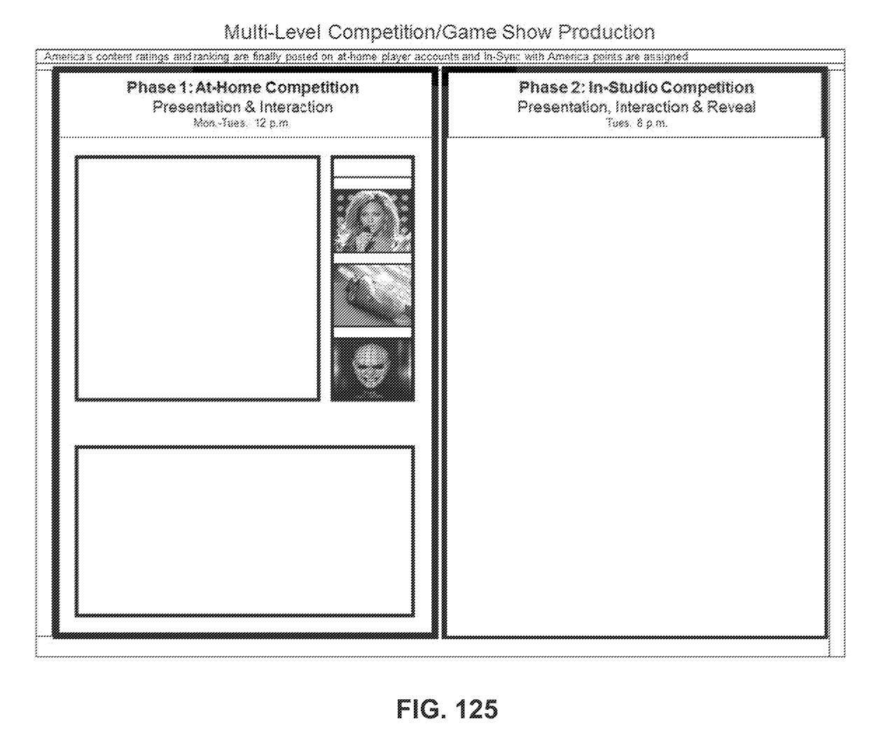

In FIG. 125, the content ratings and rankings selected by at-home participants are posted on at-home participant accounts. Each participant is assigned points based on how closely the participant was in sync with the favorite content offerings revealed in FIG. 120 (e.g., America's favorites).

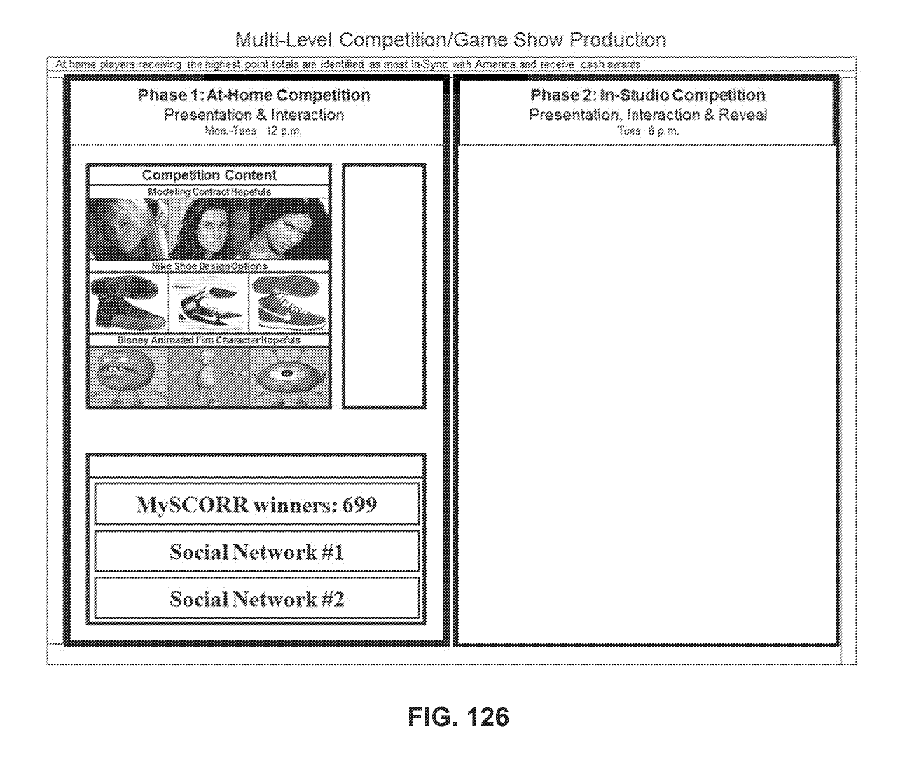

In FIG. 126, the number of at-home participant winners is disclosed. The number of winners may be classified according to, for example, a social media site with which the winners are associated. In the example of FIG. 126, there were 699 winners associated with the MySCORR social media site, 199 winners associated with Social Media Site #1, and 102 winners associated with Social Media Site #2. In an embodiment, each of the at-home winners receives a cash reward.

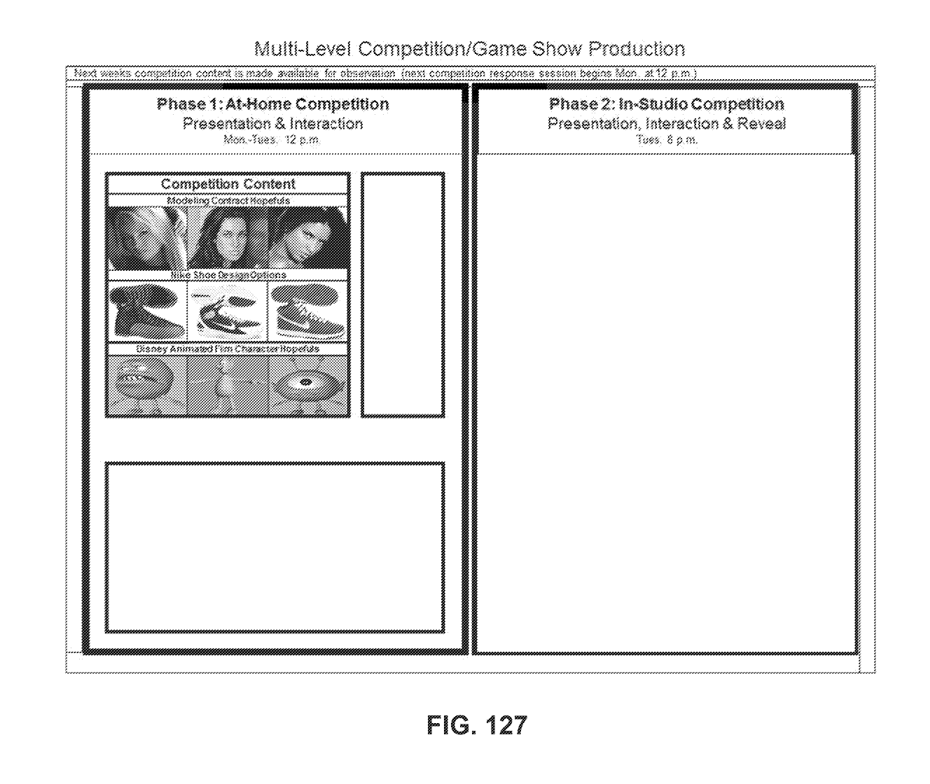

In FIG. 127, the following week's competition content is made available for observation. This may occur immediately following the televised broadcast of the current week, when the competition response submission window opens, or anytime in between.

### Judges Competition Overview

In an embodiment, this round of competition with displayed, live judges follows the first, “massive focus group” round, where competitors compete with mass, public judging. In this embodiment, the mass public judging is compared to the results of judging by a smaller, selected control group, to determine the top public round judges. This competition between public, audience member judges to become judges can be termed, in an embodiment, to be a second level of competition.

In an embodiment, these top public round judges appear on a televised round (televised judges) of competition where the competition content competitors compete and are judged by the selected top public judges. In an embodiment, the televised judges are competing to remain as televised judges. This competition between televised judges can be performed in various ways, one way being, as with the initial public judging, to compare their scoring with a known or unknown control group.

### Embodiments

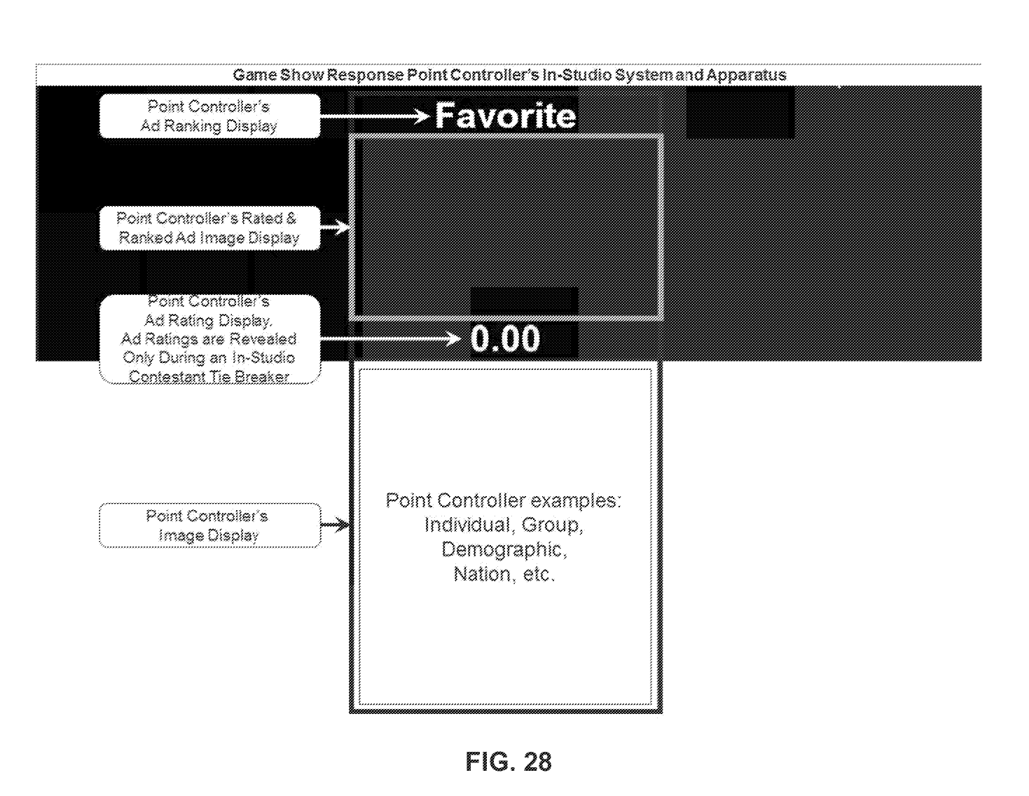

In an embodiment shown on FIG. 28, a control (also known as point controller) in-studio system is shown. In an embodiment, the representation of FIG. 28 represents the control that acts as the baseline for scoring in some of the multi-level games described herein.

In an embodiment, the representation shown acts to info viewers how the iSCORR Game Show is an extension of iSCORR's social, online and mobile competitions. In an embodiment, during the final segment of each results event we will announce the number of “In-Sync with the Controller” points are required for at home players to win cash, employment opportunities and Game Show contestant casting offers. The representation of FIG. 28 helps viewers (also known as at-home participants, or participants) see the selections made by the control, and compare these response selections to their own choices.

The embodiment on FIG. 28 shows the following elements E1-E4:

E1. Point controller's ad ranking display: In an embodiment, this display informs viewers which portion of the controller responses are bring shown.

E2. Point Controller's Rated & Ranked Ad Image Display: In an embodiment, this portion of the control representation shown a graphical representation corresponding to which response choice was selected by the control. For example, in a competition where singers are judged, if the control ranked a particular singer as 1st, a picture of this singer would appear in this section.

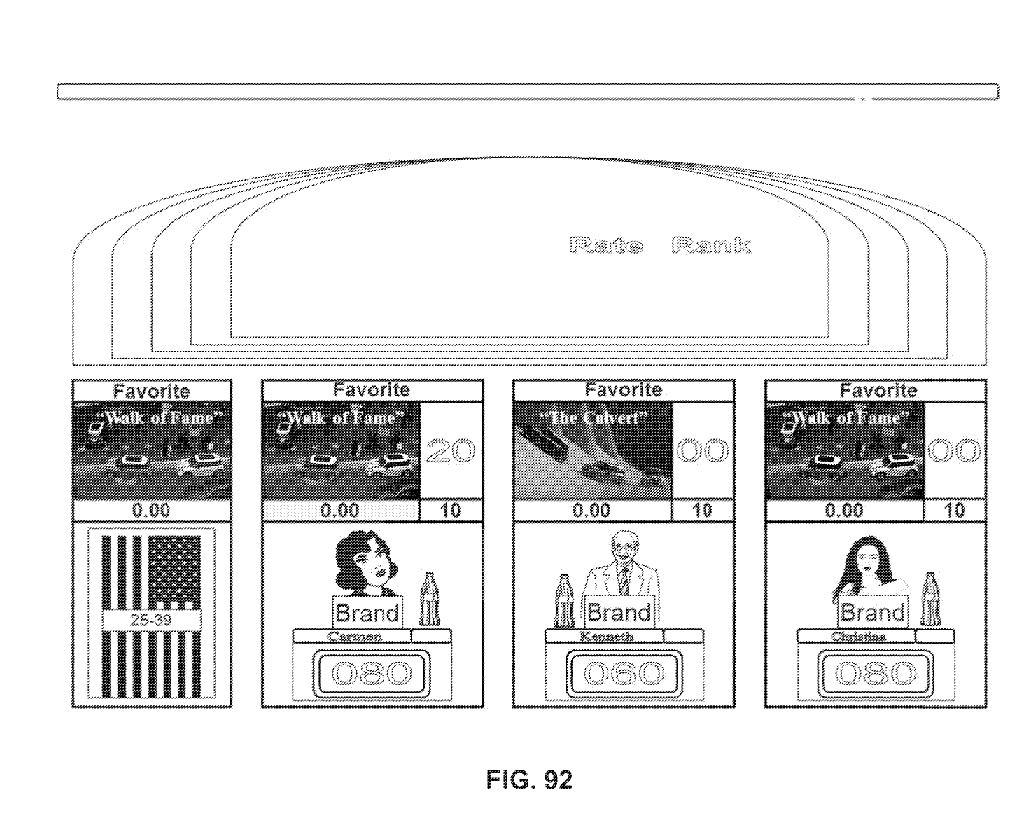

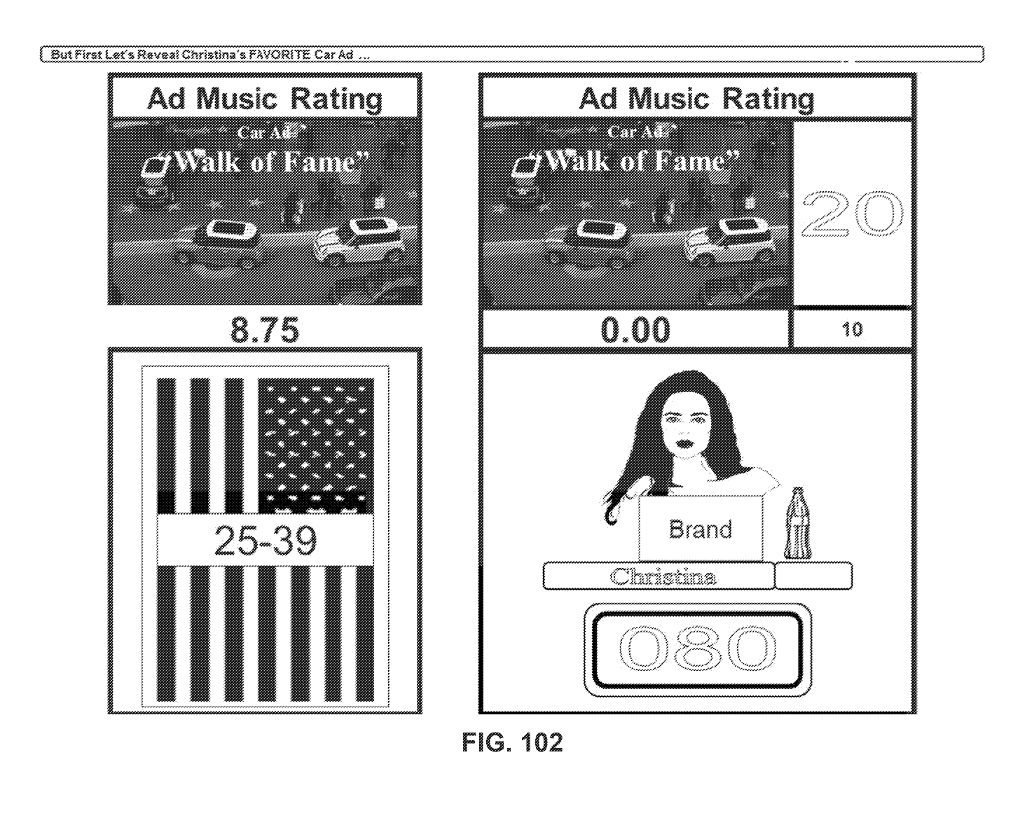

E3. Point Controller's Ad Rating Display: In an embodiment, this section can display a particular rating that was assigned by the control to a particular characteristic of a response choice. For example, a control may rate on a scale from 0-10 the quality of a particular soundtrack to a commercial, or the stage presence of a particular singer. In an embodiment, these ratings are collected, but only used/revealed during a contestant tie breaker round. An example embodiment of a tie-breaker round is discussed below with FIGS. 92-106.

E4. Point Controller's Image Display: In an embodiment, a graphical representation of the control is presented in this section. If the control is a single person, the representation could be a picture of the person; if the control is a group or company, the display could be a logo or other symbol.

The above described elements E1-E4 should be considered non-limiting examples of graphical displays of a characteristic of embodiments described herein. One having skill in the relevant art(s), given the description herein will appreciate that other display elements could be used.

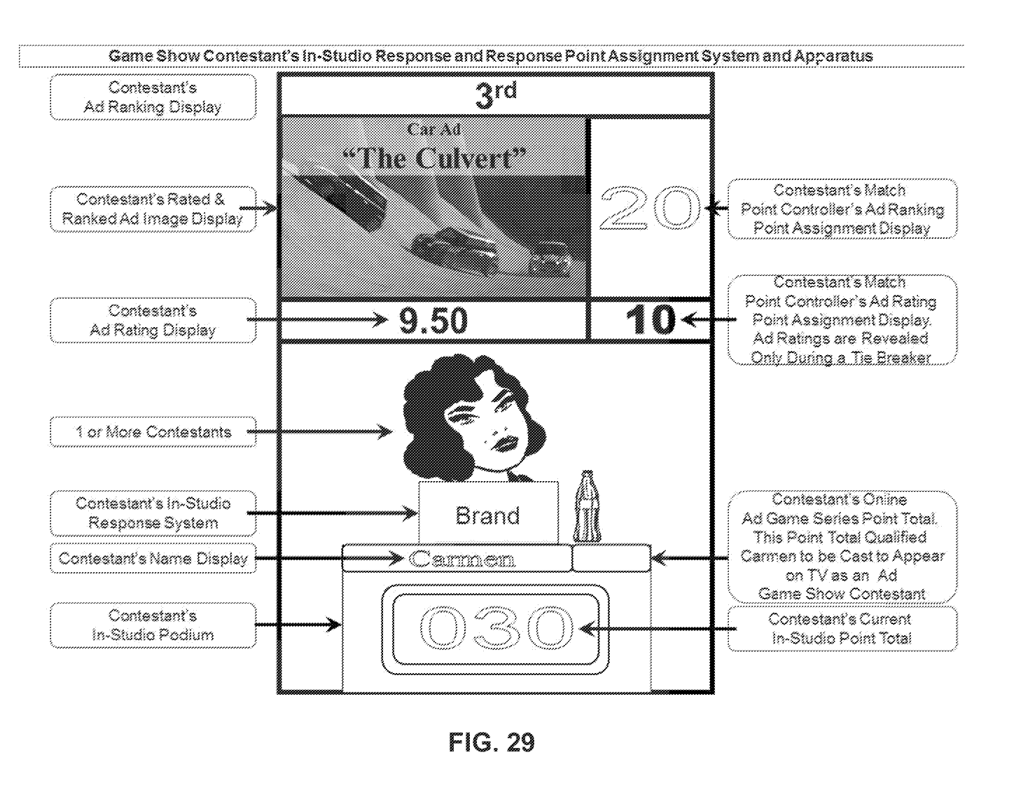

FIG. 29 depicts an embodiment of a graphical representation that is similar to the embodiment of FIG. 28. Instead of the control, FIG. 29 shows a graphical display associated with a judge (also known as in-studio contestant, judging contestant). This display can also be termed, in embodiments, a response point assignment system. The Features F1-F9 should be considered a non-limiting list of example features that can be incorporated in display embodiments:

F1. Contestant's Ad Ranking Display: In an embodiment, similar to E1 above.

F2. Contestant's Rated & Ranked Ad Image Display: In an embodiment, similar to E2 above.

F3. Contestant's Ad Rating Display: In an embodiment, similar to E3 above.

F4. Pictures of one or more contestants In-Studio: In an embodiment, similar to E4 above.

F5. Response System Contestant's Name Display: In an embodiment, this section displays the name associated with the judge.

F6. Contestant's In-Studio Podium: In an embodiment, judges are physically present in a studio, and this podium allows them to stand in a particular place.

F7. Contestant's Match Point Controller's Ad Ranking Point Assignment Display In an embodiment, as discussed below, this is value corresponding to the number of points awarded to a judge based on a comparison of their ranking selection to the control.

F9. Contestant's Match Point Controller's Ad Rating Point Assignment Display. Ad Ratings are Revealed: In an embodiment, this is value corresponding to the number of points awarded to a judge based on a comparison of their characteristic rating selection to the control, Similar to the point noted with E3 above, in an embodiment, this value is only used at a tie-breaking phase.

F10. Contestant's Online iSCORR. (Ad Game Series Point Total.): In an embodiment, this shows is the point total that qualified Carmen to be cast to appear on the show as a judge. On FIG. 29, this point total is blank, but in other embodiments a number can be listed.

F11. Contestant's Current In-Studio Point Total: In an embodiment, this is value corresponding to the number of points that have been awarded to a judge during the competition.

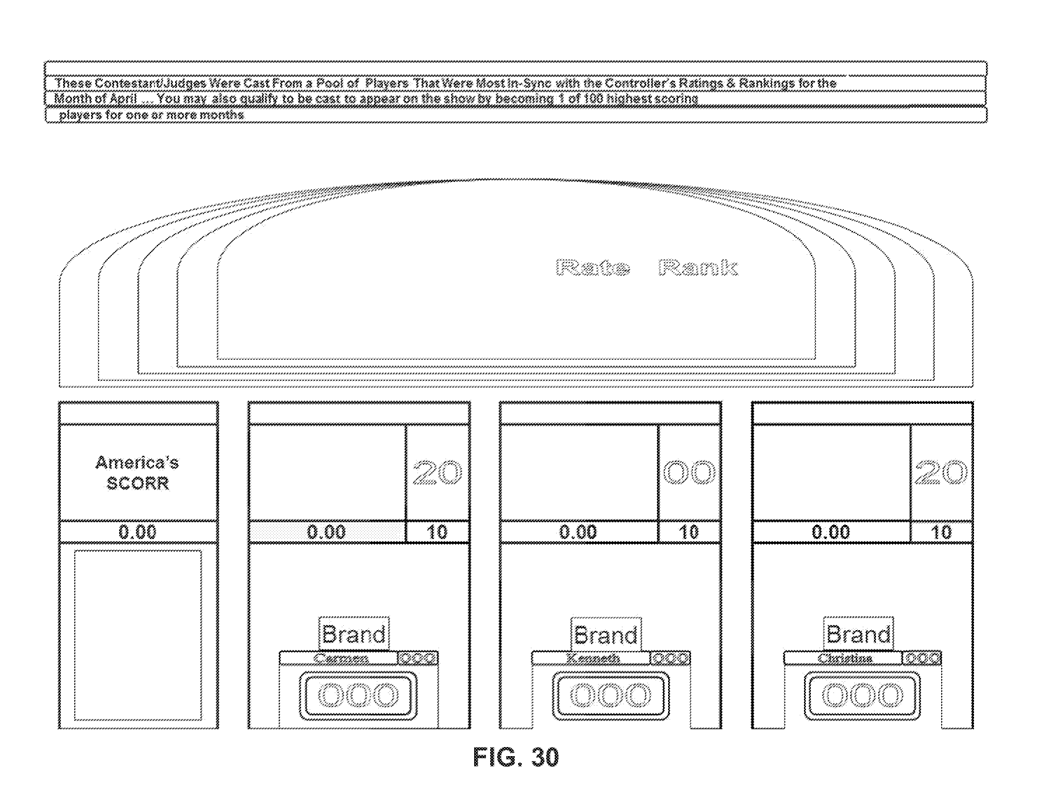

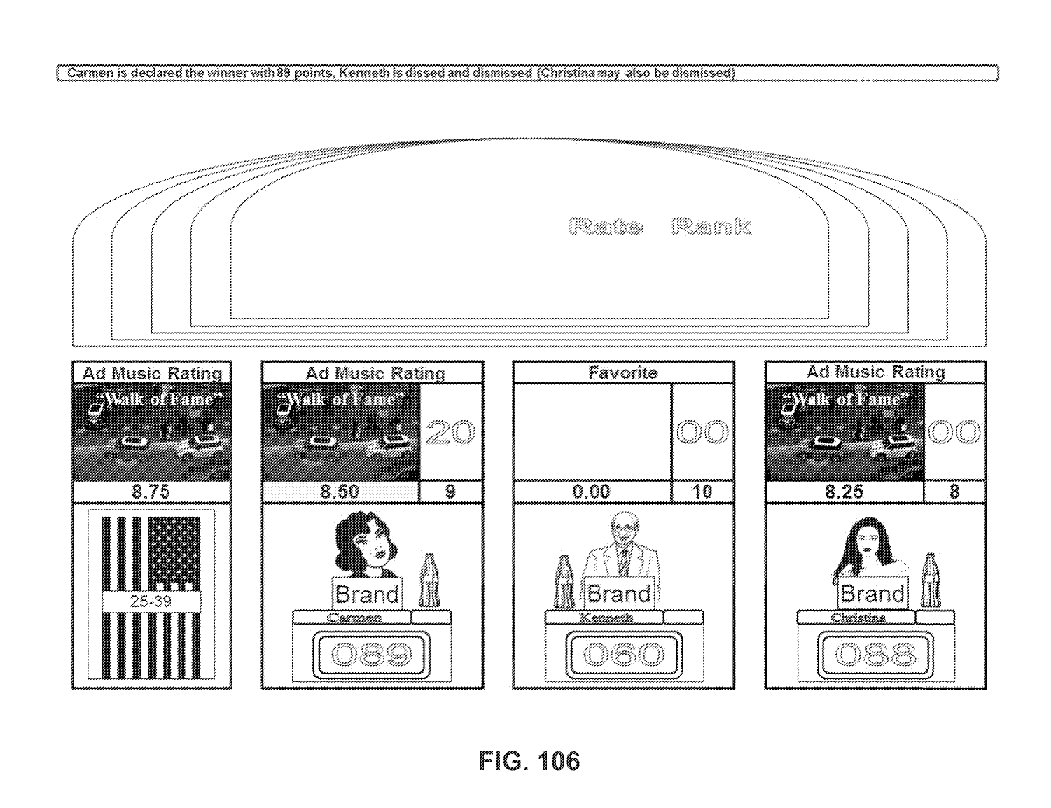

FIGS. 30-106 describe embodiments of a level of a multi-level game. In an embodiment, a level of a multi-level game has judges assessing competition content, and in the process of judging the content, the judges are competing against each other.

In an embodiment, there are multiple competitions being judged in sequence. A first competition can have subject matter that is selected to be of interest to a broad audience. Non-limiting examples of this broad audience include: A recording contract for a singer and a dancer for a stage show.

A second competition, to be judged in an embodiment, immediately after (or before) the first, is a competition that is selected to be of interest to a researchers. Non-limiting examples of researchers include market researchers, advertisers, product designers.

Examples of this competition include: music to be played in a car commercial, a tail-fin design for an aircraft, a color selection for a personal computer product line. An embodiment terms the voting structure as a “massive focus group” competition, and the multiple competitions as a “bi-level” competition—when two competitions are presented.

In an embodiment, the second competition has less appeal to a broad audience, but because the competitions are performed serially, the second contest can attract large participation. As would be appreciated by one having skill in the relevant art(s), given the description herein, embodiments of the total contest can have many different levels of competition content, each designed to have different levels of audience appeal and each having different value to demographic researchers and other parties.

FIG. 30 shows an embodiment of a game wherein three entities are voting on one or more competitions, along with a control group. In this example, the judging entities are “Carmen,” “Kenneth,” and “Christina,” and the control group is labeled “America's SCORR.” in this example, the control group is a selected demographic from the United States, and the control results are collected either before or concurrently with the judging by the judging entities.

In an embodiment, FIG. 30 shows a representation from a televised event, e.g., a televised reveal event, show. As would be appreciated by one having skill in the art, FIG. 30 shows an abstracted representation of what a television program could present. FIG. 30 shows an abstraction of the beginning of the competition presentation before the judging entities have been introduced.

In an embodiment, the judging entities, e.g., Carmen, Kenneth and Christina, are people that have been selected from a larger competing audience who have competed to appear on the television program. In an embodiment, the competing audience competed remotely, e.g., by an internet-based application, to appear as judges. In this example, the three judges that appear on FIG. 30 are the winners of this earlier, remote competition.

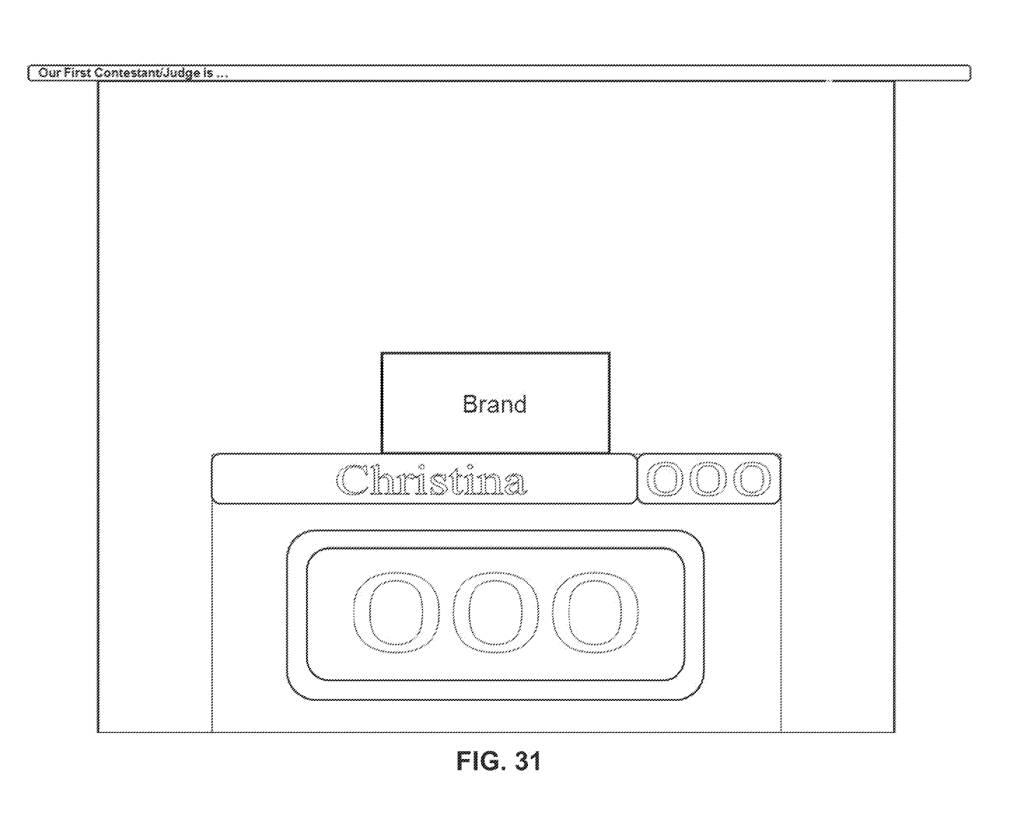

FIG. 31 shows a portion of the presentation wherein each judging entity is introduced, and other information can be presented. In this example, a brand-name (“Brand”) is associated with the judge (“Christina”) and her initial score (“000”) is shown. In an embodiment, the “Brand” labels on the FIGs. are representations of the brand of computers that are provided to the judges. In this embodiment, by having the judges interact with the computers—using the same interface as the home version of the game—additional public interest can be promoted.

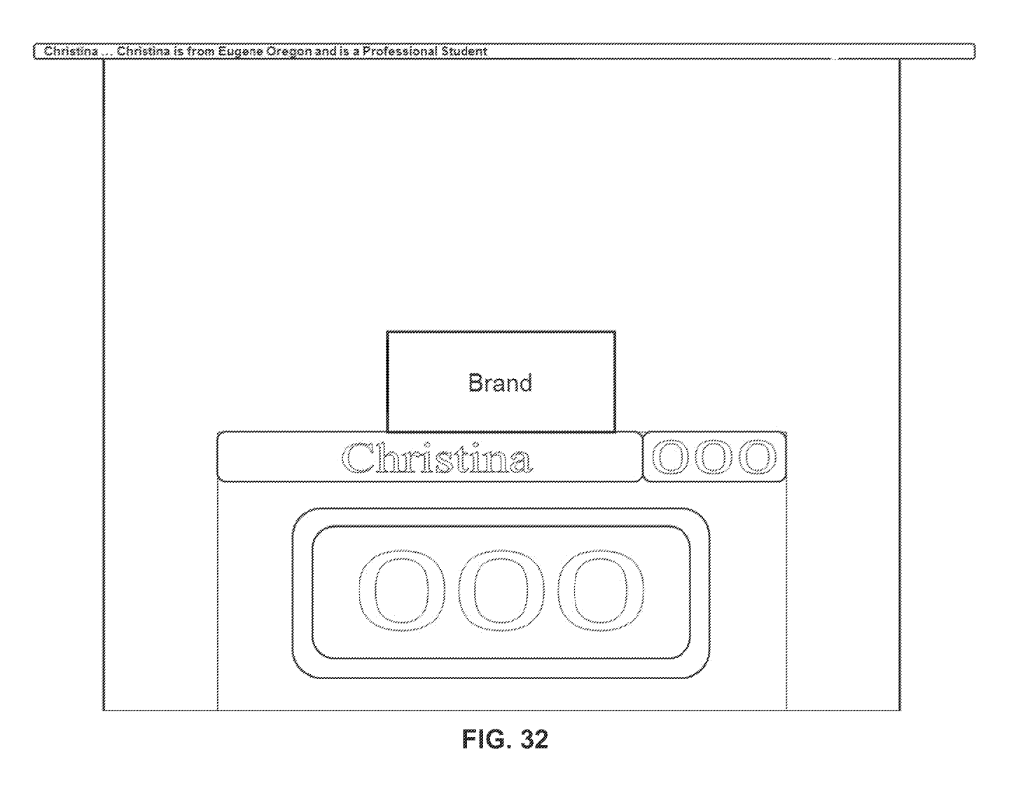

FIG. 32 shows Christina's groups: Eugene Oreg. is her hometown and professional student is her occupation. In other embodiments, judging entities can be representatives of different groups of people, e.g., social groups, demographics, etc. In one example, the social groups are online groups such as example Social Network #1, and Social Network #2. In an embodiment, Christina could represent Social Network #1, and audience appeal could be generated based on this broad association.

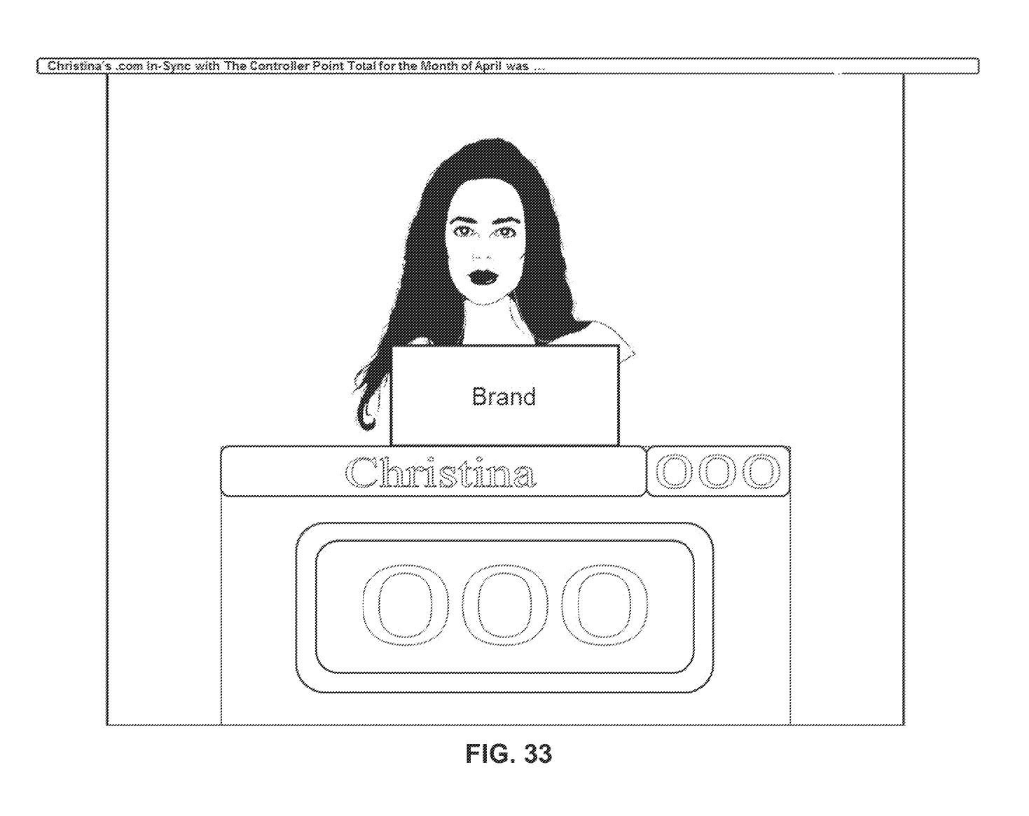

In FIG. 33, in an embodiment, a judge (Christina) is introduced to a viewing audience, e.g., television audience, network video audience, live audience for a performance, or any combination of the foregoing. In an embodiment, judges can be live in a broadcast studio, represented by pictures (as depicted on FIG. 33) or perform their judging tasks in secret. If a judging entity is a group of people, the group may be introduced at this point, or only a representative can be present, according too an embodiment.

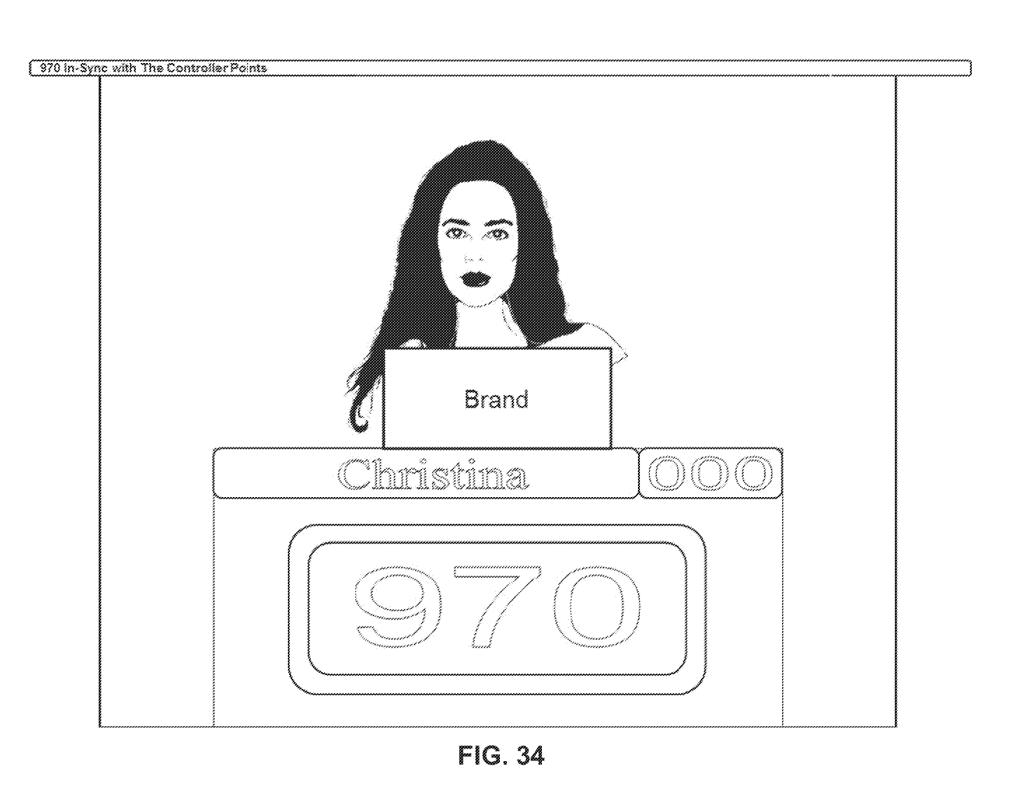

FIG. 34 depicts an embodiment where, after the judge is introduced, a score is displayed corresponding to the judge's “in-sync” score (970) over a time period, e.g., days, weeks, months, etc. The time period displayed on FIG. 34 is for the month of April. In an embodiment, displaying progress, successes, failures, information, about a judge helps an audience develop and maintain interest in their competition progress. As would be appreciated by one having skill in the relevant art, given the description herein, other approaches to developing audience connection with judging entities can be used.

In an embodiment, as discussed herein, the displayed “in-sync” score is a numeric representation of what portion of this judge's responses (selections, judging events) match up with an “accurate” selection. In an embodiment, the accurate selection is the selection of a particular group, entity, person, that represents a “control” group to judge against. In this example, the “in-sync” score measure how synchronized the judge's scores are with this control group. Control groups are discussed further herein as well. As is discussed below, this displayed score, in an embodiment, is relevant to the judge's success in competing against other entities, e.g., other judges, a studio audience, a home audience. Embodiments may call this score by different names, “in-sync” being one non-limiting example.

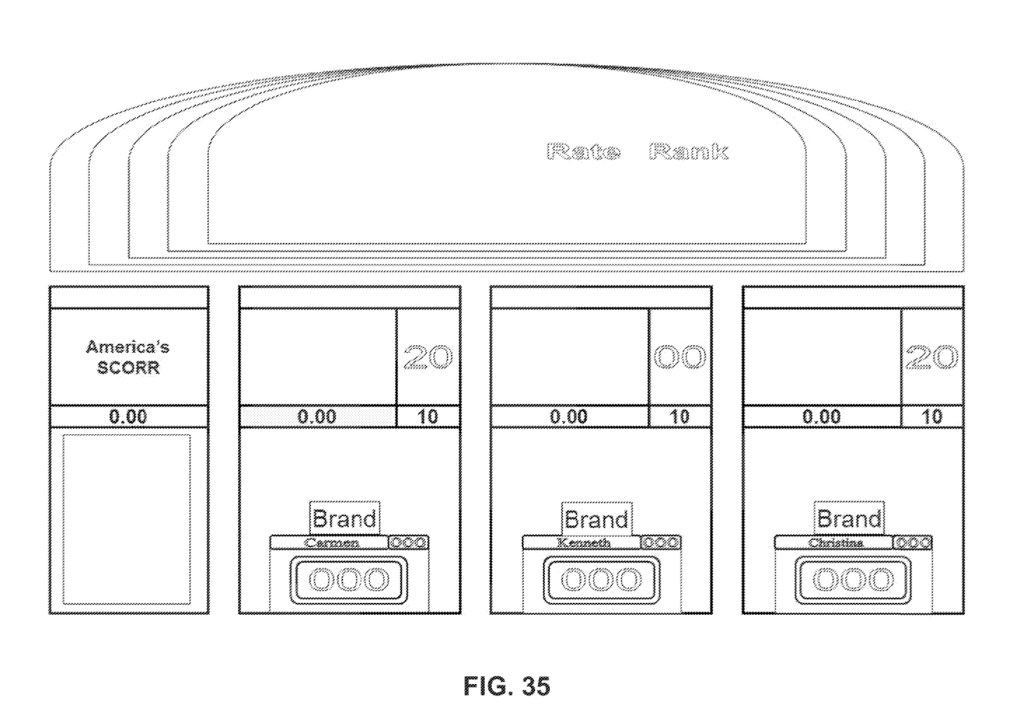

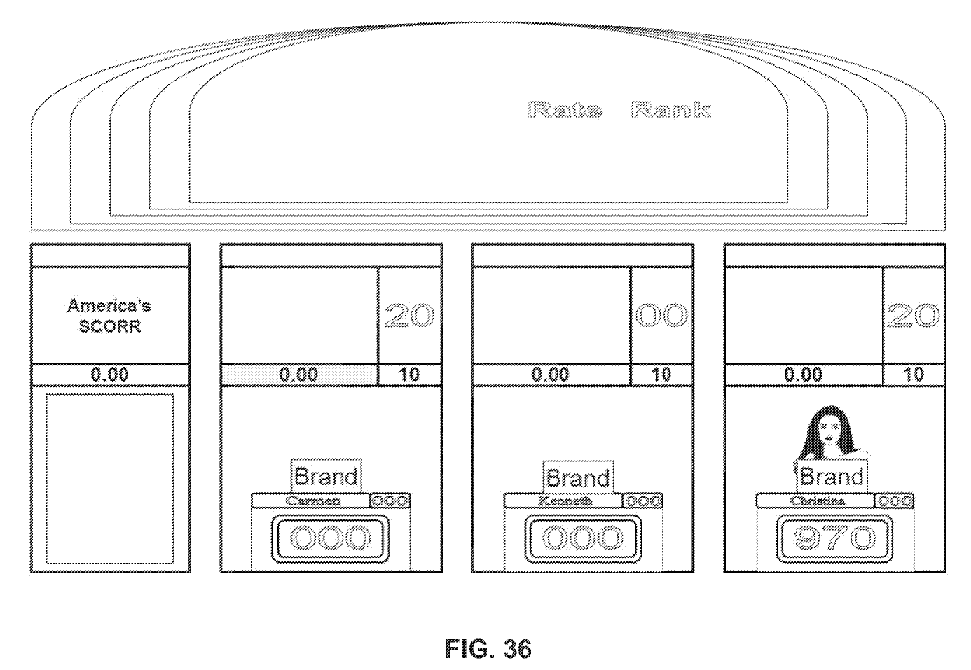

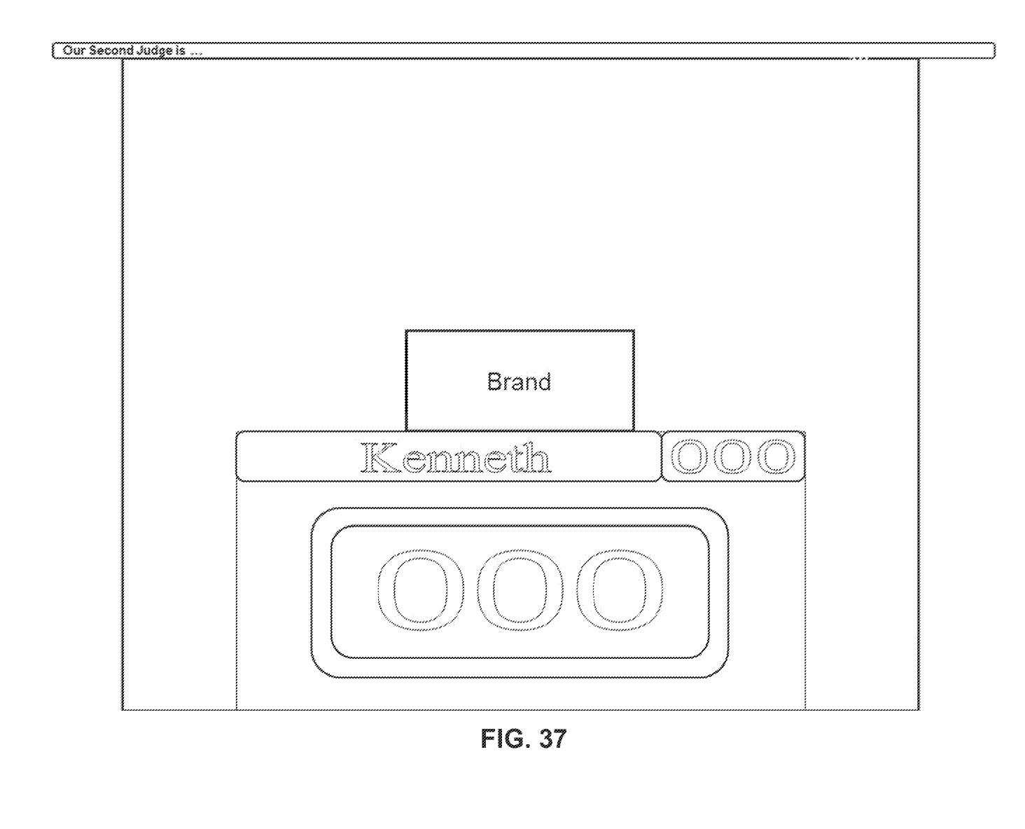

In an embodiment depicted on FIGS. 35 and 36, the judges are shown, along with their current scores, statistics, groups (if used) and pictures. Continuing with the non-limiting example, in FIG. 37, “Kenneth” is introduced. In an embodiment, judging entities that are individual people can compete against other types of entities noted above (social groups, companies). Judges who are non-celebrities can compete against celebrity judges. Different criteria can be used to select celebrity judges, in an embodiment, allowing these judges to be selected without winning a competition.

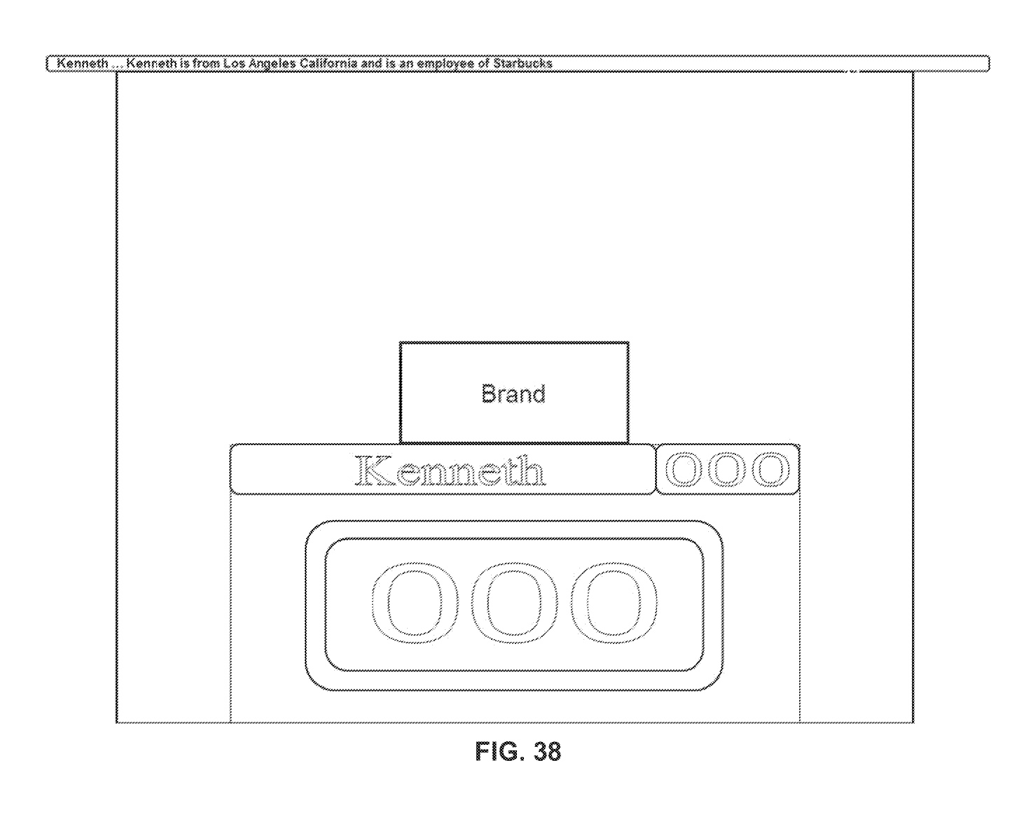

In FIG. 38, an embodiment is depicted where the second judge (Kenneth) has his groups presented to the audience. In an embodiment, judges could be selected (or preferred in a competition) because of the competitive groups to which they belong. In an embodiment, two competing advertisers, e.g. automakers, could suggest a game structure whereby their respective customers (or employees, related firms) are selected as judges. In this embodiment, audience interest can be promoted by the groups selected, and the presentation of the judge's group membership.

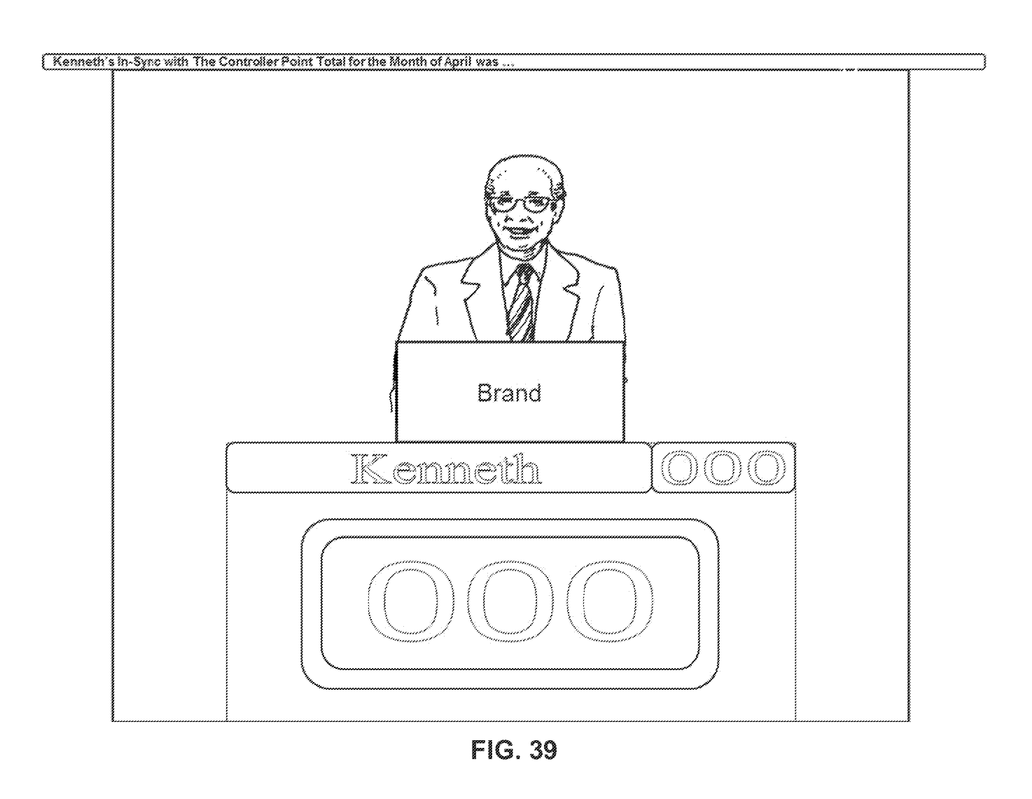

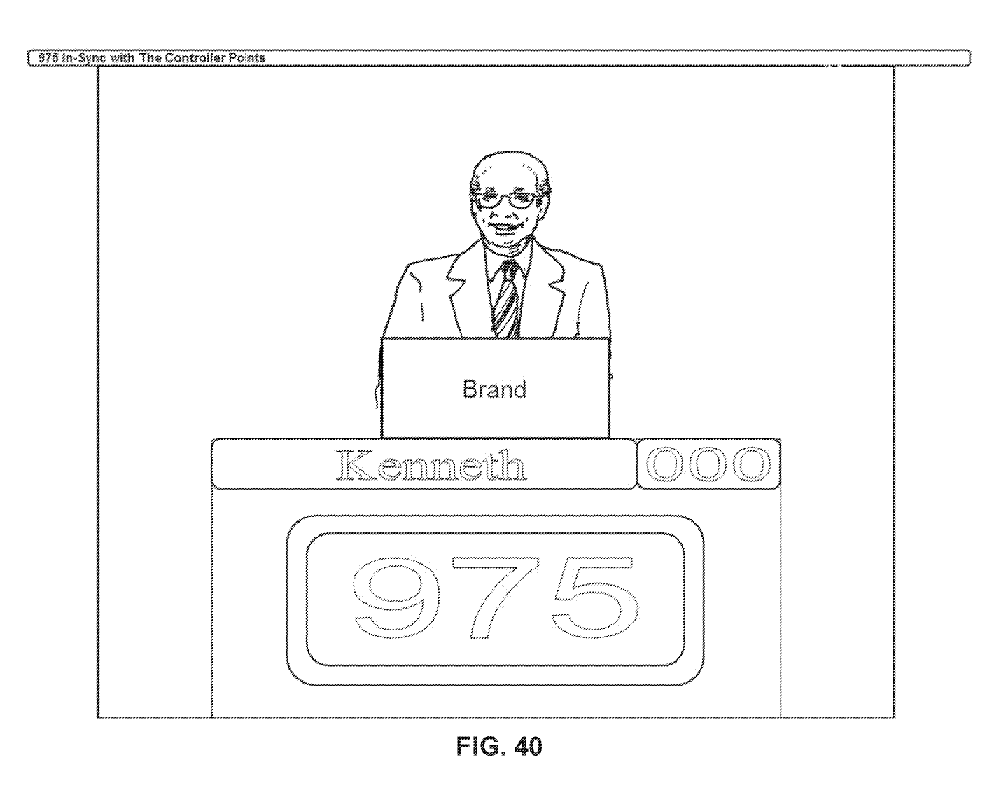

Continuing with this example, in FIGS. 39 and 40, Kenneth's “in-sync” score is displayed for the audience

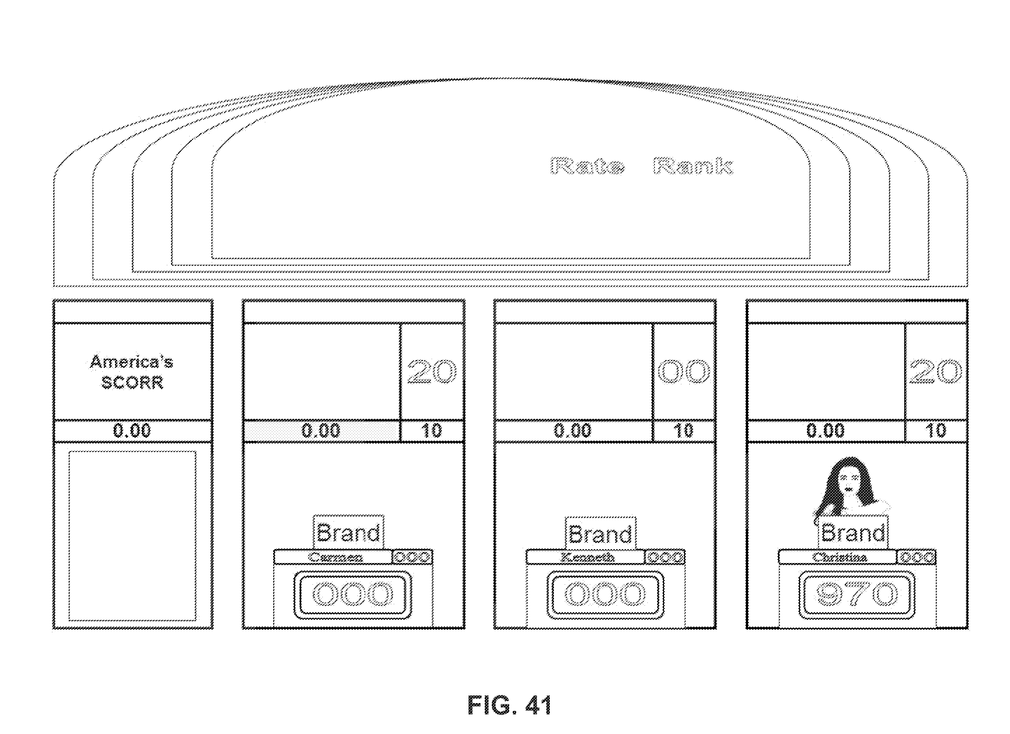

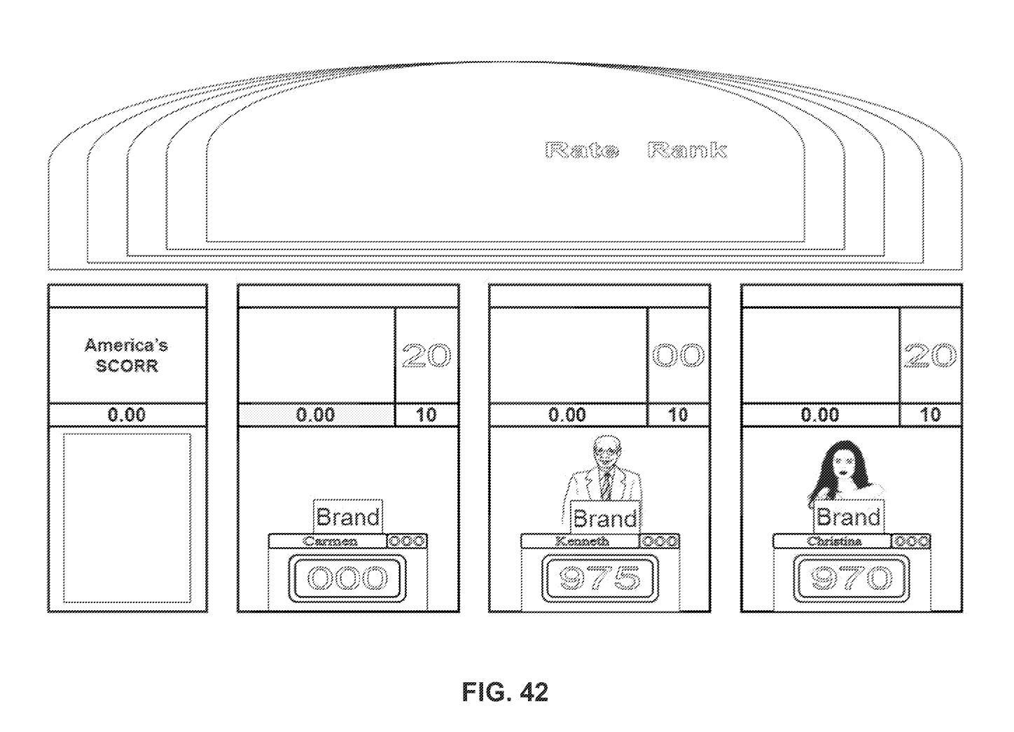

In FIG. 41, judge display is presented, in an embodiment, after each score, and in FIG. 42, Kenneth is added to the display. In an embodiment, this judge-competition display is similar to the interface used by a participation application used by a home audience to participate in similar steps. Seeing a judge on television, especially a celebrity judge, in a display that is similar to one in which an audience member has had their picture displayed, can generate audience interest, according to an embodiment.

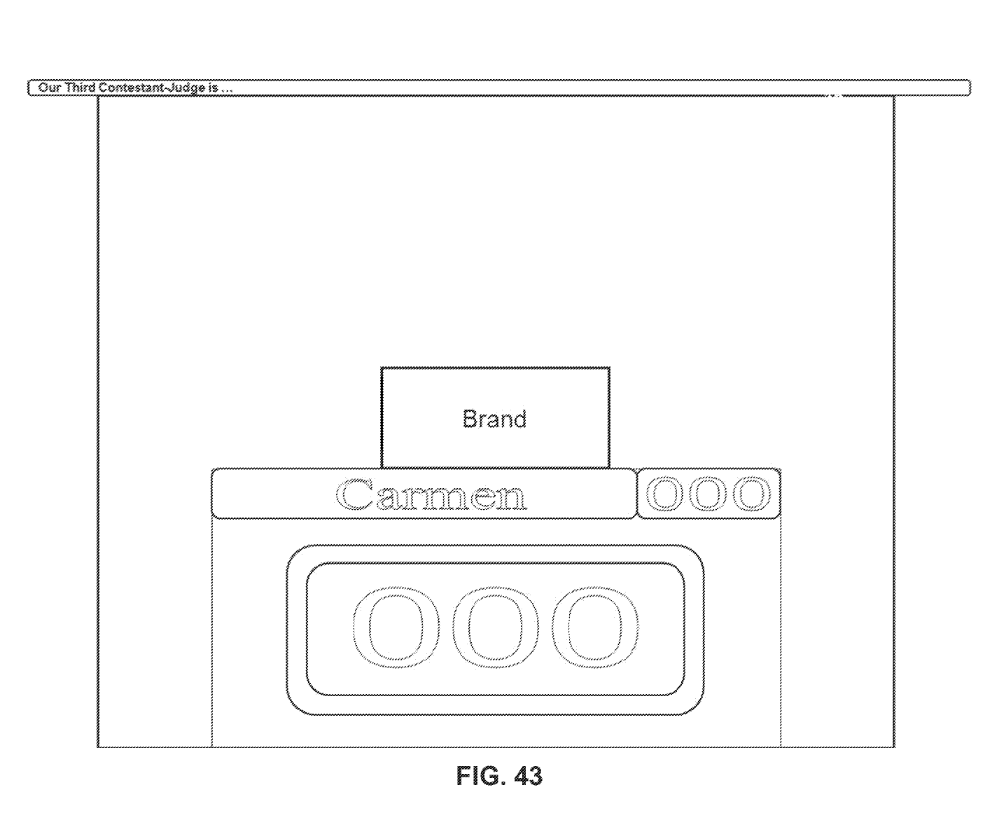

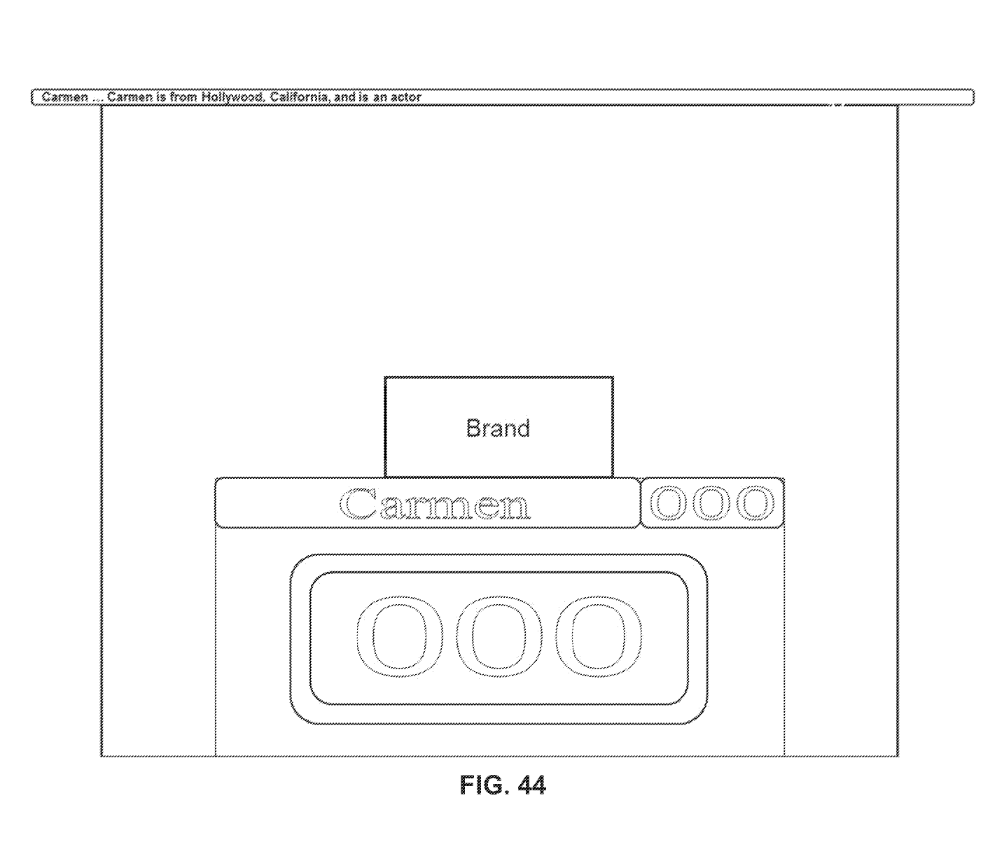

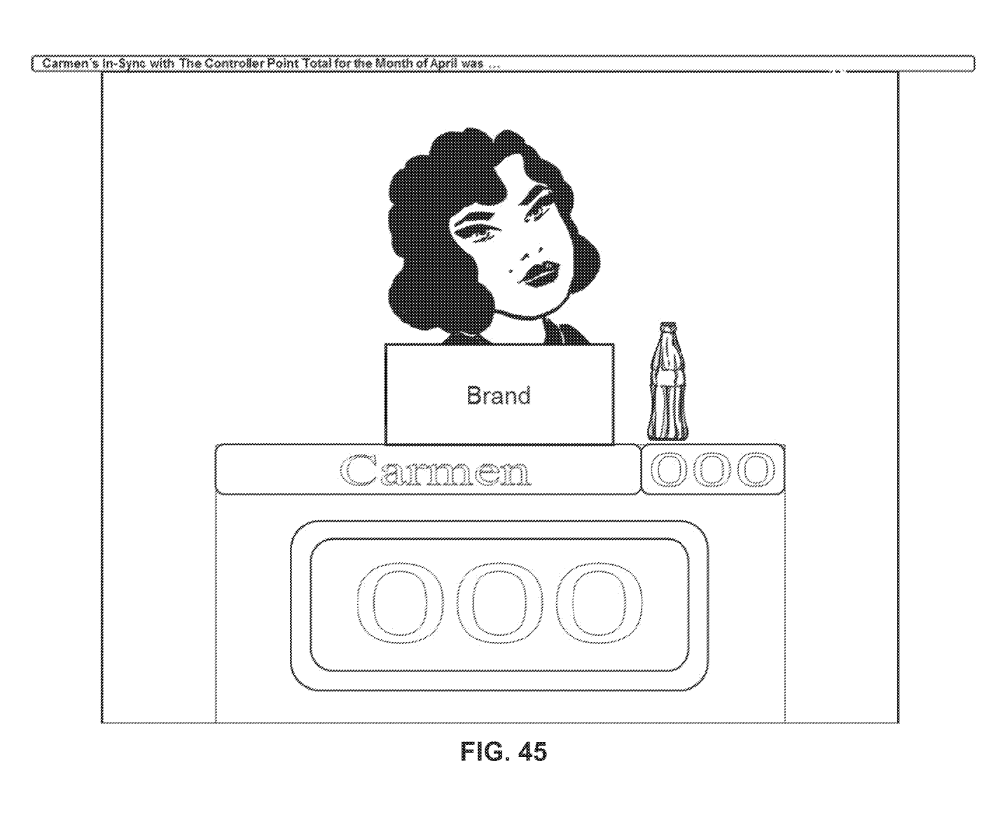

In FIG. 43, an embodiment with a third judge is depicted. In an embodiment, the number of judges participating/competing can be an reasonable limit, and not only the three described in this example. In an embodiment, as depicted on FIG. 44, the third judge is a celebrity judge—Carmen Electra, and her likeness is displayed prominently on FIG. 45. As depicted in the example of FIG. 45, other products can be presented during the judge visuals. This use of product images, in an embodiment, can be combined with the group concepts (e.g. competing companies) to promote interest in the game, according to an embodiment.

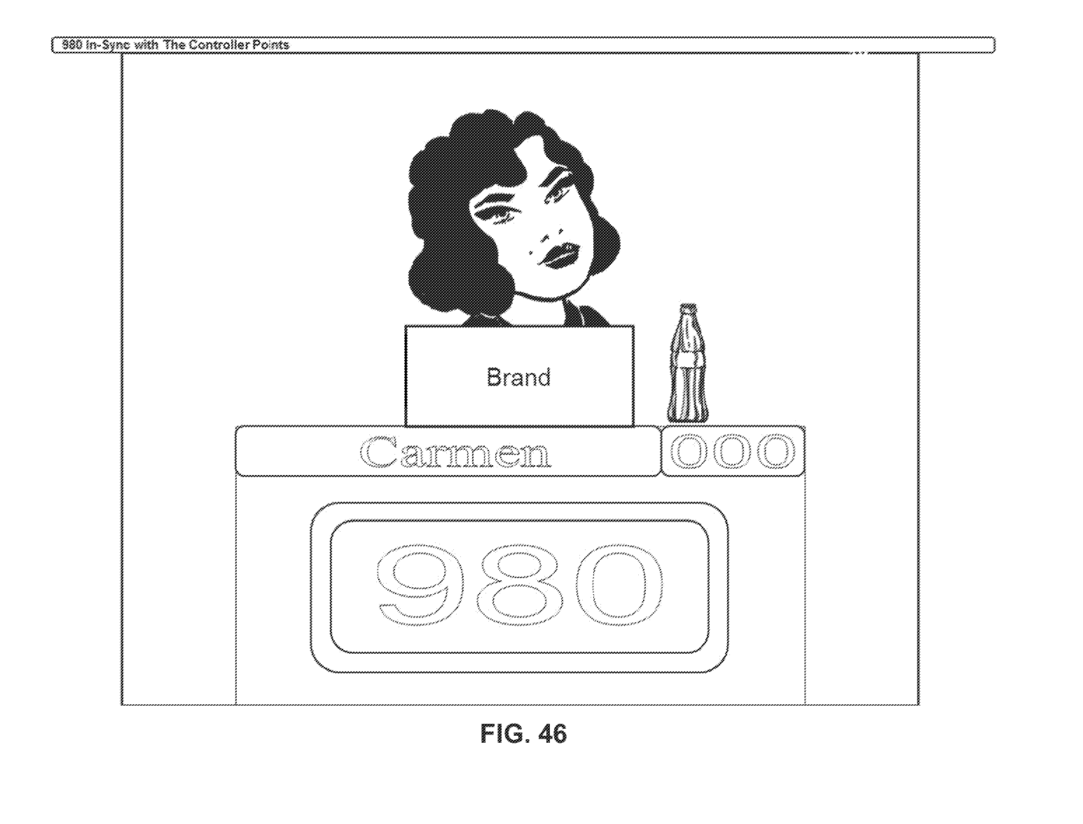

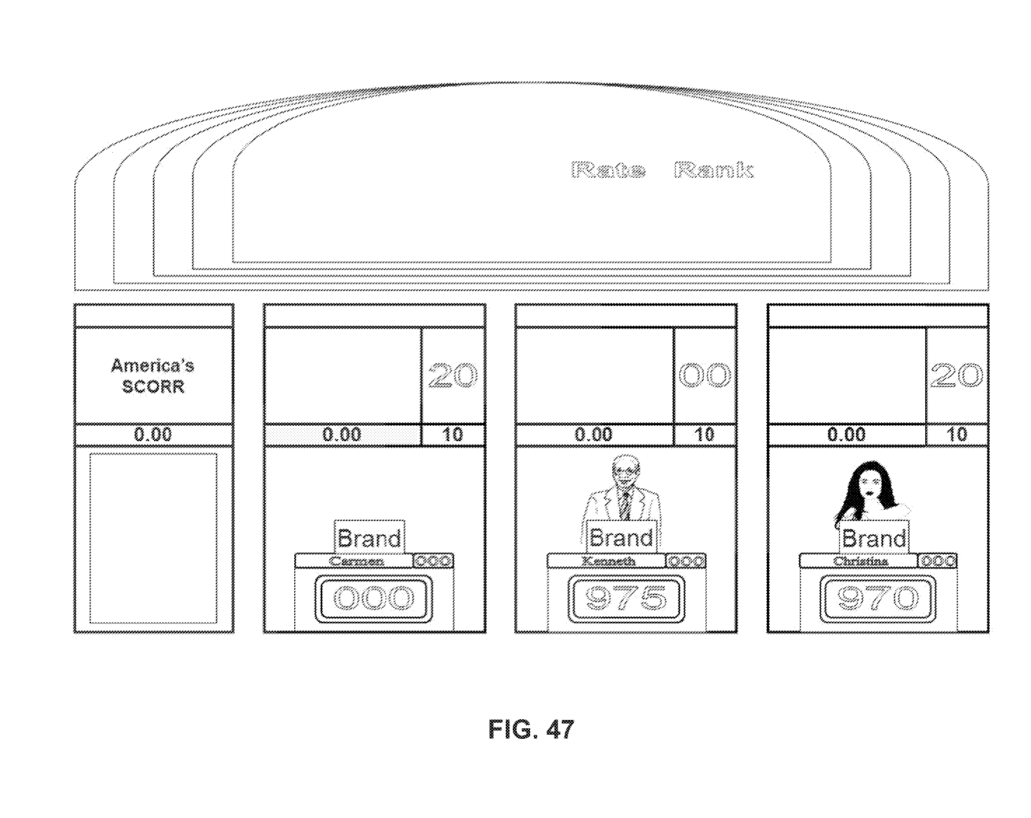

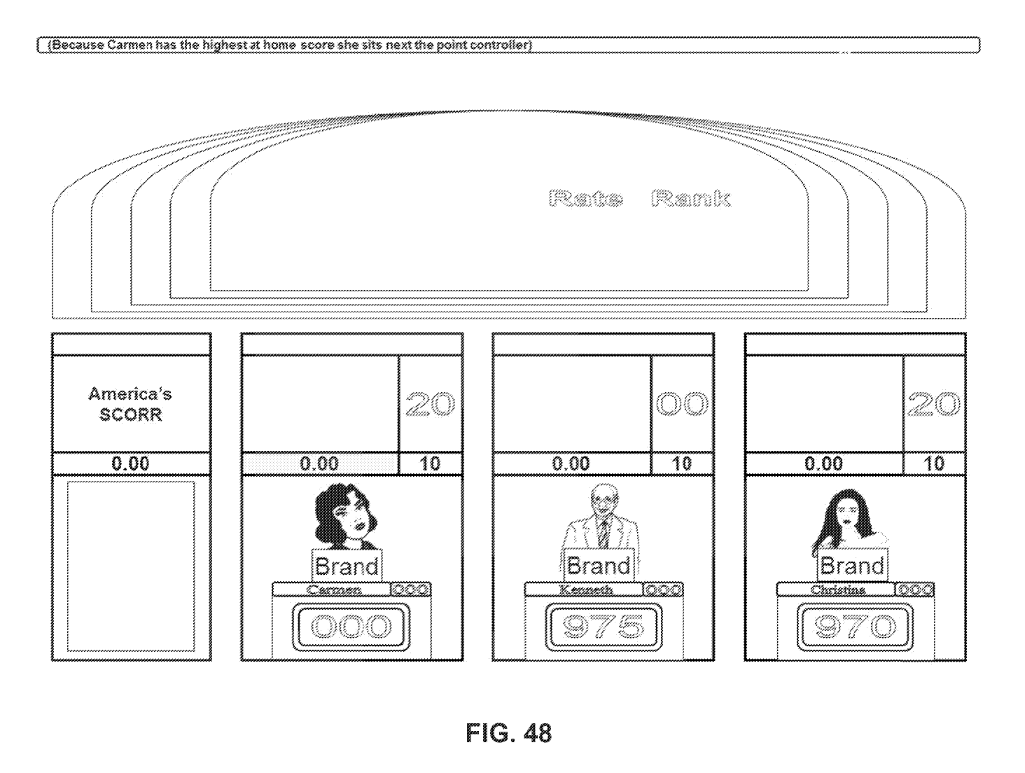

In FIG. 46, Carmen's “in-sync” score is shown. In this example, Carmen—a celebrity judge—is competing as a judge and not, alternatively, participating as a control group member. In FIGS. 47 and 48, the audience is reminded of the judges already introduced, along with the “America's SCORR” control group. As described below, this screen display is populated with additional information as appropriate during the game-play.

In an embodiment shown on FIG. 48, a relative comparison of the judge's scores can be used to change the game play. For example, a judge who has the lowest in-sync score can be specified by the game rules to vote in a particular position (e.g., first, last). In an example shown on FIG. 48, Carmen, because she has the highest “in-sync” score, is assigned to sit next to the point controller. In an embodiment, this seating/placement proximity can be an important inventive to judges. Judges participating may want to be proximate to the control display because of the added attention that portion of a display screen receives. In an embodiment, promoting the success/failure metrics for each judge highlights the competition between them.

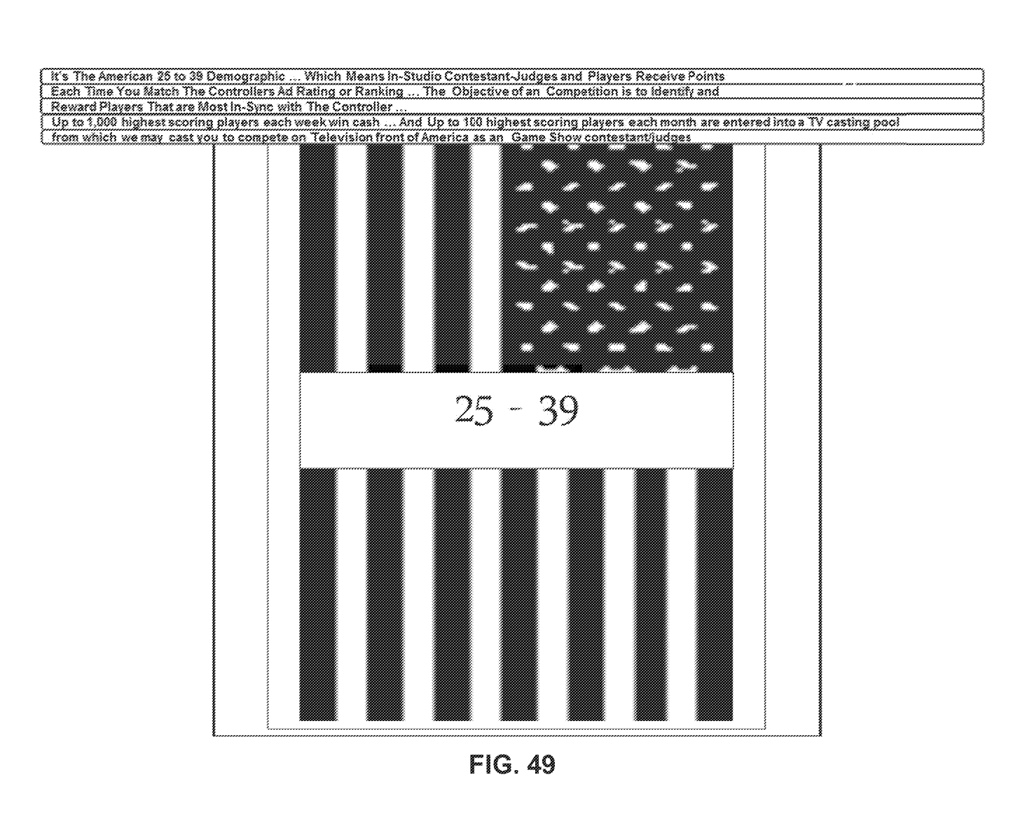

In FIG. 49, the “controller” element is introduced, according to an embodiment. As noted elsewhere herein, the controller (also referred to to as a control or control group) performs the same judging tasks as the judges, either contemporaneously with the judge's selections, or at an earlier time. In an embodiment, the controller can be a group of users participating via a network based (Internet) computer game. In an embodiment, the television program discussed in an example, is a “reveal” show, such program being used to present the results of a group of people's computer game play/judging. In an embodiment, the interest and time commitment of participants in the video game causes the participants to seek to watch this “reveal” broadcast.

As specified by FIG. 49, in this example, the controller is an American 25 to 39 demographic. Because the control group is used in the scoring, in an embodiment, in another embodiment, the controller is not revealed to the judges before the time of judging.

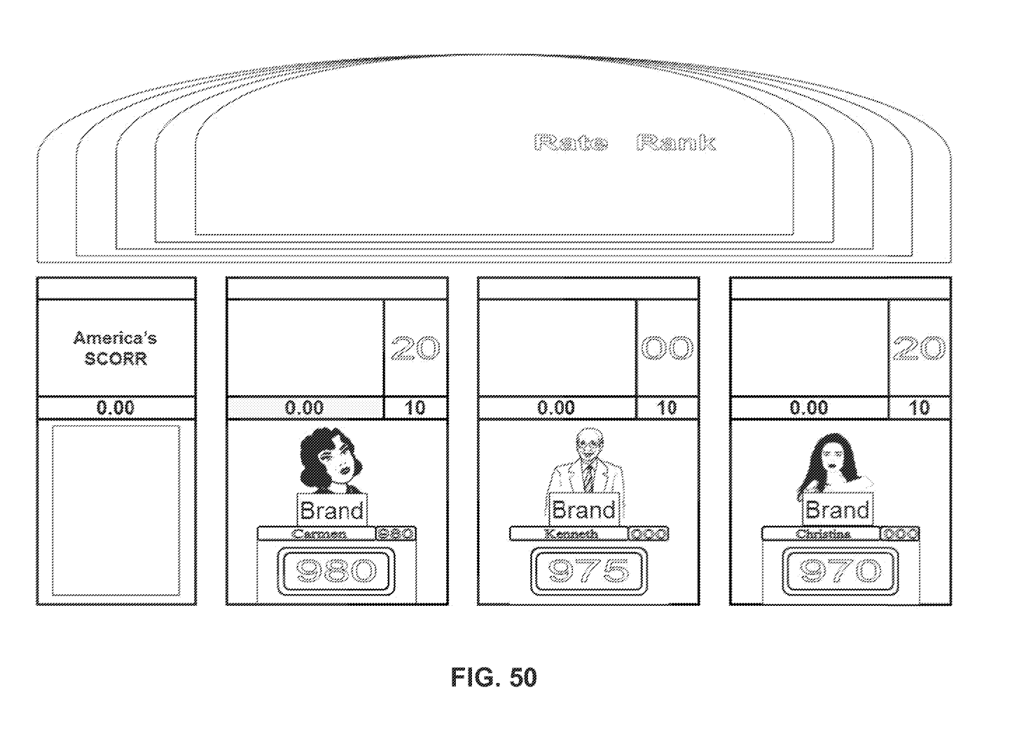

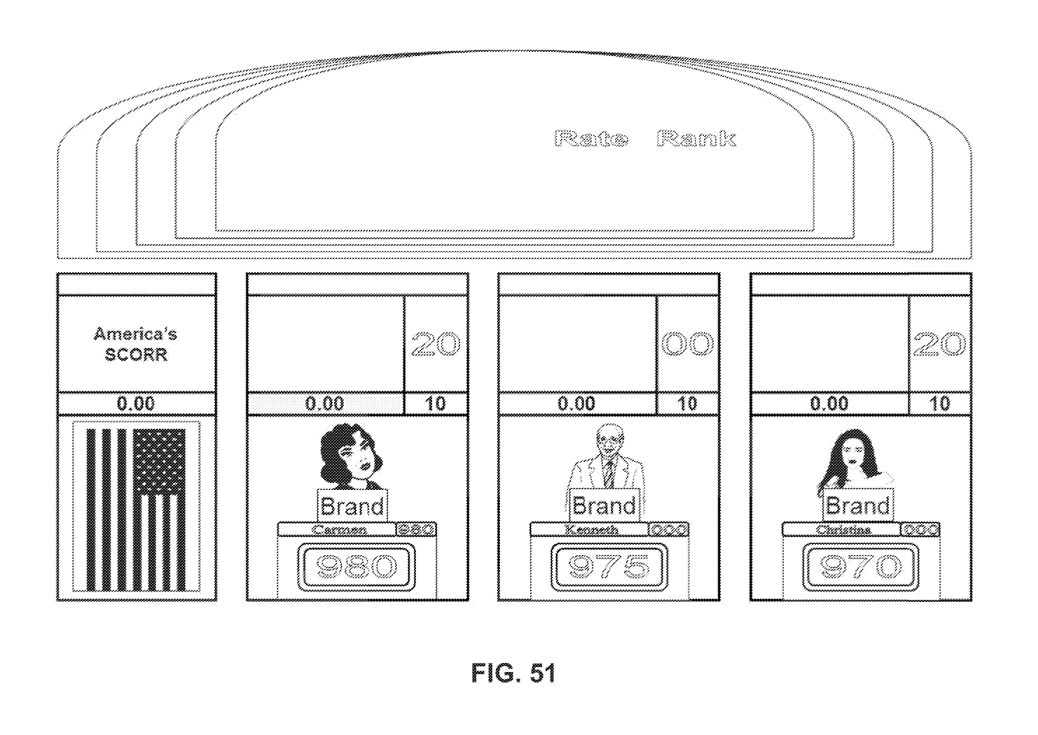

On FIGS. 50 and 51, the controller is revealed, according to an embodiment. Because of the use of the control group in game-play, people using a home-based computer game (as noted above) who are watching this “reveal show” embodiment could be interested in the identity of this control demographic

As discussed herein, the control group (controller) can be selected in a variety of ways. One way used by an embodiment, is to analyze the judge's characteristics discussed above (employment, hometown, social group, etc.) and select control groups that advantage or disadvantage the judge. For example, a control group that could disadvantage a social network judging entity is a non-technically sophisticated group of people.

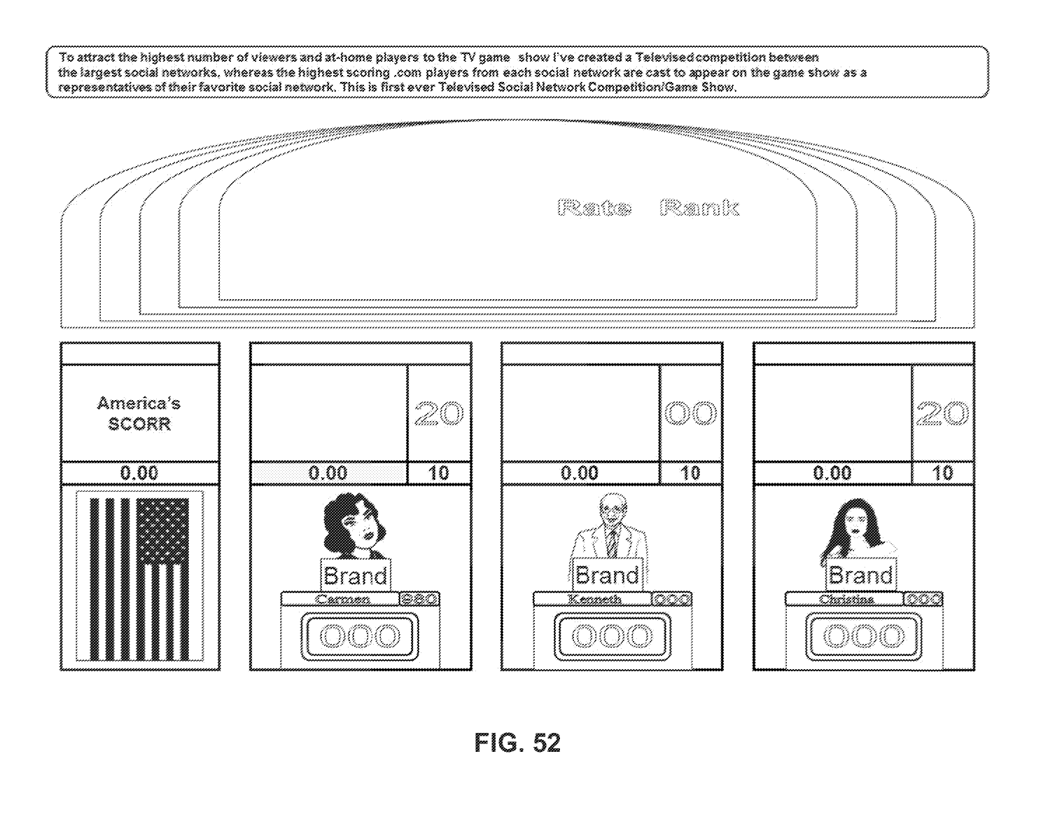

FIG. 52 depicts an embodiment, as introduced above; wherein different social networking web sites can compete. In an embodiment, the “representatives” of the social networks can be the highest scoring person (in the computer game described herein) who is a part of the network. In another embodiment, members of the social network can be asked to vote to “elect” a judge representative. In this voting example, further promotion of embodiments of the game will be achieved by discussion on the social networks.

### Judges Competing

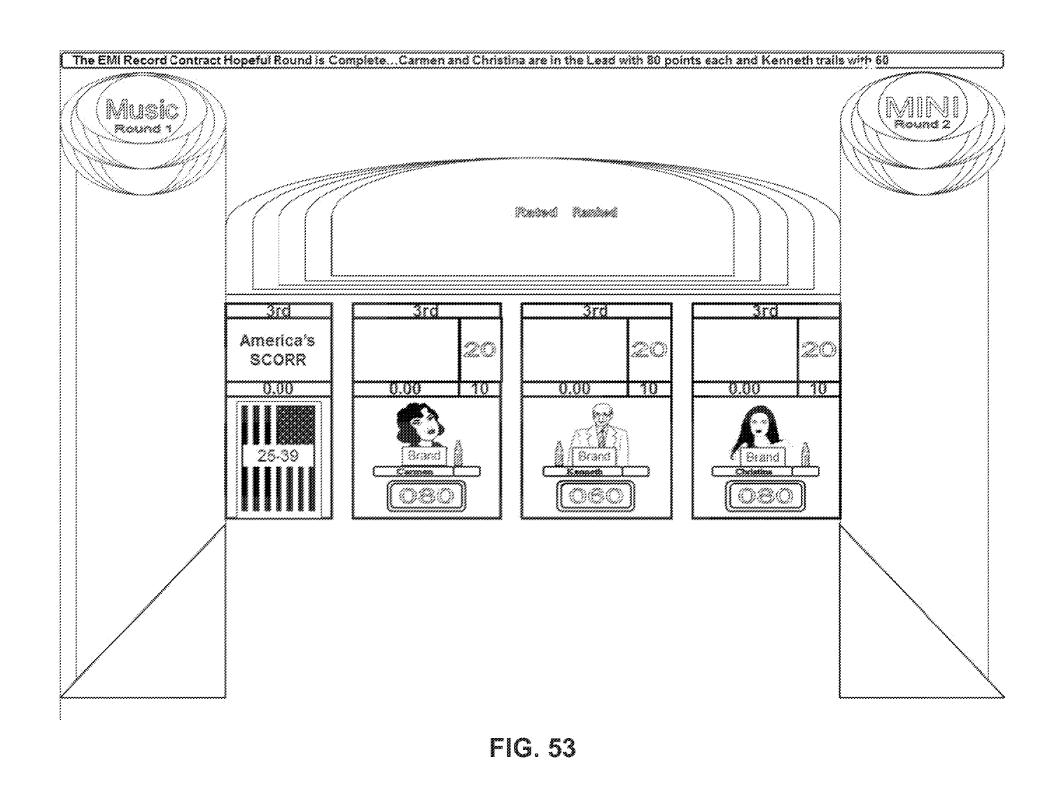

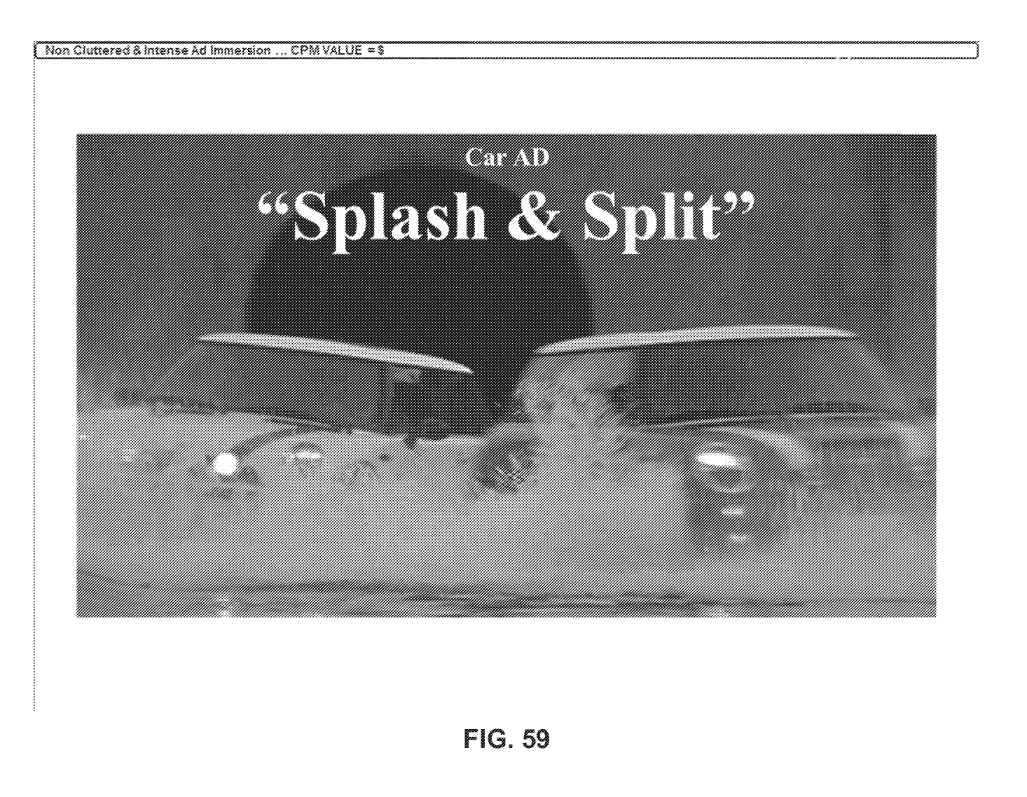

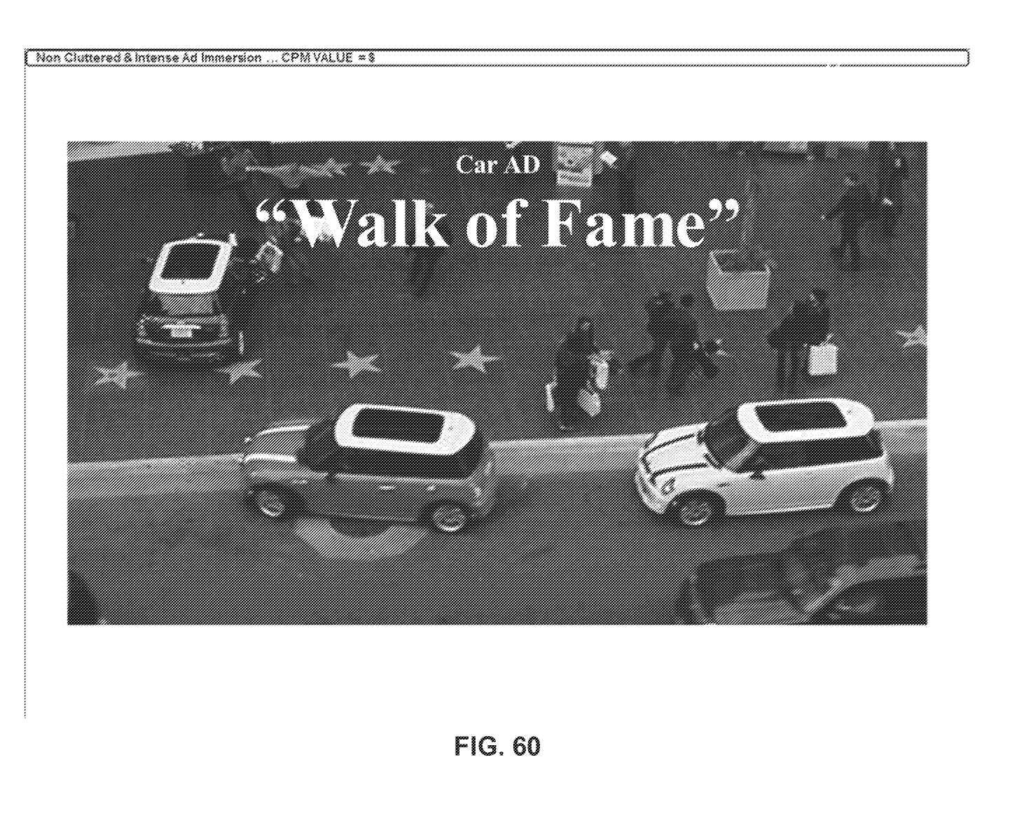

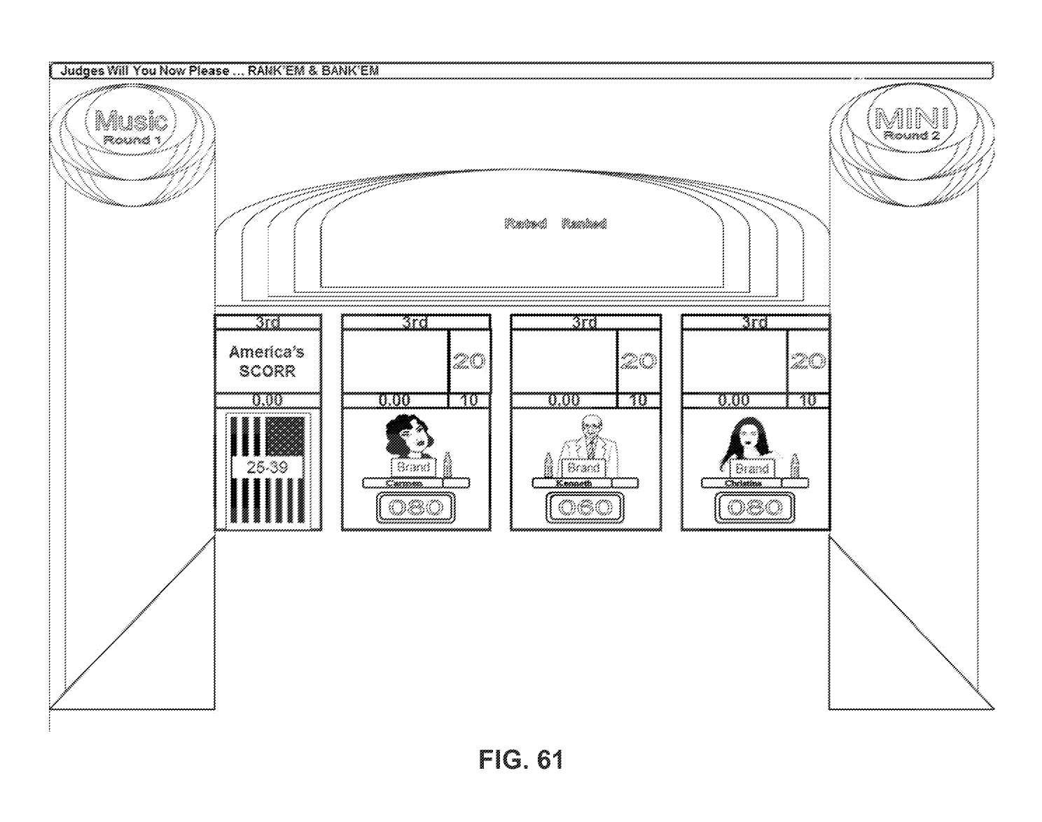

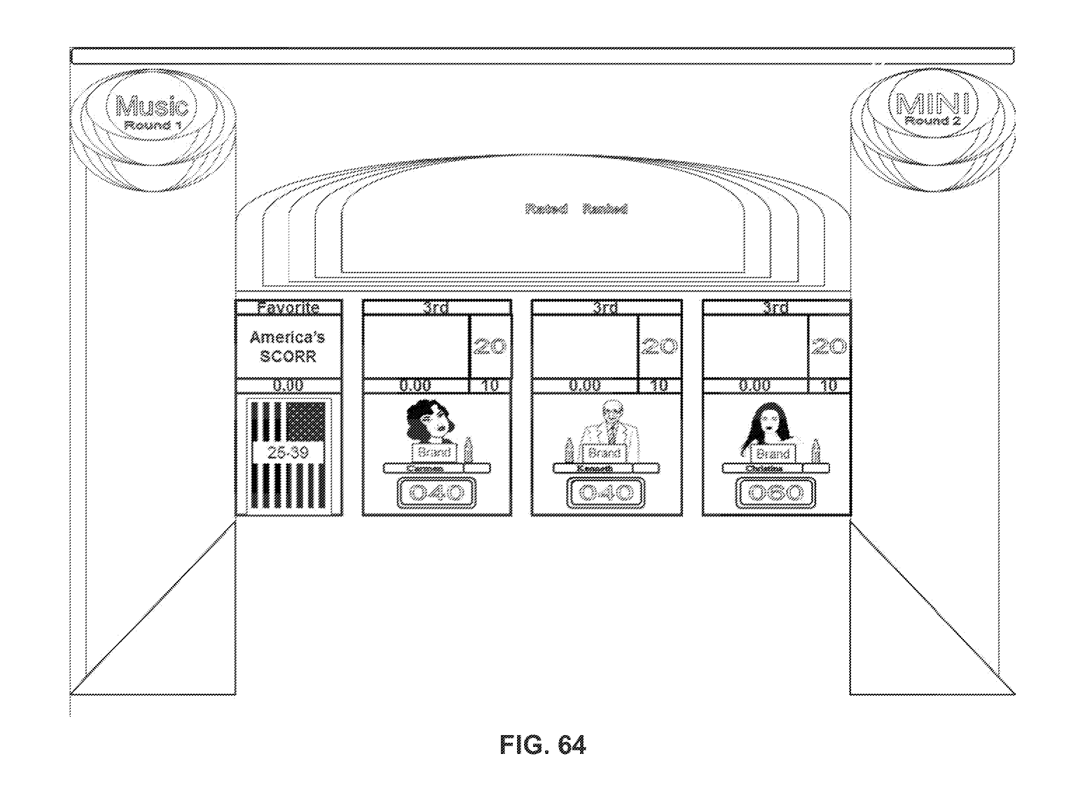

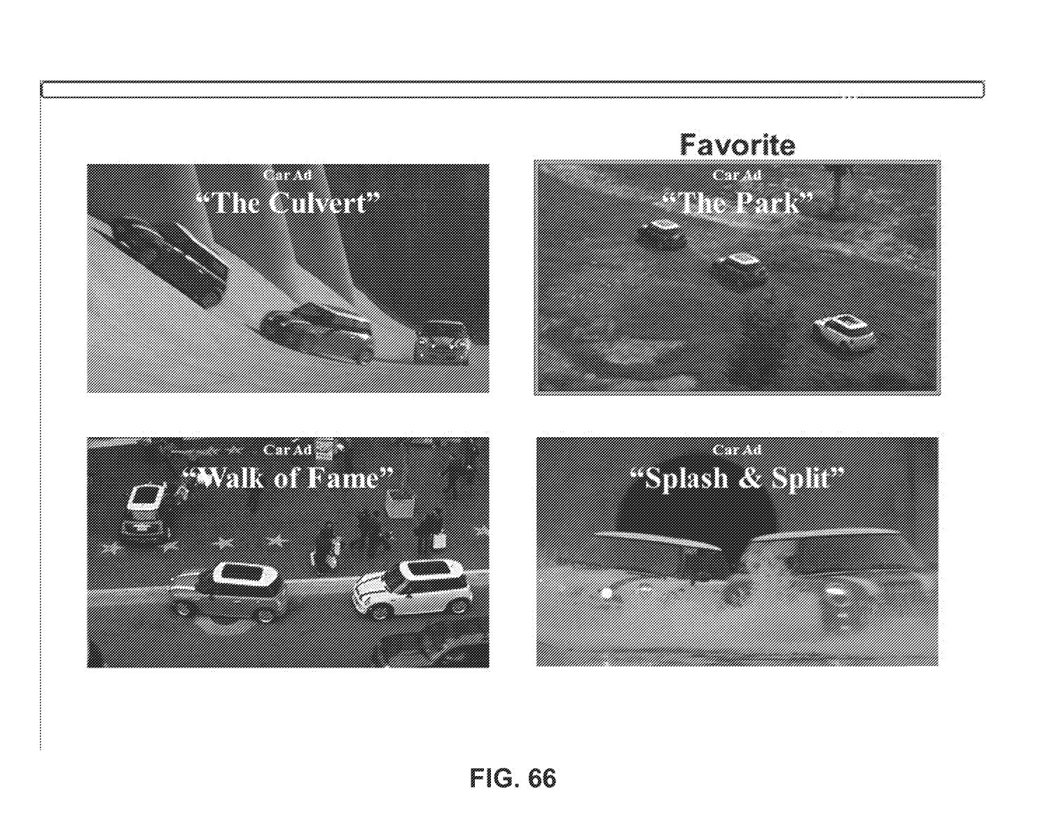

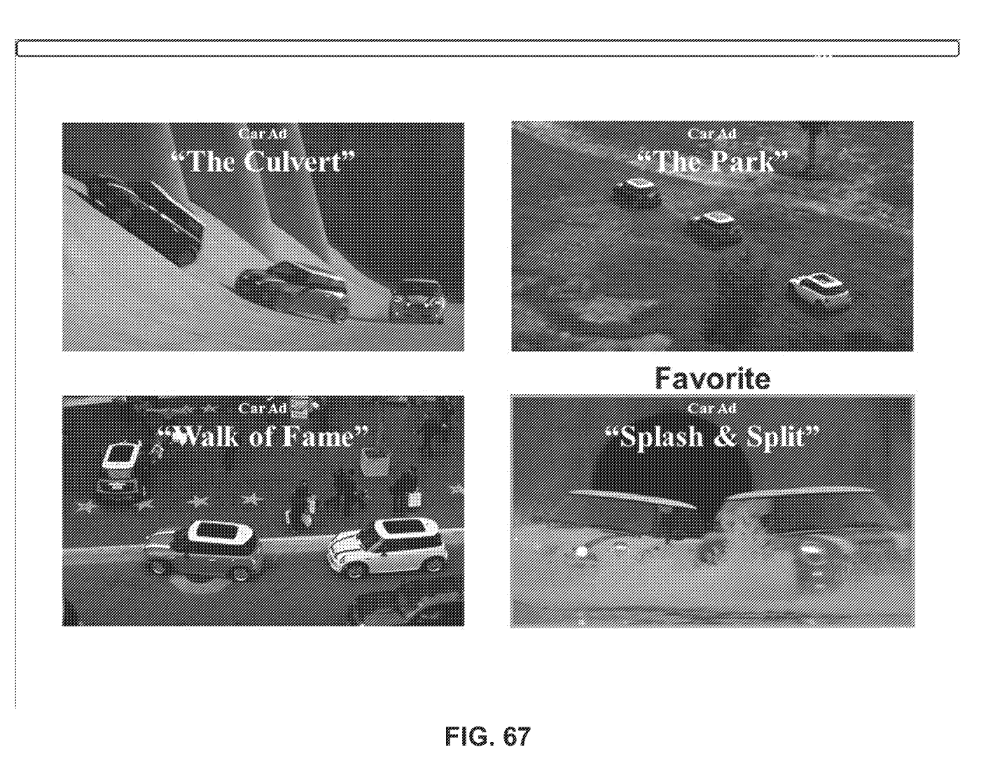

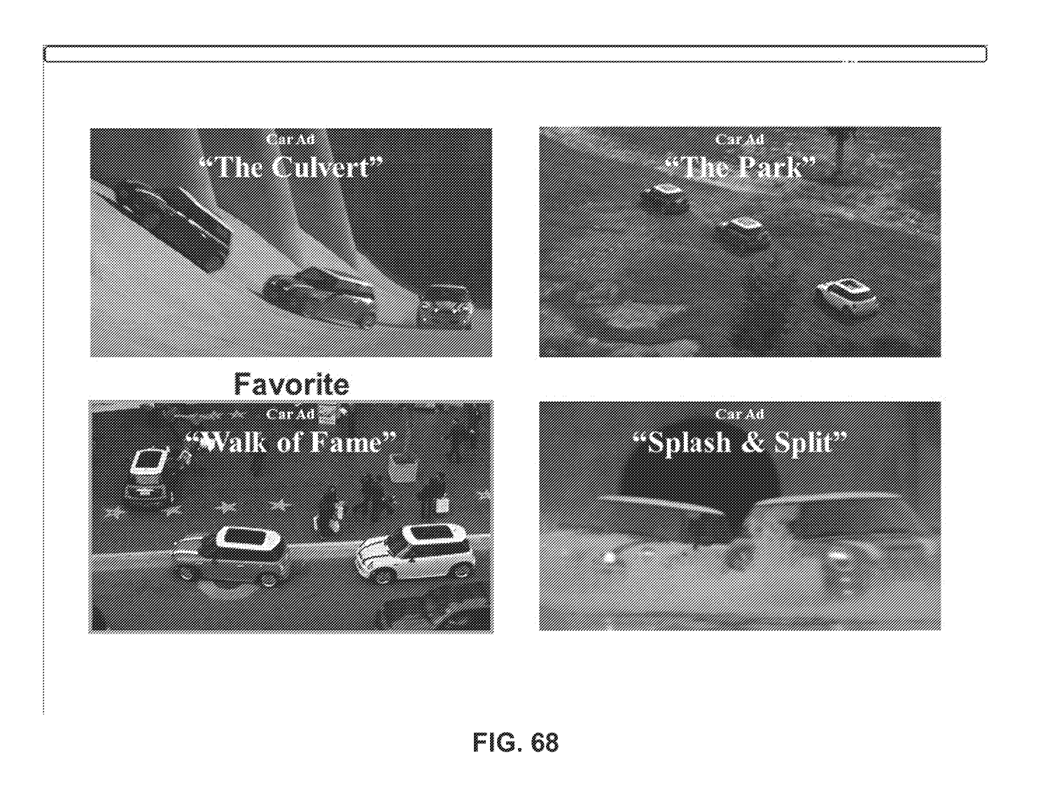

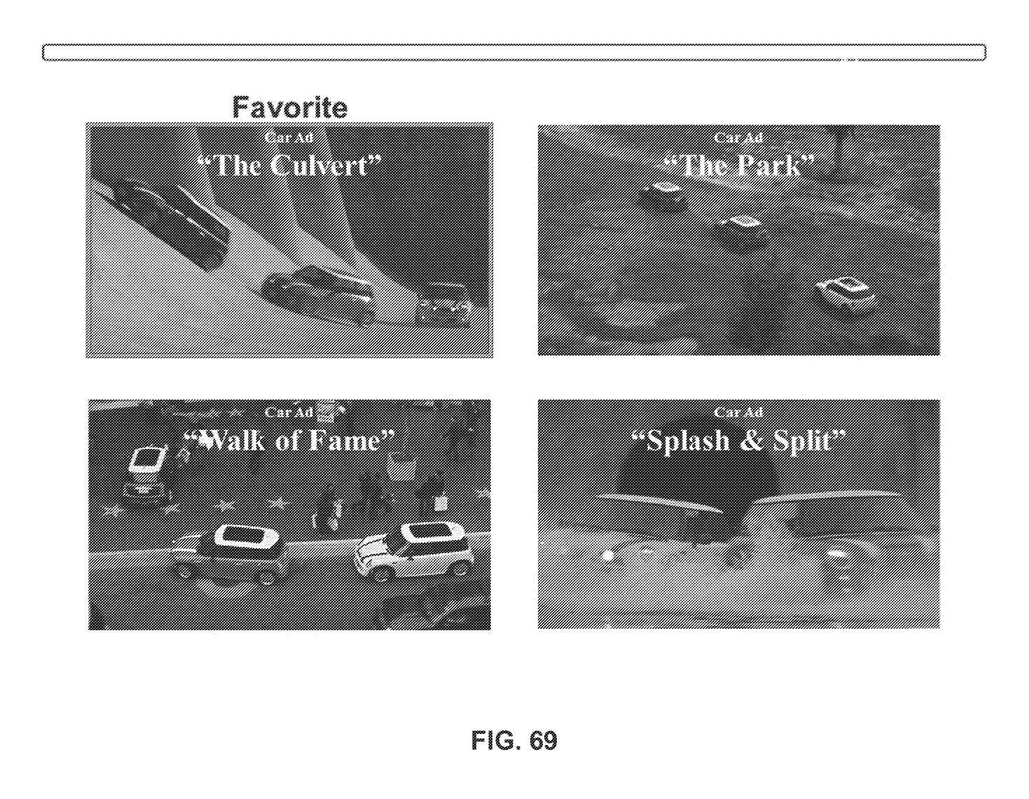

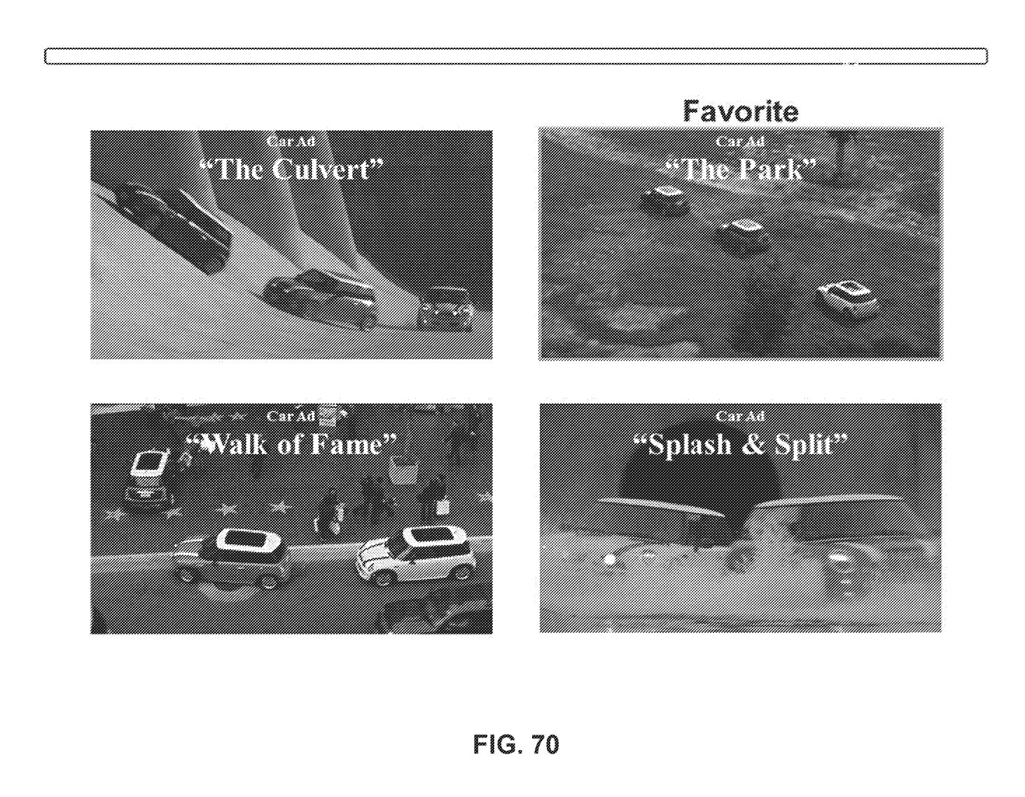

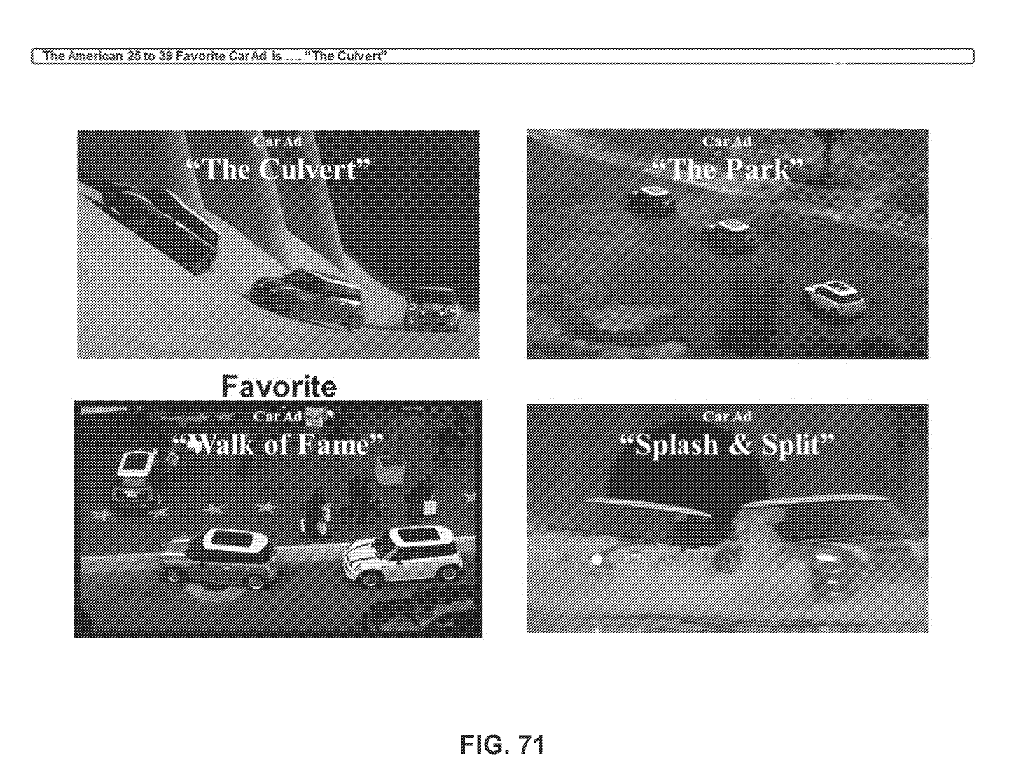

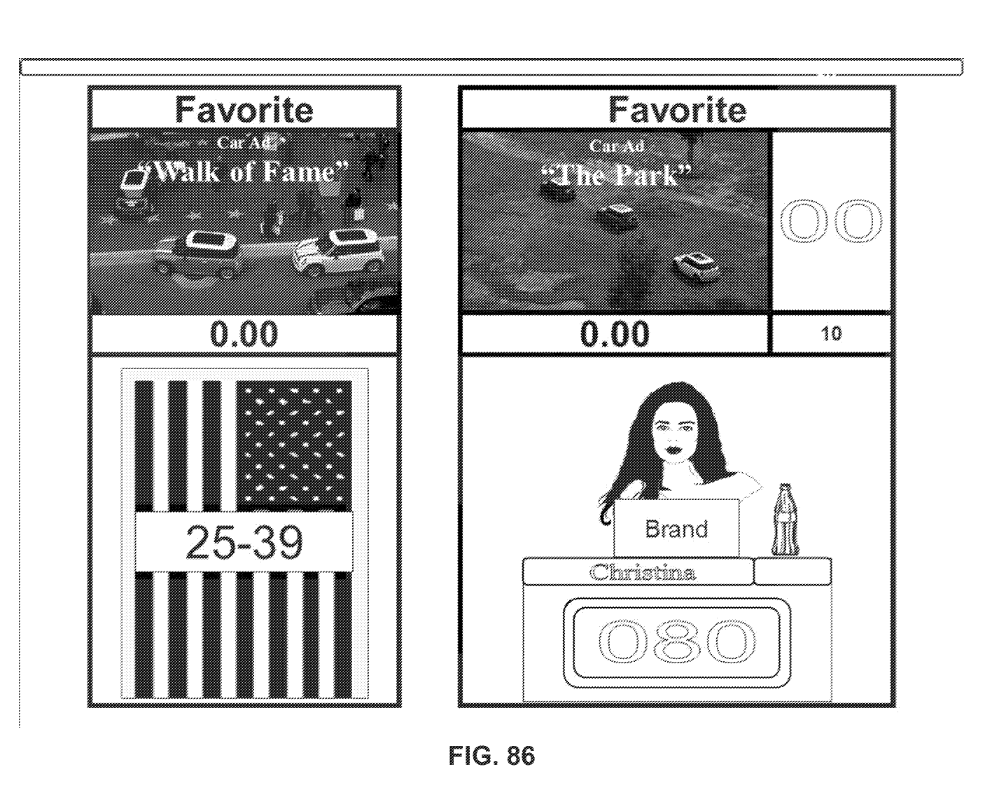

Generally speaking, FIGS. 53-91 depict embodiments of a particular level of a multi-level game where a first level competition between different competition content members (e.g., singers, products, dancers, etc.) as described herein are judged (e.g., rated, ranked, assessed, analyzed) by judging entities. As described above with FIGS. 28-52, in an example, judging entities appear on a video broadcast program (e.g., television show, web video, games show, reveal show) to provide a round of competition between first level competitors. While the judging entities are judging the first level competitors, they are also competing against each other to remain televised judges.

In a non-limiting example depicted on FIG. 53, the three judges are presented, along with related characteristics, e.g., their scores, group affiliations, associated products. Along with the judges, an abstract representation of the control group is presented, according to an embodiment. In an embodiment, this control group is known and represented at this phase, and in another embodiment, the control is unknown. In yet another embodiment, the control group identity is only partially revealed. For example FIG. 53 shows “America's SCORR,” indicating that members of the control group are American, but not identifying the particular demographic. In the FIG. 53 example, the demographic of the control group is United States residents, ages 29-39.

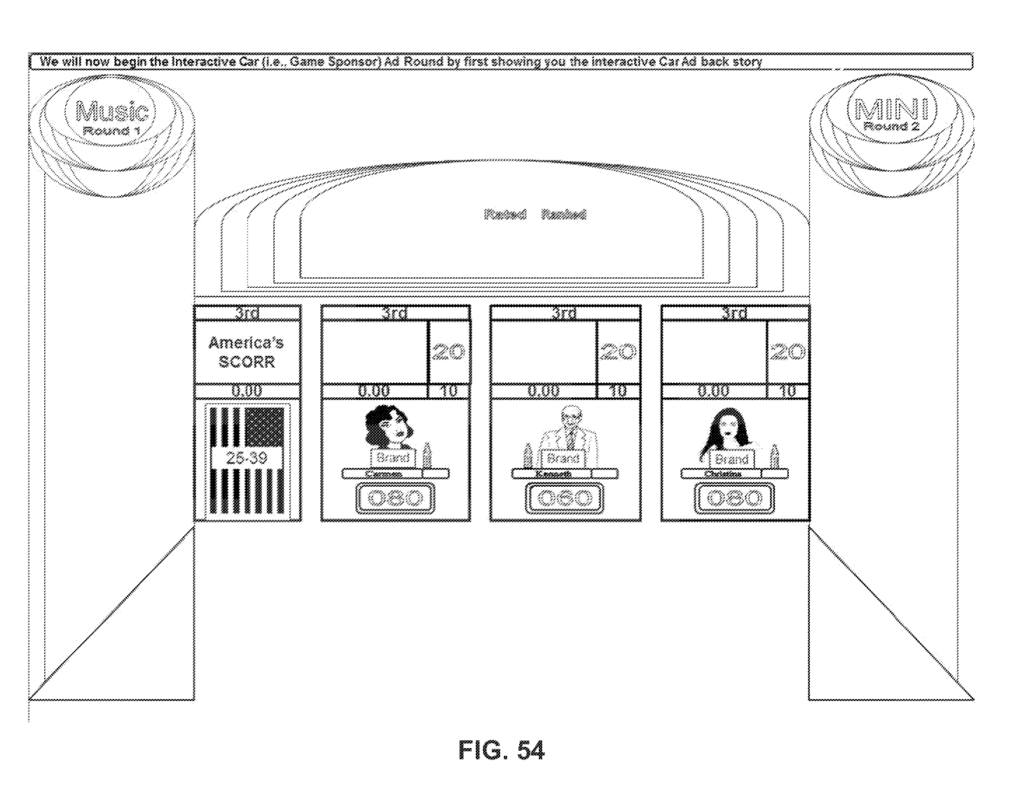

In an example depicted on FIG. 54, the television show then introduces the competition content that the judges will be judging. The first round, as depicted on FIG. 54, is labled as “Recording Contract Round 1,” such label indicating, in this example, that competing entities (individuals, groups) will be competing to be offered a recording contract. As also labeled in the example from FIG. 54, the second round of competition to be judged for small automobiles is labeled “MINI.” As noted elsewhere herein, a broad variety of competition content can be judged in embodiments of the multi-level game described herein.

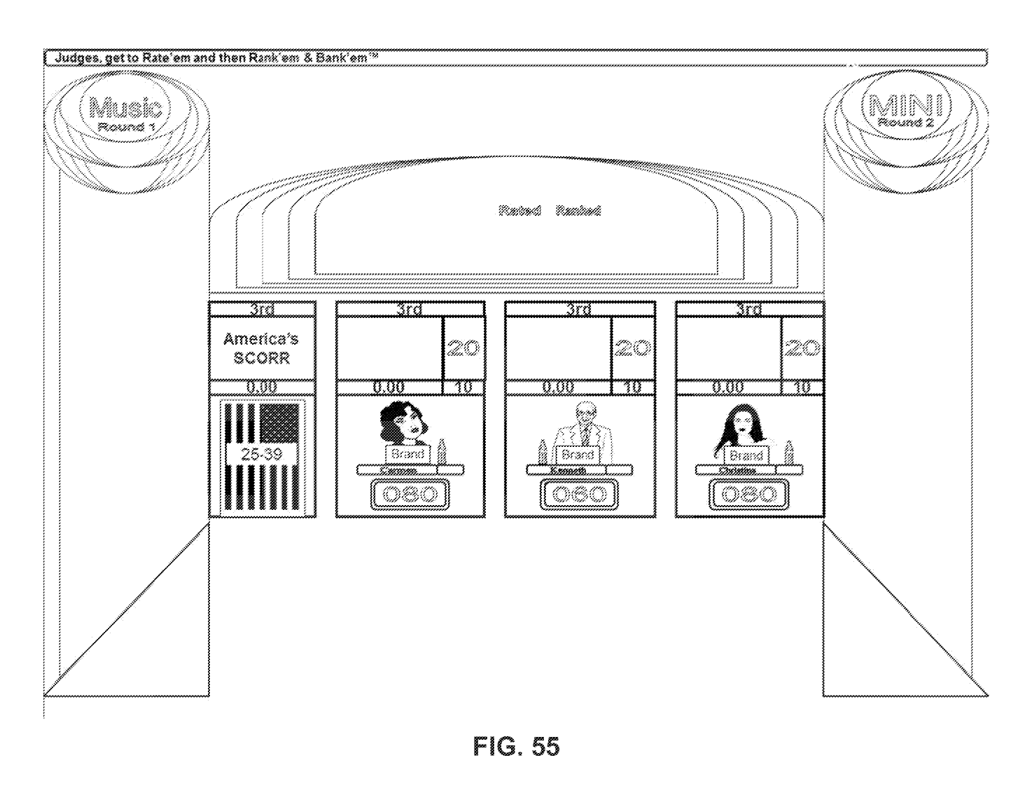

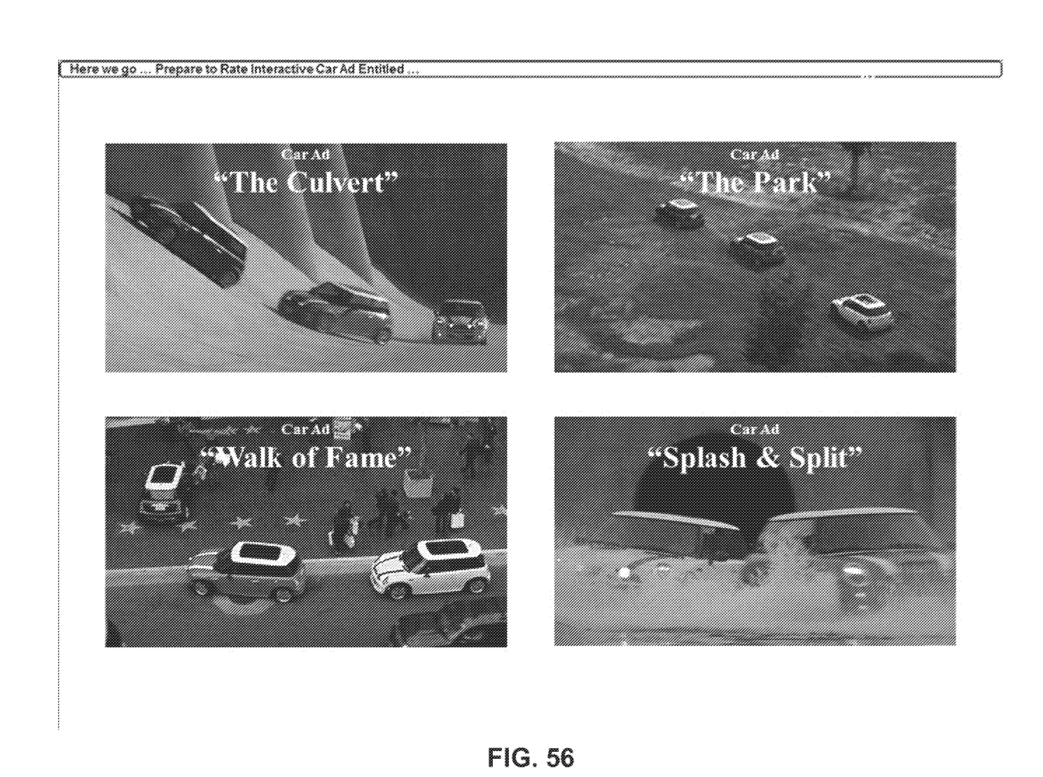

in FIG. 55, in an embodiment, the judges are invited to judge different response options. In different embodiments, these offerings may be in-person, as in a singer on a television show, or recorded video performances. In an example, this judging by the judges is termed “Rate'em, Rank'em and Bank'em.”

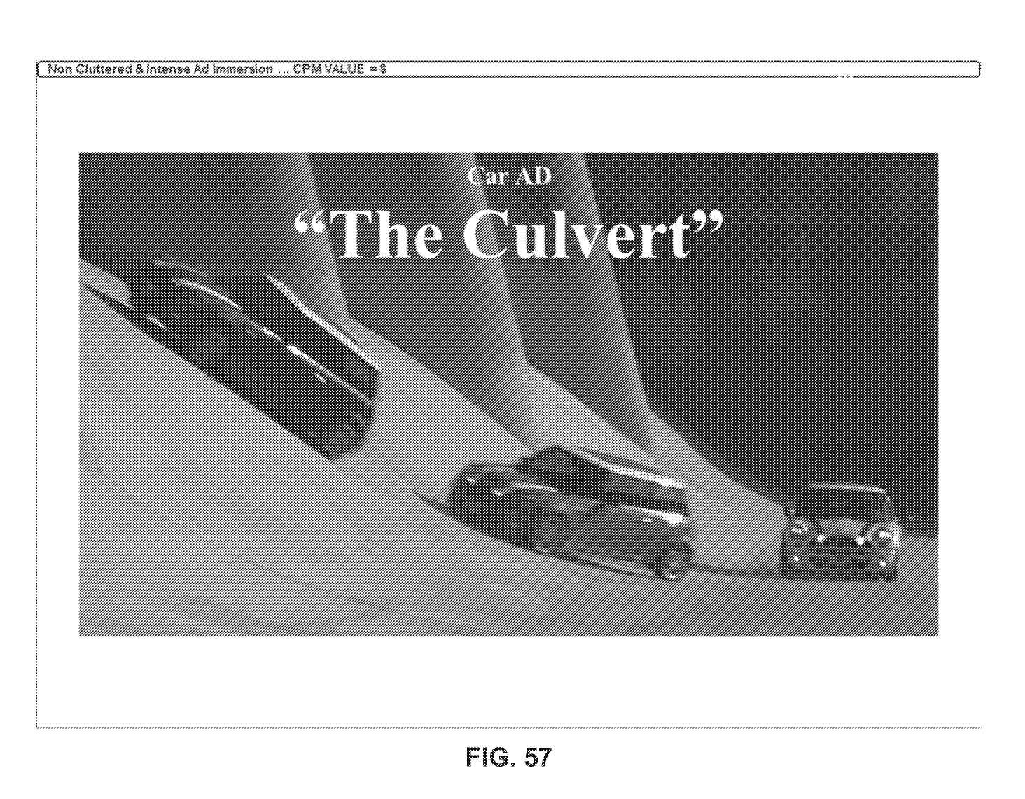

Continuing with the example, on FIG. 56, the second “MINI” round is introduced to the judges. As part of this example, the first round (Recording Contract Round 1, noted above) has already been held. In another embodiment, this MINI round comes first in the presentation.

FIG. 56 depicts four different automobile advertisements: “the Culvert,” ‘The Park,” “Walk of Frame” and “Splash & Split” In an embodiment, an advertiser, in co-operation with the producer of the game show, has selected these four offerings as potential advertisements for an ad campaign. As is discussed with the “mass focus group” above, having judges rate and rank these offerings, in an embodiment, can provide valuable feedback for advertiser marketing choices.

FIG. 57 depicts the focused display of the first advertisement (“the Culvert”) to the judges and a viewing audience. As an additional benefit to an advertiser for participating in embodiments, the presented advertisement is repeatedly presented, references and judged in the main flow of a television program.

FIG. 57 depicts the focused display of the first advertisement (“the Culvert”) to the judges and a viewing audience. In an embodiment, after each response option is displayed to the judges, the judges are invited to perform judging functions. In another embodiment, the judging functions are requested after all of the response options have been presented.

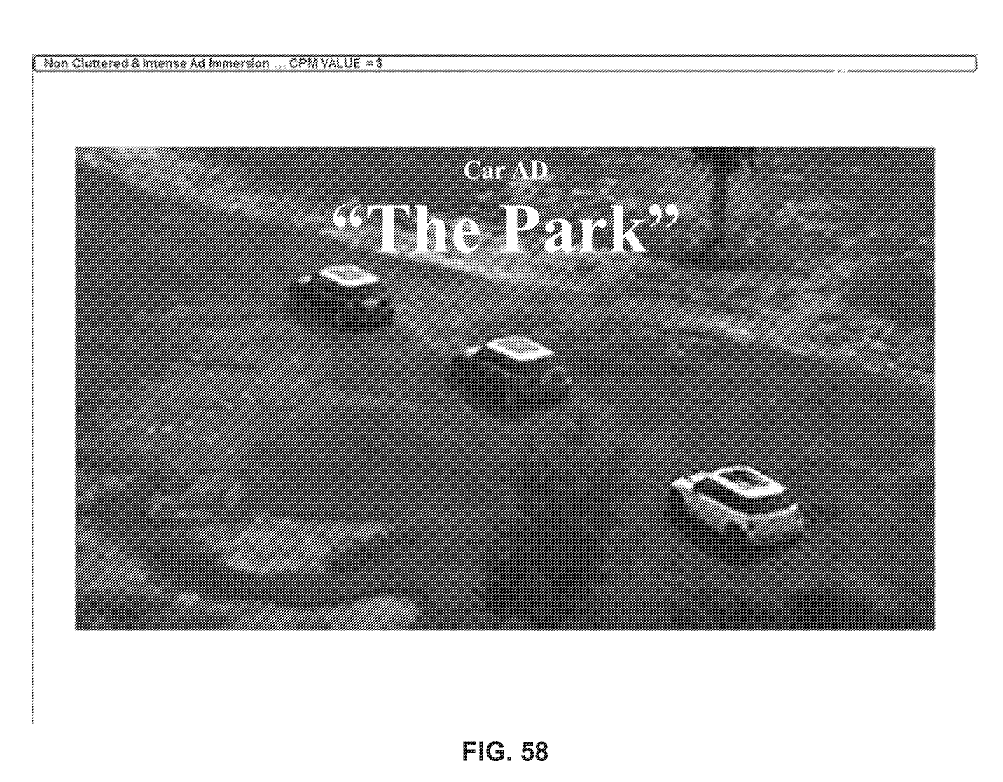

FIG. 58 depicts the focused display of the second advertisement (“the Park”) to the judges and a viewing audience. In an embodiment, the judging functions requested of the judges are termed “Rate'em,” “Rank'em” and “Bank'em.”

In an embodiment, the “rate'em” function asks the judges to score different aspects of the response offering on a scale. For example, the automobile advertisements could be rated based on their music, action, products and other characteristics, on a scale from 0-10, higher being better. In an embodiment, this exact rating structure is asked to the control group so as to provide an “accurate” score.

In an embodiment, the “rank'em” function refers to the judges being invited to rank the response options against each other in order of a particular characteristic. In an embodiment, this ranking order is overall appreciation, while in another example, the judges are asked to rank in order of its likelyhood to cause them to inquire further about the product. In an embodiment, the term “bank'em” refers to the act of committing to the judging decisions (e.g., rating, ranking) made by a judge.

### Scoring the Judge Competition

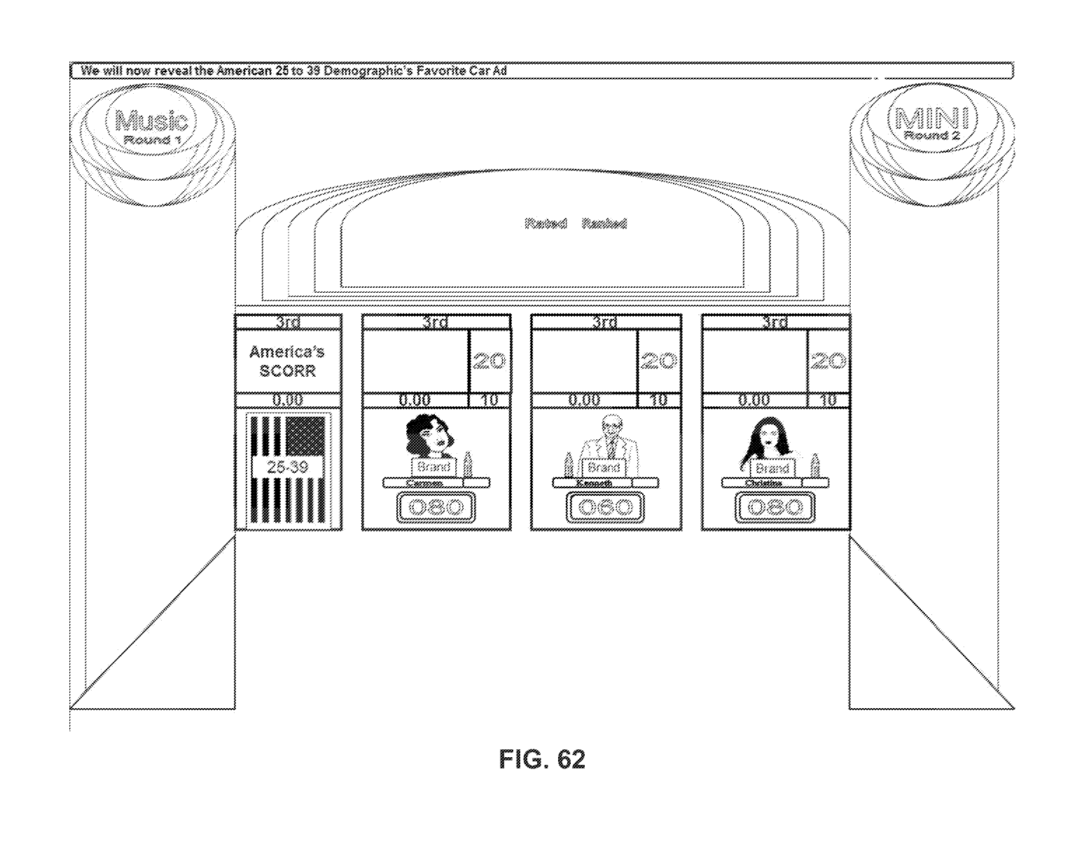

As depicted in FIG. 62, after the competition content has been offered to, and judged by, the judges, in an embodiment, the judges are scored based on their responses. In an embodiment, this scoring represents the third level of competition in the multi-level game, with the judges competing in their ability to judge.

In an embodiment, the control group, as discussed herein, provides the accurate responses that the judges are scored against. As noted on FIG. 62, in an embodiment, at this point in the “reveal show” the control group demographic is revealed to both the judges and the viewing audience including at-home competitors who judged the first level competition and competed to become judges in the second level competition.

In an embodiment, this “control group reveal” event is of interest to the at-home competitors because it reveals to them the baseline against which they were judged. In this example, as noted above, the control group demographic is 25 to 39 year old Americans.

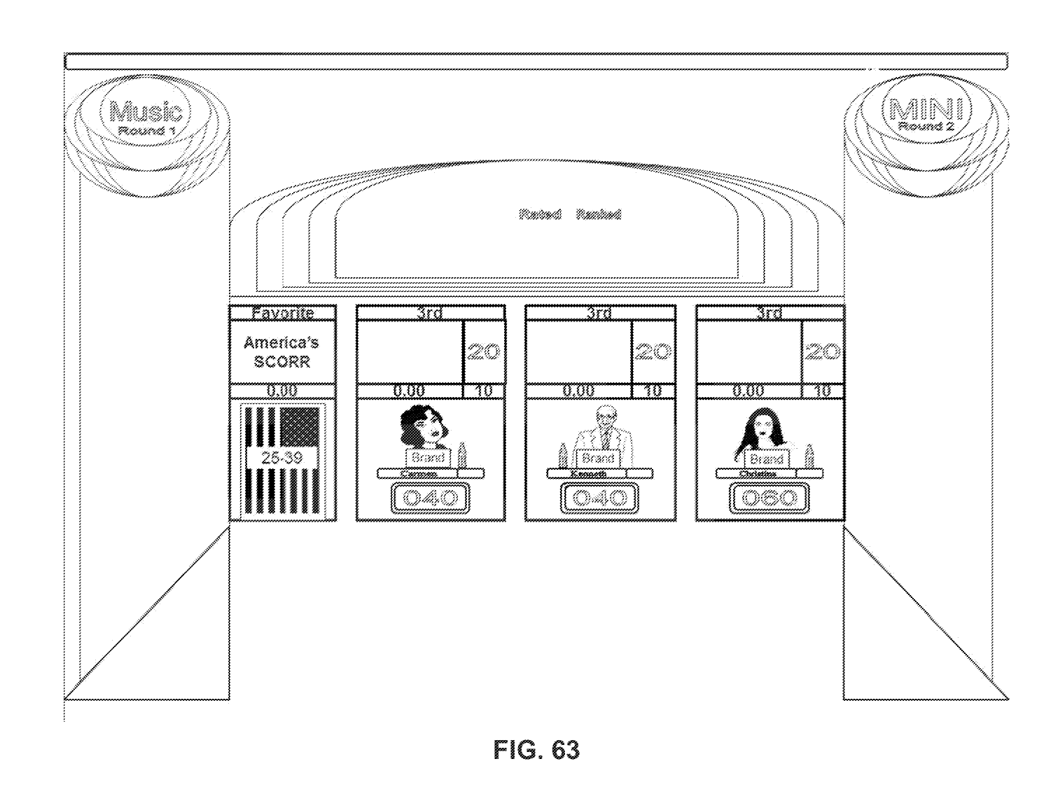

In FIG. 63, in an embodiment, the specifics of the judge decisions are reviewed and compared to the control.

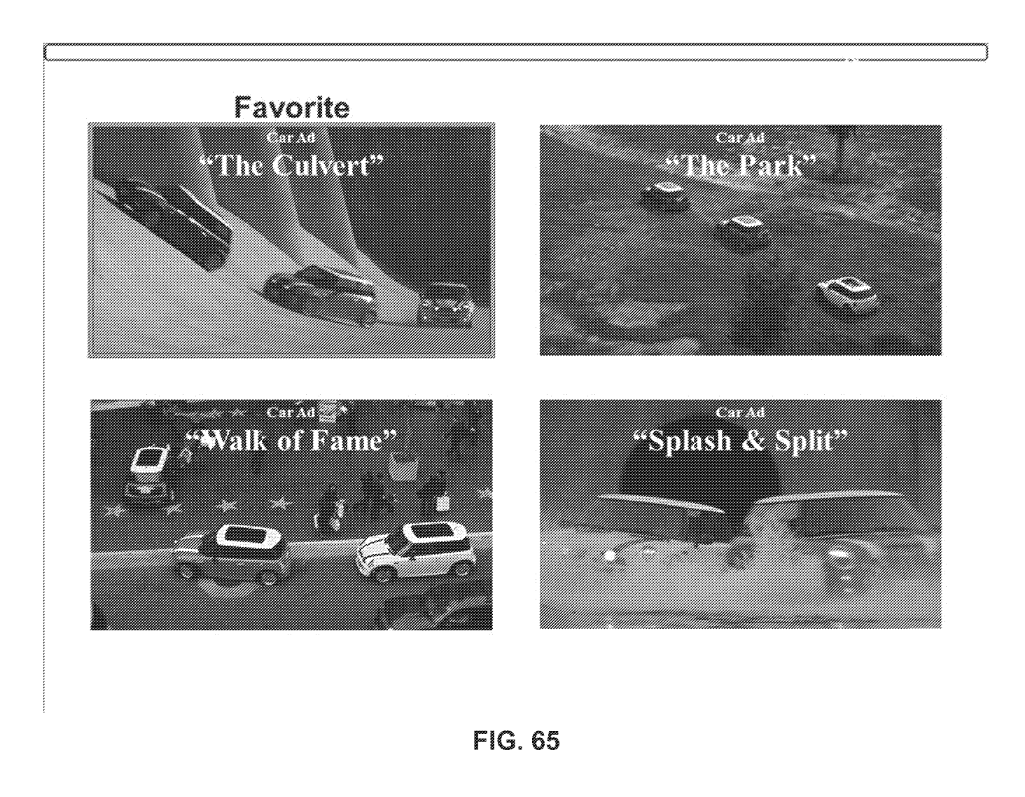

In FIGS. 65-71 each of the response options is reviewed, in an embodiment. In this example, this extra review of the response options can act to heighten excitement for the upcoming judge competition reveal. In an embodiment, because of the repeated use of video response options in the televised segments, producers of the game show can offer advertisers a high level of ad immersion for their products.

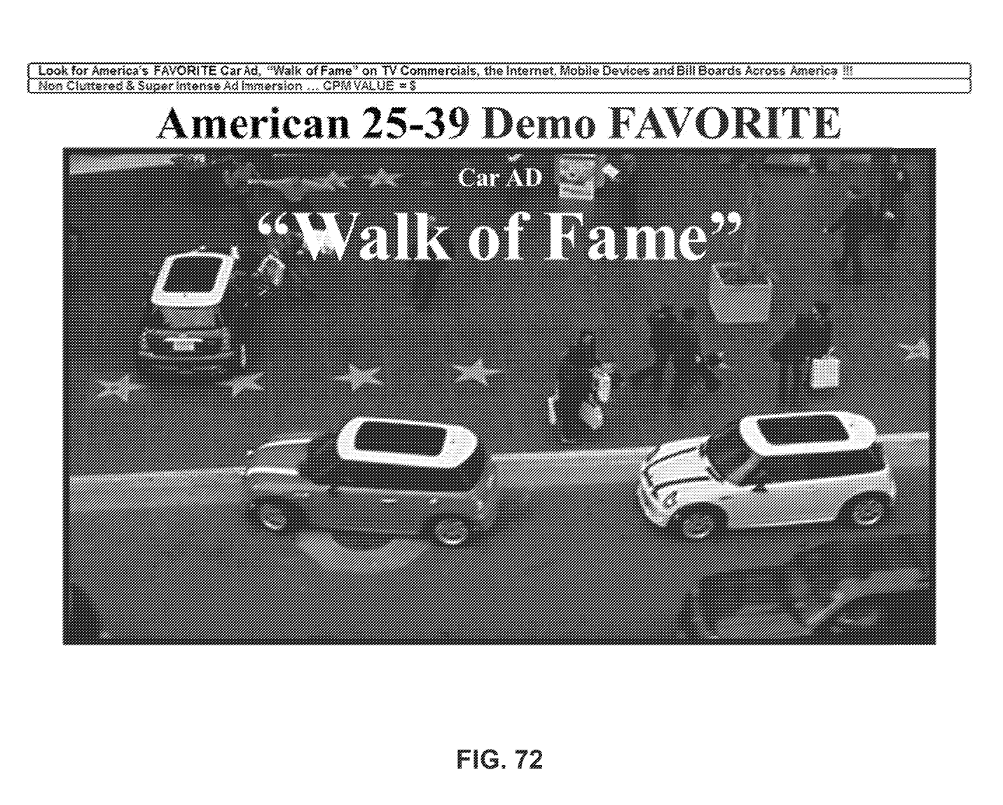

In FIG. 72, in an embodiment, the control response is revealed. In this example television program, this control reveal is significant because it is the baseline to which the judge's responses will be compared.

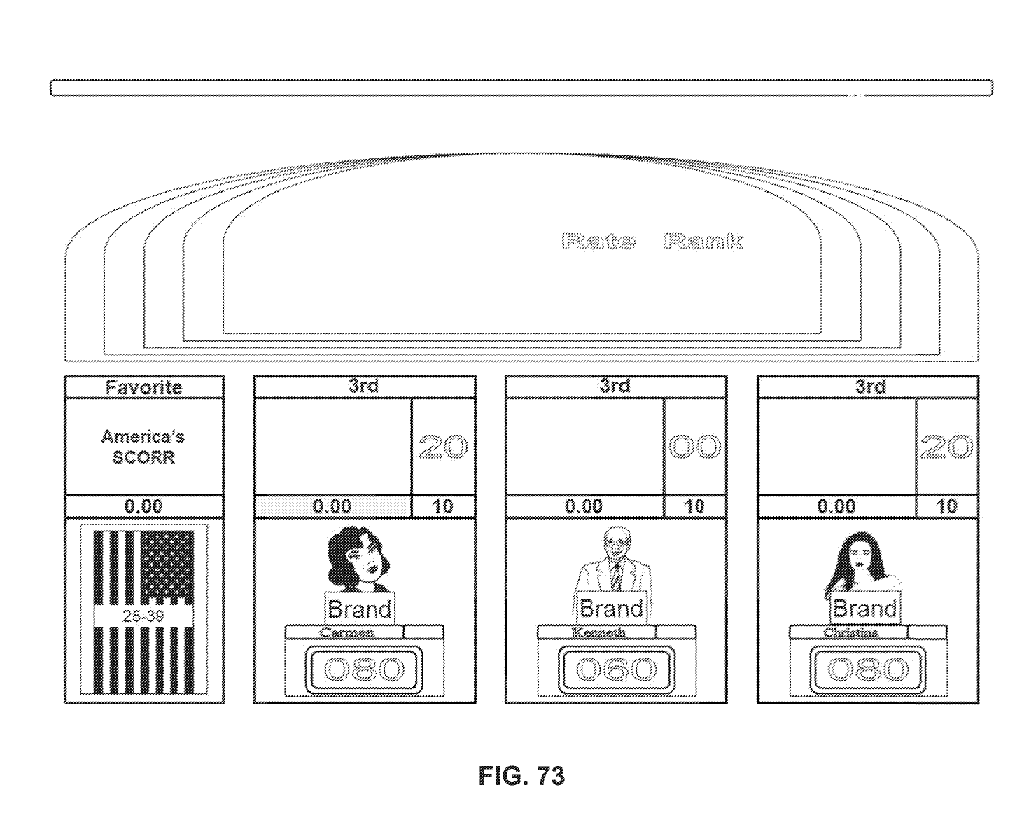

In an embodiment depicted on FIG. 73, the competition between the judges is highlighted. In this example, two of the judges (Carmen and Christina) are shown to be tied in their “in-sync” points.

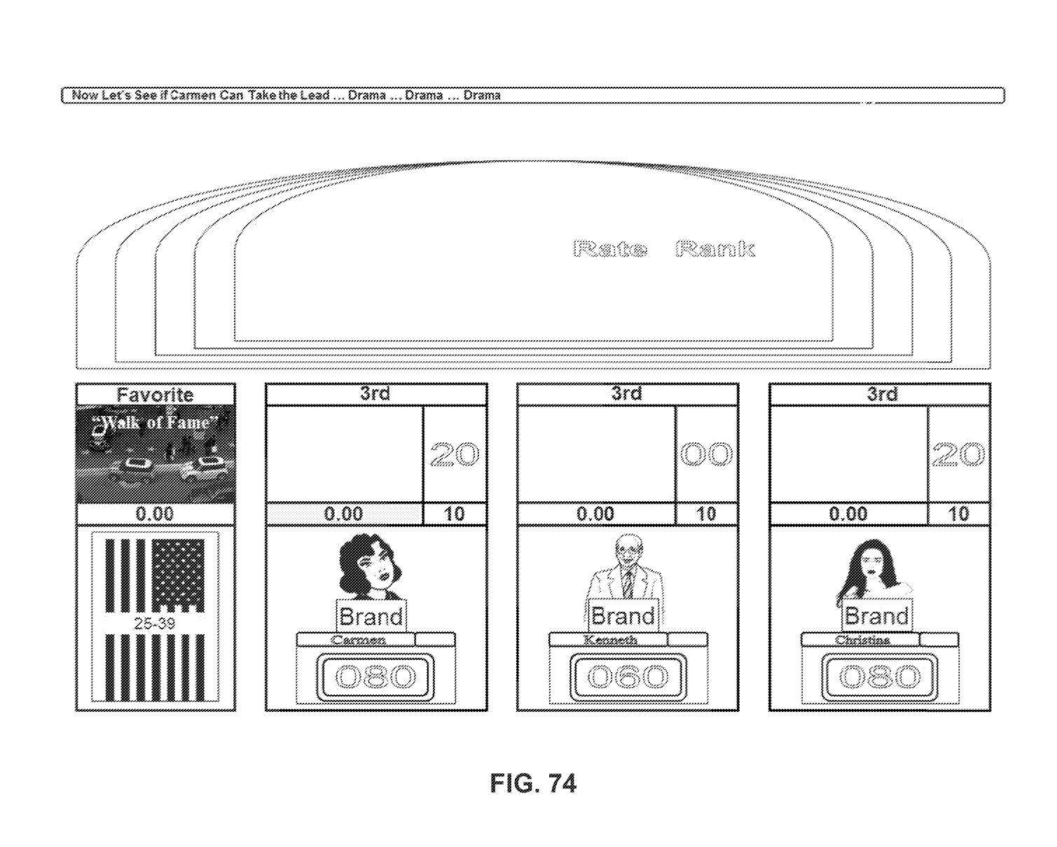

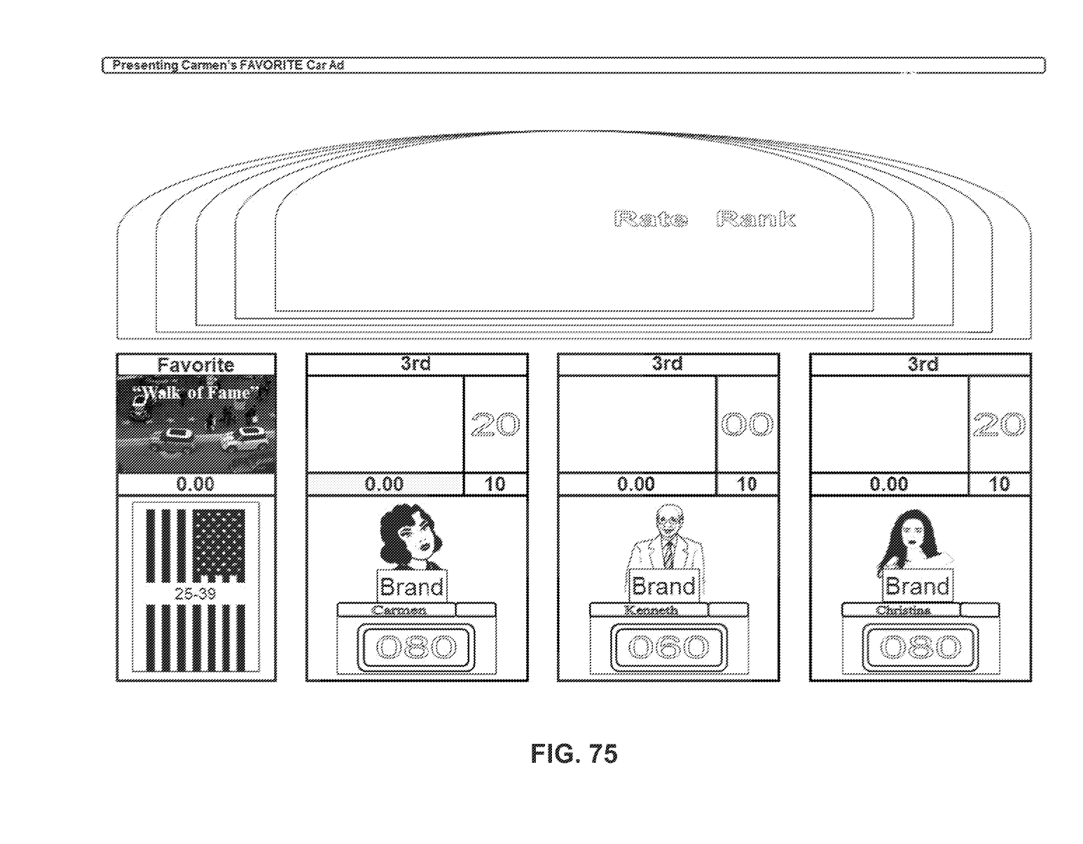

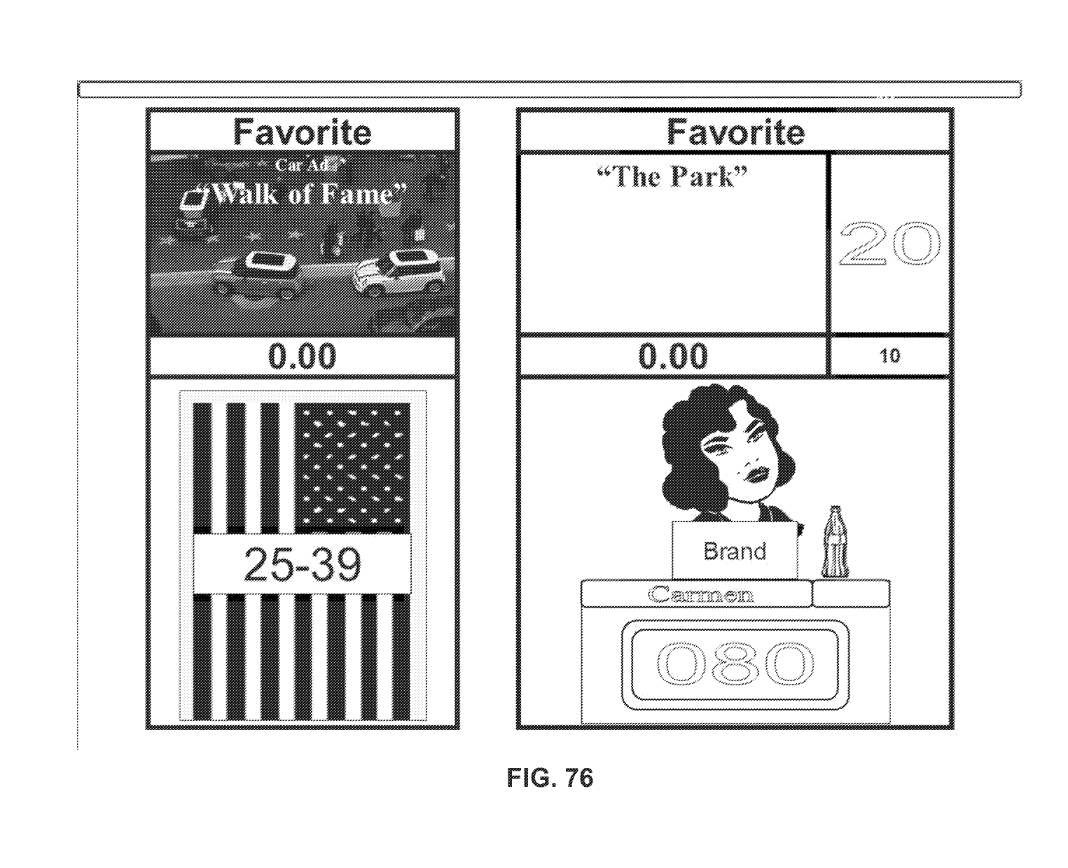

To begin an example presentation of judge results, in FIG. 74, the control-selected response option (“Wall of Frame”) is presented as a comparison point for the judge's selections. In an embodiment shown on FIG. 74, the response option selected by the control is labeled as a “Favorite.” Continuing with the example, in FIG. 75, the “Favorite” label is applied to the choice boxes for each of the judges. In FIG. 76, the focus of the game is directed to the single judge—in this case “Carmen.” In an embodiment, this highlights the multi-level character of embodiments discussed herein—allowing a singular focus on a single judge compared to the control, as well as the larger focus associated with other views, e.g., FIG. 75.

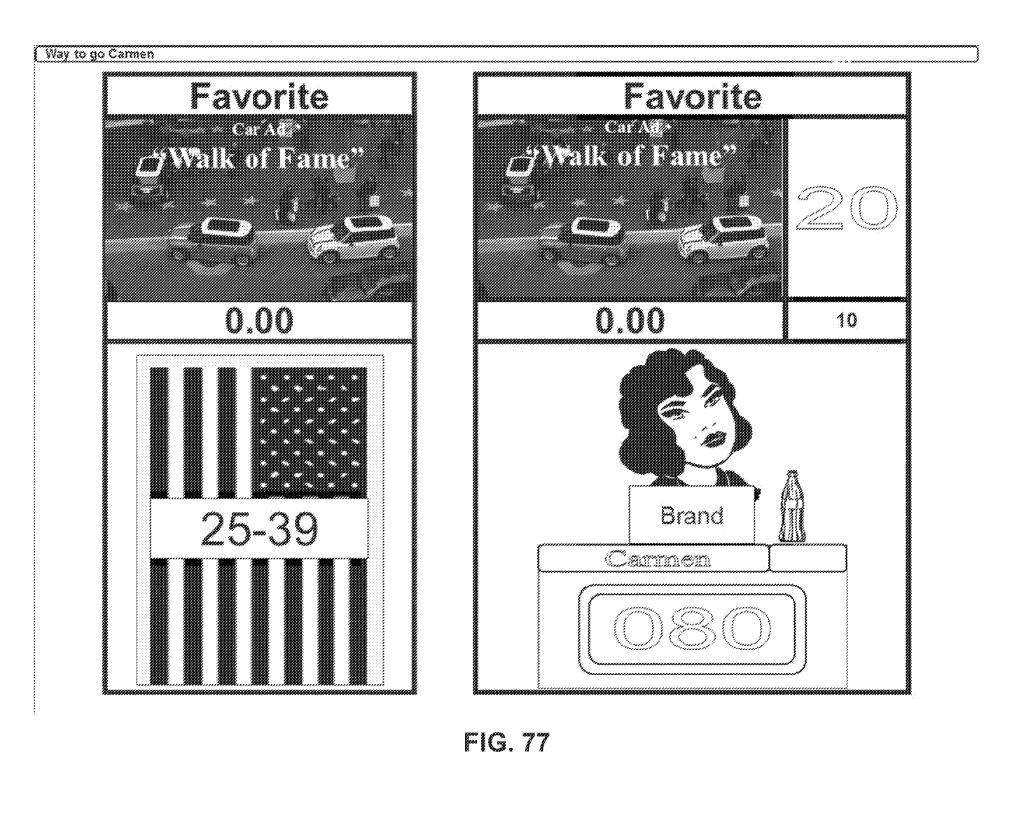

In the example depicted on FIG. 77, Carmen's choice is revealed to match control selected response option—she also selected “Walk of Frame.” In an embodiment, this match with the control has scoring implications for the competition among Carmen and the other two judges.

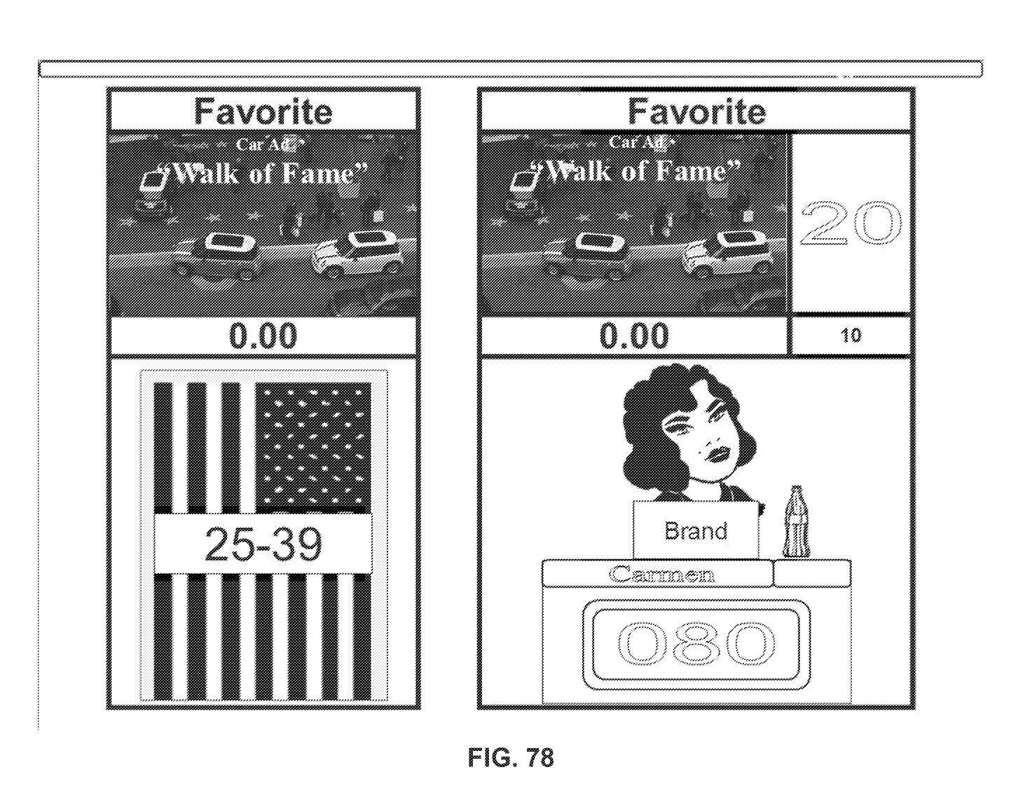

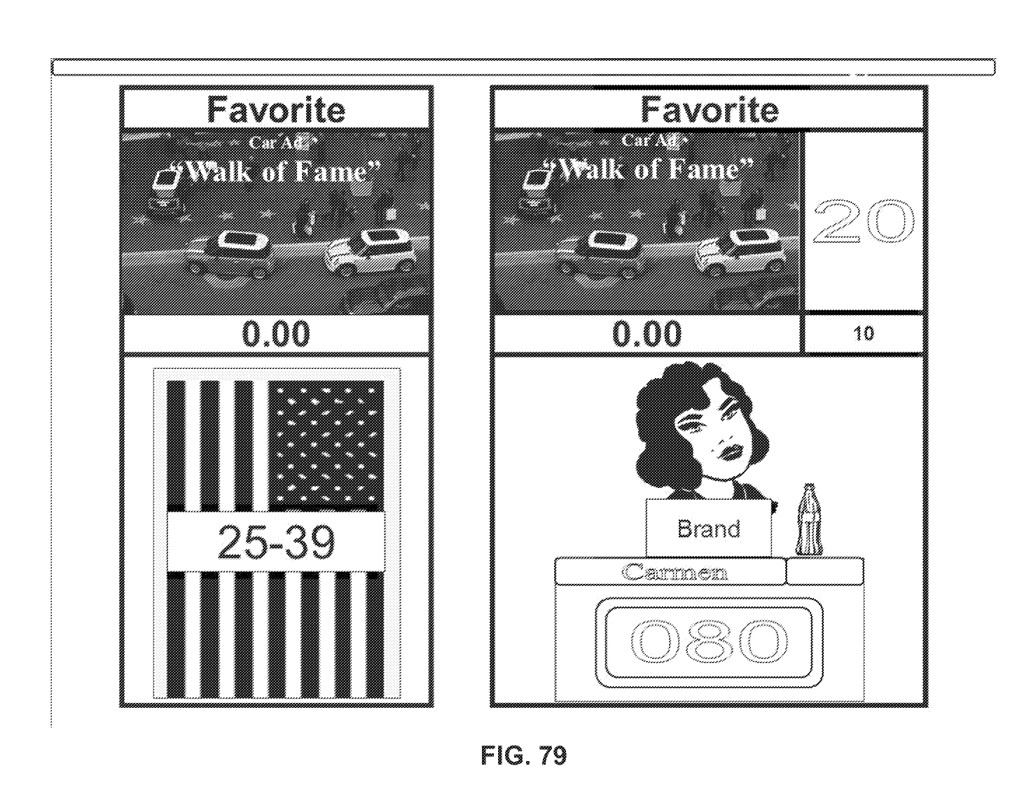

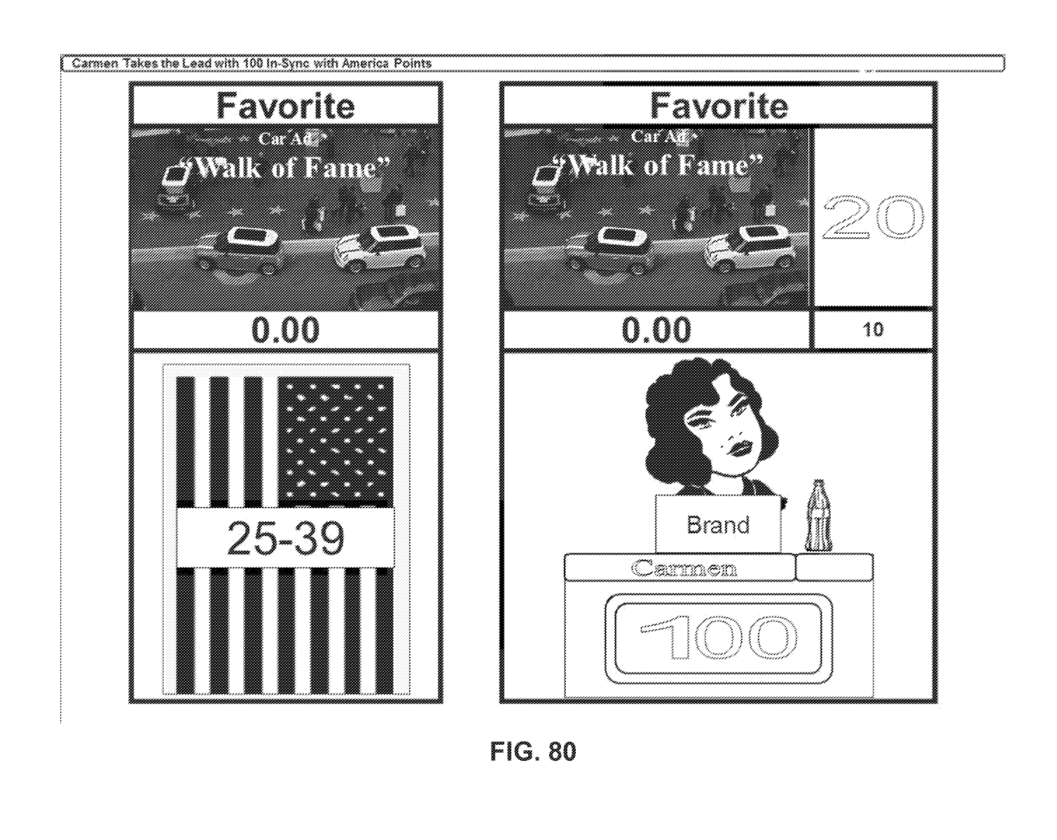

In FIG. 78, in this example, the score of “20” is added to Carmen's overall score. This value of 20, in an embodiment, corresponds to the difference between Carmen's judging of the automobile advertisements as compared to the control judging of the advertisements. In a further refinement of this embodiment, the judging performed by Carmen that led to the score of “20” was specifically the ranking (e.g., the “rank'em” step described above) as compared to the ranking performed by the control. In FIG. 79, Carmen's existing score, in this example, 80, is highlighed for an audience, and in FIG. 80, in an embodiment, her score (e.g., the “in-sync” score described above) is increased by 20, to 100.

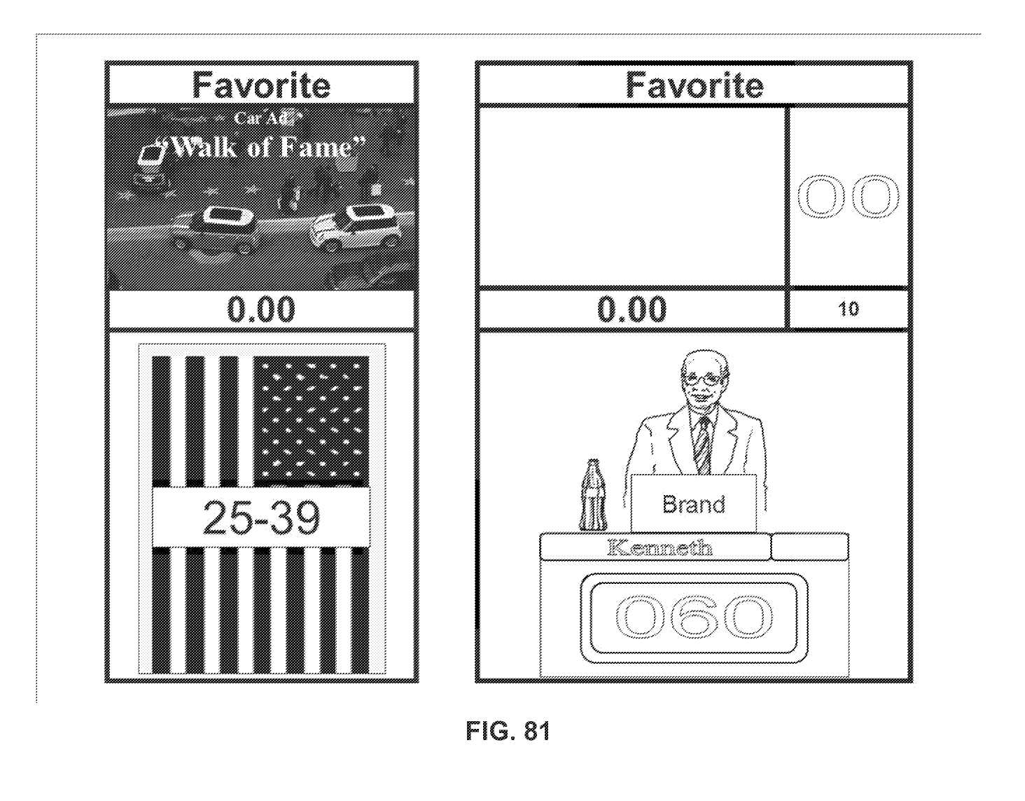

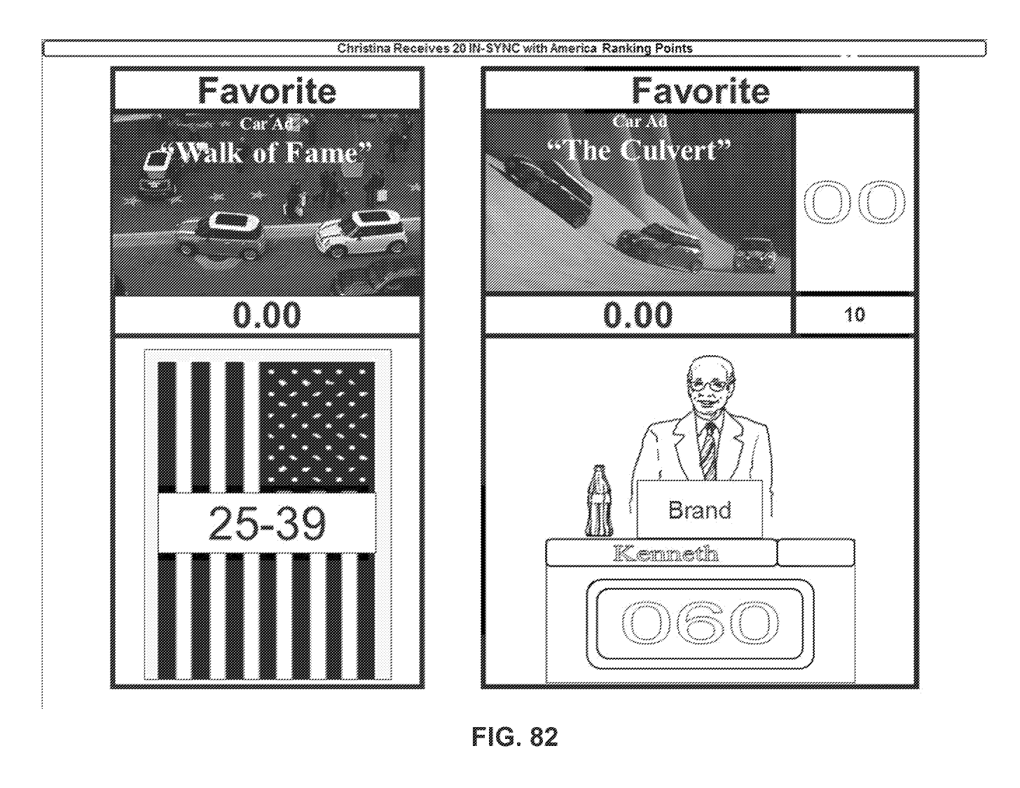

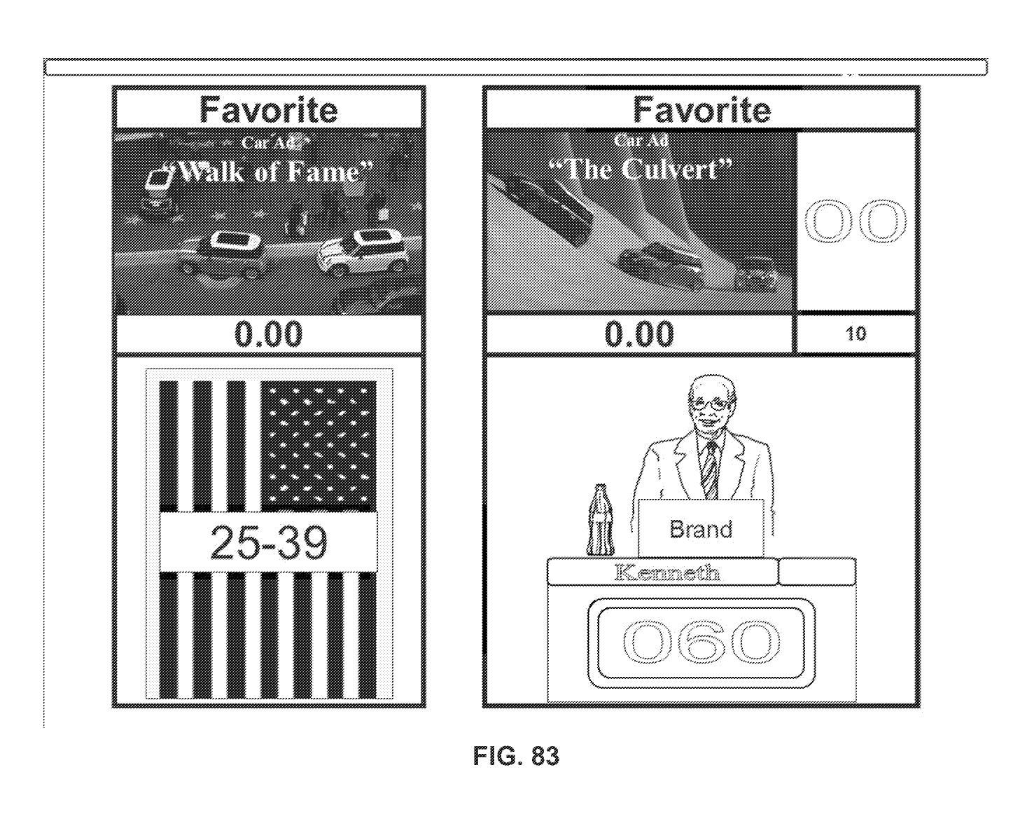

In FIG. 81, in this example, the focus is placed on the second judge, “Kenneth,” to reveal his ranking selection of the automobile videos. In this example, as shown on FIG. 82, Kenneth selected “the Culvert” as his favorite automobile advertisement. As reflected in the example on FIG. 83, because Kenneth did not match the control, no points were awarded. In other embodiments, a smaller amount of points are awarded if a match is not made, depending on the distance between the selected rank and the control rank, e.g., if control ranks 1st and judge ranks 2d, one point value is awarded, and if the control ranks first and judge ranks 3d, another, point value is awarded. In an embodiment, the point value awarded depends upon how many “steps” away the ranking are, e.g., 1st to 2d is one step. As would be appreciated by one having skill in the relevant art(s), given the description herein, different approaches to scoring based on the above-described control response could be selected without departing from the spirit of the invention.

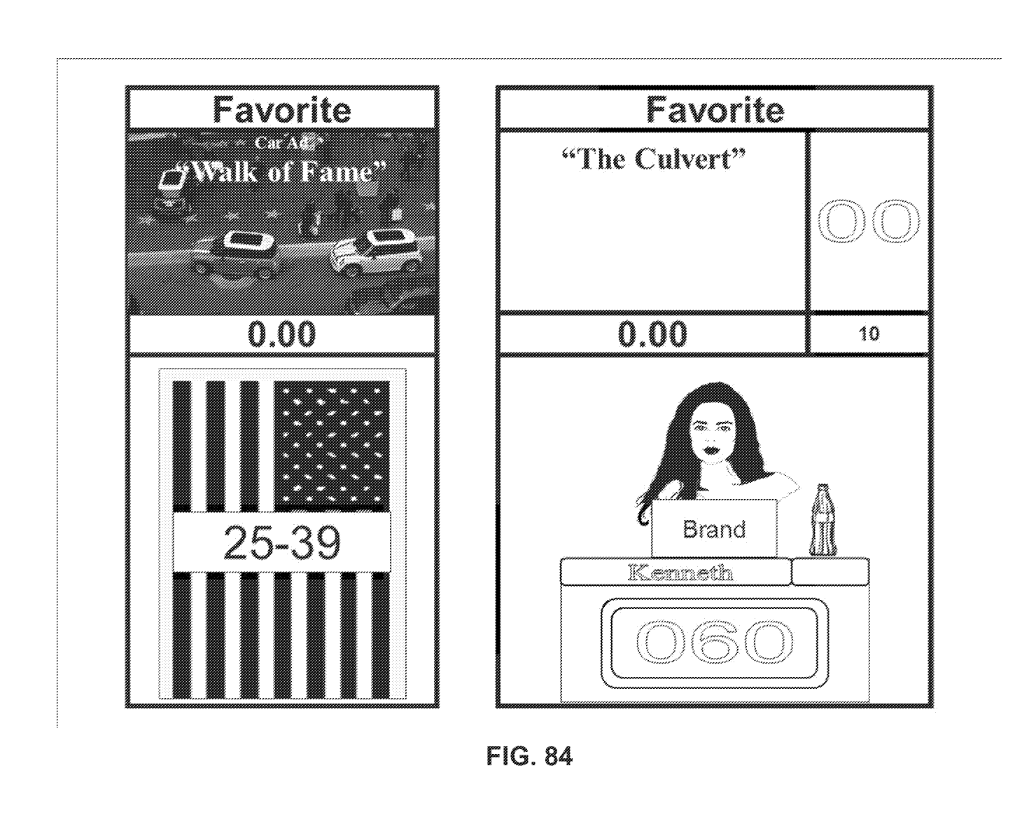

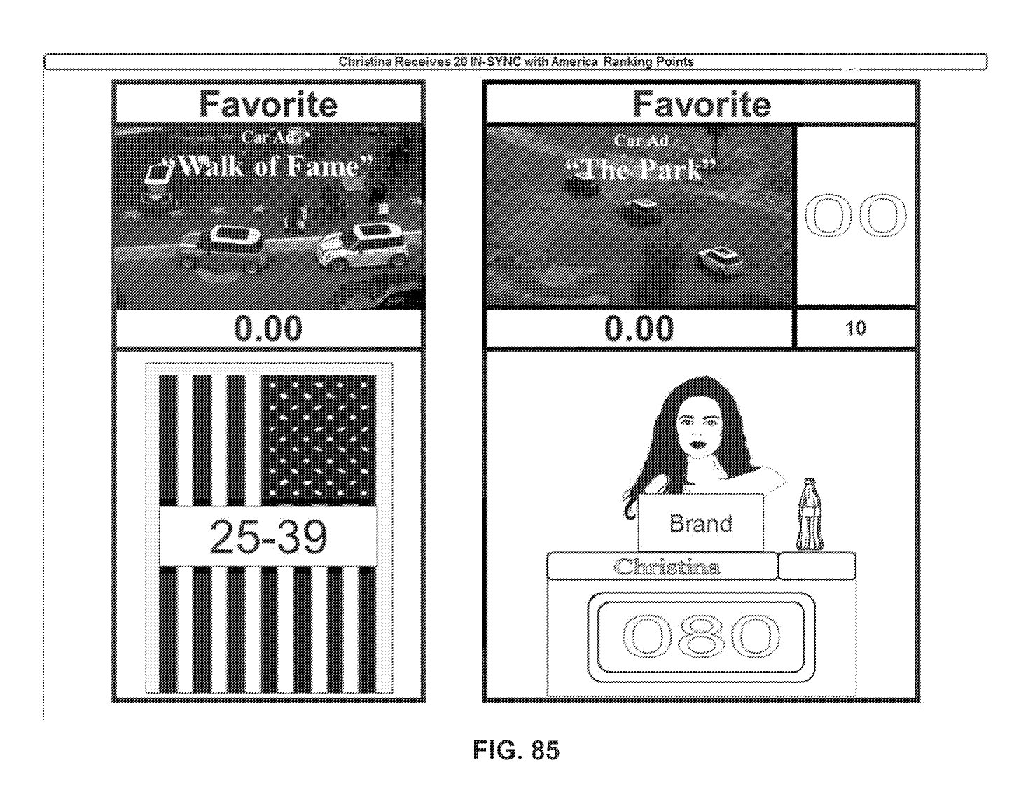

In FIG. 84, the third judge, in this example, is presented, and her current score is highlighted. In FIG. 85, in this example, it is revealed that she did not select the control-selected choice (she selected “the Park”). As with the second judge, based on her selection, she is not awarded any “in-sync” points.

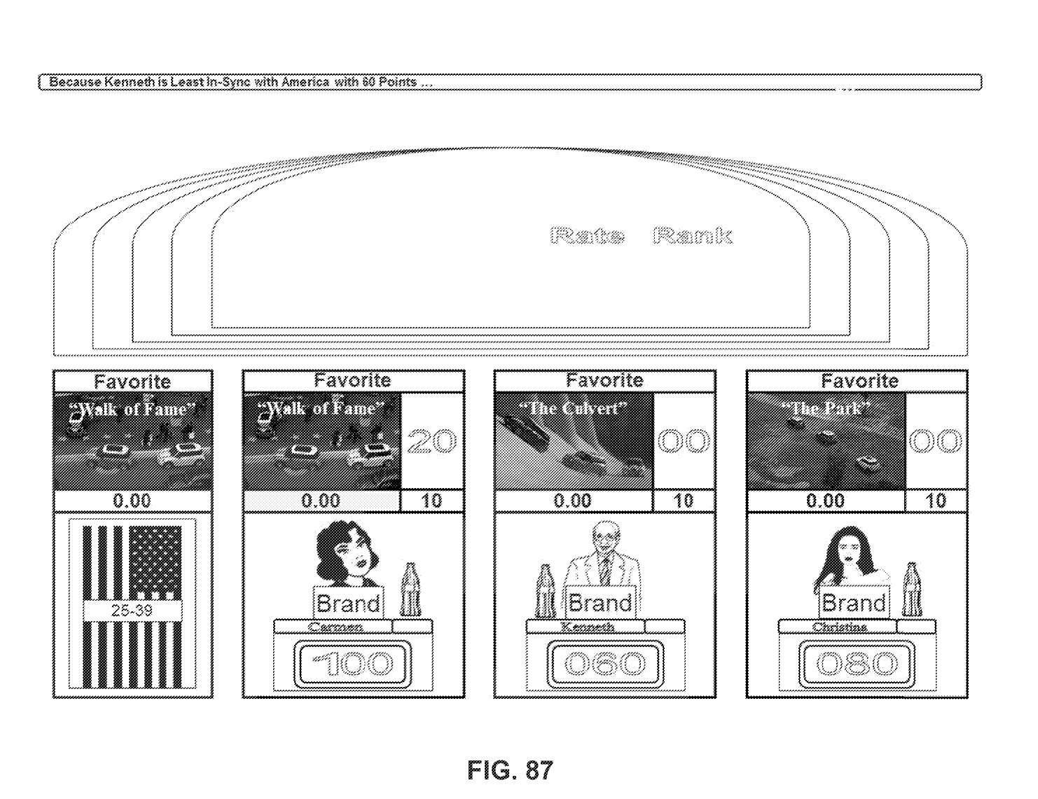

FIG. 87, depicts an embodiment of a game show presentation where the judges performance is summarized—showing their current scores and response selections. In an embodiment, this summary phase offers another opportunity to display advertiser content, In an embodiment, at any point in the previously disclosed judging process, the judges are encouraged to discuss the products and highlight different product features.

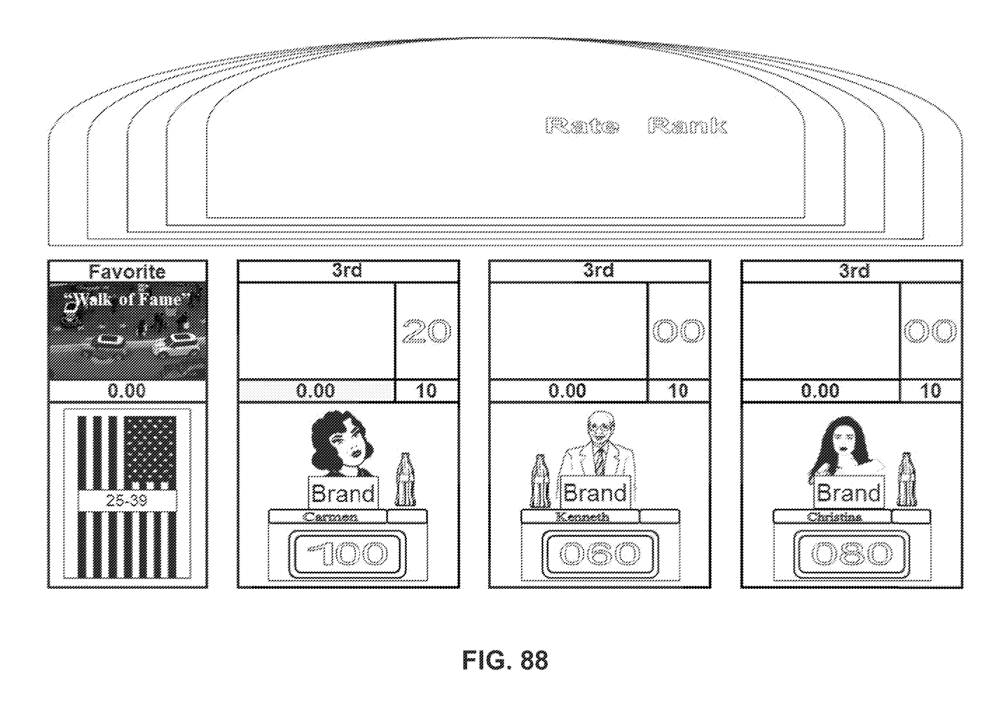

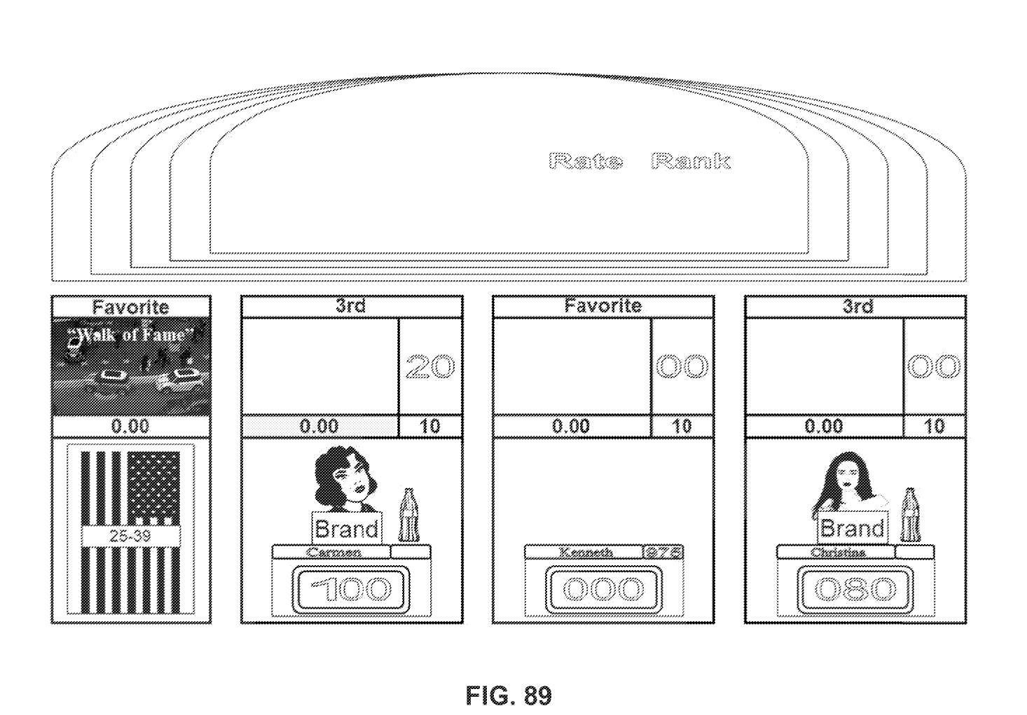

In an embodiment, at FIG. 88, based on the score totals of the judges, the lowest scoring judge—Kenneth—is eliminated from the show. In an embodiment, this elimination can be accompanied by dramatic effect (“Kenneth, you've been voted off the show!”). In an embodiment, the television show is a series that continues at regular intervals, and judges can stay on from week to week if they have high enough scores. In the example depicted on FIG. 89, the current judging panel is shown without Kenneth, this panel continuing to the next week.

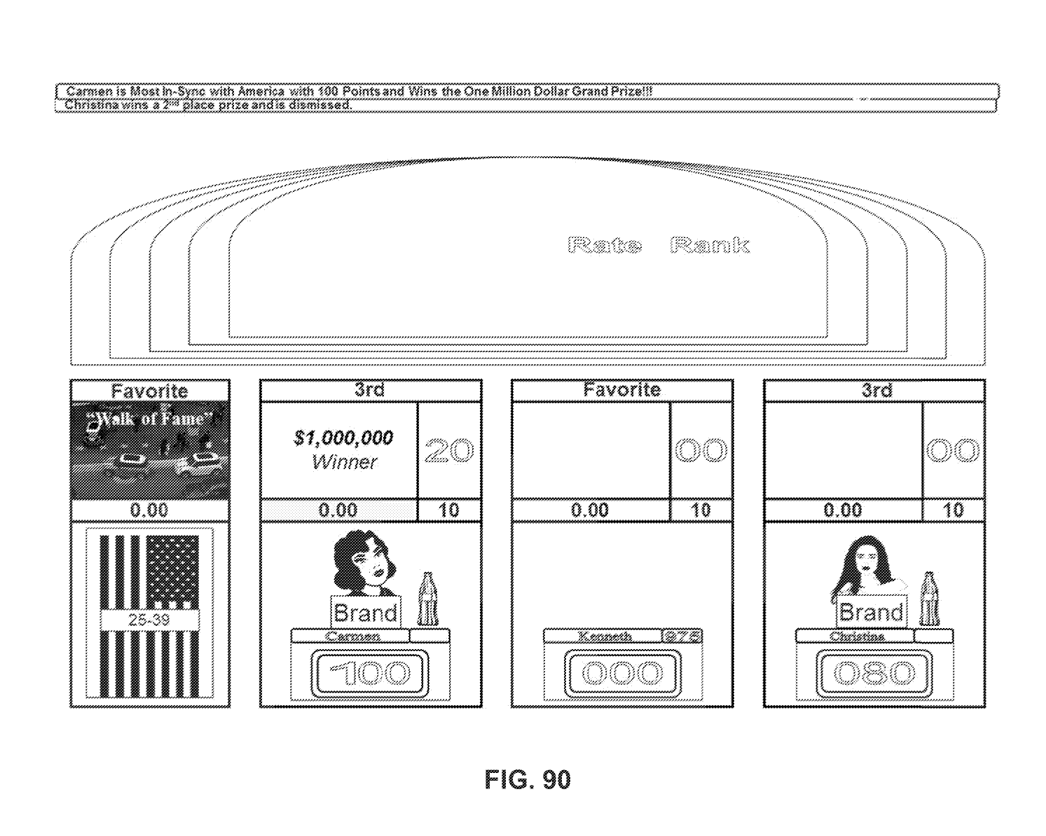

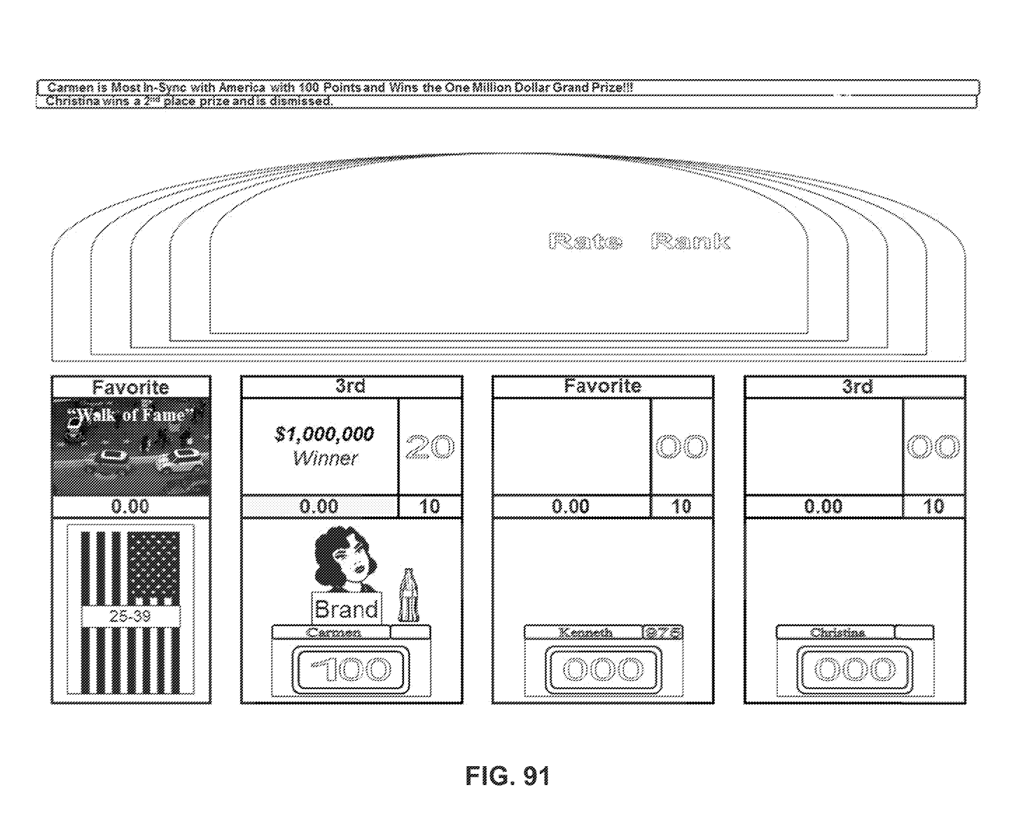

On FIG. 90, a variation of this example is shown where the conclusion of a competition is reached. In this example, because Carmen has the highest score, she is awarded a prize, another embodiment providing Christina with a prize as well. In another embodiment, the prizes can be awarded at a time other than the conclusion of the competition. As noted on FIG. 91, in an example, Christina is eliminated from an ongoing competition because she did not have the highest score.

Associated with the conclusion of the competition, as shown on FIG. 91, in an embodiment, an award score may be selected by the game producers that can be used to reward at-home participants in the home game described herein. This award score can be determined in a variety of ways, for example based on the performance of the judges. In an example, a point score of 135 is determined to be an award score, and at-home players are invited to collect prize money by logging into the on-line version of the multi-level game.

### Contestant Tie Breaking Method

As described above with the descriptions of FIGS. 30-91, different embodiments have judges competing against each other and scoring points based on their competition response choices compared to a selected control group, in the previous set of examples described with FIGS. 30-91, a winner was declared based on the highest score.

On FIG. 92, an example is shown where two judges Carmen and Christina, at the normal completion of the competition, are tied with the highest score. In FIGS. 92-106, embodiments are discussed that provide different approaches to breaking a tie at this phase in the competition.

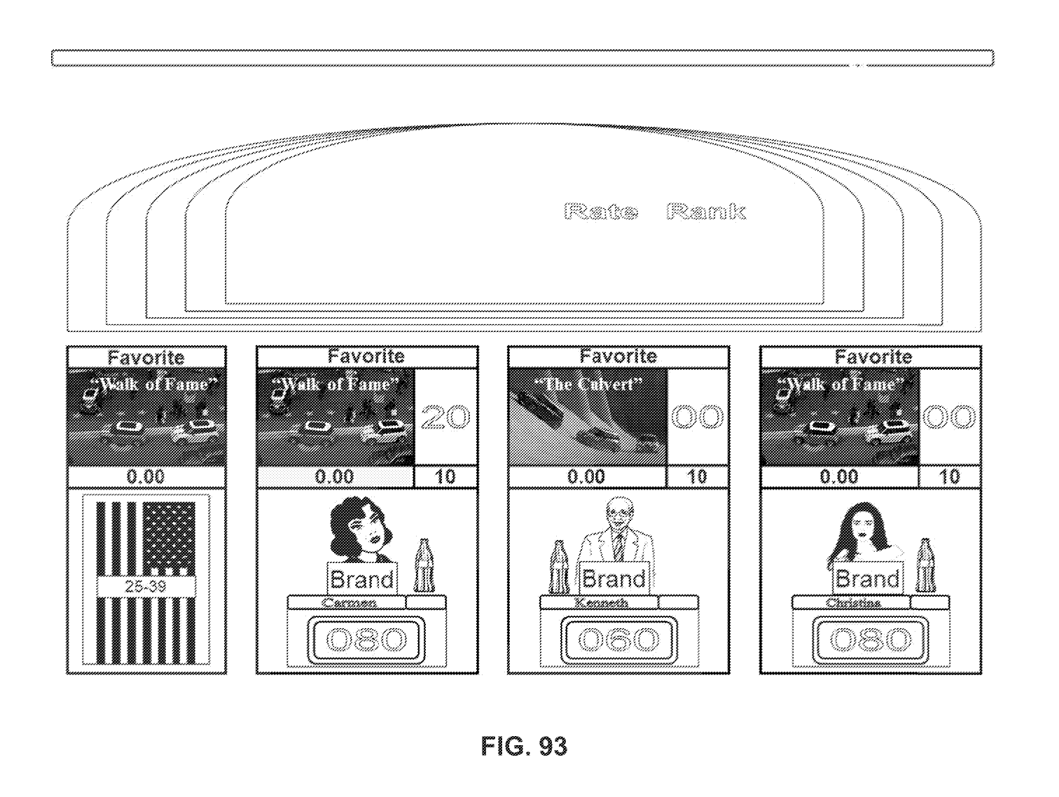

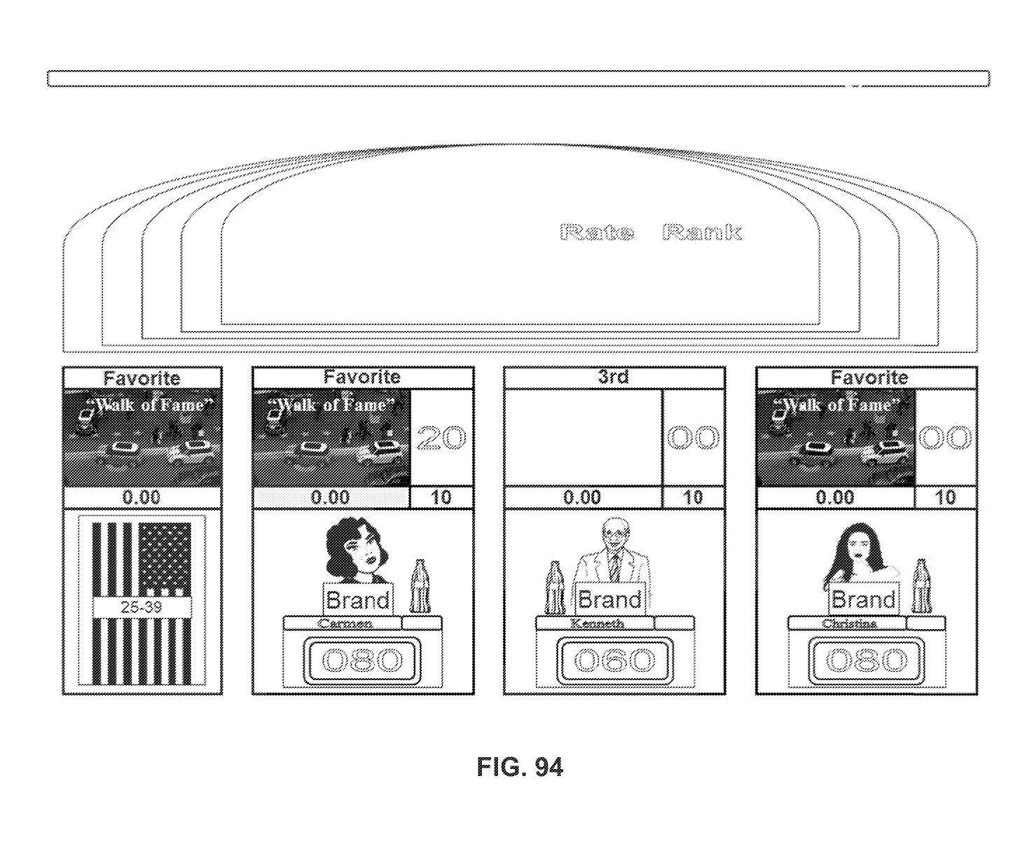

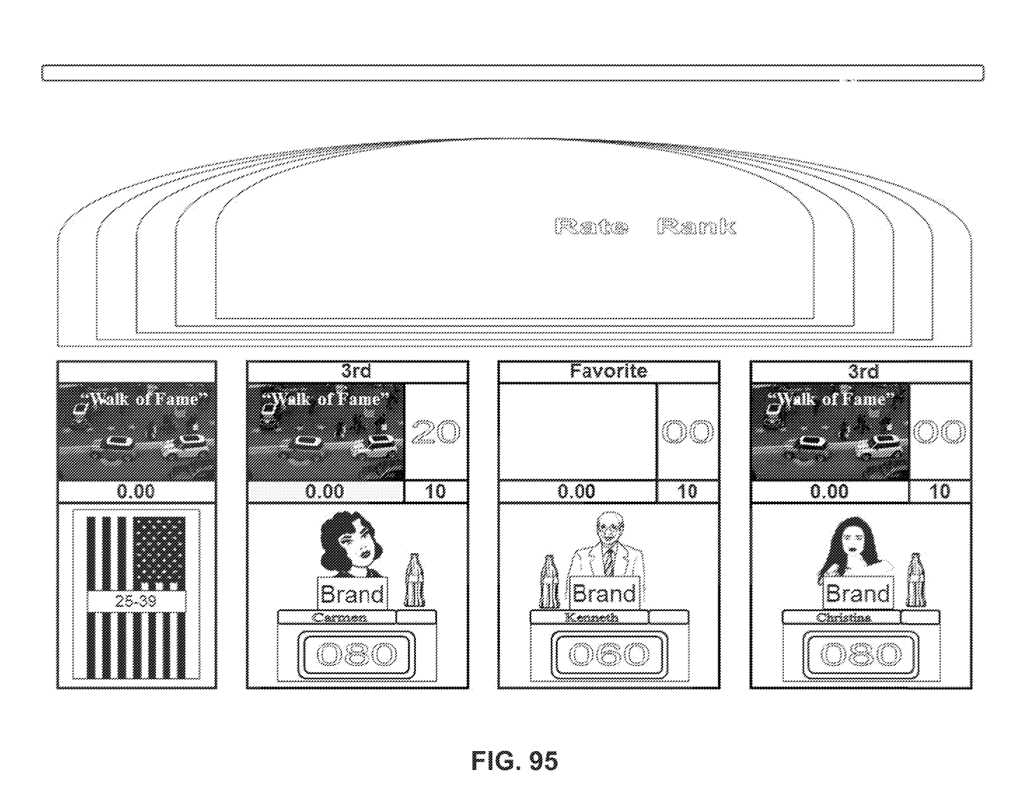

In FIG. 93, this tie is highlighted for the audience, and the specifics of a selected tie-breaking procedure are explained. As shown on FIG. 94, at this point in the competition, the judge with the lowest score can be asked to leave the program. In an embodiment, the lowest ranking judge can have their selections removed, and the competition can be highlighted with the remaining judges, as in the examples depicted on FIG. 95.

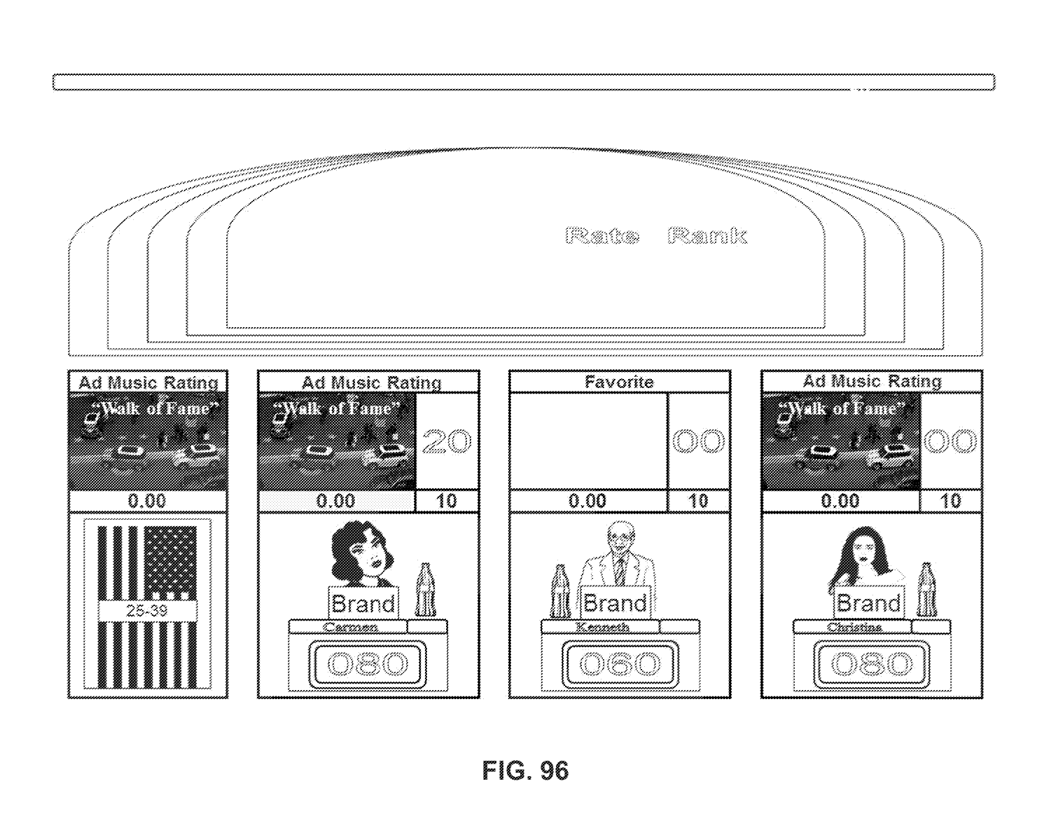

In FIG. 96, an embodiment of a tie-breaking procedure is shown. As described above in the sections describing the judging portions of the competition, during the judging process, the judges will rate and rank the response choices in the competition. In embodiments, when judges commit to their rating and ranking of the response choices, as discussed above, their to match a selected control group is used to award them points, In some embodiments discussed above, only the ranking if the response choices were used to score points. In an embodiment, a weighted ranking value may be used.

In an embodiment of a tie-breaker approach the otherwise unused rating scores can be used to break ties. In FIG. 96, in an example, the rated “Ad Music Rating” characteristic is highlighted for the audience—this characteristic corresponding, in this example, to the rating on a scale of 0-10 given by the judge for the music associated with the example automobile advertisements discussed above. In this tie-breaking embodiment, this Ad Music Rating will be used to break the tie between Carmen and Christina.

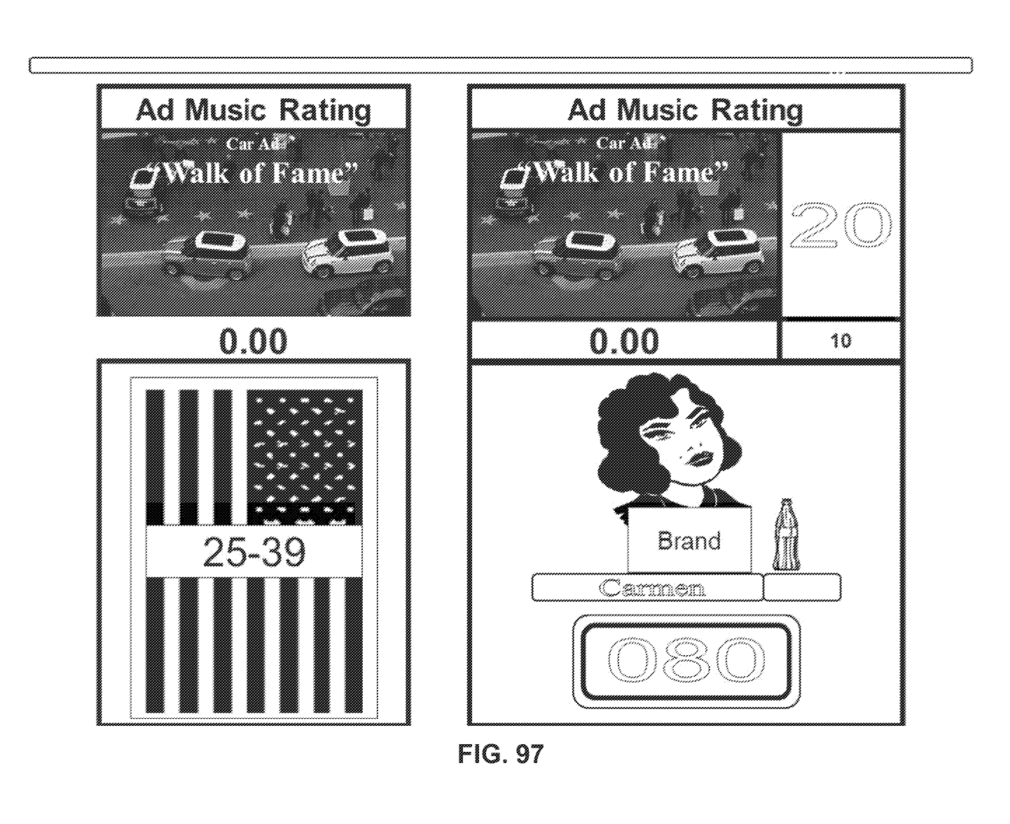

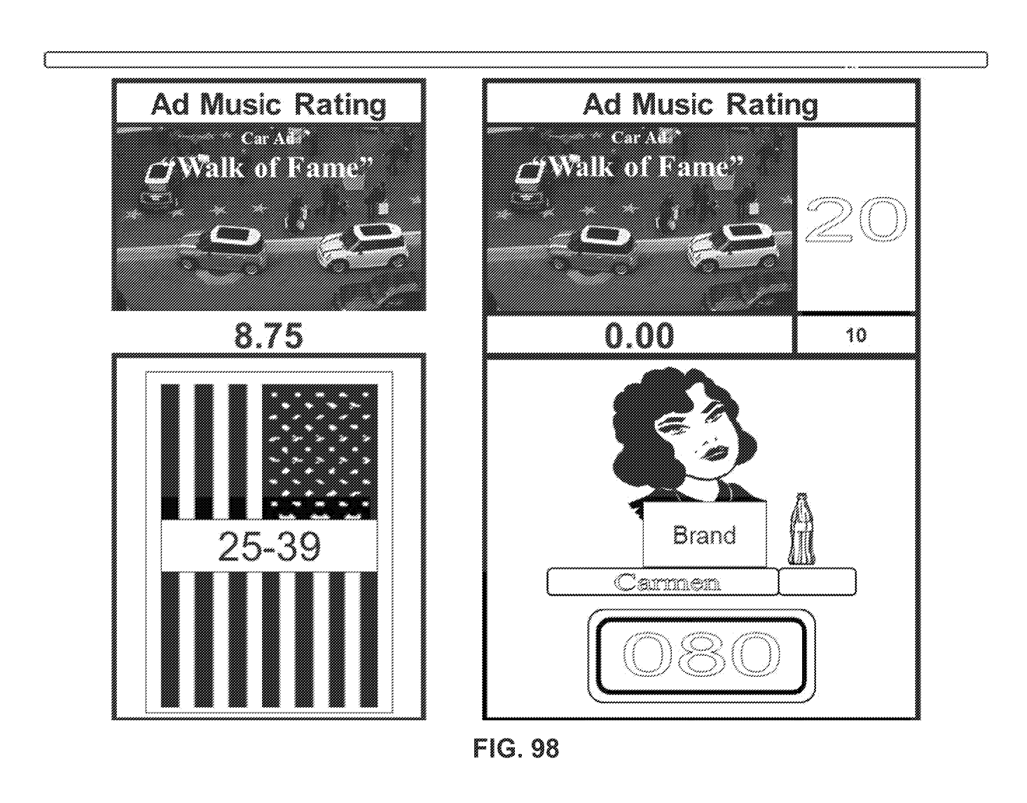

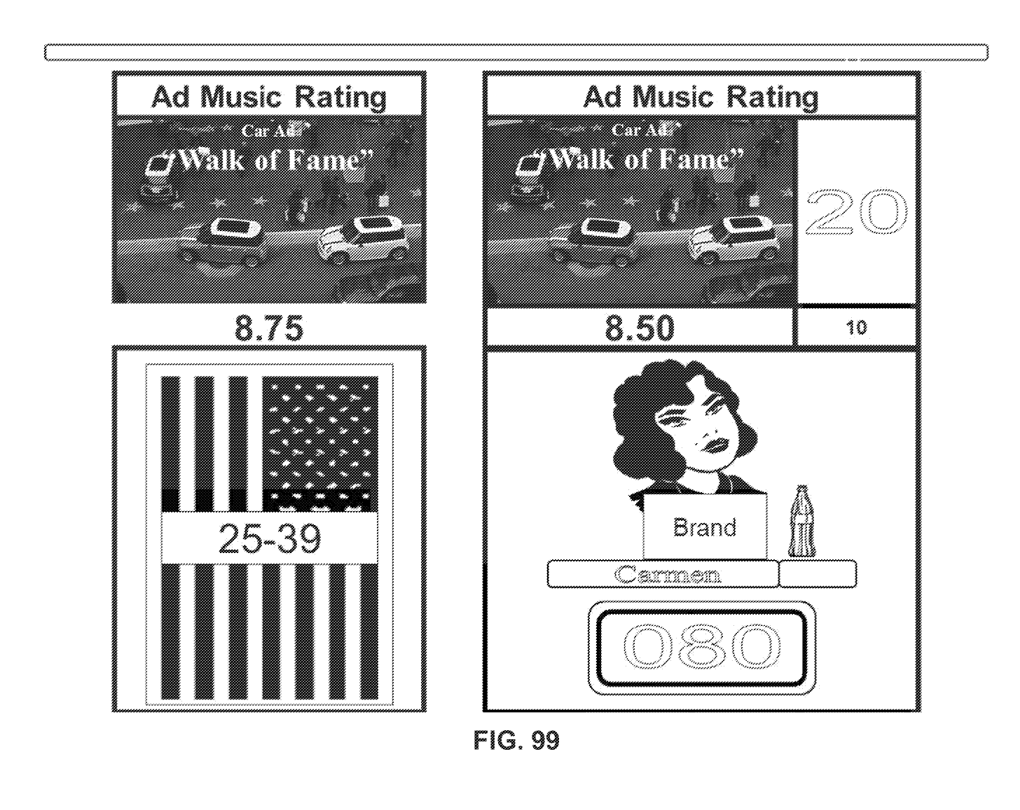

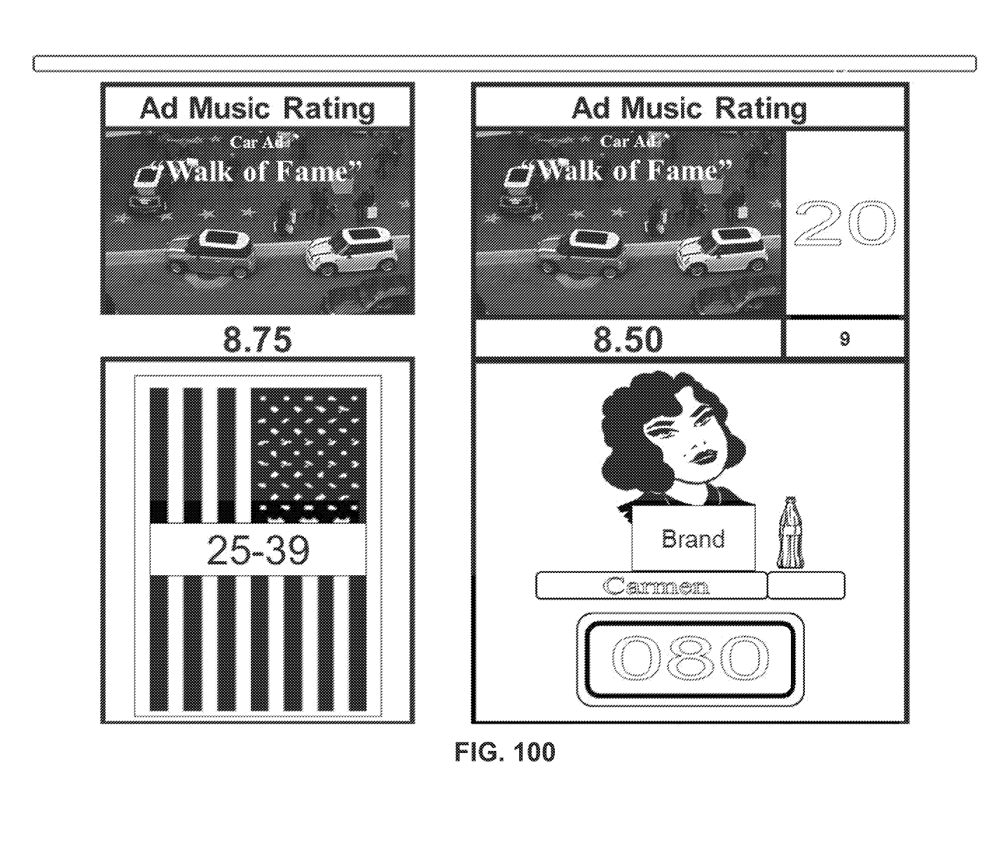

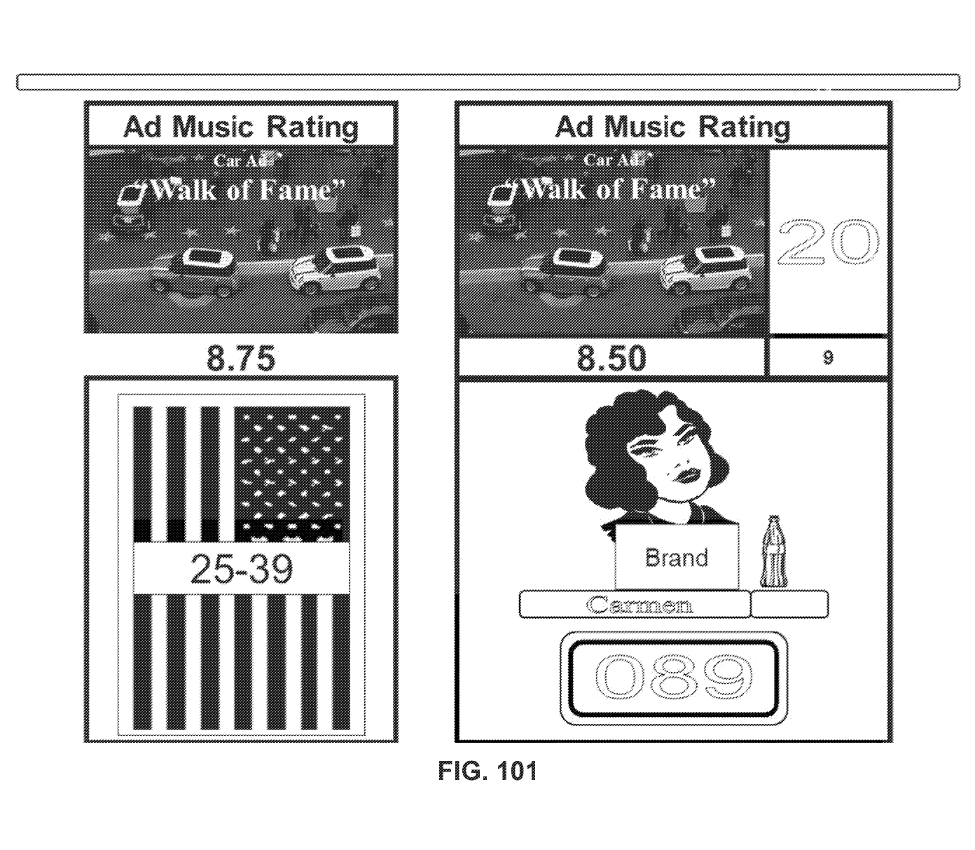

On the FIG. 97 example, Carmen is highlighted, and on FIG. 98, the control rating for the Ad Music Rating (8.75) is shown. This control score represents the baseline, the distance from which will determine Carmen's awarded tie-breaking points, according to an embodiment. After heightening the drama associated with this competitive moment, in an embodiment, on FIG. 99, Carmen's rating is revealed as 8.50. On FIG. 100, the example continues with Carmen being awarded 9 points because of the comparison of her 8.50 score to the control's 8.75. As would be appreciated by one having skill in the relevant art(s), given the description herein, this value can be determined in a variety of ways, each reflecting the comparison between the scores. On FIG. 101, the determined 9 points are added to Carmen's current score resulting in a final score of 89.

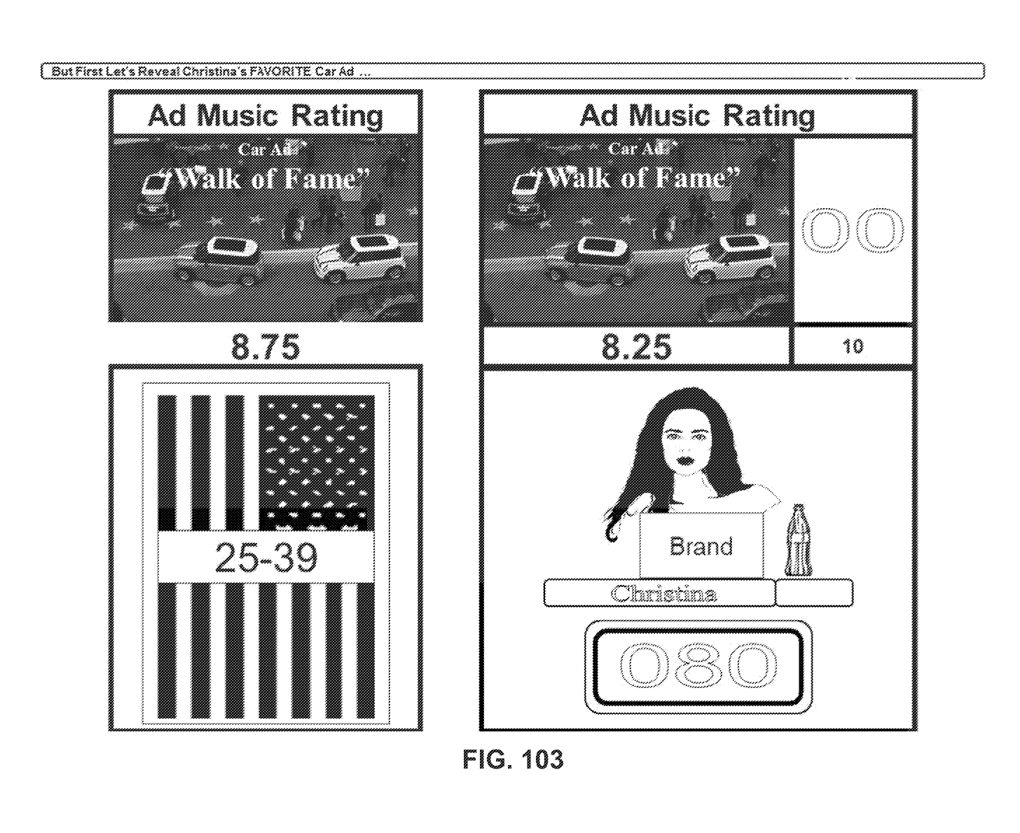

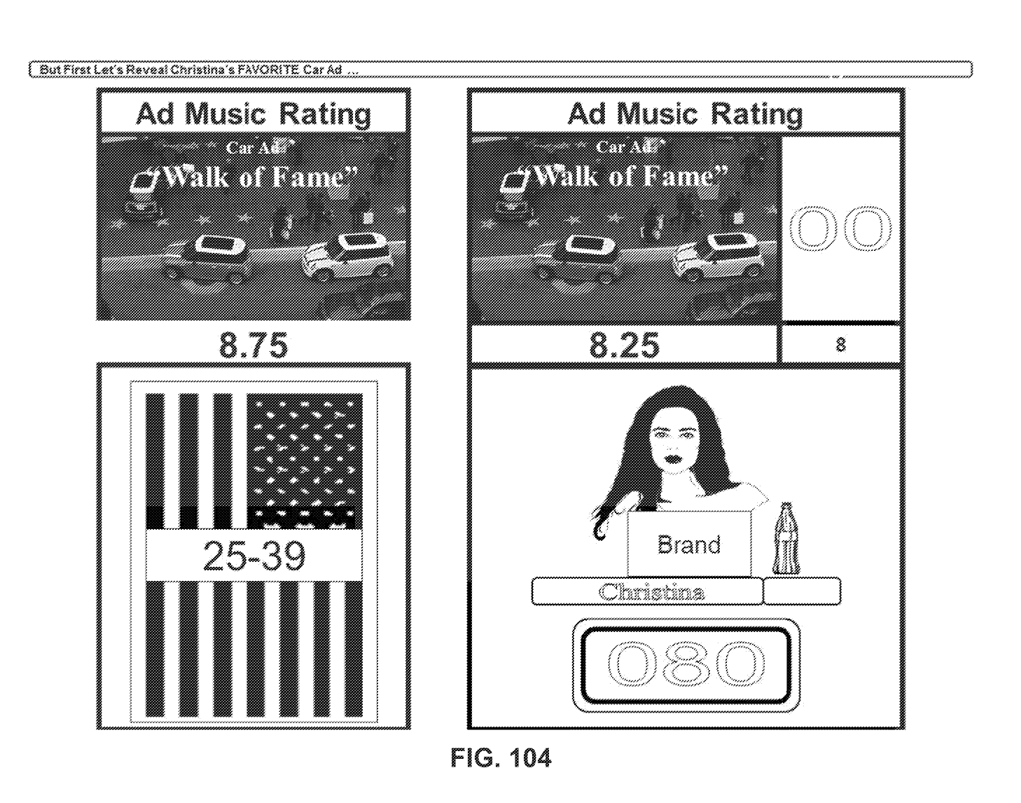

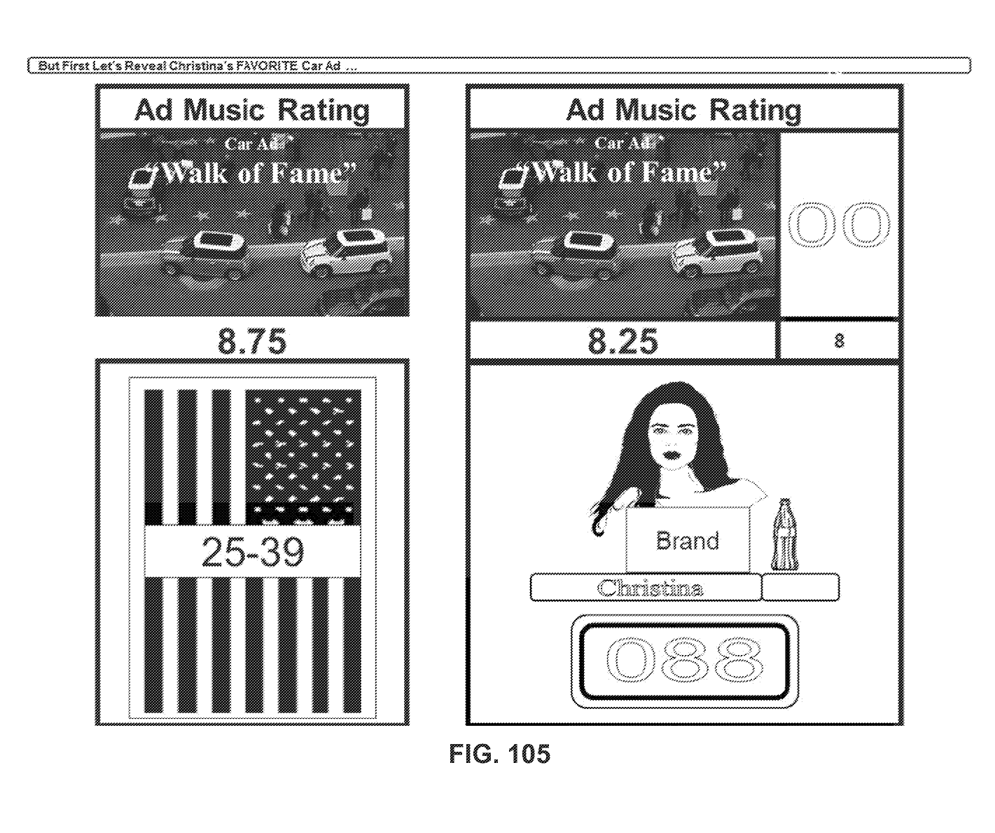

To complete the tie-breaker embodiment, Christina will go through the sequence shown with Carmen above in FIGS. 97-101, Christina is shown on FIG. 103, in this example to have entered an Ad Music Rating of 8.25, leading, on FIG. 104 to a determined tie-breaking score of 8 (8.25 being farther removed from the control rating than Carmen's 8.50). Thus, on FIG. 105, in this example, Christina has 8 points added to her score, resulting in a final score of 88. As shown on FIG. 106, in this example, Carmen prevails in the tie-breaking round. In other embodiments, additional ratings can be used to provide tie-breaking, including using multiple rating comparisons at the same time to determine the final score. In another embodiment, while multiple ratings may have been entered by the judges, these additional ratings are only used if a tie is not broken after the first tie-breaking round.

### Example Rating and Ranking System

Following is an exemplary rating and ranking system that can be used in an embodiment of the present invention.

### Game Interaction Sequence

FIGS. 1 thru 11 depict a participant's response game interaction sequence. For illustration purposes the game elements utilized for this demonstration are 6 single artist songs and 6 sponsor's corporate logo designs. Keep in mind that a game element may be anything within the universe that can be responded to or receive a response. FIG. 1 shows images representing a music artist. Each image represents a song that has been made available for evaluation on one or more evaluation platforms. The system the images are uploaded into is a type of response system. This response system is a game element ranking system. The game element ranking system enables participants (controlling players, non controlling players, controlling respondents other than players, and non controlling respondents other than players) to rank their favorite songs in the order of 1st thru 3rd place generally based on a previous evaluation of each song. The ranking system also enables participants to evaluate/rate each song based on a rating scale. Participants are enabled to re-evaluate each song or evaluate songs for a first time by simply clicking on a rating button associated with each image.

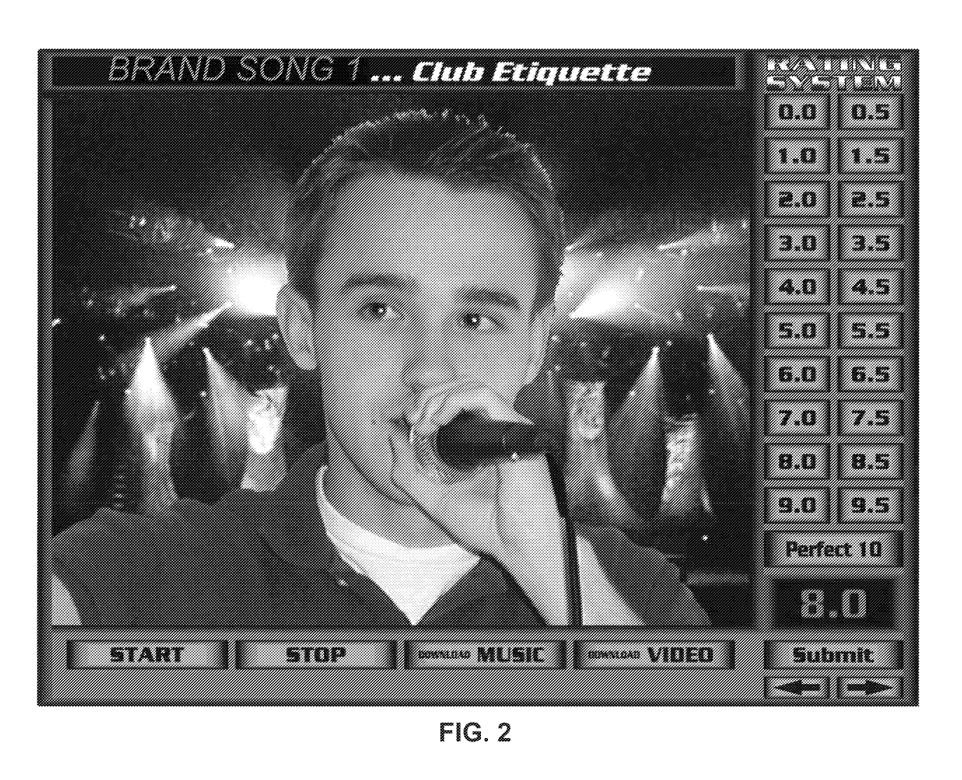

By clicking on the rating button a participant is transferred to a rating system shown in FIG. 2. Numerical rating, whether performed by participants, judges and/or a control, is also referred to herein as numerical assignment.

The rating system now enables the participant to listen to each song presented on the ranking system. The participant clicks on the download music button to listen to the song represented by the title an image posted. The participant clicks on the 8.0 as indicated by the 8.0 highlighted in red in the space below the rating buttons and above the submit button. The participant clicks on the submit button to enter the rating into a song rating database associated with the participant.

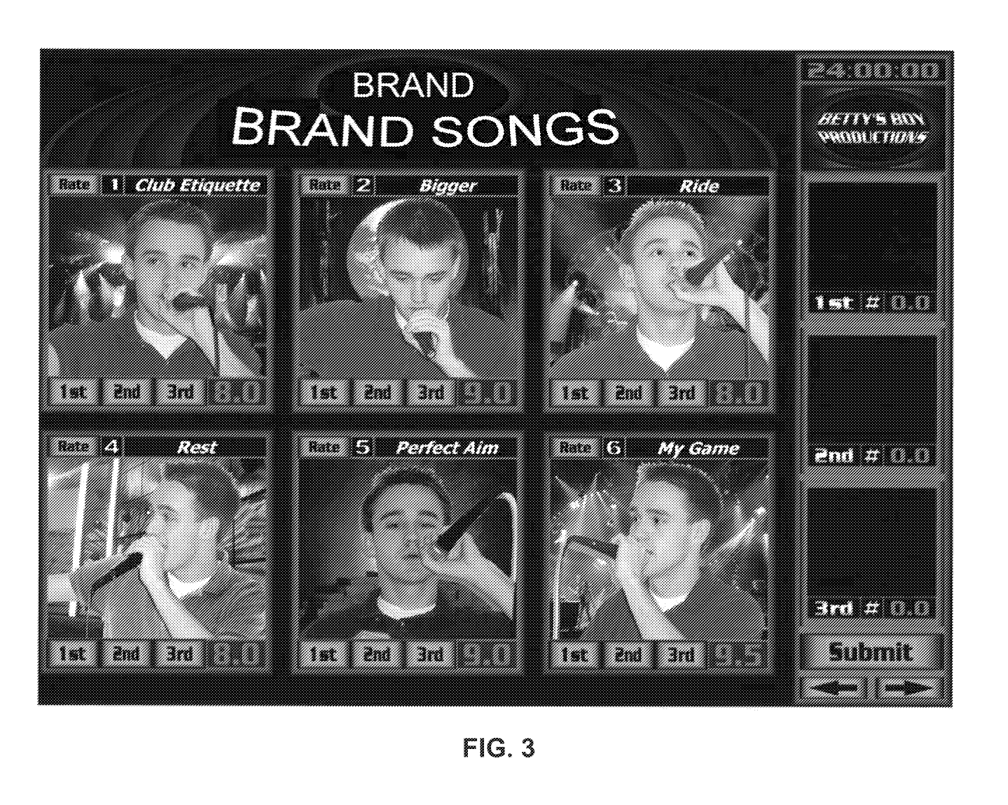

After submitting the rating the participant is transferred back to the ranking system shown in FIG. 3. FIG. 3 shows that the participant rated each of the 6 songs and is now ready to rank 3 favorite songs in the order of 1st thru 3rd place by clicking on a ranking button below each image representing a song. By clicking on a ranking button below an image the image is transferred to a staging area to the staging area is framed The red framing throughout the system identifies a participant's initial and submitted images receiving a participants one or more responses.

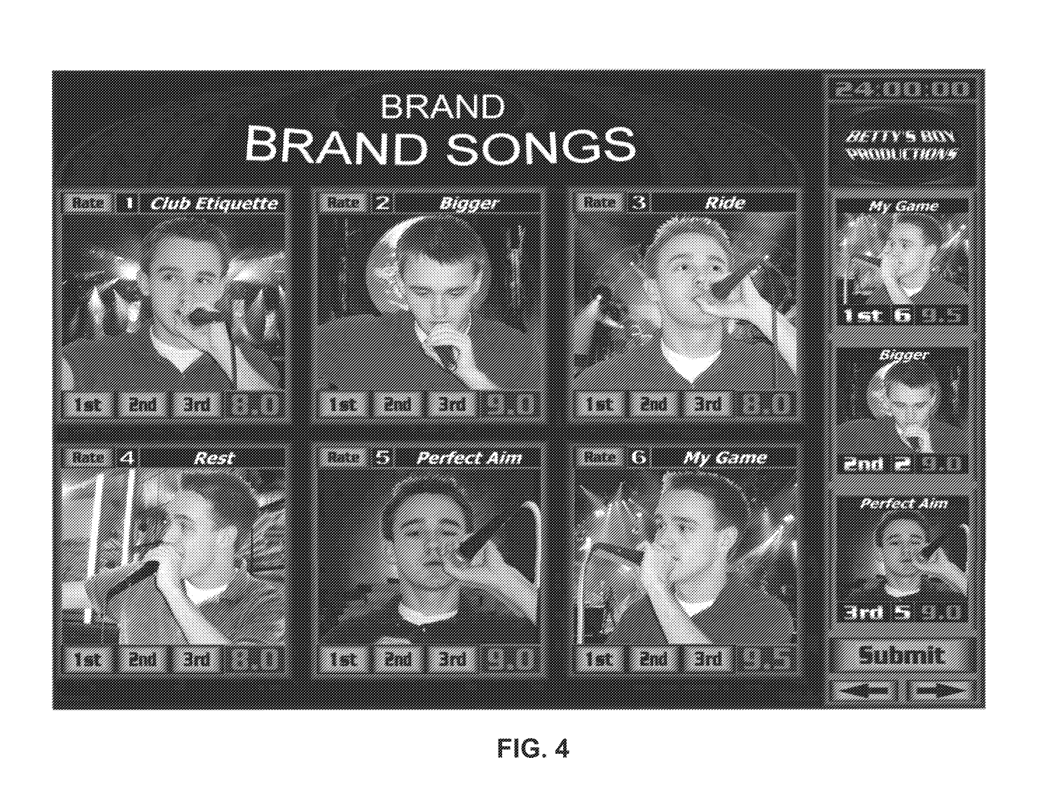

The ranking system now enables the participant to rank their 3 favorite songs according to a rating of each song, although the participant may of elected to rank songs based on a previous evaluation process. FIG. 4 shows the participants 3 favorite song rankings and rating transferred to the song response staging area. The participant may now re-evaluate one or more songs or provide a submission of each song rating and ranking by clicking on the submission button located below the ranking staging area.

When a participant is identified as a player, the participant's response submission are transferred to a response point assignment and calculation system. When the participant is a respondent other than a player the participant is transferred to a subsequent game element response system whereas one or more game element categories exist. The term respondent generally identifies the participant as a controlling participant or non controlling participant. A game producer and sponsor may designate one or more respondents other than players as a response point controller. The game producer may also designate one or more players as a response point controller whereas the designated players may be referred to as controlling players. All players, controlling and non controlling, may receive a point value for providing a response to an element that is at least similar to a response point controllers response to the element. When a producer and sponsor designate a highest number of players as a response point controller, the response point controller is unidentifiable until sometime after players submit responses. After responses are submitted the highest number of players providing a response to an element become identifiable as controlling players. Players that are not within the highest number of players become identifiable as non controlling players. Controlling players based on a single response to an element receive a point value based on their ability to respond in-sync with the response point controller.

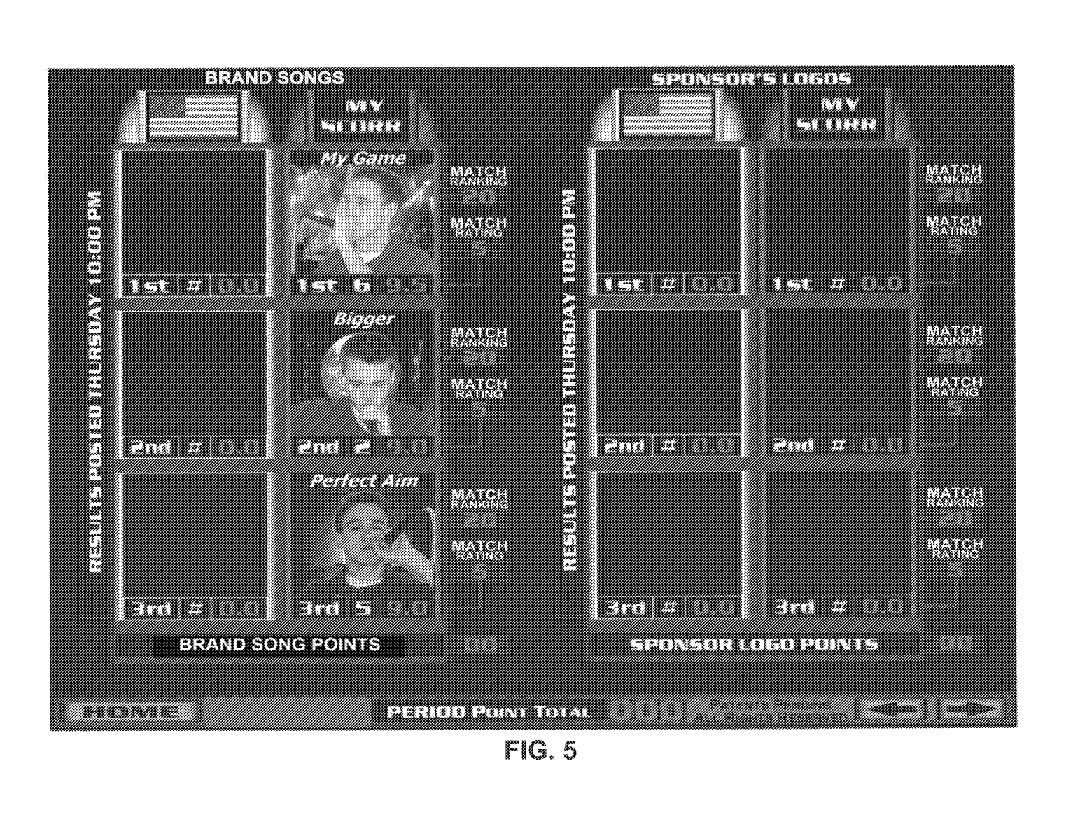

In one approach, if a highest number of players is a response point controller and the highest number of players provide a response to an element that receives a point value, and that the game results in a highest number of players receiving a highest point total. This may be true if the game only required one response to two elements. When the game requires a plurality of responses to a plurality of elements, players making up a highest number of players evolves with each response. This producer and sponsor for this game designates a highest number of Americans as a response point controller depicted by the American flag posted over the gold frames within the two game element categories shown in FIG. 5.

In contrast to the optional embodiment evaluation described in an embodiment above, in an embodiment, the evaluation step is required to progress in the game.

This game embodiment requires players to rate 6 game elements within 2 categories and rank 3 of the 6 elements within each category. This way the game embodiment requires a player to provide 18 responses (12 ratings and 6 rankings) for this period. The game embodiment may also have a number of periods or response sessions each with 18 required responses. When a game embodiment consists of 10 periods or response sessions the number of player required responses increased to 180. Identifiable players comprising a highest number of players comprising a response point controller may be a majority of players when players are required to provide one response to one of two elements, but when 180 responses are required players that receiving a highest point total are minimal.

A response game embodiment producer's and/or sponsor's objective may be to enable a massive number of players receive a highest response point total by requiring fewer responses to fewer element for fewer periods.

Returning to the game: after submitting ranked songs the participant is transferred to a response point assignment and calculation system. FIG. 5 show the participant's songs transferred into the system. The response point assignment and calculation system shows a participant's submitted responses framed in red and one or two response point controller's gold frames. A game embodiment phrase may be “Players Response are Red and The Controller's are Golden.”

The response point assignment and calculation system shown in FIG. 5 posts a players responses to elements within two game embodiment categories and a response point controllers responses within the two categories. This system posts a player's and controller's ratings and ranking to 3 element within each of two categories.

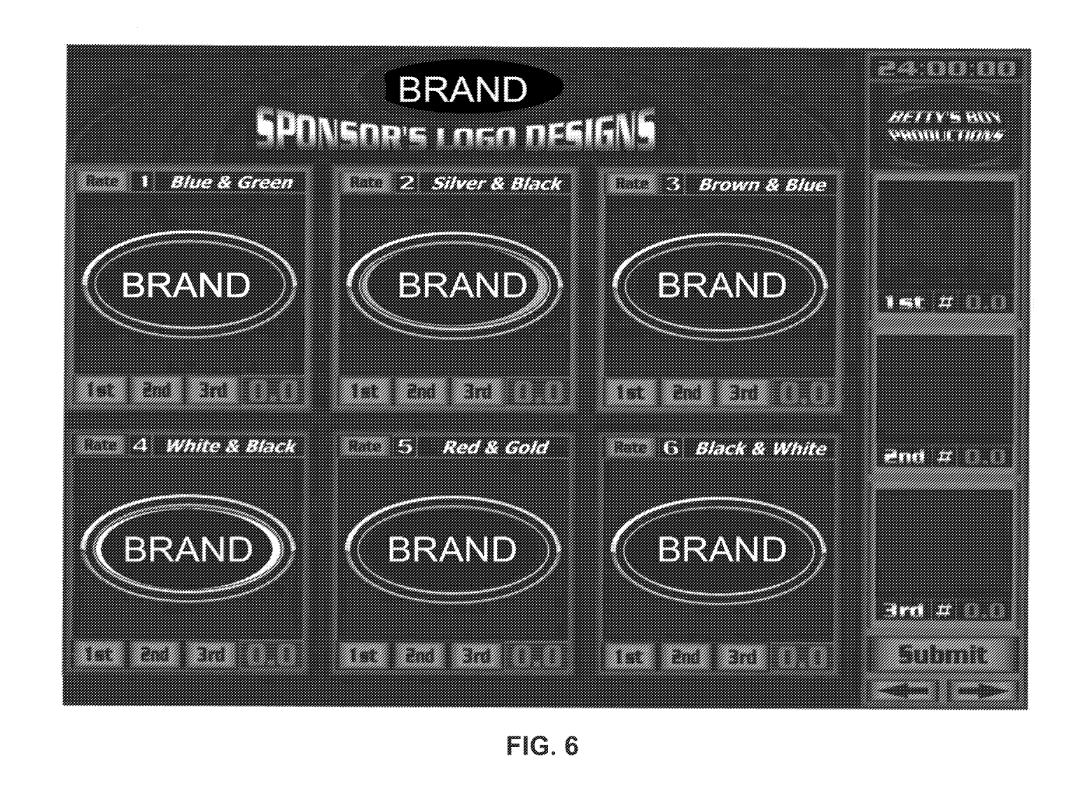

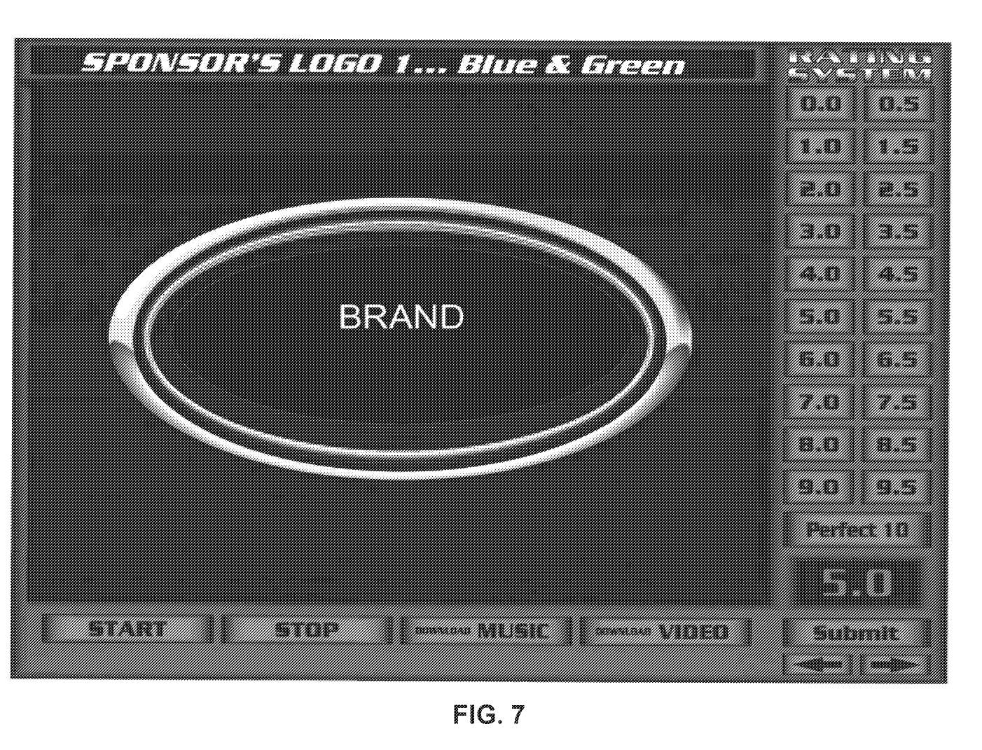

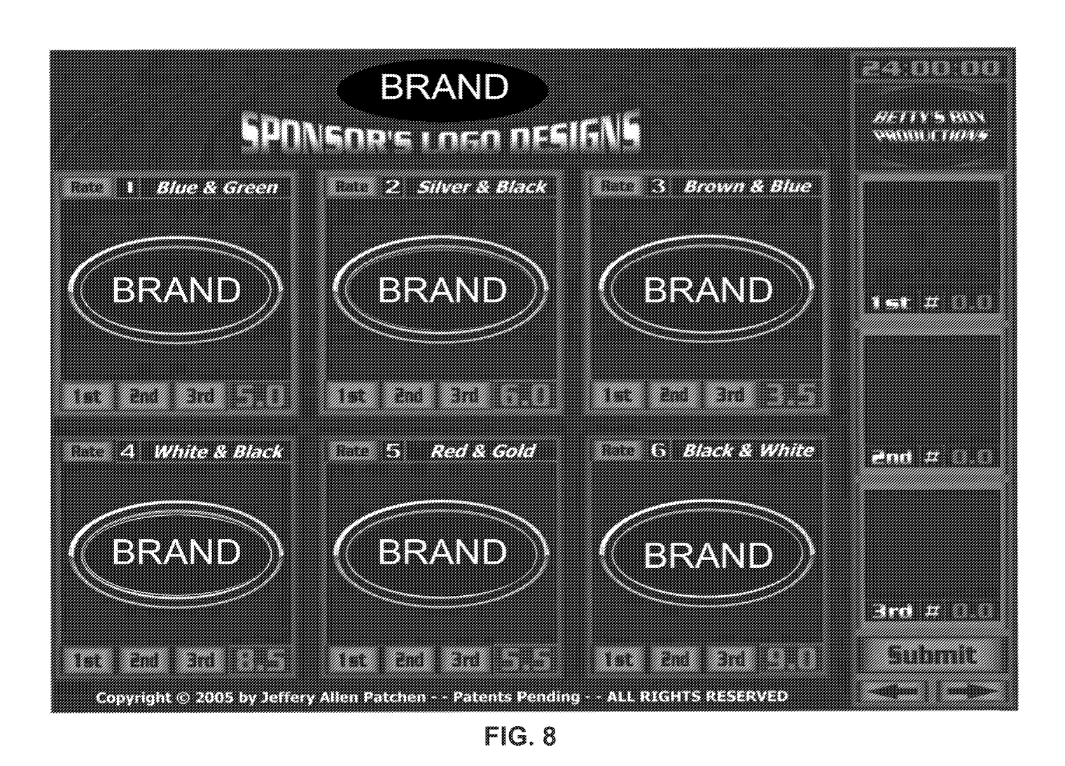

The player now clicks on the forward button located at the bottom right of FIG. 5 and is transferred to a sponsor's game embodiment element response system shown in FIG. 6. For this game embodiment the sponsor wishes to allow America to vote on a corporate logo the sponsor will utilize based on a highest number of votes or a response point controller. The player or participant clicks on the rate button associated with logo number 1 and is transferred to the sponsor's game embodiment element evaluation system show in FIG. 7. The participant rates the sponsor's six (6) game embodiment elements and is transferred back to the ranking system shown in FIG. 8 where a rating of each of the sponsor's game embodiment elements is now posted.

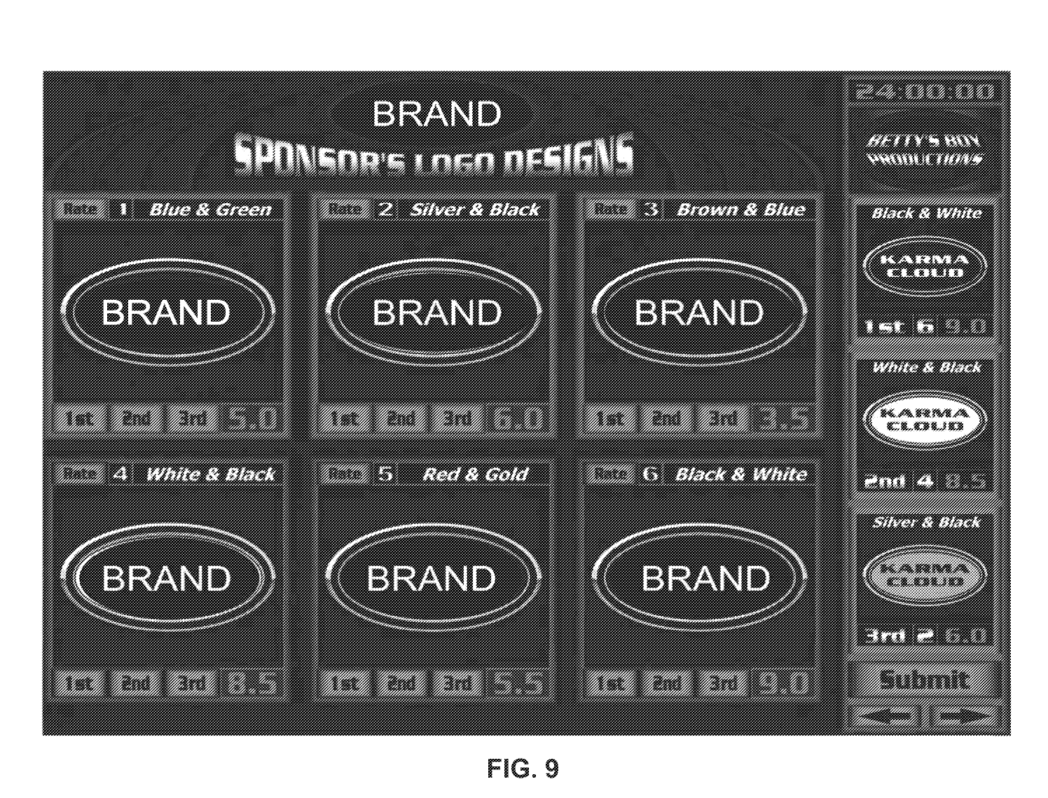

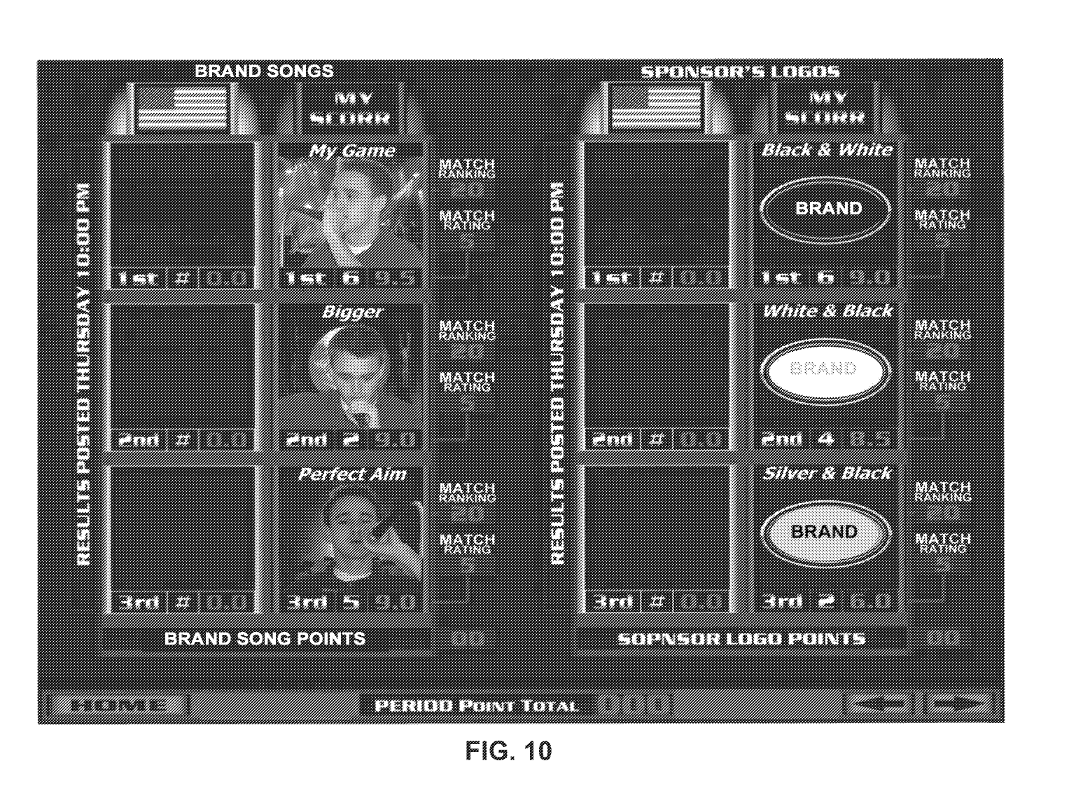

The players ranks three (3) favorite sponsor's game embodiment elements show in FIG. 9 wherein the players rating and ranking of their three (3) favorite sponsor's game embodiment element is staged. The player submits rankings by clicking on the submit button. The player is again transferred to the response point assignment and calculation system shown in FIG. 10 wherein the players rated and ranked producer's game embodiment elements and rated and ranked sponsor's game embodiment elements are posted.

Players receive twenty (20) points for matching a response point controller's ranking and five (5) points for matching a response point controller's rating.

Americas favorite producer's game embodiment elements and sponsors game embodiment elements are posted sometime after a response submission deadline.

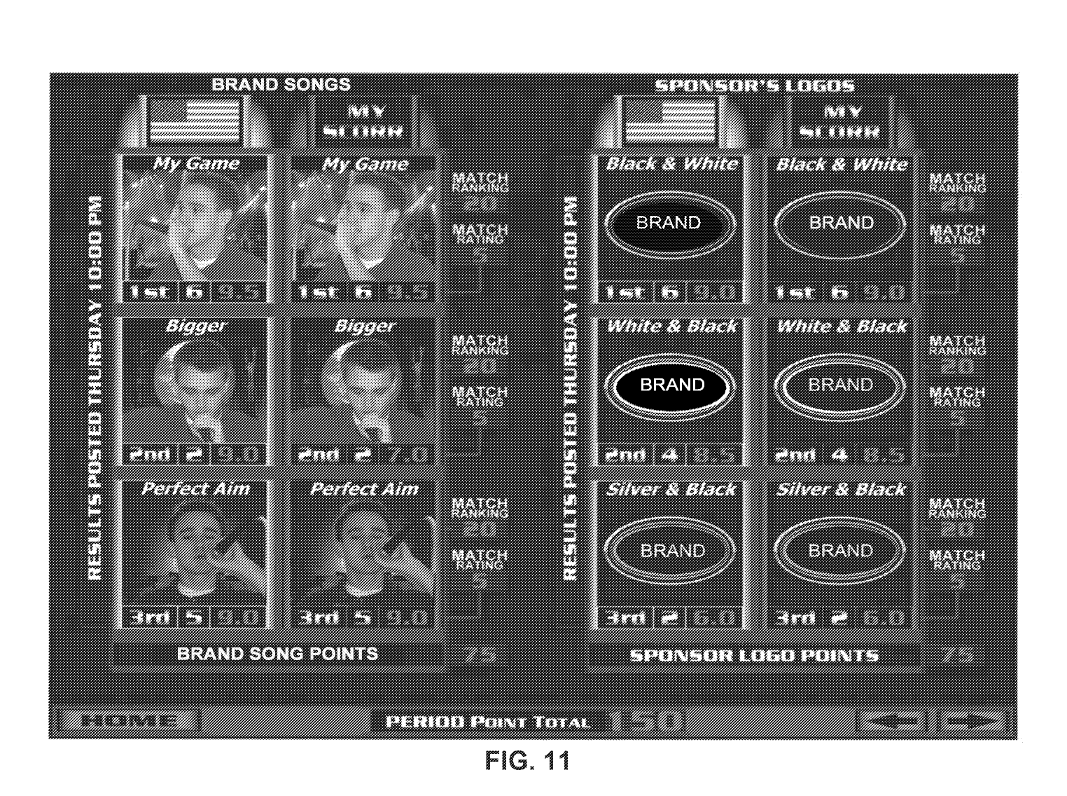

The response point controllers rated and ranked producer's game embodiment elements and rated and ranked sponsor's game embodiment elements are shown posted in FIG. 11. When the response point controller's response are posted within the response point assignment and calculation system a player's response points are assigned, calculated, and totaled. Players receiving a highest point total for a period are identified as in-sync with the response point controller that period whereas only one response point controller is utilized for the period.

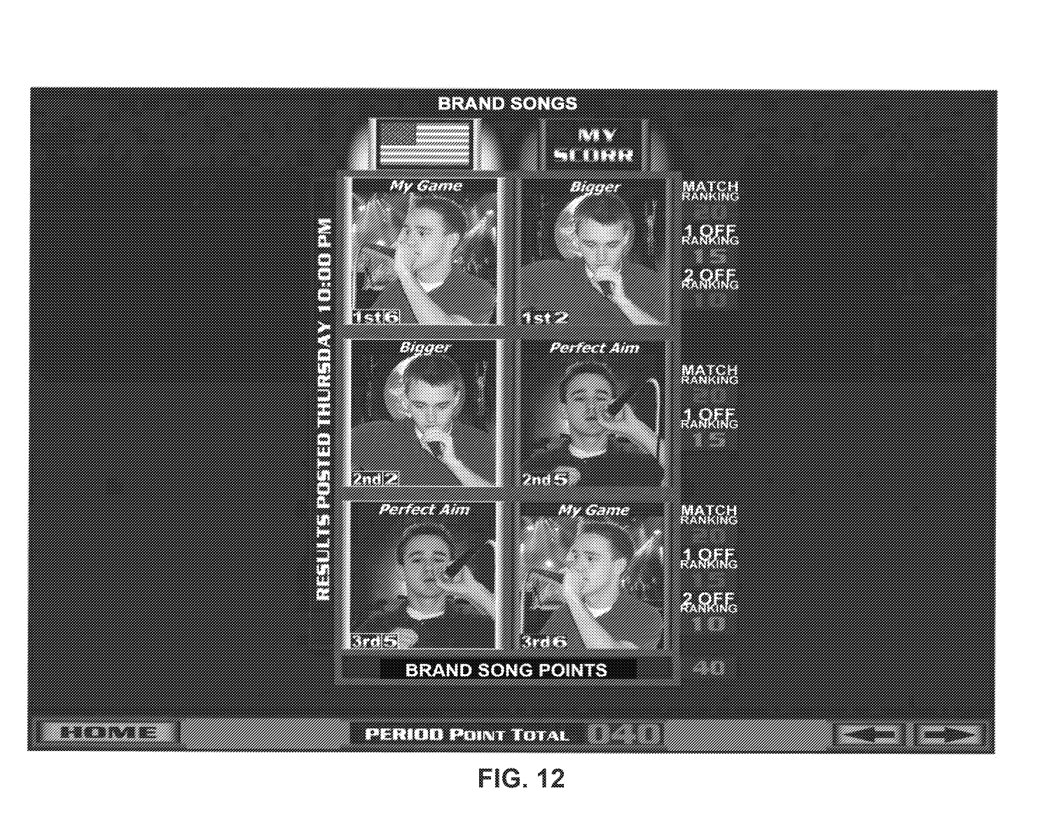

FIG. 12 shows a response point assignment and calculation system wherein a player receives point values based on responding to a same element a response point controller responds to but does not match a response with the response point controller. This type of system assigns a highest point value for matching a response point controller's response, which the player depicted failed to do, This system also assigns points of a lesser value based on proximity to a response point controller's response. The player depicted received ten (10) points for providing a response that was two off from the response point response and fifteen. (15) points twice for providing two responses that are one of each from the response point controller's two remaining responses.

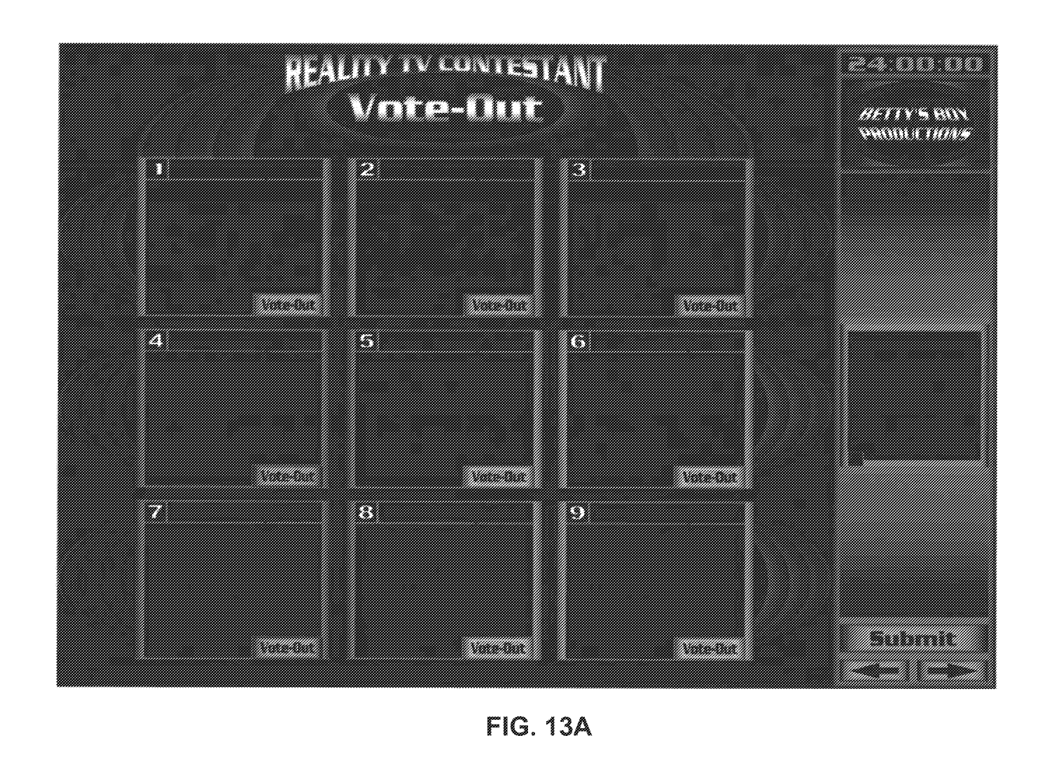

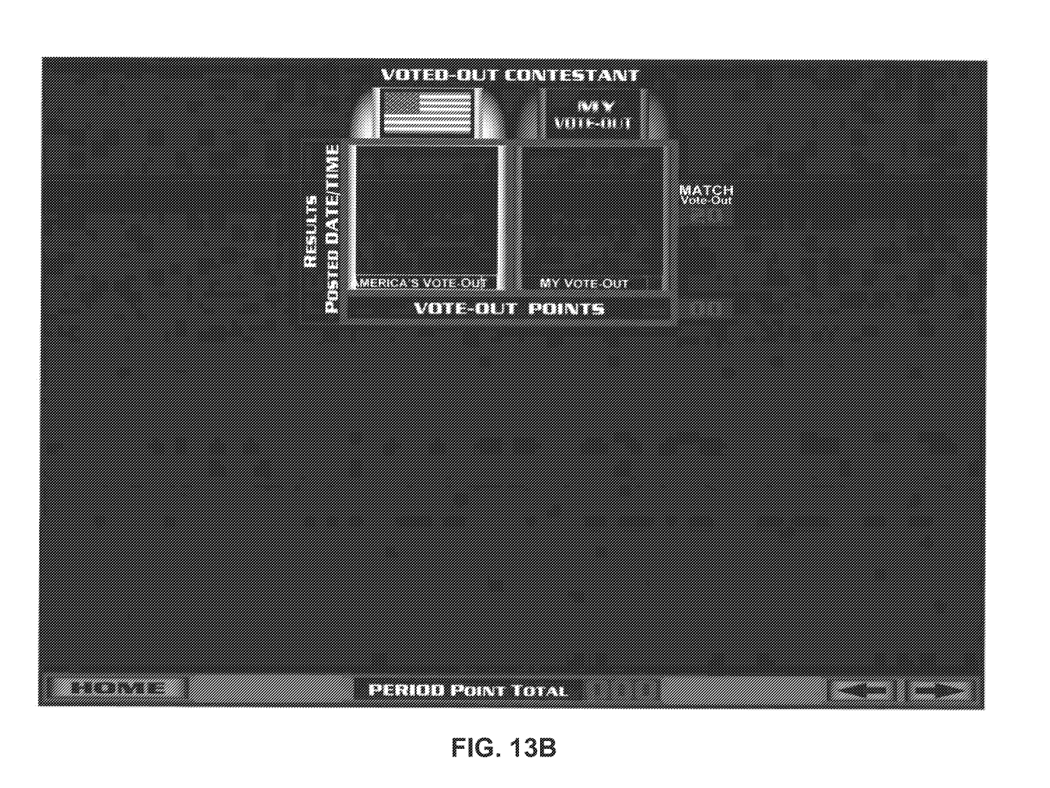

FIG. 13A shows a game embodiment element vote-out system. This system enables a participant to vote-out elements, such as reality TV contestants, after viewing or evaluating elements on one or more medias. After a participant provides a vote-out response to a least favorite or least qualified element and submits the response the element is transferred to a response point assignment and calculation system shown in FIG. 13B.

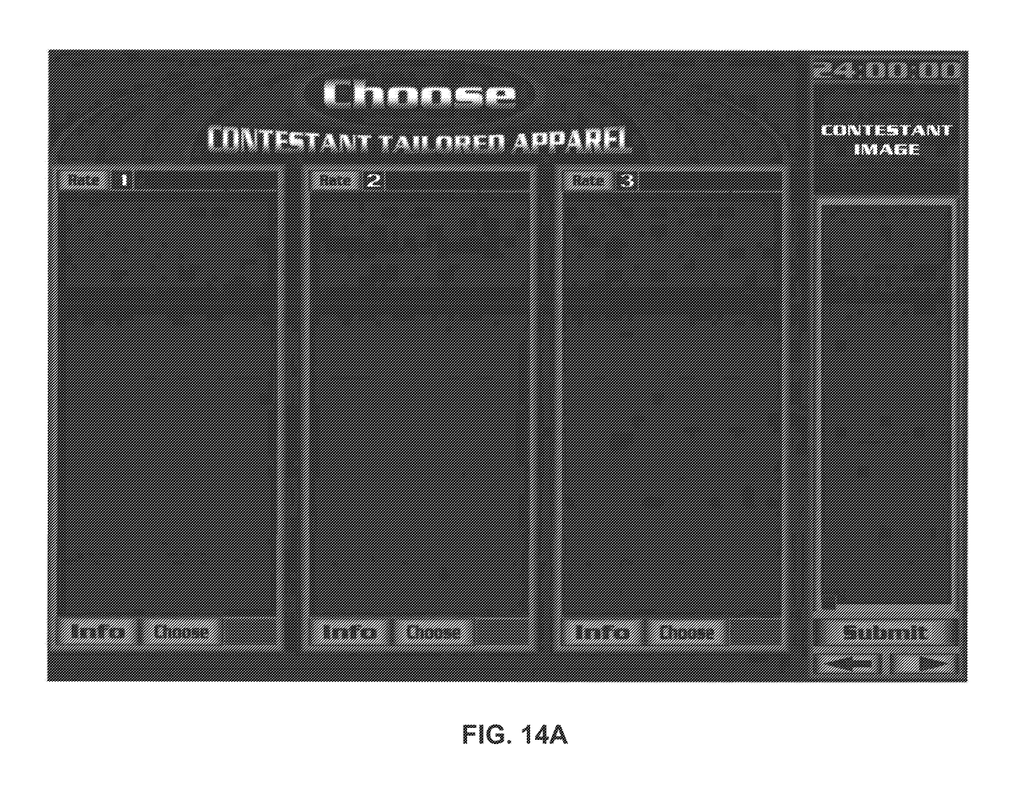

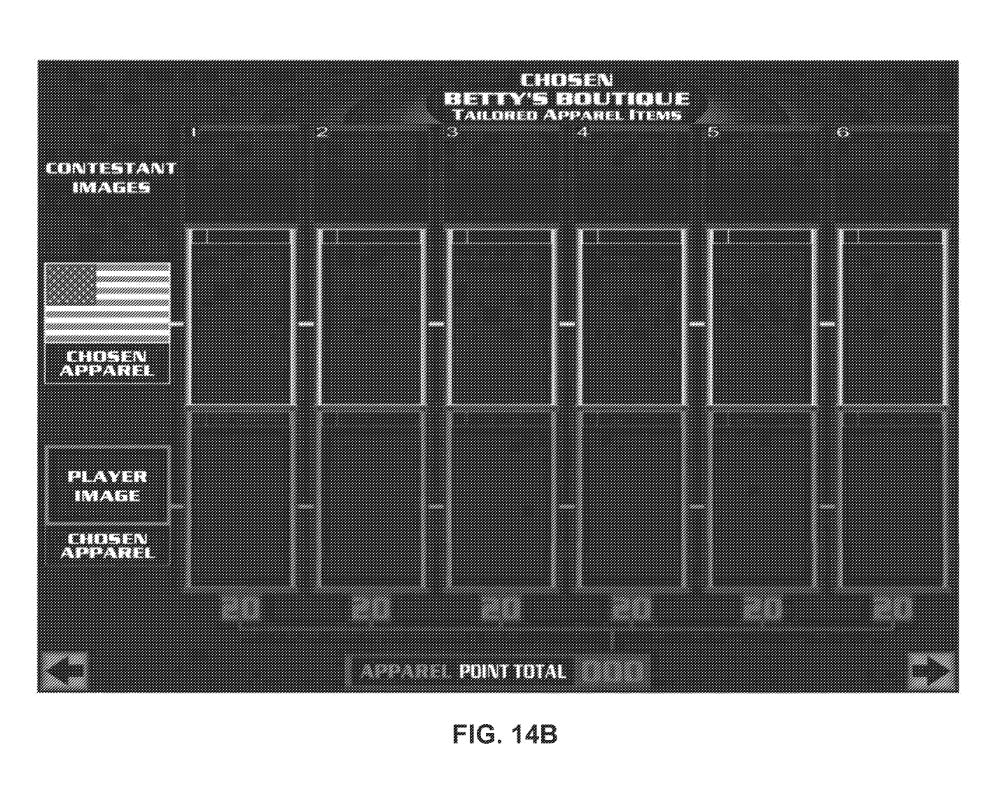

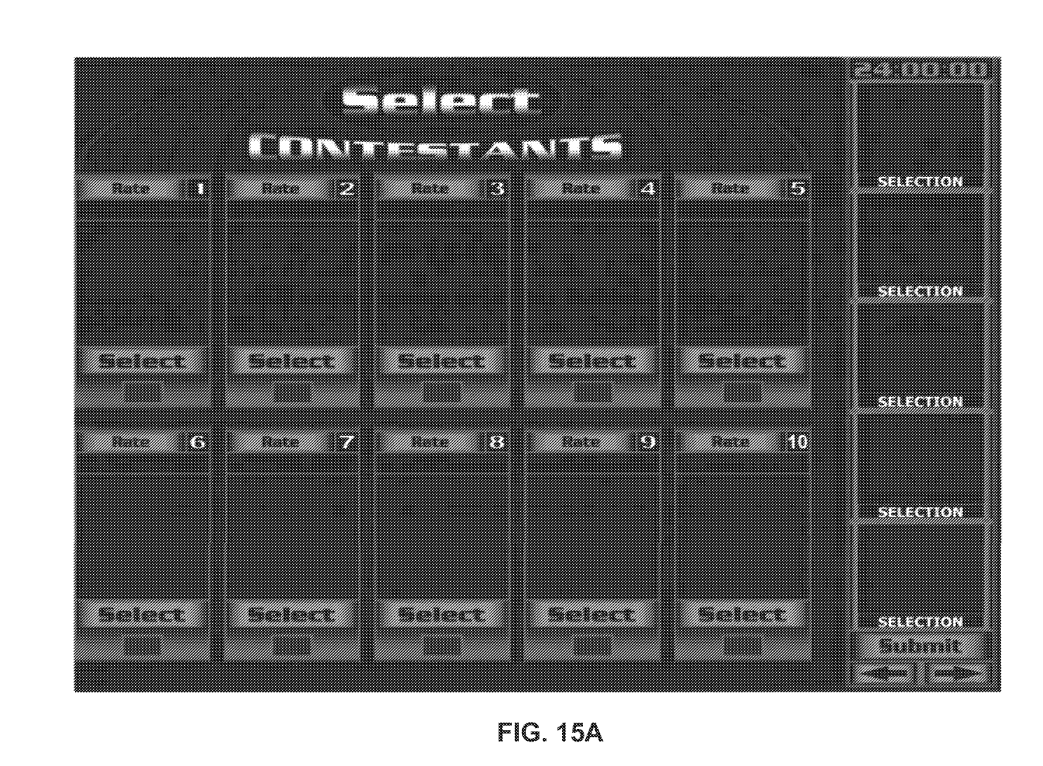

FIG. 14A shows a game embodiment element choose system. This choose system is designed to allow a pre-selected element or contestant to be posted in the upper right hand side of the system. This system may be utilized to enable participants to choose a tailored apparel set or item for a posted contestant to wear during a future event. This system may also be utilized to enable participants to determined activities, such as songs, for a contestant to perform during a future event. The element posted in the upper right and the elements made available to be selected are virtually unlimited as with all response systems.

FIG. 14B show a response point assignment and calculation system associated with the choose system. This system posts images of a plurality of pre-selected elements, such as contestants. The player's chosen elements are to be posted in red and elements receiving a response point controller's response are to be posted in gold.

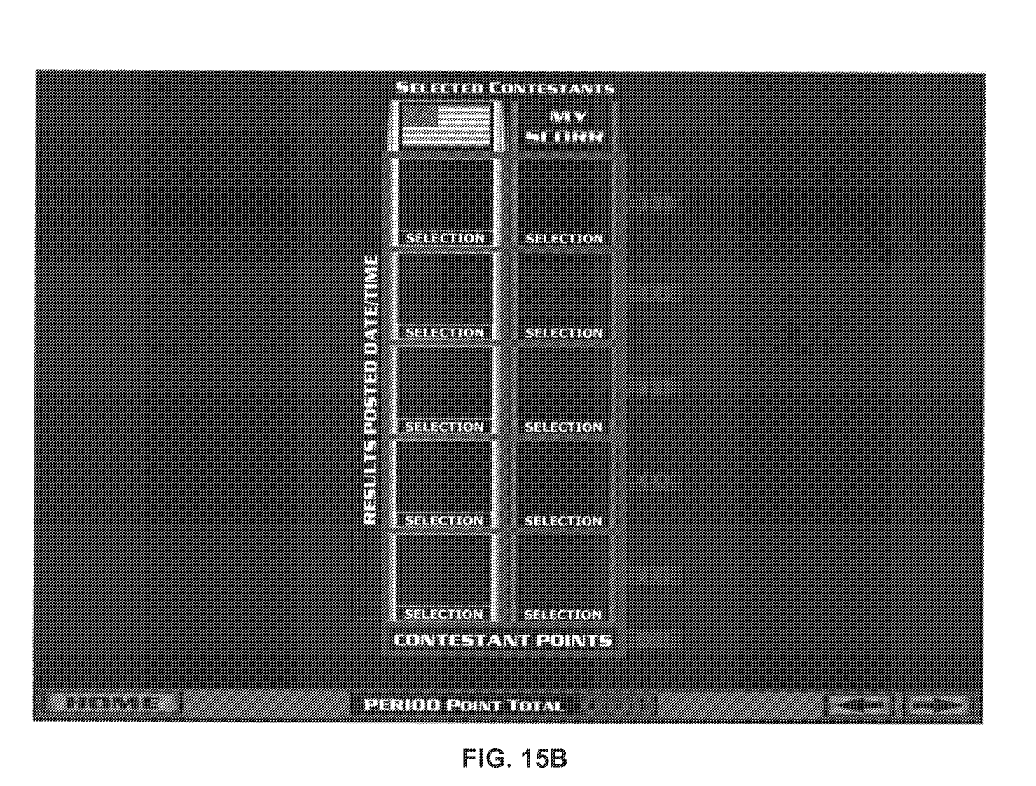

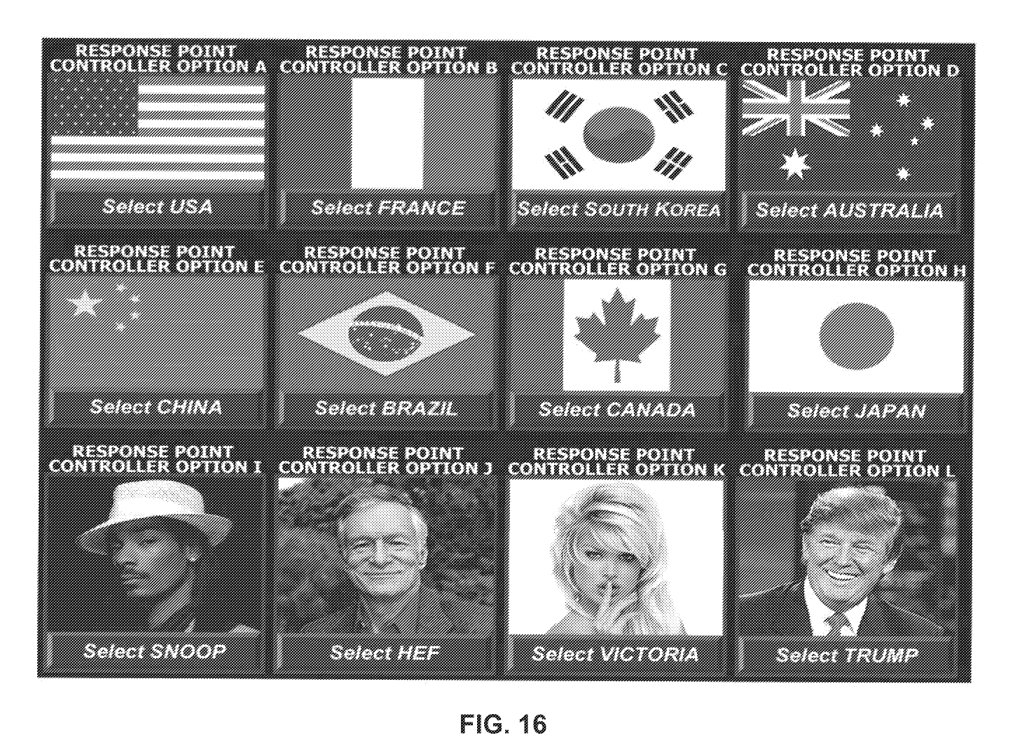

FIG. 15A shows a game embodiment element selection system. The selection system enables a participant to select a number of elements from a plurality of elements posted. This system may be utilized to enable participants to select contestants that qualify to compete during a future event. This system enables a participant to first rate or evaluate element options prior to making selections.

FIG. 15B show a response point assignment and calculation system associated with the game embodiment element selection system. This response point assignment and calculation system assigns a player a point value for selecting an element a response point controller selected. A player may receive a same point value for a first selection that matches a response point controllers last selection, the only prerequisite is to select a same element.

FIG. 16 shows a response point controller selection system. This system enables a player to select a response point controller of their choice. The selected response point controller's image, once selected, is posted over the gold frames within an associated response point assignment and calculation system.

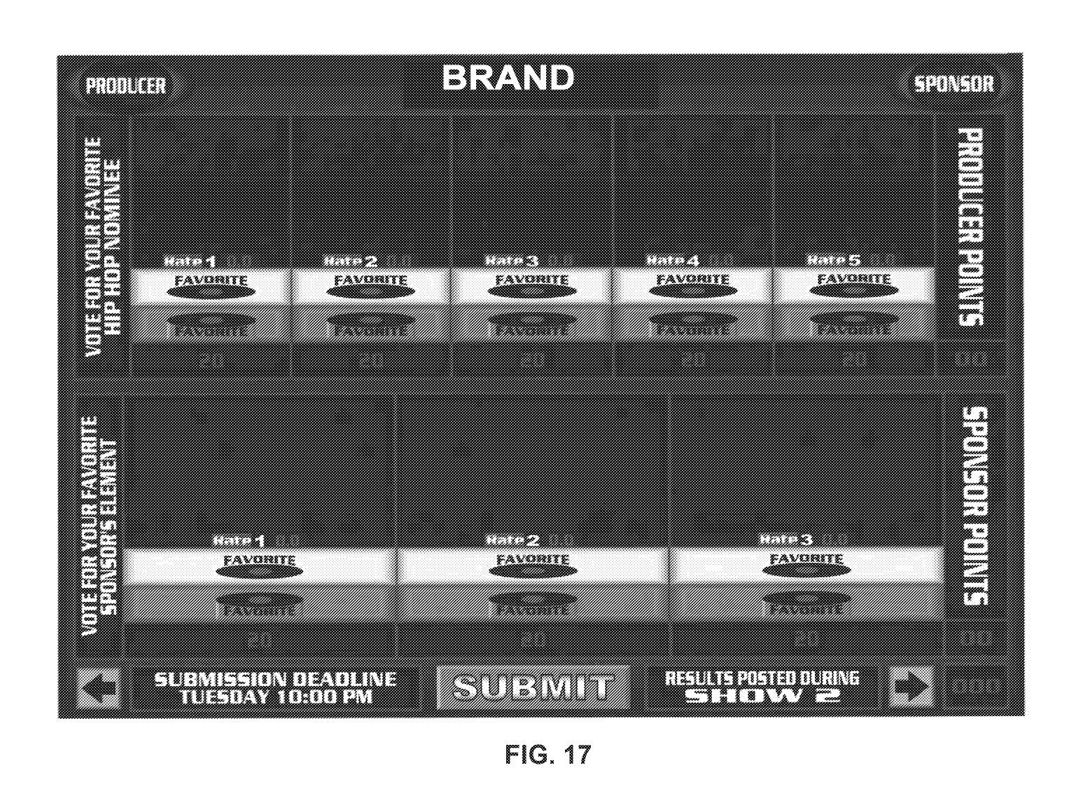

The following over and under response game embodiment systems shown in FIGS. 17, 18, and 19 are similar to the previous response game embodiment systems wherein player's responses are surrounded by red and the response point controller's responses are surrounded by gold. The over and under system may or may not employ an element evaluation/rating system. The basic difference between the over and under response game embodiment system and the previously shown systems is that the over and under system show the producer's response system and response point and calculation system posted over a sponsor's response system and response point assignment and calculation system.

The over and under system shown in FIG. 17 enables a player to vote for a favorite producer's game embodiment element and a favorite sponsor's game embodiment element. This system also utilizes a game embodiment element evaluation system enabling a player to first evaluate one or more elements prior to voting for a favorite element. The evaluation/rating system is integrated in various response game embodiment systems enabling a participant to study producer's and/or sponsor's game embodiment elements for a first time or re-evaluate game embodiment elements that the participant studies or evaluated previously on one or more medias such as Television, Internet, wireless device, CD, DVD, or any other type of available game embodiment element study or evaluation platform or media. The over and under system also requires a participant to submit a required number of response to a required number of elements prior to a response submission deadline. Sometime after a player submits responses, a response point controller's responses are posted. The response point controller's responses may be posted immediately aft a player clicks the submission button posted on the middle bottom of the system or at a later time or date.

At the same time or sometime after a response point controllers response are posted the system assigns a player a response point value based on providing a response that matches a response point controller's response.

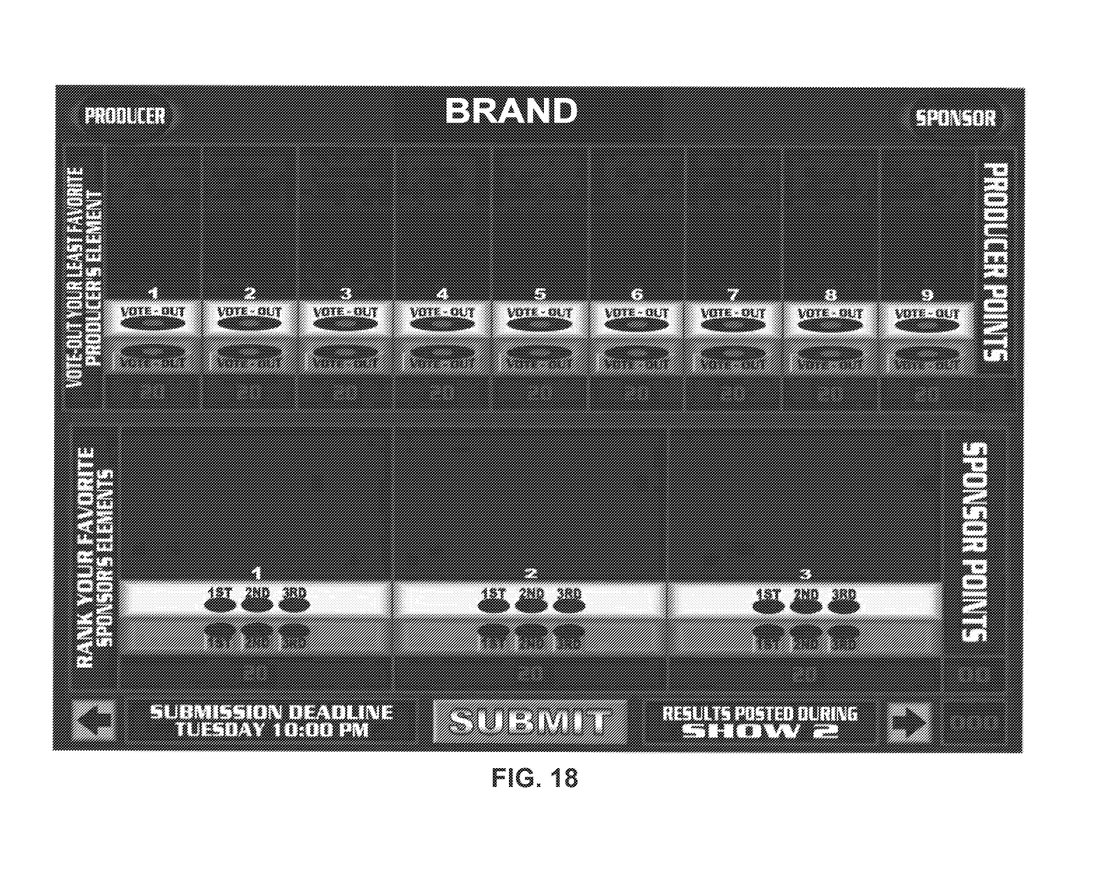

The over and under response game embodiment system shown in FIG. 18 combines a producer's game embodiment element vote-out and vote-out response point assignment and calculation system over a sponsor's game embodiment element ranking and ranking response point assignment and calculation system. This system adds a player's assigned vote-out response points and rankings response points to in order for the player to receive a combined vote-out and ranking response point total. The over and under systems show a players combined producer point assignment and sponsor point assignment in the lower right side of the system.

All response game embodiment systems may be replicated with printed material. And all printed response game embodiment systems may be replicated electronically. Printed response game embodiment systems may be inserted into publications, game kits, mailers, etc. The printed response game embodiment systems may also be sized to fit into product packing such as CD jewel cases, DVD cases, etc. Printed response game embodiment systems guide players through process of manually inputting responses to game embodiment elements, assigning response point for providing responses that are at least similar to a response point controller's responses, and calculate a point total.

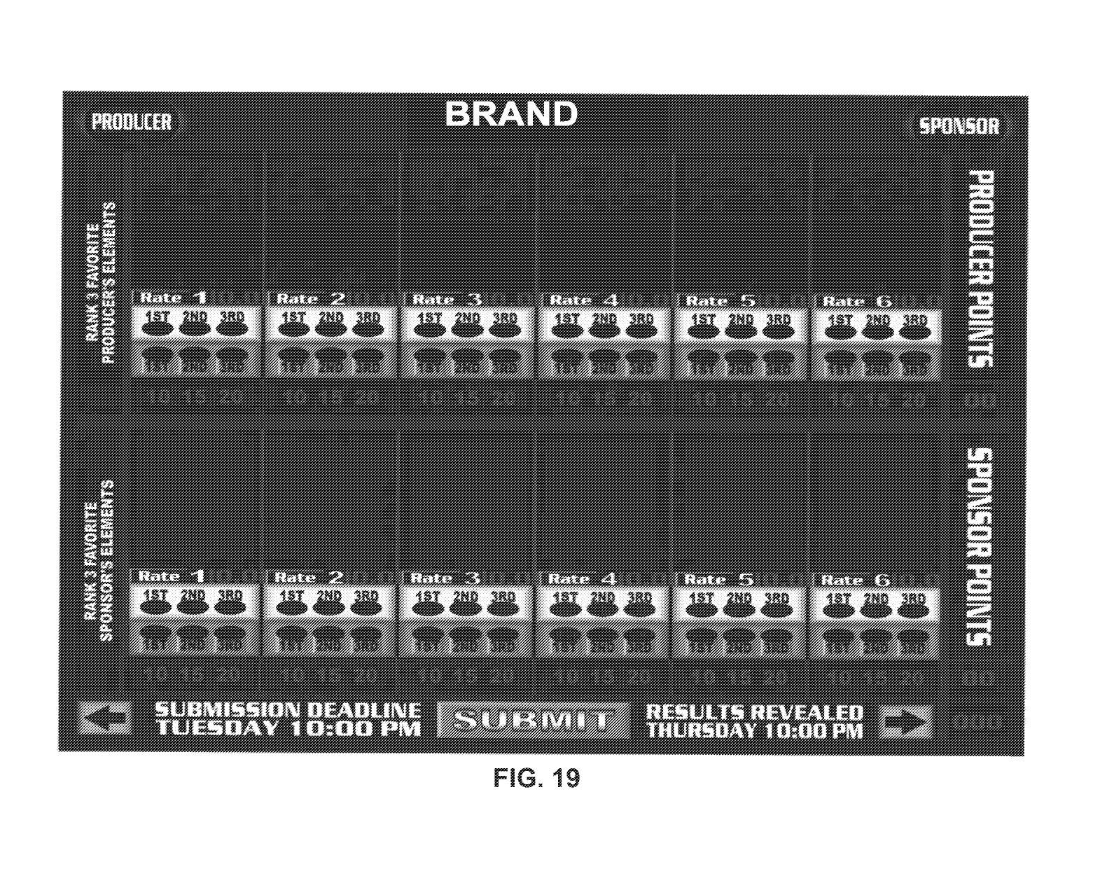

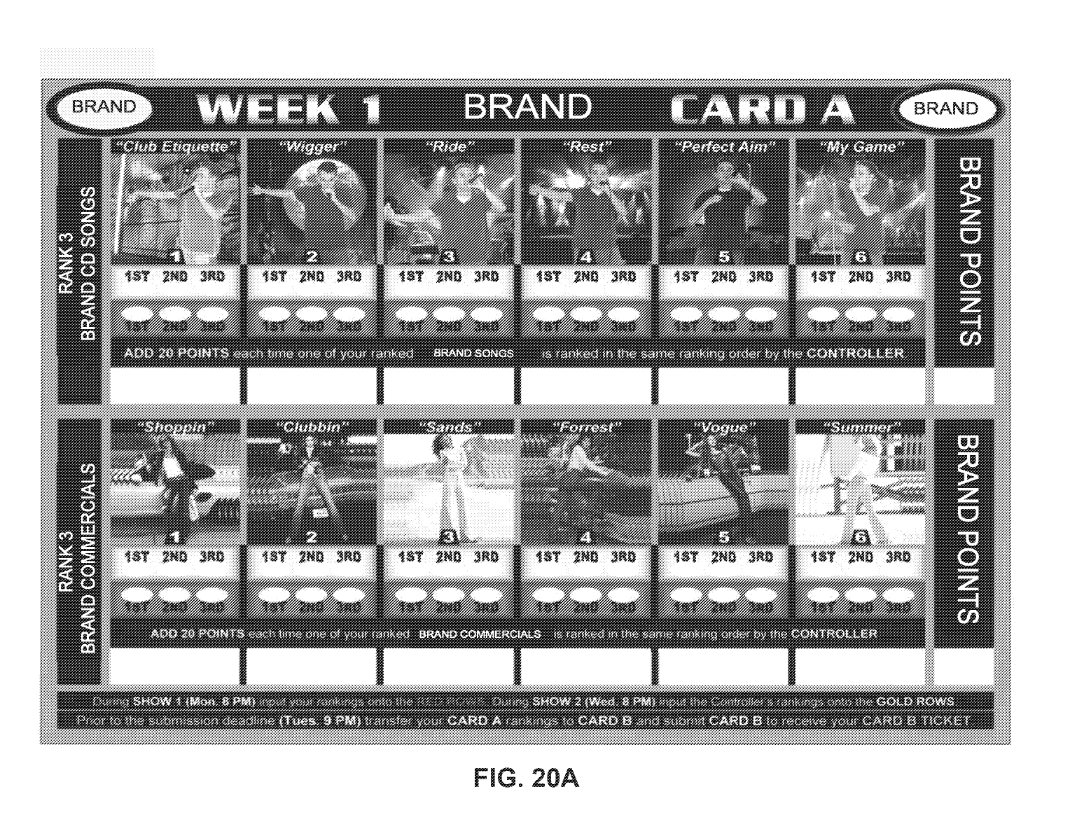

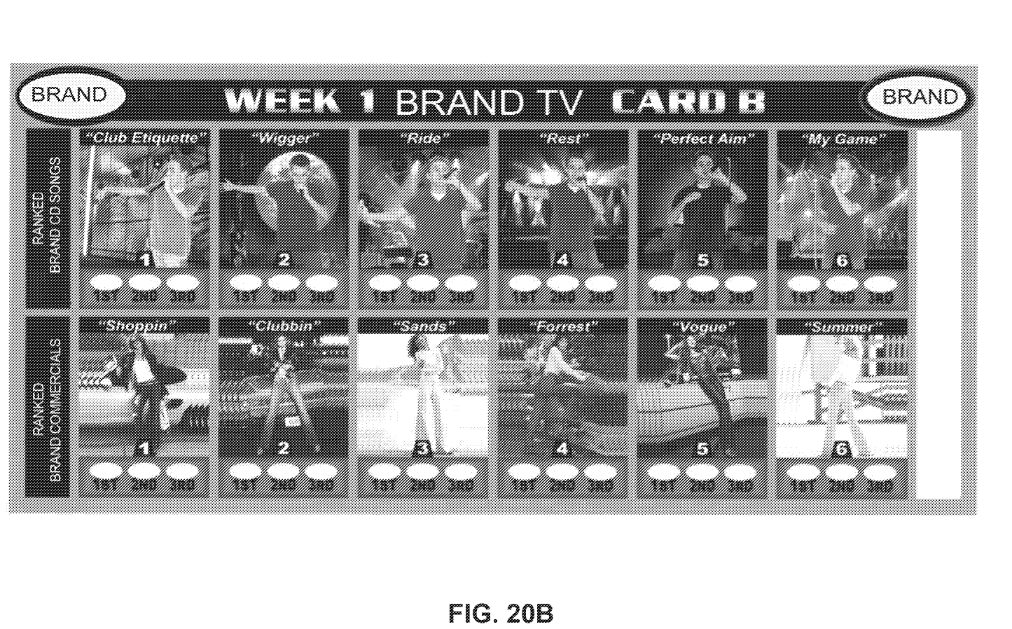

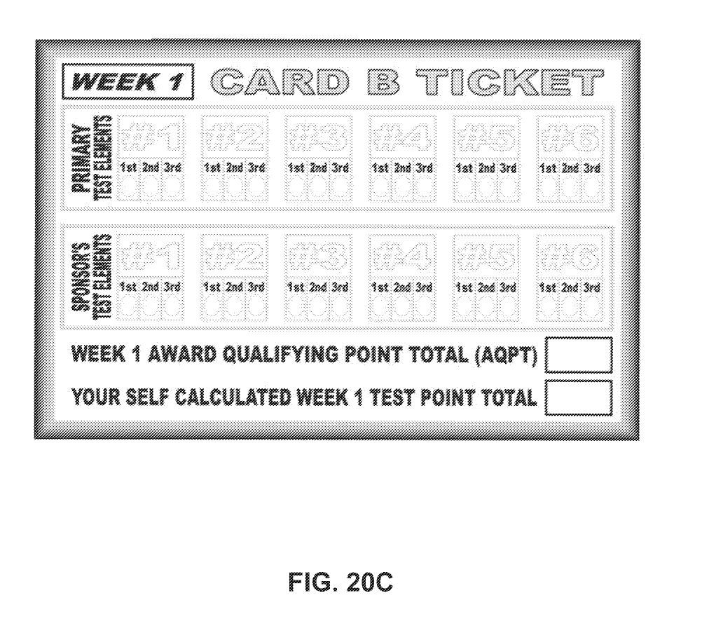

The following two (2) card one (1) ticket printed response game embodiment system shown in FIG. 20A is virtually identical to the electronic over and under response game embodiment system shown in FIG. 19.

The following text may be attached to a two (2) card one (1) ticket printed response game embodiment system.

### During Phase I

Response game embodiment producer's and sponsor's game elements are presented on one or more medias.

Player Instructions:

Step 1; on your card A (FIG. 20A) red rows rank your 3 favorite producer's and sponsor's game elements

Step 2; transfer your rankings to a retail card B (FIG. 20B)

Step 3; submit your card B prior to a submission deadline in order to receive your card B ticket (FIG. 20C)

### During Phase 2

The response point controller's ranked producer and sponsor game element are revealed. An award qualifying point total (AQPT) is revealed.

Player Instructions:

Step 1; on your card A gold rows input the response point controller's ranked game elements

Step 2; on your card B ticket in put the AQPT

Step 3. on your card A input 20 points in the white area below the your red rows each time one of your ranked elements is ranked by the response point controller and in the same ranking order.

Step 4; on your card A calculate your response point total

Step 5; when your point total meets or exceed the AQPT submit your card B ticket to qualify to win.

### Period & Series Awards

Up to 1,000 players receiving a period point total that meets or exceeds a period AQPT are awarded $1,000 and 10 players receiving a series point total that meets or exceeds a series AQPT become millionaires.

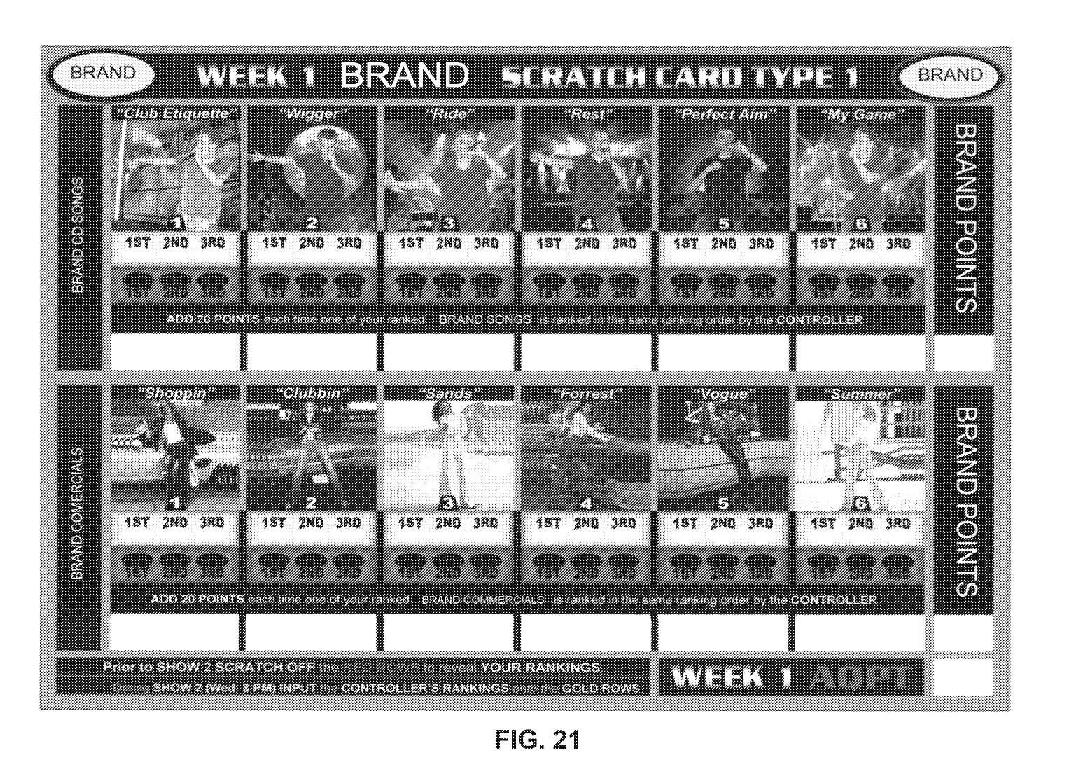

The printed player scratch response and response point controller input response card game system shown in FIG. 21 are similar to the previous two (2) card one (1) ticket system except that a player is required to scratch concealed predetermined player response located under the scratch off material on the red rows. The player is then required to input the response point controller's response onto the gold rows. In an embodiment, this system is designed as a game of chance whereas response game system that require a player to input responses to elements based on an evaluation process with or without the use of an evaluation system is designed to measure over time players innate ability to respond in-sync with a response point controller. The scratch and input game system, as well as all other previous system are event drivers whereas participants are driven to an event where a response point controller's response to elements are revealed.

The following text may be attached, in an embodiment, to a scratch and input response card game system.

### During Phase 1

Instructions:

Scratch of the red rows to reveal your ranked producer's and sponsor's game elements

### During Phase 2

The response point controller's ranked producer and sponsor game elements are revealed. An award qualifying point total (AQPT) is revealed.

Instructions:

Step 1; on the gold rows input the response point controller's rankings

Step 2; input the AQPT onto the bottom right side of your card

Step 3. input 20 points in the white area below your red rows each time one of your scratched ranked elements is ranked by the response point controller and in the same ranking order.

Step 4; calculate your point total

Step 5. when your point total meets or exceed the AQPT submit your scratch card to qualify to win.

Period & Series Awards

Up to 1,000 players receiving a period point total that meets or exceeds a period AQPT are awarded $1,000 and 10 players receiving a series point total that meets or exceeds a series AQPT become millionaires.

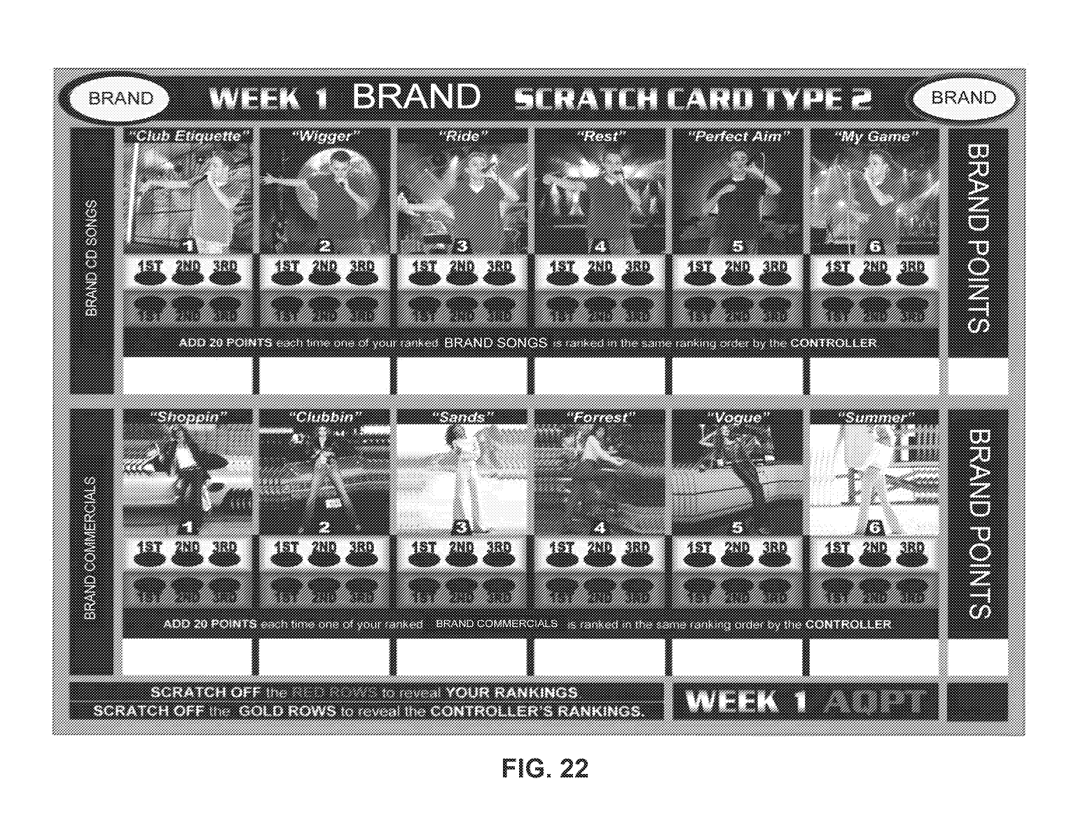

The over and under scratch card game system shown in FIG. 22 requires a player to scratch off material covering a player's predetermined responses within the red rows and scratch of material covering a response point controller's predetermined responses within the gold rows. In an embodiment, the player then is required to assign point values for responses that are at least similar and calculate a point total. The player then may be required to scratch off the material covering the scratch off box located at the lower right side of the system to reveal an award qualifying point total.

In an embodiment, the following text may be attached to a scratch card game system.

Scratch Card Game System Type 2 (Instant Winner)

Instructions:

Step 1; scratch of the red rows to reveal your rankings

Step 2; scratch of the gold rows to reveal the controller's rankings

Step 3; scratch of the bottom right box to reveal an AQPT

Step 4. input 20 points in the white area below the red rows each time one of your scratched rankings matches a scratch point controller's rankings.

Period & Series Awards

Up to 1,000 players receiving a period point total that meets or exceeds a period AQPT are awarded $1,000 and 10 players receiving a series point total that meets or exceeds a series AQPT become millionaires.

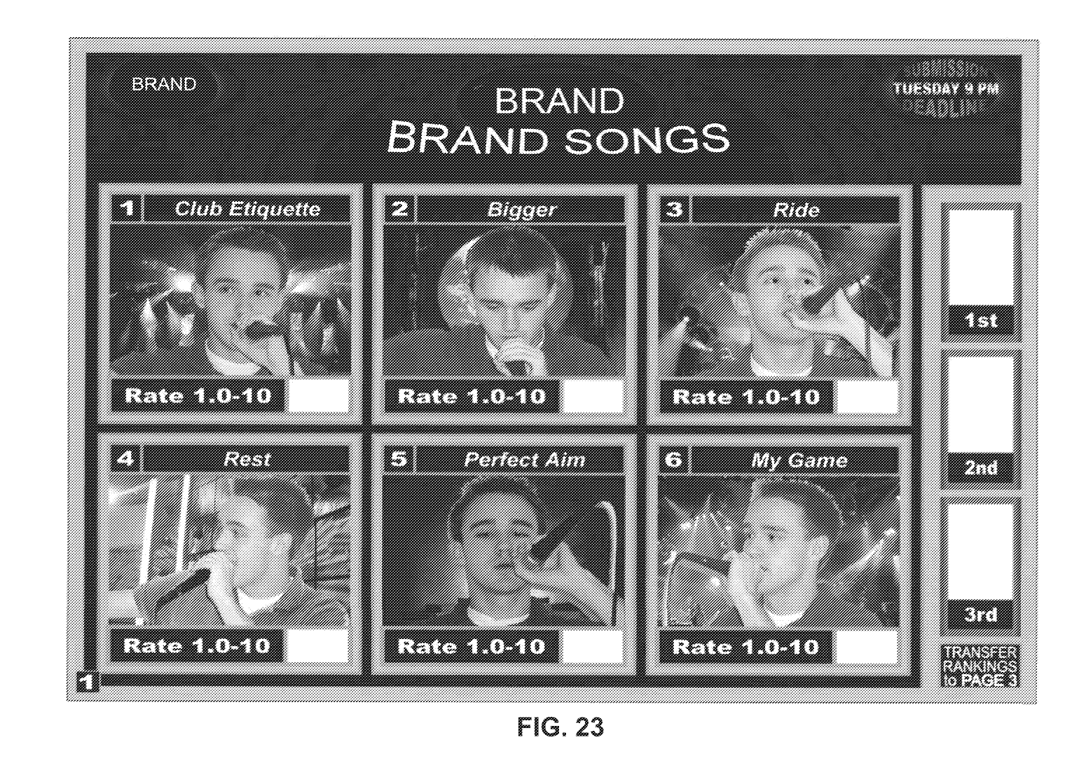

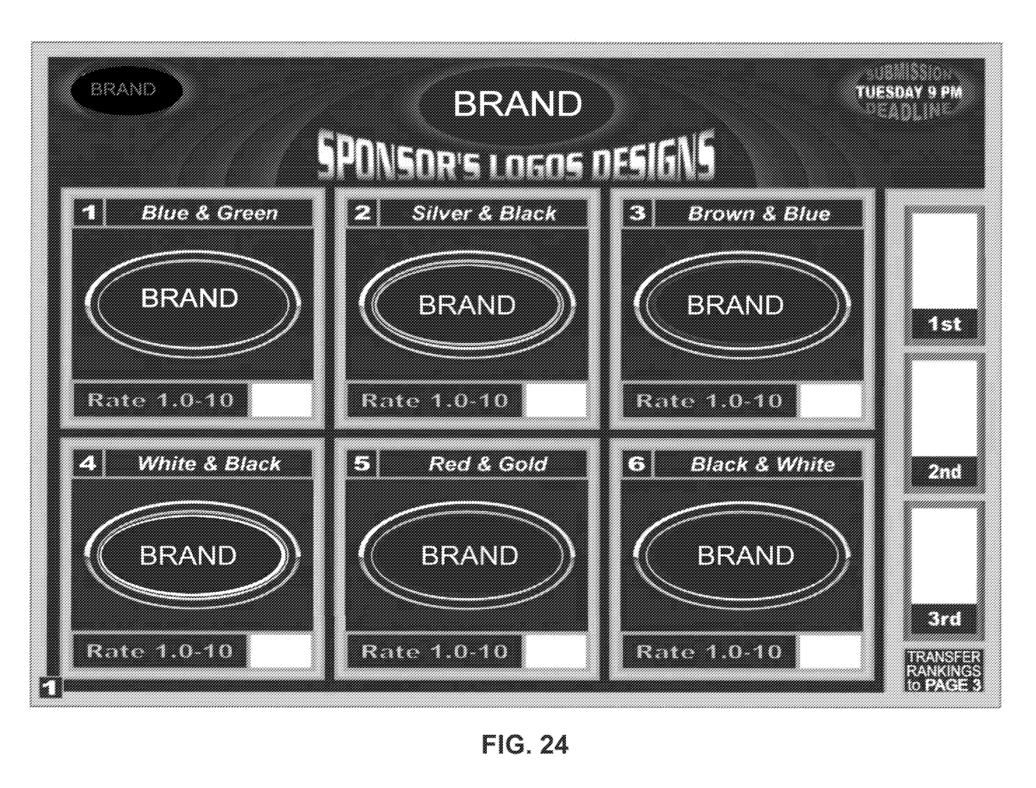

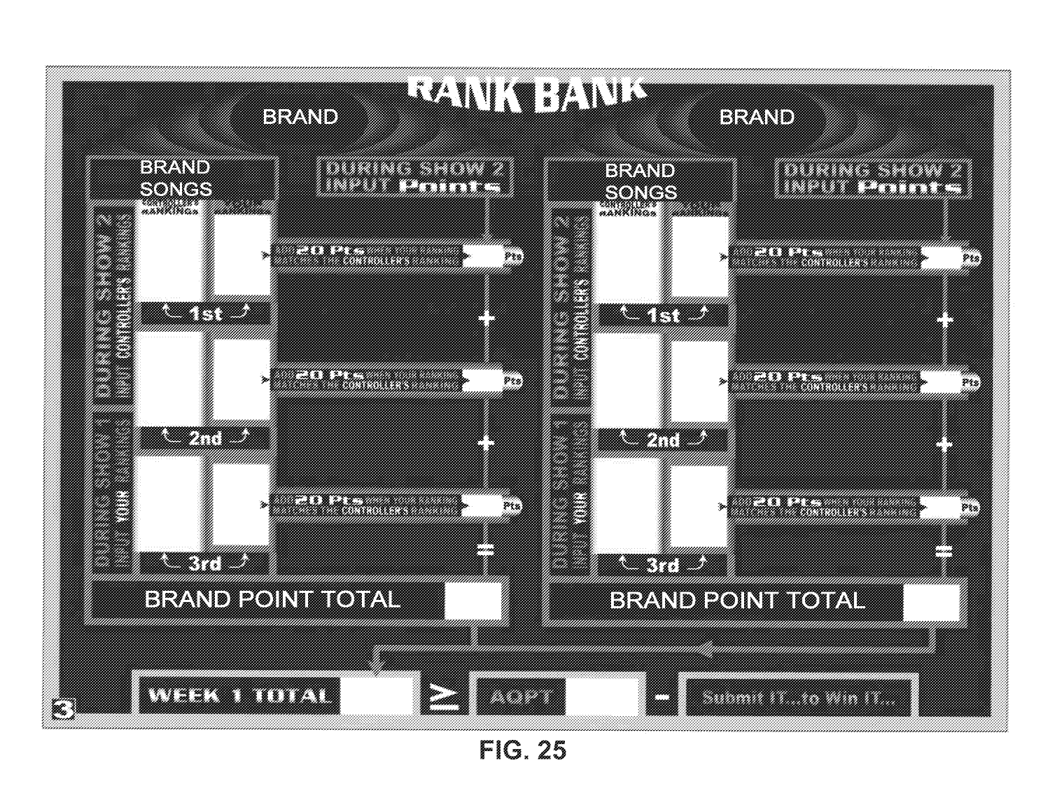

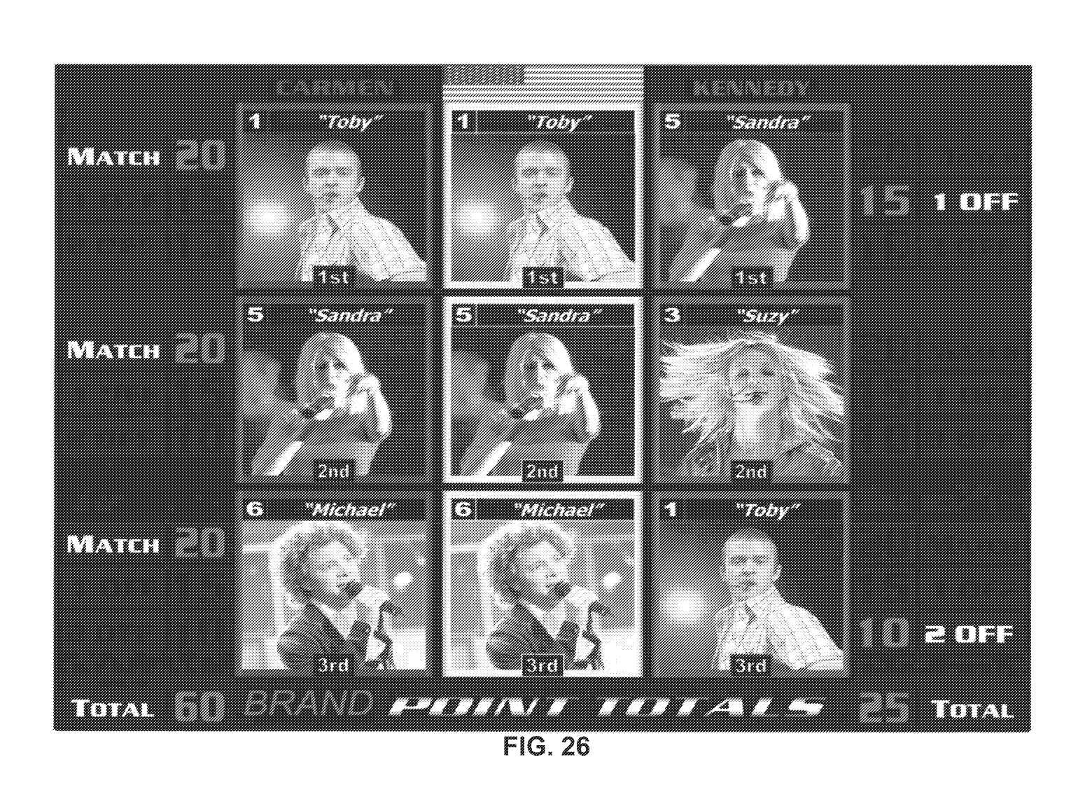

FIGS. 23, 24, and 25 show a printed response game system fold-out. In an embodiment, the printed fold-out is a printed replica of with respect to form and function as the electronic response game systems shown in FIGS. 1 thru 11, excluding the evaluation system. As stated, all response game systems may be offered as electronic or printed games. In an embodiment, the electronic games allow a participant to submit responses whereas the printed systems required a participant to access an available response submission platform. Each white area within the system in intended as a manual input area. To create a fold-out effect the bottom of FIG. 23 is attached to the top of FIG. 24 and the bottom of FIG. 24 is attached to the top of FIG. 25. In an embodiment, the printed fold-out response game system may be sized to as a publication or product insert.

Generally, a printed fold-out or over and under response game system may be combined with a game element presentation media, In an embodiment, the game element presentation media may be printed or digital. For example a printed system showing images representing audio game elements may be combined or come with a game element evaluation or presentation CD or DVD.

FIG. 23 is page 1 of the fold-out game system which is similar to the electronic system shown in FIG. 1. This printed response system allows the participants to manually perihrm the functions of the electronic response system. In an embodiment, the white area at the bottom right of each framed image representing a game element enables a participant to record game element evaluations, In an embodiment, the white area at the right side of the page enables a participant to record game element rankings. FIG. 24 is a sponsor's game element evaluation and response system. In an embodiment, the sponsor's system shown is identical to form and function as the producer's game element evaluation and response system shown in FIG. 23.

FIG. 25 is page 3 of the printed fold-out system. In an embodiment, the white areas frame in red are designed to enable a player to input page and page 2 game element ranking. In an embodiment, the white areas framed in gold are designed to enable a participant to input a response point controller's rankings during a subsequent presentation event or a show 2. In an embodiment, the white areas designated as point input areas are designed to enable a player to self assign point values, input calculated producer and sponsor point totals, and calculate a period point total.

In an embodiment, the following text may be attached to a fold-out response game system.

### During Phase 1

Response game producer's and sponsor's game elements are presented on one or more medias.

### Player Instructions:

Step 1. on PAGE 1 RANK your 3 FAVORITE PRODUCER'S TEST ELEMENTS

Step 2. on PAGE 2 RANK your 3 FAVORITE SPONSOR'S TEST ELEMENTS

Step 3. on PAGE 3 input the numbers of your RANKED TEST ELEMENTS into the RED FRAMES

Step 4. SUBMIT your RANKINGS prior to the SUBMISSION DEADLINE

### During Phase 2

In an embodiment, the response point controller's ranked producer and sponsor game element are revealed. An award qualifying point total (AQPT) is revealed.

Step 1. on PAGE 3 input the numbers of the CONTROLLER'S RANKED TEST ELEMENTS into the Gold Frames

Step 2. on PAGE 3 input the AQPT into the box located at the bottom middle of the page

Step 3. on PAGE 3 input 20 points each time one of your RANKINGS is RANKED in the same order by the CONTROLLER

Step 4. on PAGE 3 calculate your PERIOD 1 TOTAL

Step 5. when your PERIOD TOTAL meets or exceeds the PERIOD AQPT . . . Submit IT . . . to Win IT!

### Period & Series Awards

Up to 1,000 players receiving a period point total that meets or exceeds a period AQPT are awarded $1,000 and 10 players receiving a series point total that meets or exceeds a series AQPT become millionaires.

FIG. 26 Shows a response game and talent show studio presenting a full at TV screen image of an in-studio response point assignment and calculation system. In an embodiment, the in-studio system shows a response point controller's responses framed in gold located in the center of the system. In an embodiment, the colored frames to the left and right of the gold frames in-studio participants game element response areas.

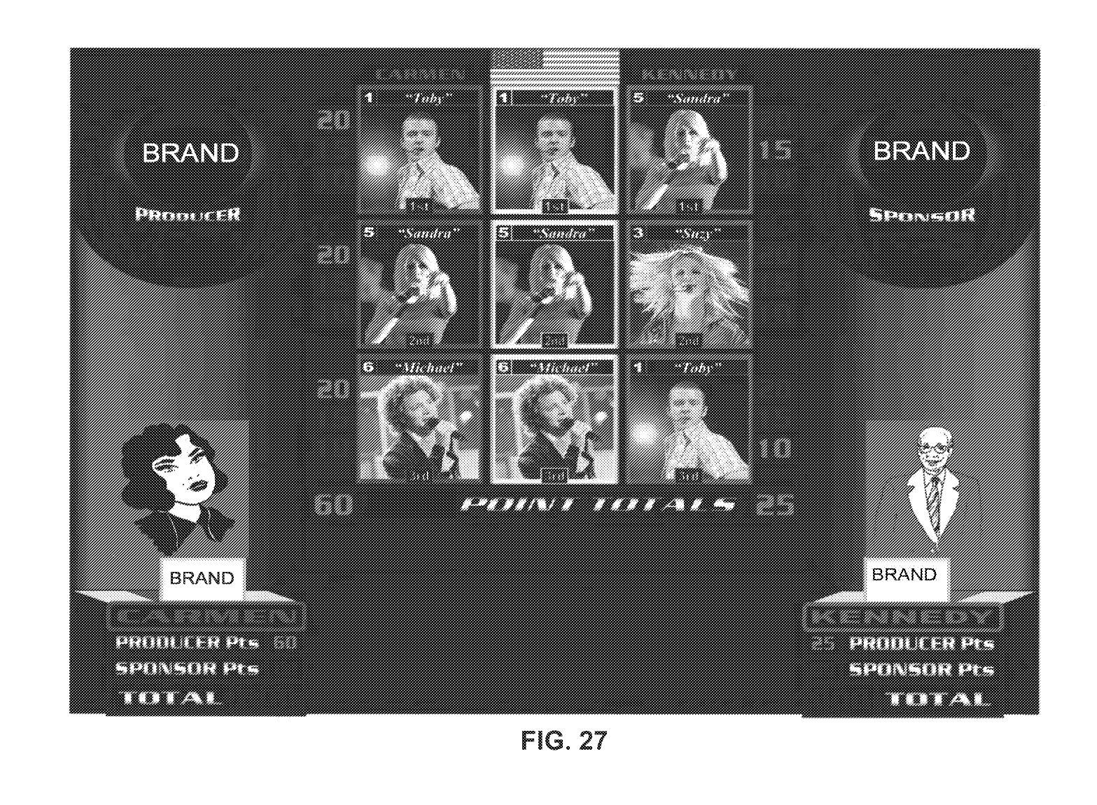

FIG. 27 shows the in-studio response point assignment and calculation system, in-studio participants and their response point totaling system located below each participant. In an embodiment, the in-studio participants may be referred to as in-studio judges. In an embodiment, the in-studio judges may have qualified to become in-studio judges by receiving a highest response point total from a current or previous response game. An in-studio participant receiving a lowest point total for one or more periods is dismissed or dissed by on their lack of ability to respond in-sync with a response point controller. This type of game and talent show may be referred to as “American Idol” meets “Family Feud” meets “Test the Nation.” The “American Idol” reference is due to the talent aspect of the show, the “Family Feud” reference is due to the in-studio participants or teams of participants, the “Test the Nation” reference is due to a nation of viewers utilizing an electronic or printed response game system associated with the game and talent show. In an embodiment, the game and talent show generally will present game and talent elements during a show 1. Subsequent to show 1 in-studio judges and at home players' or judges submit responses to a required number and type of responses to a required number of presented elements. At the beginning of a show 2, the in-studio judge's responses are presented. Prior to show 2 at home player may have been able to selected one of the in-studio judges as a response point controller for their game. Once the in-studio judges response are posted the response point controller's response are revealed as shown in FIG. 26. Each time a response point controller's response is revealed the in-studio judges are assigned a point value for providing a response to an element that is at least similar to the response, point controller's response to the same element. At the end of the show, the in-studio judge receiving the lowest point total is dissed or dismissed and the winner is revealed as a prize winner. In an embodiment, the winner's next opponent is presented and the show goes on during the same or a next period.

Response games may be utilized not only as the functionality to produce and protect game and talent show formats but may be utilized for all medias and format with an existing or future voting element.

The response point controller may be a nation of viewers or a segment of a nation of viewers. Therefore, a game element or contestant within the show may be voted-out by a nation but not by the tribal counsel. A player that is in-sync with the judge's vote may feel a sense of accomplishment and may even be able to participate in a response game where the judge's voting is performed in real time or able to been sealed or kept secret, but with a response point controller as a nation the players most in-sync with the nation and not the counsel qualify to become response game winners.

### Example Embodiments

### Novel Response Games and Tests

By utilizing element response periods, a multiplicity of element response games/tests may be incorporated into the periods to provide viewers and participants a significant, compelling and rewarding viewing and interactive experience.

An element response game/test may be considered a game or a test. In an embodiment, the combined terms eliminate the conjecture of frivolity the single term game may represent. By no means should an element response test be considered an arbitrary participation event due to the fact that societies and members within may forever be changed for the better.

An element response game/test utilizes the primary functional components of the periods. Generally, the primary functional components of an element response period are one or more element controllers and element response options or response elements.

During an element response game/test, the one or more element controllers determine the fate of the plurality of elements within the game/test while the element response game/test participants provide responses to elements to which the element controllers are also providing responses.

Upon completion of an element response session within an element response test participants are assigned or assign themselves point values for providing correct or nearly correct responses to elements presented during a presentation test phase prior to a response session phase.

A correct or nearly correct response to an element is determined by an element controller's response to the element.

During an element response game/test a participant may be assigned a match or point value each time the participant's response to an element is at least similar to an element controller's response to the same element.

An element response game/test may be comprised of a plurality of element response periods with a plurality of element response categories within each period.

One or more participants with a highest match or point total for the game/test or a highest match or point total with respect to one or more element categories within the game/test, when the one or more element categories are controlled by a different element controller, become the most qualified participants to represent or assist the element controller of the game or the element controller's of one or more categories within the test.

An element response test may include one or more primary tests, one or more secondary tests, or one or more primary and secondary tests. In an embodiment, the drawings show a primary and secondary test period.

An element response test allows a test provider and those directly or indirectly associated with the test provider to identify test participants with an ability to respond to test elements in a manner that is at least similar to one or more element controllers.

A primary element response test utilizes one or more primary element controllers to determine correct responses to elements or control the fate or future of elements within one or more test element categories or sub categories, whereas the fate or future of elements are controllable. Primary element controllers are designated based upon one or more primary test objectives with respect to responses to elements to be received by the primary controllers.

During a primary element response test one or more primary element controllers designated to directly or indirectly controller the fate or future of one or more elements or provide correct responses to one or more elements within the test are generally required to provide one or more predetermined types of responses to one or more of the one or more elements presented during the test prior to a primary element controllers element response submission deadline.

A test utilizing a plurality of element controllers may be considered a single controller test when participants area allowed to provide a response to match only one of the plurality of controllers. When participants are required to provide a response to match two or more of the plurality of element controllers the test may be considered a multi-controller test.

Element response periods, games, and tests generally designate one or more element categories for one or more revenue providers.

When a test provider, licensee, and or revenue provider is allowed to or required to designate one or more controllers for a plurality of element categories, participants in sync with each controller may qualify to be selected to participate in a future production as an assistant or representative to the controller to which they are in sync.

### Example

A test has four (4) element categories each controlled by a different element controller.

Category 1 element response options are music lyrics for a future music CD. In an embodiment, the lyrics are provided by a music performer. Category 1 element controller is the creator of the music lyrics

Category 2 element response options are a plurality of designs for the future music CD packaging. In an embodiment, the designs are provided by a music CD packaging artist. The category 2 element controller is the artist the music CD design artist.

Category 3 element response options are designs for a new type of footwear. In an embodiment, the footwear designs are provided by a shoe company which happens to be a revenue provider. In an embodiment, the category 3 element controller is a mystery controller to be revealed sometime after a response submission deadline.

Category 4 element response options are designs for a new type of automobile. In an embodiment, the automobile designs are provide by GM, another revenue provider. In an embodiment, the category 4 element controller is also a mystery controller to be revealed sometime after the response submission deadline.

Participants found to be in sync with the category 1 controller, the music performer, qualify to be selected to assist the music performer in a reality Television production showcasing one or more selected participants assisting the performer in determining which music lyrics from a plurality of music lyrics provided by the performer are most suitable to become element response options in a future test.

Participants found to be in sync with the category 2 controller, the artist, qualify to be selected to assist the artist in a reality Television production showcasing one or more selected participants assisting the artist in determining which music CD designs from a plurality of music CD designs provided by the artist are most suitable to become element response options in a future test.

Participants found to be in sync with the category 3 controller, the mystery controller, which was revealed to be a majority of participants from demographic C, qualify to be selected to represent participants from demographic C in a reality Television production showcasing one or more selected participants representing demographic C in determining which elements from a plurality of elements provided by a shoe company are most suitable to become element response options in a future test.

Participants found to be in sync with the category 4 controller, the mystery controller, which was revealed to be a majority of all participants, qualify to be selected to represent all participants in a reality Television production showcasing one or more selected participants found to be in sync with a majority of participants representing all participants in deciding which elements from a plurality of elements provided by GM are most suitable to become element response options in a future test and a future GM commercial.

A test may result in one or more productions subsequent to the test showcasing participants in sync with various elements controllers assisting or representing the element controllers. One or more participants in sync with two or more controllers may be selected to assist or represent the two or more controllers.

A plurality of element controllers may be designated to control elements within the same element category. Participants may be allowed to provide a response to match each of the plurality of controllers. Participants in sync with more than one controller may be selected to assist or represent more than one controller.

A test element controller may be a majority of all participants or viewers from one or more societies, territories, or nations, or a segment of participants or viewers from one or more societies, territories, or nations. Participants comprising the controller may be seen by participants not comprising the controller to have a response advantage. A test provider may not be affected by those not comprising the controller due to the fact that a controller is generally designated according to a test objective or goal. In this instance, the test objective or goal would be to capture data or responses from the designated element controller. In an embodiment, the designated element controller may be referred to as a target segment of in terms utilized in marketing a target demographic.

A provider may designate a plurality of element controller for an element response test in order to require entities comprising one or more target demographics to provide subjective responses to element they controller in order to participate in a test whereas said test element are controlled by another element controller or demographic.

A provider may require participants comprising a controller to provide subjective responses to elements they control without consideration, except for a feeling of control, in order to become participants in other tests or element categories controlled by other controllers.

### Single Event Test

An element response test may begin and end during a single event or program. A test provider may randomly designate an element controller by methods such as a random selection apparatus or methods similar to balls emitted from of an apparatus. In an embodiment, the random selection apparatus may be referred to as an element controller identifier. In an embodiment, the apparatus or balls may have indicia representing an element controller.

### Example

### Prior to an Event

Remote participants are afforded access to at least one type of response evaluation, recording, and point calculation system prior to an instant element response game.

A plurality of possible game element controllers and element response game participants are presented with a plurality of game elements. In an embodiment, the plurality of element controllers and participants submit a required number of one or more types of responses to a required number of elements prior to an element response submission deadline.

During the Event

A randomly selected or provider designated element controller is revealed. In an embodiment, the element controller's responses to elements and a qualifying point total or point range is revealed. Participants with a qualifying point total or range are instructed to re submit their initial responses prior to a response submission deadline. Participants calculate response points and identify themselves as either qualified or unqualified. Self determined qualified participants re submitted initial qualifying responses are received. Self determined qualified participants are revealed. Consideration is provided to self determined qualified participants once qualified resubmitted responses match initially submitted responses.

### Example 2

### Pre Test Event

A test provider registers (fee or free?) a plurality of possible element controller's and a plurality of test participants whereas the test participants may comprise one or more of the plurality of element controllers. In an embodiment, the possible element controller's and test participants are afforded access (fee or free?) to at least one type of element evaluation, response, and response point calculation system. In an embodiment, the possible element controller's and test participants are presented with a plurality of test elements. In an embodiment, the possible element controllers and test participants are instructed to submit a required number of one or more types of responses to a required number of elements prior to an initial response submission deadline whereas the deadline is prior to the test event. Test participants are instructed to calculate response points during the event each time a selected element controller's response to an element is at least similar to the participant's response to the same element. In an embodiment, the test provider receives responses from the possible element controllers and test participants. In an embodiment, the test provider stores test participants initial responses to be compared to qualified test participants initial response resubmission.

During Test Event

In an embodiment, the test provider presents the plurality of test elements, at least one selected element controller, the at least one selected element controller's responses to elements, and a qualifying response point total or point range. Participants are instructed to calculate response points in order to identify themselves as either qualify or not qualified to receive consideration based on a self assigned point total with respect to their initially submitted responses compared to the selected element controller's responses. Test participants with a qualifying point total are instructed to resubmit (free or fee?) initial responses prior to an initial response resubmission deadline. In an embodiment, the provider identifies resubmitted responses as qualified or not qualified. In an embodiment, the provider posts or announces one or more self identified qualified participants.

Post Test Event

In an embodiment, the provider compares each self determined qualified test participant's resubmitted responses with initially submitted responses. When a participant's resubmitted qualified responses match initially submitted responses the participants is selected or qualifies to be selected to receive consideration based on initially providing responses to elements that match or are at least similar to the selected element controller's responses to the same elements.

“Viewer/Consumer Controlled” Element Response Period, Game, and Test Concept

### Viewer/Consumer Auditioned and Cast Host

Generally, an element response test requires a producer or provider of the test to hire a host to communicate to test element controllers and test participant's information and instructions with respect to the test. In order to further enhance a “Viewer/Consumer Controlled” event or event series the test producer or test provider may utilize the invention to afford viewers an opportunity to receive consideration for auditioning and casting the host of their choice for an upcoming test or test series.

### “Viewer/Consumer Controlled” Tests

Viewers/consumers may apply to control various aspects of a test. Viewers chosen as a result of the application or selection process may be allowed to cast element response options for a future element response test.

When a majority of test participants/consumers or a majority of a segment of test participants/consumers is designated as an element controller of elements within the future test or one or more element categories within the future test the fate or future of elements within the test or within the one or more categories become participant/consumer controlled. When the majority of participants/consumers determine a correct response to one or more elements cast by selected viewers the element receiving the response is totally participant/consumer controlled.

### Example

Selected viewers cast competition elements for a future test. In an embodiment, the competition elements are contestant hopefuls and competition activity options. Selected viewers choose products or services or aspects of products or services for commercials during the competition or placement in the competition production. Home viewers choose most qualified contestant hopefuls to compete and most suitable competition activities. Home viewers may then determine one or more finalists through an evaluation process. In an embodiment, the competition may now be referred to as viewer controlled. Although no test points were offered and viewers received no consideration for their efforts, viewers would have a more intimate level of knowledge of contestants and products versus current methods of viewer interactive competitions. Therefore, a viewer controlled competition allows viewers to control the basic elements and actions associated with a competition which are selecting contestant hopefuls, contestants, competition activities, products for commercials and placement, judging contestants performances, voting for one or more most qualified contestants to become or qualify to become a finalist or winner.

By allowing selected viewers to determine which contestant hopeful options qualify to become contestant hopefuls and which activities options will be available for home viewers to choose from the pre competition production process may be referred to as viewer controlled.

In an embodiment, the elements of the competition production such as contestant hopefuls, activity options, a sponsor's or advertiser's products or service options for commercials or placements may be utilized as element response options in a test with selected viewers as competition production element controllers. In an embodiment, the competition element options such as contestant hopefuls, activity options, products or services may be utilized in the same or another element response game or test with home viewers as competition element controllers.

Home viewer selected contestants may be utilized in the same or another test with the home viewers as element controllers.

In an embodiment, the above method of viewer controlled competitions may also be utilized for a viewer controlled audition wherein the home viewer determined finalists proceed to a next level of the same competition or audition or is cast to appear in a product such as Television, film, video, or publication.

### “Viewer/Consumer Controlled” Element Response Tests

Test elements within one or more element categories made available to receive responses may be directly related to identifying and choosing participants to control the selection process of the same or similar types of elements for an ongoing series of “Viewer Controlled” element response tests.

One or more participants in sync with an element controller with respect to each element category may be chosen to star in a reality series or documentary showcasing the one or more participants controlling the selection process of the same or similar types of elements for a future element response test of the same or similar theme.

When the future test provider designates a majority of participants to controller elements within each category of the future test, the future test becomes the worlds first “Viewer Controlled” element response test.

Element response test participants may be selected to controller various other aspects of preparing a future element response test. For example, participants may be selected to become element response test production executives. In an embodiment, the new type of response test executive may control processes prior to and during the future test.

Response test executives may select:

Response Test Elements

Element Controllers

Response Types

Number of Responses

Time of Response Test Broadcast

Revenue Providers

Types of Consideration Offered Participants

Consume Controlled Production and Events

Currently production and event elements are selected by conventional means and methods according to assumed suitability or appeal to a target consumer demographic.

Element response tests provide new and most effective methods and systems for production element selection.

A test provider is enabled to provide consumers with an opportunity to receive consideration for determining which elements within a test will be incorporated into a future production or event. In an embodiment, the production or event may be related to entertainment, politics, business, economics, or manufacturing, to name a few.

In an embodiment, the test would generally designate a majority of consumers or a majority of consumers from one or more demographics as a production or event element controller. One or more test participants/consumers in sync with the element controller are selected to receive consideration.

Therefore, the production or event results in consumers providing themselves with their favorite production or event elements and at the same time are provided with an opportunity to receive consideration.

A limitation exists with current means and methods of presenting element to which consumers are able to choose.

Current methods of selecting elements for consumers to choose from would be for one or more individuals, groups, or businesses directly or indirectly associated with the provider, or the provider to select elements. These methods are inefficient when compared to allowing qualified consumer representatives to select elements for other consumers to choose from. Through element response testing resulting consumer representatives may be proven to have an innate ability to identify elements a majority of consumers find most appealing or suitable.

Consumer representatives are identified as a result of an element response test that allows a majority of consumers to control elements within the test.

Consumer representative are identified when a majority of consumers is designated as a controller of elements presented during an element response test. Test participants (individual consumers) receive a point value each time a response to a test element matches or is at least similar to an element controllers (a majority of consumers) response to the same element. Test participants with a highest point total for a period or series of periods are identified as consumers that are in sync with or have the pulse of the majority of consumers.

One or more consumers in sync with a majority of consumers or a majority of a segment of consumers (i.e., a designated element controller) may by selected to represent the element controller as element casting directors for a subsequent element response test. This way the elements incorporated into the subsequent test for consumers to choose from are selected by consumers representing consumers.

Therefore, when the subsequent test provider allows a majority of test participants/consumers to determine which elements are most appealing or suitable for a future production or event the future production or event elements are totally consumer controlled.

In reference to the above example a majority of test participants/consumers from one or more target demographics may be substituted or incorporated resulting in elements selected for the test and future production or event controlled by consumers form the one or more demographics.

### Viewer/Consumer Controlled Event

Conventional and herein novel viewer interactive event/series allows viewers/participants to interact with one or more interactive elements of an event. A “Viewer Controlled” event allows viewers/participants to control one or more interactive elements of an event. An event theme is based upon the type of elements, interactive or not, that are incorporated into the event. Generally an event theme is chosen based upon an event objective or goal. For example, a Television network is in need of a host for a new Television program. In an embodiment, the network may license embodiments and a related host search Television program format to offer viewers an opportunity to receive consideration for correctly responding to the interactive elements of the host search. In an embodiment, the interactive elements for a host search would normally be determined by producers of the search or a producer's one or more associates. Therefore, the theme is a viewer interactive host search. When element response test methods are incorporated into the search viewers may become host search element response test participants. In an embodiment, the test provider or host search producer may designate a controller of host search elements placed into the test by the producers to be a majority of test participants.

One or more participants identified as a result of the test as in sync with the controller may be selected to participate in the pre production a future host search element response test as representative to the controller. In an embodiment, the element controller representatives are representing the majority of element response test participants. In an embodiment, the selected participants may control aspects of the future host search element response test. In an embodiment, the selected participants may determine which future host search elements from a plurality of elements are most suitable to be incorporated into the future test for future test participants to respond to.

When the future test provider designates an element controller of the future host search test elements to be a majority of participants, the elements cast by the representatives of the majority of participants during the pre production of the test become “Viewer Controlled.” Therefore, the conventional phrase viewer interactive event may now be replaced by the phrase viewer controlled event.

### “Viewer Controlled Event”

In an embodiment, the compelling element response game/test format for providers, sponsors, and participants is to provide an ongoing series of games/tests with element response options of a theme or genre that are most enticing for each major demographic of a nation, a continent, or the world.

For example, the major demographics may be children (combined with adult supervision), teens, young adults, and adults.

Announce to each demographic that the initial game/test is “viewer interactive” and all subsequent games/tests are viewer controlled”

In an embodiment, the elements for all initial games/tests are generally cast by casting directors hired by the game/test provider or are cast by the provider themselves.

In one embodiment, the element controller of each game/test is a majority of the game/test participants. A group of participants who achieve a highest game/test point total qualify to represent the majority of participants (i.e., the element controller) in a subsequent game/test as element casting directors. Therefore, all subsequent games/tests become “Viewer Controlled.”

When the element response options of an element response game/test are audition or competition elements, each viewer interactive audition or competition results in an ongoing series of viewer controlled auditions and competition. By allowing each demographic (children with parent or adult supervision, teens, young adults, and adults) to control auditions for Television and film, the resulting Television and film products will become widely recognizable, according to an embodiment. By allowing each demographic to control competitions for a nation's or the world's favorite elements, the resulting elements will become widely recognizable, according to an embodiment. In an embodiment, the element controller representatives from each demographic will become widely recognizable as well, according to an embodiment.

### Political Element Response Test

Political element response test participants with a highest point total with respect to a majority of members of one or more societies or a majority of members of one or more segments of one or more societies may be selected or qualify to be selected to star in a future political type of production as representative to the one or more societies or one or more segments of one or more societies.

### Political Test

To show a range of an ERG/T one or more element categories may incorporate a future political candidate presenting well thought out political strategies or stands according to beliefs consistent with past actions. In an embodiment, the candidate or candidate hopeful may present a same or similar stance which may show the candidates vision or ability to envision a best strategy which the candidate will not change to appease a new or different polling result.

### Free, Free, or Bid Participation

Element response tests may be free, fee, or bid based. Generally, an element response test requires no fee, although a fee or bid may be required as a test parameter or qualifier.

A fee may be required to identify a participation level. Various participation levels may provide a range of award opportunities. Fees may be based on various test levels. A participant's fee based test selection may be determined by how accessible or assumed ability to be in sync with an element controller.

### Element Response Test Utility

An element response test may be utilized by viewers to identify and select most suitable, viable, qualified, or talented in studio, in audience, and/or at home (local or remote); contestant, element judge, element controller representative, and element controller hopeful options, hopefuls, as well as the ultimate entities.

An element response test may be utilized by test producers to identify and select most suitable, viable, qualified, or talented in studio, in audience, and/or at home (local or remote); contestant, element judge, element controller representative, and element controller hopeful options, hopefuls, as well as the ultimate entities.

In an embodiment, the term participant and the terms contestant, element judge, element controller representative, and element controller may be synonymous. In an embodiment, the term participant may also refer to individuals or teams hoping or attempting to achieve one or more test or personal goals or objectives.

An element response test may be utilized to identify participant semi-finalists, finalists, and/or winners.

### Element Controller Designation

When a plurality of potential primary element controllers are providing one or more predetermined types of responses to a predetermined number of elements within an element response period one or more of the potential primary element controllers may be designated sometime before, during, or after a response submission deadline. One of the one or more potential primary element controllers may be designated at a time consistent with, same as, or after a primary element response test participant's element response submission deadline.

### Primary Element Controller Test

An entity or entities comprising one or more primary element controllers of elements within an element response test may be allowed or required to participate in a primary element controllers test. Each entity may receive a point value when the entity's response to an element is at least similar to:

Another entity's response to the same element wherein the other entity comprises another primary element controller.

Another entity's response to the same element wherein the other entity comprises an alternate element controller.

Another entity's response to the same element wherein the other entity comprises an ancillary element controller.

A percentage (generally a majority) of entities response to the same element whereas the percentage of entities comprises the same primary element controller.

A percentage of entities response to the same element whereas the percentage of entities comprises another primary element controller.

A percentage of entities response to the same element whereas the percentage of entities comprises an alternate element controller.

A percentage of entities response to the same element whereas the percentage of entities comprises an ancillary element controller.

A percentage of primary element response test viewer's response to the same element.

A percentage of ancillary test viewer's response to the same element.

A percentage of primary test participant's response to the same element.

A percentage of alternate test participant's response to the same element.

A percentage of ancillary test participant's response to the same element.

A percentage of polled or surveyed members of one or more societies or one or more segments of one or more society's response to the same element.

An element response game may utilize one or more segments of a plurality or a universe of element response game participants as element controllers, in this scenario participants may qualify to receive an award, title or recognition based at least in part on their ability to identify and response to elements in manner at least similar to the element controller or a segment of a plurality of element response game participants comprising an element controller.

An element controller game/test objective may be to identify an element controller or entities comprising an element controller in sync with an element controller or ERG/T participants.

An element controller game/test may allow or require an entity or entities comprising an element controller to qualify to remain an element controller or an entity comprising an element controller.

An element controller game/test may require the entity or entities to provide a required number and type of responses to a required number of elements in a manner that is at least similar to a majority of all participants or a majority of one or more segments of participants.

When the entity or entities are in sync with participants the entity or entities may be offered an opportunity to remain as an element controller or entity comprising an element controller.

When the entity or entities are in sync with participants the entity or entities may qualify to receive consideration.

An entity or entities comprising one or more element controllers of elements within an element response period may be allowed or required to participate in an element controllers test. Each entity may receive a point value when the entity's response to an element is at least similar to:

Another entity's response to the same element wherein the other entity comprises another element controller.

A percentage (generally a majority) of entities response to the same element whereas the percentage of entities comprises the same element controller.

A percentage of entities response to the same element whereas the percentage of entities comprises another element controller.

A percentage of element response period viewer's response to the same element.

A percentage of ancillary test viewer's response to the same element.

A percentage of ancillary test participant's response to the same element.

A percentage of polled or surveyed members of one or more societies or one or more segments of one or more society's response to the same element.

An element controller game/test objective may be to identify an element controller or entities comprising an element controller in sync with an element controller or ERG/T participants.

An element controller game/test may allow or require an entity or entities comprising an element controller to qualify to remain an element controller or an entity comprising an element controller.

An element controller game/test may require the entity or entities to provide a required number and type of responses to a required number of elements in a manner that is at least similar to a majority of all participants or a majority of one or more segments of participants.

When the entity or entities are in sync with participants the entity or entities may be offered an opportunity to remain as an element controller or entity comprising an element controller.

When the entity or entities are in sync with participants the entity or entities may qualify to receive consideration.

### Test Participants as Entities Comprising an Element Controller

A plurality of members of the one or more societies belonging to each of the plurality of segments may be enrolled as both entities comprising test element controllers and test participants. Test participants belonging to each segment may be required to submit a same number of one or more types of response to a same number of test elements prior to a response submission deadline designated for each segment.

In an embodiment, the test response platform administrator may group submitted responses from each controlling segment during a designated response session and/or upon completion of a designated response session with respect to each segment. In an embodiment, the response platform administrator identifies each element receiving a required number of one or more similar types of response from a highest number (majority?) of test participants from each of the plurality of segments comprising each of the plurality of controllers respectfully. In an embodiment, the identified elements may be prepared by to be revealed during a first segment of a next phase.

In an embodiment, the response platform administrator may assign a point value to a test participant each time the participant's submitted one or more responses to an element are at least similar to a test element controller's response to the same element. Therefore, each participant may receive a number of response point totals with respect to a number of test element controllers.

A response test administrator may require test participants to submit initial responses prior to an initial response submission deadline with respect to a segment to which the participants belongs and to re submit initial responses when the initial responses are identified by the participants with respect to points information provided by the administrator as qualifying the participant to receive consideration.

This method may require the administrator to only compare a test participants self determined consideration qualifying initial response resubmission with the participants initial response submission to identify the participants as qualified to receive consideration and may not require the administrator to assign point values to either initial response submission or initial response re submissions.

Test participants with a highest point total with respect to each controller qualify to represent that controller resulting in a test participant possibly qualifying to represent more than one controller. When a plurality of test element are incorporated into various themed test element categories a participant may receive a highest response point total for one element category with respect to one element controller and a highest response point total for another element category with respect to another element controller. This way the participant may qualify to represent each element controller with respect to each test element category theme. In essence the participant is identified as having an innate ability to provide matching or similar responses to elements of different themes with respect to different controllers.

### Element Responses Test Preparation

Based on one or more period or test objectives or goals an element response period or test provider designates:

a number test periods;

a number of test phases for each period;

a day and time to begin each test phase;

an element response submission deadline for each response session;

one or more test revenue providers for each phase;

a plurality of primary test elements for each response session;

a plurality of revenue provider's test elements for each response session;

one or more primary element controllers;

one or more alternate element controllers;

with or without the test providers assistance, one or more element controllers for the revenue provider's test elements;

one or more types of responses the one or more primary element controllers are required to provide test elements;

one or more types of responses the one or more alternate element controllers are required to provide test elements;

one or more types of responses the one or more and revenue provider's element controllers are required to provide the revenue provider's test elements;

a number of test elements to which the one or more primary element controllers are required to provide the one or more types of responses;

a number of test elements to which the one or more alternate element controllers are required to provide the one or more types of responses;

a number of test elements to which the revenue provider's one or more element controllers are required to provide the one or more types of responses;

one or more test element observation platforms;

one or more test element response submission platforms;

one or more element evaluation and response recording systems for the test and revenue providers one or more element controllers;

one or more test participant element evaluation, personal response recording, controller response recording, and response point calculation systems;

a number of participants to receive consideration with respect to each response session;

level of consideration afforded to qualified test participants;

Prior to an element response period the period provider may afford members of one or more societies or member of one or more segments of one or more societies with access to at least one of a periods one or more observation platforms and at least one of a periods one or more response submission platforms an opportunity to become entities comprising an initial element controller wherein an element controller ultimately comprised of a majority of members of one or more societies or a majority of members of one or more segments of one or more societies.

Prior to an element response period with one or more directly or indirectly associated ancillary element response tests, the ancillary element response test administrators may afford members of one or more societies with access to at least one of a periods one or more observation platforms and at least one of a periods one or more response submission platforms an opportunity to become ancillary element response tests participants.

Prior to an element response test, the test provider may afford members of one or more societies or members of one or more segments of one or more societies with access to at least one of a tests one or more observation platforms and at least one of a tests one or more response submission platforms an opportunity to become entities comprising one or more element controller and/or element response test participants.

### Test Preparation Example

A test provider selects a plurality of elements most suitable to become test elements, according to one or more test element suitability criterions or test objectives, during a future element response test.

A plurality of test element controllers each comprised of a segment of future test participants belonging to at least one nation may be designated to directly or indirectly determine the fate/future of the plurality of selected test elements by a number of one or more types of responses the controllers may be required to provide a number of the plurality of test elements.

Generally, when test elements are capable of having a future a test element controller's required type of response to an element is positive response the controller directly affects the future of that element and indirectly affects the future of elements not receiving the positive response and when a test element controller's type of response to an element is negative response the controller directly affects the future of that element and indirectly affect the fate of elements not receiving the negative response. In an embodiment, the test element controller's one or more types of responses to an element may also be responses test participants must provide the same element in order to receive a point value. A test participant may also receive point value each time the participant's response to an element is at least similar to a controller's response to the same element. Therefore, a test element controller may be designated to directly or indirectly control the future of test elements, when test element futures are controllable and determine correct responses to a number of test elements during an element response test.

Members of the at least one nation may informed of an opportunity to simultaneously participate in a future element response test as entities comprising one of a plurality of element controllers and element response test participants whereas a plurality of test participants with a highest point total with respect to each of the plurality of controllers are selected to star on Television as a representative to the one or more controllers to which they are in sync and/or receive a one million dollar award.

### Ancillary Element Response Test

Ancillary element response tests associated with an element response period generally allow or require ancillary test participants to provide a same one or more types of responses to a same number of elements as at least one element controller presented during the element response period prior to an ancillary element response test participants element response submission deadline. An ancillary test participant's response submission deadline is generally the same as or prior to an element response period element controller's response submission deadline.

Ancillary Element Response Test Associated with a Primary Test

Ancillary element response tests associated with a primary element response test generally allow or require ancillary test participants to provide a same one or more types of responses to a same number of elements as at least one primary or alternate element controller presented during the primary element response test prior to an ancillary element response test participants element response submission deadline. An ancillary test participant's response submission deadline is generally the same as or prior to a primary element response period primary or alternate element controller's response submission deadline.

### Ancillary Games and Tests

Another objective of an element response period or element response test may be to afford viewers the opportunity to participate in one or ancillary element response games or tests. An ancillary game or test may be directly or indirectly associated with one or more primary element response period or test observation platforms, (e.g., network Television, Video, etc.). By affording viewers of element response periods the opportunity to participate in ancillary element response games directly or indirectly associated with the element response period observation platform, the observation platform provider may garner a higher percentage of viewers when compared to not affording viewers with an opportunity for ancillary game or test participation.

Ancillary game winners may receive recognition or awards from a provider of a primary observation platform or revenue provide associated with the primary observation platform.

### Example

An ancillary test provider/administrator affords viewers of an element response period or series of periods an opportunity to participate in an ancillary element response test.

In an embodiment, the ancillary game administer instructs participants to observe and evaluate the element response options presented on the primary observation platform at a certain date and time.

In an embodiment, the ancillary game administer may provide participants with printed or electronic element response systems. An element response system may allow participants to evaluate elements presented on the primary observation platform one or more times subsequent to the primary platform presentation.

In an embodiment, the ancillary participants observe the primary observation platform showing the elements available to receive one or more responses from one or more element controllers and participants of one or more ancillary element response games.

Before an element response deadline the element controller submits responses to one or more elements subsequent to ancillary to an ancillary test participants response submission deadline when the element controller is other than a percentage of ancillary game participants. When the element controller is a segment of element response game participants the element controllers response submission deadline and the ancillary element response game participants response submission deadline is the same.

In an embodiment, the primary provider and the ancillary test administer may share response submissions. Therefore, the ancillary administrator is able to assign point value to each participant that responds to an element in a manner that is at least similar to one or more element controllers. In an embodiment, the administrator is then able to identify participants with the highest score. In an embodiment, the administrator is then able to communicate identities of one or more winners to the period provider.

During an event subsequent to the presentation of the element response options on the primary observation platform the primary provider reveals the controllers responses to one or more elements as well as the element finalist for the period. In an embodiment, the primary provider may also reveal one or more winning ancillary game participants. At this time the ancillary provider may reveal the one or more winning participants. In an embodiment, the one or more winning participants may receive recognition or an award from the primary provider. In an embodiment, the one or more winning participants may also receive recognition or an award from the ancillary administrator.

During a series of element response periods the ancillary administer may allow participants to accrue points. Ancillary participants receiving a highest point total for a series of periods may be revealed on the primary platform.

In an embodiment, the ancillary game administer may not be associated or have a direct relationship with the primary provider. Therefore, the ancillary game winners may be recognized or receive awards in ways other than stated above.

Another example of an ancillary game with an administrator with no direct relationship or association with a primary provider may be a wagering game, pool game, card, lot, or scratch card, or a combination of two or more games.

### Element Response Pool Game

Wagering, Pool, Retail Card, and Retail Card/Lotto Type games may be played by friends and co-workers utilizing printed or electronic element evaluation, response, rating, ranking systems, as well as element controller and participant databases with point calculation system.

### Ancillary Element Responses Games

Casino Games

Slots

Wagers

Table Games

Board Games

Ancillary games and systems may be utilized by businesses to test executives, employees and applicants. In an embodiment, the participants game/test scores may indicate the participants that are most qualified to represent an element controller of one or more element categories within an element response game when the element controller is targeted by a business.

### Primary and Alternate Element Response Test

Primary and alternate element response tests utilize both one or more primary element controllers and one or more alternate element controllers. Participants may be required to participate in a primary test controlled by a primary element controller and may participate in one or more alternate tests each controlled by an alternate element controller. When the primary element controller is a majority of all element response test participants an alternate element controller may be comprised of a segment or demographic of test participants whereas the segment or demographic may overlap the majority of test participants.

### Alternate Element Response Test

During a primary element response test one or more alternate element controllers may be designated to directly or indirectly controller the fate or future of one or more elements or provide correct responses to one or more elements within the test. In an embodiment, the one or more alternate element controllers are generally required to provide one or more predetermined types of responses to a predetermined number of elements presented during the test prior to an alternate element controller's element response submission deadline.

When a plurality of potential alternate element controllers are providing one or more predetermined types of responses to a predetermined number of elements within a primary element response test one or more of the potential alternate element controllers may be designated sometime before, during, or after a response submission deadline. One of the one or more potential alternate element controllers may be designated at a time consistent with, same as, or after a response submission deadline for alternate element response test participants.

An alternate element controller of one or more elements within an element response test may not be revealed or remain a mystery until a same time, a time consistent with, or after an alternate element response test participant's element response submission deadline.

### Alternate Element Response Test

When an element response test utilizes a plurality of element controllers for each element within the test or test element category at least one element controller is designated as a primary controller and the remaining element controllers are designated as alternate controllers. In an embodiment, the primary controller is generally to accomplish a primary test objective and the one or more alternate controllers are designated to accomplish at least one alternate test objective.

Test participants may be required to participate in a primary test controlled by a primary controller and may be allowed to participate in one or more alternate tests each controlled by an alternate controller.

When a primary controller is a majority of all test participants an alternate controller may be a majority of a segment all participants.

### Alternate Element Controller Test

An entity or entities comprising one or more alternate element controllers of elements within an element response test may be allowed or required to participate in an alternate element controllers test. Each entity may receive a point value when the entity's response to an element is at least similar to:

Another entity's response to the same element wherein the other entity comprises a primary element controller.

Another entity's response to the same element wherein the other entity comprises another alternate element controller.

Another entity's response to the same element wherein the other entity comprises an ancillary element controller.

A percentage (generally a majority) of entities response to the same element whereas the percentage of entities comprises a primary element controller.

A percentage of entities response to the same element whereas the percentage of entities comprises the same alternate element controller.

A percentage of entities response to the same element whereas the percentage of entities comprises another alternate element controller.

A percentage of entities response to the same element whereas the percentage of entities comprises an ancillary element controller.

A percentage of primary element response test viewer's response to the same element.

A percentage of ancillary test viewer's response to the same element.

A percentage of primary test participant's response to the same element.

A percentage of alternate test participant's response to the same element

A percentage of ancillary test participant's response to the same element.

A percentage of polled or surveyed members of one or more societies or one or more segments of one or more society's response to the same element.

Alternate Element Response Test Associated with Primary Test

Alternate element response tests associated with a primary element response test generally allow or require alternate test participants to provide a same one or more types of responses to a same number of elements as at least one primary or alternate element controller presented during the primary element response test prior to an ancillary element response test participants element response submission deadline. An alternate test participant's response submission deadline is generally the same as or prior to a primary element response period primary or alternate element controller's response submission deadline.

Response types are identified on a response platform and by an element response host during an element response option presentation.

One or more element controllers (one or more primary or one primary and one or more alternates) designated to one or more element categories and element response game participants may be required to provide a required number and type of responses to a required number of elements within the category. In an embodiment, the type of responses may be announced by an element response game host and presented on an element response platform corresponding to each element within the category.

### Example

An element response game host presents 8 element response options from one element category.

One or more element controllers designated to the one element category and element response game participants are instructed to rate/evaluate each element from the one category on a 1.0 to 10.0 scale and rank the four (4) elements in the order of 1st thru 4th place according to at least one criterion. Each element will receive at least one rating or evaluation response and 4

### Example 2

Controller(s) and participants are instructed to rate each element from the one category on a 1 to 10 scale according to three criterions and rank

One or more types of responses to elements within a specific element category or element sub category

An element response period or series of periods (JF, don't get excited maybe we should say an element response period, a series of element response periods, an element response period in combination with one or a series of element response periods may incorporate a game/test for one or more element controllers or entities comprising separate or the same element controllers of element response options within one or more element categories, element sub categories, or one or more elements category regressions of the period or series of periods.

In an embodiment, the term game and test may be synonymous.

An element response game provider may reveal the identity of one or more element controllers prior to participants element response submission deadline. A provider may not reveal the identity of one or more element controllers until after an element response submission deadline. A controller not revealed until after an element response submission deadline may be identified before the submission deadline as a secret or mystery controller.

An element response game may have a plurality of element categories. One or more categories may have controllers that are identified to participants before an element response session or element response submission deadline. One or more other categories may have controllers that are not identified to participants until after an element response submission deadline.

An element response game may have one or more categories of element response options. Each category may have one or more element controllers.

A controller for one category may be identified to participants before an element response session or before an element response submission deadline.

An element response game may utilize a plurality of element controllers (identified, mystery, or identified and mystery) and a plurality of element categories. Element controllers may be required to provide a specific number and type of responses to a specific number of elements within al categories or within one or more designated categories. Generally, element response game participants are required to provide the same number and type of responses to the same number of elements within all categories as the controllers. Participants may be allowed or required to select one or more element controller for their specific game or test and may be allowed or required to select one or more element categories.

When a plurality of element controllers exist, participants may be required to provide a required number and type of objective responses to a required number of elements within each category.

One or more consideration opportunities may correspond to all or different controllers.

When award opportunities correspond to different controllers, participants may be allowed to select one or more controllers for their game based upon identifying with the one or more controllers or identifying with the one or more award opportunities corresponding to a specific identified or mystery controller.

When a plurality of element controllers exist within an element response game, participants may be allowed to

One or more types of awards may correspond to one or more element controllers, identified or mystery.

One or more types of awards may correspond to one or more identified or mystery controllers. Participant may be allowed to select one or more element controllers according to the award opportunities associated with each controller.

An element response game may have one or more element categories with one or more identified and one or more mystery controllers. Participant may be required or allowed to submit objective and subjective responses to elements within the one or more element categories resulting in the provider capturing a participants objective and subjective response data.

An ancillary element response test may be associated with a secondary element response test or one or more secondary element response test element categories.

### Consideration

Consideration may be offered to viewers/consumers for registering to become test participants.

### Consideration

One of the most notable things a participant may receive is an employment offer. An employment offer may be combined with a salary commensurate with a Television network executive. In an embodiment, the employment offer may be an element casting director for a subsequent or future element response period or game. One or more most qualified participants may by selected to represent one or more of the element controllers to which the participant relates to on an element response level higher than all other participants.

When an element controller of an element response game is a segment or a majority of a plurality of element response game participants, one or more participants with a highest point total may qualify to represent the segment or the majority of participants in a subsequent or future element response period or games as an element casting director.

A plurality of most qualified element response game participants may be selected to participate in the production of a subsequent or future element response period or game as element casting directors for one or more periods of the game when the game consists of a plurality of periods. Therefore, the one or more periods of the game may be referred to as viewer/consumer controlled. When participants are from diverse social backgrounds and ethnicities the game or test may be referred to as diversely controlled.

A multiplicity of most qualified element response game participants may be selected to participate in a subsequent or future element response period or game as a plurality of entities comprising an element controller.

An element response game may allow participants to audition and cast entertainers or contestants for Television programs or series. In an embodiment, the most qualified participants may then be selected to participate in the program or series.

### Example

A Television network provides an element response game with the main objective of allowing participants to audition and cast one or more leading, supporting, or walk on roles in a future Television series. In an embodiment, the future Television series has one or more element response option incorporated into one or more episodes of the series. Various programs may incorporate one or more element response options into every or every other program. A multiplicity of the most qualified participants from the previous game responds to a required number of the element response options within the program.

Therefore, a television program or series that normally provides little or no interactivity may allow and multiplicity of most qualified element response game participants to interact with the program or series they helped to cast.

Generally, the game/test is utilized to engage participants or teams of participants that qualify to represent one or more element controllers of the game/test in a future game/test as an element controller assistant or representative. One or more participants most qualified to represent or assist a controller in a subsequent game/test are generally participants with the ability to identify element that an element controller will have an affinity to.

An element response game may have a plurality of element response options from a plurality of categories or sub categories. Each category or sub category may be assigned to a different element controller.

An element response game or element response category may allow a participant to response to elements objectively, partially objectively, subjectively, or partially subjectively. When an element controller is known, a participant may provide objective responses to elements. When an element controller is partially known, a participant may provide partially objective or partially subjective responses to elements. When an element controller is unknown, a participant may respond to elements subjectively.

A provider may wish to garner subjective response data to element response options. Therefore, the provider may keep the element controller a secret until an element response deadline has passed, This may provide a more suspenseful game format.

A plurality or multiplicity of participants most qualified to represent one or more element controllers may participate in a future production as an element controller representative from a remote location such as from home, school, or office. One or more most qualified participants may also represent the one or more element controller on a production site.

Participants qualified to receive an award may become an element response option, an element casting director, an element casting coordinator, an element casting assistant, an element casting consultant, an entity which determines element placement.

### Consideration

Gift Certificates

Product Certificates

Discounted Product or Gift Certificates

Event Tickets

Cash Prizes Awards

Response Test Point Total Certification

Titles

Entered into a Sweepstakes or Drawing

Selected to Become A High Level Participant or Contestant

Award/Prize

Products responded to by an element controller may be provided as prizes to be received by winning or most qualified ERG/T participants.

Employment or Contract Opportunities

Employment or contract opportunities may include, but are not limited to: casting director, celebrity judge, consultant, executive, assistant, representative, focus group leader.

When a predetermined number of most qualified participants is exceeded award winners may be determined by time taken to submit responses, number of periods the participant has previously participated in, number of elements responded to that did not require a response.

### Consideration

A test may provide one or more most qualified participants or participants in sync with a controller to become an element controller assistant or representative.

A test objective may be to identify and award a specific number or range of most qualified participants. A provider may increase the number of elements, element categories, element controllers (when participants are required to be in sync with more than one controller to receive consideration), phases within each period, periods within each series, or series. When a number of most qualified participants exceed a desired number a provider may require the excessive number of most qualified participants to participate in one or more additional tests in order to achieve a manageable number of most qualified participants. In an embodiment, the higher the number of responses participants are required to provide will result in a lower number of most qualified participants.

A test objective may be to identify or search for participants or teams to assist, represent, replace, or become one or more element controllers or entities comprising an element controller.

Test participants and teams will generally receive consideration (including, but not limited to, prizes, awards, certifications, recognition) based at least in part upon a participant's or team's ability to subjectively, objectively, or subjectively and objectively provide responses in sync with one or more element controllers controlling elements within one or more test element categories, element sub categories, or one or more combinations of element categories, or element sub categories.

### Game Show Contestants

A test prize or award may be consistent with one or more of the test provider's objectives. A provider's objective may be to identify applicants most qualified to participants on a game show as contestants and to allow various other games to exist utilizing the elements of the test.

Participants of various themes of element response tests with a highest point total or a highest number of matches may be selected or qualify to be selected to participate in a range of future productions or businesses which may or may not be directly or indirectly related a test theme or genre.

Various test themes may garner actions or responses conducive to identify participants who qualify for an almost unlimited number of future positions or opportunities that are directly or indirectly related to each theme.

A test provider may allow participants to receive consideration based on a participant identified as being in sync with a plurality of element controllers whether the element controllers are designated to controller elements or provide correct responses to elements within one or more of the same element categories or different element categories.

### Example

A test provider designates two element controllers for one element category. In an embodiment, the one element controller, controller A, is corporate executive, the other element controller, controller B, is predefined as comprised of a plurality of test participants. Controller B is ultimately defined by responses received by a majority of the plurality of participants.

In an embodiment, the test provider's objective is to identify a group of participants qualified to be selected to receive a salary while assisting the executive and representing the plurality of participants simultaneously during a future production. In an embodiment, the objective is accomplished by requiring participants to provide a set of responses to elements within one element category with respect to controller A and controller B.

In an embodiment, the two controllers, the executive and the plurality of participants, are instructed to provide the same one or more types of responses to a same number of elements within the one element category. In essence, test participants are instructed to provide a set of responses, response A to correspond to controller A and response B to correspond to controller B. Participants are informed, each time a participant's response A response to an element matches or is at least similar to controller A's response to the same element the participant is allowed to assign them self or is assigned a point value. And, each time a participant's response B response to an element matches or is at least similar to controller B's response to the same element the participant is allowed to assign them self or is assigned another point value. And, participants with a highest point total with respect to controller A (the executive) combined with a highest point total with respect to controller B the majority of participants) qualities to be selected to receive a monetary award and/or assist the executive and represent the participants simultaneously during a future production.

In an embodiment, the test provider inquires: Who would be more qualified to assist the executive and represent a nation than those who are most in sync with the executive and the nation? In an embodiment, the provider exclaims, that's right . . . no one!

Providing test participants with consideration based on receiving a highest point total with respect to multiple controllers may be accomplished in many ways.

### Consideration

Test participants with a highest or passing score with respect to an element controller may receive a certificate or be acknowledged as qualified to represent or assist the element controller.

### Example 1

A famous celebrity is designated as a controller of one or more themes of test elements. Participants that provide responses to test elements that match or are at least similar to the celebrity's responses to the same elements a higher number of times than all other participants receive certification acknowledging them as qualified to assist or represent the celebrity with respect to the element themes.

### Example 2

A majority of viewers is designated as a controller of one or more themes of test elements. Participants that provide responses to test elements that match or are at least similar to the majority of viewer's responses to the same elements a higher number of time than all other participants receive certification acknowledging them as qualified to assist or represent the majority of viewers or the nation to which the viewers belong.

### Award

Most qualified test participants may be awarded products or product discounts.

### Consideration

Participants with a highest test score may be selected or qualify to be selected to participant in a pre production, production, or post production of an event or event series. A participant's part or position in the event or series may be as an assist or representative of the element controller to which the participant has a kinship to, which was proven when the participant was able to identify and respond to elements to which the element controller has an affinity.

### Consideration

A test objective (primary) may be to identify and award at least one participant most qualified to receive a prize, award, title, certificate, recognition, employment, etc. (i.e. consideration). Various means may be utilized in conjunction with matching one or more element controller's responses to identify most qualified participants especially when one or more most qualified participants are selected to receive employment such as in a future production in order to qualify the production or aspects of the production and/or event subsequent to the production as viewer controlled when all participants or a segment of participants comprises an element controller.

By allowing participants to become employed or act as an independent contractor in a future event or series production a participants commitment level should generally be established prior to engaging the participant. When elements are presented allowing a participant to increase their prize level or commitment level and are not capitalized on by a participant the participant may be seen as not qualified or uncommitted.

### Example

Prior to each test viewers are afforded an opportunity to register to participate in the process of auditioning and casting one or more hosts for the test (allowing participants to audition and cast their own host adds to a viewer/participant controlled concept) and the test as well. Those who participate in the auditioning and casting process of the one or more hosts may be seen as most committed or serious and potentially qualified when compared to those who elect not to participate in all aspects of a test when participating in all aspects is either revealed or not by a provider as a qualification prerequisite.

### Consideration Based on a Percentage of Revenues

Awards provided to winning participants or qualified participants of not only element response tests but all types of games and tests may be determined by a percentage of revenue generated during or after the game or test.

By allowing participants to assist in the creation of a product or participate in a test allowing participants to respond to elements that may or may not have been incorporated into a future product, participants may be inclined to consume or purchase the products in order to increase the revenue generated by the products in order to increase the amount of awards provided when the amount of awards provided are in a direct or indirect relationship to the revenue generated by the product.

If a game show allowed members of one or more societies to participate in a game or test relating to the pre production of the game show and participants were to receive 20 percent of the revenues generated from the game show in the show's first 18 months of production, 200 MILLION DOLLARS in prizes and awards would have been received by winning or most qualified participants.

Test participants with a highest test score at the conclusion of a test series may be awarded 10 percent of revenues generated up to one week from the time the product is made available or when the product generates $100,000.00. In an embodiment, the highest scoring or most qualified participants would share $10,000.00

In essence, awards may be a percentage of revenues generated over a period of time. In an embodiment, the period of time may be before, during, or after a game/test series or one or more combinations of before, during, or after the game/test.

A test may provide consideration to participants before, during, or after a phase, period, or series. Consideration may include, but is not limited to: recognition, certification, a prize, an award, employment, etc.

Participants and viewers may receive consideration based on a prize pool. A prize pool may consist of a percentage of revenues directly or indirectly associated with the game or test. Products sale may be directly associated the test and may include elements presented for consumption during a commercial or within the test. Products associated with a test may incorporated into the test as element response options. Therefore, revenue providers, test licensees, element controllers, viewers, and participants may directly or indirectly contribute to a prize pool. For example, viewers are informed 10% of revenues generated from the sales of element response options during a period are entered into a prize pool to be offered to 1,000 participants with a highest score during the period. In an embodiment, the element response options generate 10 million dollars in sales resulting in 1,000 participants with a highest score receiving 1000 dollars each. Another example is when viewers and participants are informed that a sponsor provided 10 million dollars in revenues to run commercials, place products into the test, and to capture marketing data and that 20 percent of the 10 million is given back to participants that are identified as in sync with the sponsor's controller. In an embodiment, the sponsor's revenue provides 2 million dollars for the prize pool to be divided amongst 1,000 highest scoring participants.

Viewers and participants may be afforded an opportunity to purchase products directly or indirectly associated with the test at a discount. A percentage of revenues generated from discounted product sale may be entered into a prize pool.

A retailer may provide discounted products to viewers and participants to facilitate methods for participation. A percentage of revenue generated from the products may be entered into a prize pool. For example, Sony may offer discounted DVD and CD players to participants to enable viewers and participants to view and listen to element response options.

Test participants identified as in sync with an element controller may be required to participate in further testing with element response options controlled by the same or a different element controller. For example, 200,000 participants are identified as in sync with an element controller that happens to be a celebrity. In an embodiment, the 200,000 participants may then be required to participate in a test that is controlled by a majority of viewers (non participants). Consideration may be offered to participants that are in sync with both the celebrity and the majority of viewers.

Participants consuming products prior to or during a test or game may be offered consideration of a higher value than participants that do not consume products prior to or during a test or game series. Products available for purchase prior to a test may provide an advantage to participants. For example, a test series is televised each week presenting music products as element response options. Test participants are afforded an opportunity to consume the products before and during a response session. Participants purchasing one or more of the available products relating to the test will qualify to receive consideration of a higher value than participants who do not purchase the related products. A percentage of revenue generated from the purchases products by consumers and/or test participants may be entered into a prize pool.

A revenue provider may pay a fee to garner survey data from participants. Participants who provide survey data may be offered consideration of a higher value than participants who do not provide survey data. Participants who provide data for a plurality of surveys may qualify to receive consideration of a higher value than participants who only provide less survey data. In essence, when a revenue provider pays a fee to garner marketing or direct marketing data from viewers or participants, or pays a fee for each participant that answers a survey or questionnaire, or pays a fee for a quantity of data, (viewers may be element controllers not qualified to receive consideration and participants may be element controllers who do qualify to receive consideration) a percentage of revenue generated from the revenue provider may be entered into a prize pool.

When participants are informed they may qualify to receive consideration of a higher value for providing data or performing actions that are or are not directly or indirectly related to one or more test or game objectives, a percentage of participants may provide the data or perform the actions to qualify to receive consideration of a higher value than participants who do not provide the data or perform the actions.

Currently, direct marketing spend is over 200 billion dollars per year. A revenue provider may pay 100 million dollars of revenue during 10 week test series to have a direct marketing relationship with 5 million test participants.

A company may pay a fee to acquire various types of data from test participants. Participants may be informed that a percentage of the fee is entered into a prize pool. Participants may be more likely to provide data when no prize pool or consideration is offered. This method creates a positive relationship between the company and participants.

### Stocks

Participants receiving a qualifying point total may be offered shares of a test providers company or one or more companies associated with a provider. Participants who become owners or share holders may be more likely to consume products directly and indirectly associated with the one or More companies.

### Response Points

Element response tests are utilized by test providers to identify test participants that are in sync with one or more controllers of elements within a test. Generally, an element response test provider or administrator requires one or more designated element controllers and test participants to submit a predetermined one or more types of responses to a predetermined number of test elements prior to an element response submission deadline. Each time a participants submitted response to an element is at least similar to an element controller's response to the same element the participant is assigned or qualifies to be assigned a point value. Participants with a highest number of points with respect to one or more elements controllers are identified by the test provider as in sync with the one or more element controllers.

A participant's response to an element may be at least similar to an element controller's response to the same element when the element controller and participants are required to submit similar types of responses to a plurality of elements. Similar types of responses may be ranking, placing, grading, judging, evaluating, and rating.

Test with Multiple Point Methods

A test may incorporate a plurality of element categories and one or more categories may utilize different response test point assignment methods. In one category participants may begin with a positive point value, another category may start participants with a negative point value, when combined participants with a zero point value may be identified as most qualified.

In essence, a test may utilize unconventional point schemes, such as most negative points for positive consideration, most positive points for negative consideration, and zero points for positive or negative consideration.

### Response Point Values

Similar response point values may be weighted according to a degree of similarity. A participant that submits a same ranking response to an element as an element controller may receive a higher point value than a participant that submits a ranking response to the same element but is one or more ranks off from the controller's ranking response. A participant that ranks the same element an element controller ranks but is two ranks off from the controller's ranking response may receive a higher point value than a participants that is three ranks off and a lower point value than a participant that is one rank off.

### Example

An element response test provider presents twenty test elements. In an embodiment, the provider instructs an element controller and test participants to rank their three favorite elements in the order of 1st through 3rd place. In an embodiment, the provider informs test participants each time a participant's ranking response to an element matches the controller's ranking response to the same element the participant is assigned 20 points; each time a participant's ranking response to an element is one rank off from the controller's ranking response to the same element the participant is assigned 15 points; each time a participant's ranking response to an element is two ranks off for the controller's ranking response to the same element the participant is assigned 10 points.

In an embodiment, the element controller ranks element one in 1st place, element two in 2nd place, and element three in 3rd place.

Participant A ranks element one in 1st place, element three in 2nd place, and element two in 3rd place.

### Participant A Receives

20 response points for matching the controller's ranking response to element one.

15 response points for ranking element two one rank off from the controller's ranking response to element two

15 response points for ranking element three one rank off from the controller's ranking response to element three.

Participant A receives a total of 50 response points.

Participant A ranks element one in 1st place, element four in 2nd place, and element three in 3rd place. Participant A receives:

20 response points for matching the controller's ranking response to element one.

No response points for not ranking element two.

20 response points for matching the controller's ranking response to element three. Participant B receives a total of 40 response points.

Therefore, participant A with 50 response points is identified as more in sync with the element controller than participant B with 40 response points even though participant A only matched the element controller's ranking response to an element once and participant B matched the element controller ranking response to an element twice.

### Weighted Response Point

A test element controller's response to an element is determined by a test provider to be correct response to the element. Correct responses may be weighted according to a degree of innate response ability a participant is required to possess in order to provide a correct response to an element. Generally, a higher number of test elements available to receive a response require participants to have a higher degree of innate response ability in order to provide a correct response when compared to a lower number of test elements available to receive a response.

Generally, when one or more of a plurality of elements are made available to receive evaluation or ranking responses, the evaluation or ranking response may be weighted.

When the test provider determines a higher number of elements qualify to receive a lowest ranking than a highest ranking the test provider may allow participants to receive a higher point value for correctly responding to lower ranking elements. When a test provider determines a higher number of elements qualify to receive a highest ranking the test provider may allow participants to receive a higher point value for correctly responding to higher ranking elements.

### Example

A test provider may incorporate five related theme test elements into one element category and twenty related theme test elements into another element category. In an embodiment, the provider may instruct an element controller and test participants to select their favorite element from each category. Participants may be allowed or required to assign them self or assigned a higher point value for correctly selecting their favorite element from the category with a higher number of elements than the category with a less number of elements.

A correct response to an element within a category with five elements may provide participants with an opportunity to receive a higher point value than a correct response to an element within a category with twenty elements when each element within the five element category requires plurality responses and one element in the element category with twenty elements requires one response.

In an embodiment, the following is an example of how a test provider may utilize the weighted response point assignment method.

A test provider designates an element controller comprised of a majority of test participants. In an embodiment, the provider presents twenty test elements. In an embodiment, the provider instructs participants (through out this document the inventor includes at this point the term element controller in conjunction with test participants even when participant and element controller are synonymous) to rank five of the most appealing elements in the order of 1st through 5th place. Test participants are informed they will receive a highest point value for matching the element controllers fifth place element and progressively lower point values for matching the controllers fourth, third, second, and first place elements respectfully. It is explained to participants that a higher point value is provided for matching the controllers 5th place element due to the fact that a higher number of elements qualify to receive a 5th place ranking than elements that qualify to receive a 1st place ranking.

Beginning a Test with Points (Plus and Minus)

An element response test provider may assign test participants with a number of points prior to a test. A test participant may receive a point value each time the participant provides a correct response to an element. And, a point value may be deducted from a participants beginning point total each time the participant fails to provide a correct response to a test element. Test participants with a response test point total closest to their beginning point total are identified as the most qualified test participants.

Beginning a Test with Points (Plus and Static)

An element response test provider may assign test participants with a number of points prior to a test. A test participant may receive a point value each time the participant provides a correct response to an element. And, a point value may not be deducted from a participants beginning point total each time the participant fails to provide a correct response to a test element. Test participants with a highest response test point total are identified as the most qualified test participants.

Beginning a Test with Points (Static and Plus)

An element response test provider may assign test participants with a number of points prior to a test. A test participant may not receive a point value each time the participant provides a correct response to an element. And, a point value may be added to a participants beginning point total each time the participant fails to provide a correct response to a test element. Test participants with a response test point total closest to their beginning point total are identified as the most qualified test participants.

Beginning a Test with Points (Static and Minus)

An element response test provider may assign test participants with a number of points prior to a test. A test participant may not receive a point value each time the participant provides a correct response to an element. And, a point value may be deducted from a participants beginning point total each time the participant fails to provide a correct response to a test element. Test participants with a response test point total closest to their beginning point total are identified as the most qualified test participants.

Beginning a Test with Points (Minus and Plus)

An element response test provider may assign test participants with a number of points prior to a test. A test participant may receive a negative point value each time the participant provides a correct response to an element. And, a point value may be added to a participants beginning point total each time the participant fails to provide a correct response to a test element. Test participants with a response test point total closest to their beginning point total are identified as the most qualified test participants.

Beginning a Test with Points (Minus and Static)

An element response test provider may assign test participants with a number of points prior to a test. A test participant may receive a negative point value each time the participant provides a correct response to an element, And, a point value may not be deducted from a participants beginning point total each time the participant fails to provide a correct response to a test element. Test participants with a lowest response test point total are identified as the most qualified test participants.

Beginning a Test with Negative Points (Plus and Minus)

An element response test provider may assign test participants with a number of negative points prior to a test. A test participant may receive a positive point value each time the participant provides a correct response to an element. And, a negative point value may be added to a participants beginning point total each time the participant fails to provide a correct response to a test element. Test participants with a response test point total closest to their beginning negative point total are identified as the most qualified test participants.

Beginning a Test with Negative Points (Pins and Static)

An element response test provider may assign test participants with a number of negative points prior to a test. A test participant may receive a positive point value each time the participant provides a correct response to an element. And, a negative point value may not be added to a participants beginning point total each time the participant fails to provide a correct response to a test element. Test participants with a lowest negative response test point total are identified as the most qualified test participants.

Beginning a Test with Negative Points (Static and Plus)

An element response test provider may assign test participants with a number of negative points prior to a test. A test participant may not receive a point value each time the participant provides a correct response to an element. And, a negative point value may be added to a participants beginning negative point total each time the participant fails to provide a correct response to a test element. Test participants with a response test point total closest to their beginning negative point total are identified as the most qualified test participants.

Beginning a Test with Negative Points (Static and Minus)

An element response test provider may assign test participants with a number of negative points prior to a test. A test participant may not receive a point value each time the participant provides a correct response to an element. And, a positive point value may be added to a participants beginning point total each time the participant fails to provide a correct response to a test element. Test participants with a response test point total closest to their beginning point total are identified as the most qualified test participants.

Beginning a Test with Negative Points (Minus and Plus)

An element response test provider may assign test participants with a number of negative points prior to a test. A test participant may receive a positive point value each time the participant provides a correct response to an element. And, a negative point value may be added to a participants beginning negative point total each time the participant fails to provide a correct response to a test element. Test participants with a response test point total closest to their beginning point total are identified as the most qualified test participants.

Beginning a Test with Negative Points (Minus and Static)

An element response test provider may assign test participants with a number of negative points prior to a test. A test participant may receive a positive point value each time the participant provides a correct response to an element. And, a point value may not be deducted from a participants beginning point total each time the participant fails to provide a correct response to a test element. Test participants with a highest response test point total are identified as the most qualified test participants.

Beginning a Test with Zero Points (Plus and Minus)

An element response test provider may not assign test participants with a number of points prior to a test. A test participant may receive a point value each time the participant provides a correct response to an element. And, a point value may be deducted from a participants beginning point total each time the participant fails to provide a correct response to a test element. Test participants with zero response points are identified as the most qualified test participants.

Beginning a Test with Zero Points [Standard] (Plus and Static)

An element response test provider may not assign test participants with a number of points prior to a test. A test participant may receive a point value each time the participant provides a correct response to an element. And, a point value may not be deducted from a participants beginning point total each time the participant fails to provide a correct response to a test element. Test participants with a highest response test point total are identified as the most qualified test participants.

Beginning a Test with Zero Points (Static and Plus)

An element response test provider may not assign test participants with a number of points prior to a test. A test participant may not receive a point value each time the participant provides a correct response to an element. And, a point value may be added to a participants beginning point total each time the participant fails to provide a correct response to a test element. Test participants with zero response test points are identified as the most qualified test participants.

Beginning a Test with Zero Points (Static and Minus)

An element response test provider may not assign test participants with a number of points prior to a test. A test participant may not receive a point value each time the participant provides a correct response to an element. And, a point value may be deducted from a participants beginning point total each time the participant fails to provide a correct response to a test element. Test participants with zero response test points are identified as the most qualified test participants.

Beginning a Test with Zero Points (Minus and Plus)

An element response test provider may not assign test participants with a number of points prior to a test. A test participant may receive a negative point value each time the participant provides a correct response to an element. And, a point value may be added to a participants beginning point total each time the participant fails to provide a correct response to a test element. Test participants with zero response test points are identified as the most qualified test participants.

Beginning a Test with Zero Points (Minus and Static)

An element response test provider may not assign test participants with a number of points prior to a test. A test participant may receive a negative point value each time the participant provides a correct response to an element. And, a point value may not be deducted from a participants beginning point total each time the participant fails to provide a correct response to a test element. Test participants with a highest negative response test point total are identified as the most qualified test participants.

### Example 1

A controller ranks element number ten in first place and a participant ranks the same element in fifth place. In an embodiment, the participant's response to the element ten is four responses off from the controller's response to the same element. In an embodiment, the participants may assign them self or may be assigned a four off point value.

### Example 2

Element controllers and participants are required to utilize the universal 1.0 to 10.0 scale to rate a plurality of test elements. Participants may assign them self or may be assigned a point value each time a response to an element matches or is at least similar to an element controller's response to the same element. Participants are informed a response that is ten tenths or 1.0 off from the controller's response to the same element is the farthest off a response to the element may be and still allows the participant to assign them self or be assigned a point value. Participants are informed the highest point value possible is a match point value and the lowest point value possible is a ten off point value.

A controller evaluates/rates element number nine with a 7.9 and a participant rates element number nine with a 8.4. In an embodiment, the participant's response is to element number nine is five off or five tenths from the controller's response to element number nine. Therefore, the participant is allowed to assign them self or is assigned a five off point value.

### Point Assigned Upon Registration

Test participants may be afforded an opportunity to receive points prior to a test by performing one or more tasks requested by the test provider. Participants may be presented with a survey or questionnaire during a test registration or at the beginning of a test period. Those who complete the survey or questionnaire may receive a beginning point value or may be allowed to participate in a higher level test with consideration of a higher value than participants who refuse to fill out the survey or answer the questionnaire.

### Free Response Points

Test participants may be presented with various free point element categories. A free point element category allows a participant to receive a point value for simply responding a number of one or more elements within the category. For example, a revenue provider may incorporate a plurality of elements into a free point element category. In an embodiment, the elements within the category when responded to by a number of participants may provide the revenue provider with direct marketing data.

### Captive Points

A test participants assigned point values may be held captive until the participant perform one or more tasks which may or may not be relative to the test. By performing the one or more tasks the participants captive point values may be released.

In an embodiment, the various point assignment methods explains within this document may utilized in, but not limited to: games of chance, other games of skill, and other tests requiring objective and subjective responses.

### Matching/Paring Point Value

Element controllers and participants may be required to match one or more elements to or with one or more other elements from a same or one or more other element categories in order to receive a matching or pairing point value.

In an embodiment, the fact that participants with a highest test point total qualify or qualify to be selected to assist or represent an element controller and draw a salary in the process shows that an element response test requires innate response ability or skill on a higher level than all other forms of interactive games and tests.

In an embodiment, the test may allow a controller or an entity comprising a controller to receive a point value each time the controller or entity responds to an element within a period that matches, nearly matches, or is at least similar to an entity, a plurality of entities with one voice, a segment of a plurality of entities, a percentage (generally a majority) of a segment of a plurality of entities, a percentage of a segment of a segment of a plurality of entities, etc.

### Match Points

An element response game participant may receive a match point value each time the participant's response to an element matches a controller's response to the element.

### Near Match Points

An element response game participant (viewer or entity comprising an element controller) may receive a near match point value each time the participant's response to an element is one response type from a controller's response to the element.

### Regressive Near Match Points

An element response game participant may receive a regressive near match point value each time the participants response to an element is two or more response types from a controller's response to the element.

A correct or almost correct response to an element is determined by an element controller's response to the element.

### For Example:

8 element response options are presented.

An element controller and element response game participants are instructed to rank 3 of the 8 elements in the order of 1st thru 4th place.

Rankings Controller Participant Points

1st place Element 1 Element 1 X

2nd place Element 4 Element 2 X-A

3rd place Element 2 Element 3 0

4th place Element 5 Element 4 X-B

In an embodiment, the participant ranked element 1 in 1st place and the controller ranked element 1 in 1st place. In an embodiment, the participant's response to element 1 matches the controller's response to element 1. In an embodiment, the participant receives a match point value of X.

In an embodiment, the participant ranked element 2 in 2nd place and the controller ranked element 2 in 3rd place. In an embodiment, the participant's response to element 2 is 1 rank off from the controller's response to element 2. In an embodiment, the participant receives a near match point value of X-A.

In an embodiment, the participant ranked element 3 in 3rd place and the controller ranked element 2 in 3rd place. Since the controller did not respond to element 3 the participant receives no points.

In an embodiment, the participant ranked element 4 in 4th place and the controller ranked element 4 in 2nd place. In an embodiment, the participant's response to element 4 is 2 ranks off from the controller's response to element 4. In an embodiment, the participant receives a regressive near match point value of X-B.

In an embodiment, the participant ranked element 1 in 1st place and the controller ranked element 1 in 1st place. In an embodiment, the participant's response to element 1 matches the controller's response to element 1. In an embodiment, the participant receives a match response point value of X.

In an embodiment, the participant ranked element 2 in 2nd place and the controller ranked element 2 in 3rd place. In an embodiment, the participant's response to element 2 is 1 rank off from the controller's response to element 2. In an embodiment, the participant receives a closest or most similar response point value of X−1.

In an embodiment, the participant ranked element 3 in 3rd place and the controller ranked element 2 in 3rd place. Since the controller did not respond to element 3, the participant receives no points.

In an embodiment, the participant ranked element 4 in 4th place and the controller ranked element 4 in 2nd place. In an embodiment, the participant's response to element 4 is 2 ranks off from the controller's response to element 4. In an embodiment, the participant receives a close or similar response point value of X−2.

In an embodiment, the participants point total=X+(X−1)+0+(X−2)

When variable X is 5 the participant's point total is 5+4+0+3=12.

Therefore, the participant received a highest point value for matching the controller's response to an element and regressive point values for closely, similarly or almost matching the controller's responses to an element.

response point value for a matching a controller's response to an element. The participant receives a point value less than

is 1 rank off from the controller's 2nd place element to receive 5-1 points.

The participant did not respond to the controller's 3rd place element and receives 0 points.

The participant is 2 ranks off from the controller's 4th place element and receives 5-2 points.

When variable X is 5 the participant's point total is 5+4+0+3=12.

Total=X+(X−1)+0+(X−2)

The participant receives:

A match response point value for matching the controllers 1st place element.

A close or similar response point value for almost matching the controller's 2nd place element.

And, no points for failing to respond in a manner that is at least similar to the controller's 3rd place element

of the 8 elements that are most qualified to become element response options during a subsequent period.

Match Response Points vs. Similar Response Points

Participants may receive a point value for matching a controller's response to an element response option. This type of response may be referred to as a match response.

Participants may also receive a point value for almost matching a controller's response to an element. This type of response may be referred to as a close or similar response.

of a lesser value than a match response for responding to an element a close or similar response.

An element response game provider may allow participants to receive a point value each time the participant's response to an element is at least similar, or within a regressive limit, to an element controller's response to the same element.

Generally, when participants receive a point value each time a response to an element is close or is at least similar to an identified element controller, the participant responds to elements with objectivity. When participants receive a point value each time a response to an element is close or is at least similar to a mystery controller, the participant responds to elements with subjectivity.

### Objective and Subjective Response Points

When an element category has at least one identified controller and at least one mystery controller, participants may be required to provide one or more objective responses to one or more element and subjective responses to one or more elements within the same category. Participant's objective response points and subjective response points may result in a combined point total. Participant's objective and subjective points may not be combined resulting in separate point totals.

with a plurality of element controllers. In an embodiment, the plurality of controllers for the one or more categories may be identified before an element response session or element response submission deadline. One or more of the plurality of controllers for one element category may be identified controllers and one or more other controllers for the same category may be mystery controllers. When an element category has at least one identified controller and at least one mystery controller, participants may be required to provide one or more objective responses to one or more element and subjective responses to one or more elements within the same category. Participant's objective response points and subjective response points may result in a combined point total. Participant's objective and subjective points may not be combined resulting in separate point totals.

An element response game participant may win an award for, but not limited to, receiving the:

Highest objective point total for one or more categories

Highest subjective point total for one or more categories

Highest objective and subjective point total for one or more categories

Highest objective point total for one or more categories combined with a highest subjective point total for one or more other categories

Highest objective and subjective point total for one or more categories and a highest objective point total for one or more other categories

Highest objective and subjective point total for one or more categories and a highest subjective point total for one or more other categories.

### Points

A provider may allow a participant to receive a free match or point value for simply responding to an element. This may be an effective way of gathering subjective response data, but is less enjoyable than revealing an element control the participant may qualify to assist or represent because of the subjective response.

Element response game participants may be assigned a match or point value each time a response to an element is at least similar to an element controller's response to the element.

Participants with a highest match or point value may qualify to be selected to assist or represent the element controller during a subsequent or future event or series of events.

### Points

Generally a match or point value is assigned to an element response game participant each time the participants response to an element is at least similar to an element controller's response to the element.

In an embodiment, the types of responses to elements may be determined by an game provider. In an embodiment, the types of response to elements may be predicated upon the data or response information the provider intends to garner. (see uploading responses into an element response game/test system) Generally, response types may be positive, evaluating, ranking, or negative. Each type of response may have a plurality of variations. For example, a positive response may be good, very good, or excellent. An element response game participant may be assigned a match or point value to an element when the participants response to the element is at least similar or is at least the same type as the element controller's response to the element.

For example, an element controller response to an element may be excellent. An element response game participants response to the element may be good. In an embodiment, the participants response and the controller's response may be considered to be at least similar when the responses are the same type.

A participant may be assigned a higher match or point value when a response to an element is an exact match to the controller's response to the element. A participant may receive a match or point value of a lower value than an exact match when the response is at least similar or a similar type.

A participant may be assigned a perfect score for elements in one or more categories or sub categories. Each time a participants response to an element matches or is at least similar to a controller's response to the element the participant may keep the assigned points. Each time a participant fails to match or response in a similar manner, the participant may have points deducted. A less point deduction may occur when the participant response is of a similar type and a higher point value may be deducted for a different type.

Generally, an element controllers element response submission deadline is after an element response game participants element response submission deadline. When an element controller is a segment or a majority of element response game participants, the element controllers element response deadline and the participants element response deadline coincide.

### Response Test Points

A test participant may receive a point value each time the participant responds to an element

A test participant may receive a point value each time the participant submits a response to an element.

A test participant may receive a point value each time the participant submits a number of response to an element.

A test participant may receive a point value each time the participant submits a response to a number of elements.

A test participant array receive a point value each time the participant submits a number of response to a number of elements.

A test participant may receive a point value each time the participant submits a positive response to an element determined by a test provider to be qualified or suitable according to a expressed qualifying or suitability criterion.

A test participant may receive a point value each time the participant submits a positive response to an element determined by an element controller to be qualified or suitable according to an expressed qualifying or suitability criterion.

A test participant may receive a point value each time the participant submits a negative response to an element determined by a test provider to be unqualified or least suitable according to a expressed qualification or suitability criterion.

A test participant may receive a point value each time the participant submits a positive response to an element determined by an element controller to be unqualified or least suitable according to an expressed qualification or suitability criterion.

A test participant may receive a point value each time the participant submits a response to an element that is revealed during a future event.

### Lowest Point Totals

Test participants may have points deducted for providing or submitting incorrect responses to elements. Participants with a lowest point total or a lowest point range may be eliminated or dismissed from a test event, event segment or event series and/or may not qualify to participate in one or more subsequent test events, event segments or event series.

### Bonus Points

Bonus points may be assigned to a participant with a perfect score for a test, test phase, test period, test series, or a category within the test, test phase, test period, or test series.

### Bonus Points

Test participants assigned a perfect test score, a highest test score, or a test score within a range may be assigned bonus points. Participants who participate in one or a predetermined number of test periods may receive bonus points.

### Team Participation

Teams may consist of groups of individuals participating with a network such a the NTN network available at restaurants and pubs.

### Team Participation

A test may require team participation when two element controllers are utilized for one element category. Each team may be comprised of two participants. One team member may be assigned to one element controller and the other team member may be assigned to the other element controller. When each member is in sync with their assigned controller the team may qualify to receive consideration.

### Printed and Electronic Response Recording Point Calculation Systems

Generally element response period and test providers afford entities comprising element controllers, primary, secondary, and ancillary test participants and viewers (listeners when applicable) access to one or more electronic and/or printed personal element response recording, personal and controller's element response database, and personal response point calculation systems for one or more periods. In an embodiment, the printed systems may be utilized for a plurality of periods or games/tests. Some electronic or printed system users may be allowed to utilize one or more element response platforms for response submissions.

### Printed System

In an embodiment, the printed test system includes two sub systems. In an embodiment, the first sub system is an element evaluation and personal response recording system. The second sub system is a personal and element controller response recording, and response point calculation system.

### Business Applications

Employee and Applicant Testing

Domestic and international businesses may take a particular interest in element response tests whereas one or more designated element controllers for elements within a particular test may be comprised of members of one or more societies or one or more segments of one or more societies to which the businesses provide or target entertainment, products, consumables, services, news, data, and etc. In an embodiment, the businesses may wish to identify employees or applicants with an ability to objectively or subjectively respond to elements within an element response test in a manner that is at least similar to one or more controllers of elements within the test, Businesses may also be interested in element response tests

Individuals and teams seeking employment with various businesses may identify themselves or be required to identify themselves as in sync with one or more element controllers when an element controller is comprised of entities a business targets.

Individuals and teams with an ability to be in sync with an element controller may have a higher value to the company than those not in sync with an element controller.

### Example

An animated film production company is preparing to enter into a pre production phase for a new animated film. In an embodiment, the film will target consumers of animated films and animated characters. In an embodiment, the company announces a search for animated character and product designers and character and product casting directors who are in sync with consumers and fans of animated films, characters, and products, Twice a year an element response test provider with an exclusive one year license conducts a search for “The World's Favorite Animated Characters” and “The World's Most Qualified Animated Character and Product Casting Directors.” The element response options incorporated into the test are various types of animated characters and products.

designated to control elements within the test are entities comprised of current and future fans and consumers of animated films, characters, and products. In an embodiment, the company prepares to engage those who can prove they are able to identify and respond to the element controllers favorite animated characters and products in a manner that matches or is at least similar to the element controller. Therefore, the company's next animated film team will consist of test participants who are in sync with the companies target audience and consumer base. Due to the cute throat nature of the entertainment businesses the company and many others will form teams of IP design around experts in an attempt to produce their own element response tests that closely resembles but does not infringe on the patents, copyrights, trademarks, and various program format registrations of the test. But, when the company an all others come to realize the inventor went not only the extra mile but an extra million miles to protect not only the basic systems, methods, and format of the test but all commercially viable permutations the company and all others will then be compelled to participate in a bidding war to garner a lifetime exclusive license once the current licensees one year license agreement expires.

Due to the unlimited types of elements that may be incorporated into element response games/tests, and the various types of targeted viewers and consumer that may be designated to control elements within the games/tests, companies that provide elements to or capture data from viewers and consumers will benefit by developing a relationship with element response test licensees or becoming element response test licensees which will ultimately result in developing relationships with and providing consideration to viewers and consumers in a manner never before offered.

Various businesses that may benefit from developing relationships with element response game/test licensee or becoming element response test licensees include, but are not limited to:

Television Networks

Television Production Companies

Film Production Companies

Video Production Companies

Music Labels

Radio Stations

Print Media Publishers

Advertising Agencies

Gaming Producers

Retailers

Wholesalers

Service Providers

To Name a Few . . . .

Companies within virtually all fields of business may identify current employees and future applicants who are qualified to directly or indirectly represent the needs and desires of targeted consumers.

Employees in sync with the one or more element controllers may receive or qualify to receive bonuses and/or salary increases.

Employees not completely in sync with the one or more element controllers may receive or qualify to receive training to become more in sync with the one or more element controllers. Employees with an average point total may not receive or may not be selected to receive bonuses or salary increases.

Entertainment companies may wish to identify various executives/employees with a lowest point total for an element response test phase, period, series of periods, or series of series with respect to one or more element controllers. Employees oblivious to the expressed desires and needs of the one or more element controllers may qualify to be put on probation, fined, or released from the company.

### Employee Testing

Business executives and employees with a highest response test point total with respect to one or more element controllers as a result of one or more response sessions may receive company bonuses or a salary increase.

Business employees with a highest response test point total with respect to one or more element controllers as a result of one or more response sessions may qualify to become executives.

Business executives and employees with a lowest response test point total with respect to one or more element controllers as a result of one or more response sessions tray not receive company bonuses or a salary increase.

Business executives and employees ith a lowest response test point total with respect to one or more element controllers as a result of one or more response sessions may be put on probation, fined, or released from the business.

Business executives and employees with a highest response test point total with respect to one or more element controllers as a result of one or more response sessions may be hired as executives or executive consultants.

In an embodiment, the above businesses may be directly or indirectly related to an industry with a consumer base. For example, a few businesses that would benefit by identifying executives, employees, and application that are in sync with a consumer base may those in the entertainment industry or those who provide data to the entertainment industry.

### Business Employees and Applicants

An element response test enables an employer or employer representative to identify employees and applicants with an objective, subjective and/or innate ability to respond to elements in a manner that is at least similar to one or more element controllers. Generally, a most effective element controller for this purpose is one who is comprised of the employer's consumer base or target audience.

### Example

In an embodiment, the employer or employer representative directs or affords applicants access to an element response system. In an embodiment, the system presents to the applicants a plurality of element response options controlled by the employer's consumer base. Each applicant receives a point value each time a response to an element is at least similar to the element controller's responses to the same element. One or more applicants with a highest point total are determined to be the most qualified to represent the element controllers.

Therefore, an element response test ultimately results in an element controller determining the most suitable test elements and identifying participants most qualified to represent the element controller.

### Applicant Interview and Hiring System

Another embodiment can enable employers to interview company applicants without direct interaction. A plurality of applicants may provide photos and bios to an employer. In an embodiment, the employer's administrator may upload applicant's photos and bio into the company's interview and hiring system. In an embodiment, the employer may select a plurality of the most qualified applicants and choose plurality business situations or problems selected applicants would be required to define or find solutions to. In an embodiment, the applicants may be informed electronically of the business situations and problems and define situations or provide solutions in the way of text or videos. In an embodiment, the employer may RATE selected applicants definition or solution to each problem by giving each applicant a grade. In an embodiment, the employer may hire the applicant with the highest grade or invite 2 or more applicants with the highest grades to be interviewed in person. Therefore, embodiments can provide employers with a way to interview and qualify the top applicants in a time effective manner.

### Personnel Review and Promotion System

Another embodiment of the invention can enable employers to review and promote company employees. In an embodiment, the employer's administrator can upload employee's photos, upgraded bias, accomplishments and reprimands into the company review and promotion system. In an embodiment, the CEO can select a plurality of the most qualified employees and choose a plurality of business situations or problems for selected employees to define or find solutions to. In an embodiment, the employees can define situations or provide solutions in the way of text or video demonstration. In an embodiment, the CEO can RATE selected employees definition of each situation or solution to each problem by giving each employee a number or letter grade. In an embodiment, the CEO can promote the employee with the highest grades or invite 2 or more employees to compete for the promotion through a series of alternate tasks the CEO can rate. Therefore, embodiments can provide employers with a way to review and promote employees in a lore effective manner.

### Advertisement and Promotion Tool

A example test objective is promote and market a product or consumable. Movie studios generally spend between 50 and 100 million for World wide promotion of a movie (consumable). An element response test incorporating movie or film elements is not only a World wide promotional tool but a revenue generating promotional tool when revenue providers are brought into the test equation. Therefore, a test may be referred to as a “Revenue Generating Promotional Tool” (RGPT).

Element response tests are poised to become a standard tool for consumable producers to generate revenues during a consumable branding period and allow revenue providers to develop a relationship with consumers on a level never before offered.

### Tests Resulting in Consumables

A test may result in manufacturing or producing products, such as, automobiles, shoes, Television programs, Television game shows, films, video games, songs, and etcetera. In an embodiment, the resulting product may be different for each society, territory, continent, etc. when a product manufacturing or producing controller (i.e., element controller) is comprised of members of one or more societies or members of one or more segments of one or more societies.

### Example

A test is offered with an objective of allowing participants to controller and participate in the production of a music CD by a soon to be World famous artist “FRICTION.” Element response options are music beats, lyrics, and CD cover design. In an embodiment, the test is licensed to a producer/provider within each continent. All providers designate a majority of participants within their respective continent as an element controller for the beats, the lyrics, and the CD cover design. In an embodiment, the controller from each continent may determine their favorite beats, lyrics, and CD design which may be the same or different from other controllers within other continents, Therefore, the music and art may be tailored to the desires of a majority of participants from each continent. Therefore the music artist and associated label would have an advantage over other artists and labels not utilizing this method of tailored production.

This method may also apply to various segments (graphics) within a society.

By allowing members of different parts of the world to participate in their own music production, the music produced for members within each part of the world may have a higher consumption rate than music produced for all parts of the world.

### Assistant and Representative Testing

Participants contracted or employed to participate in a future production as an assistant or representative to one or more element controller may be required to pass an element response test during or after their participation in order to qualify to remain contracted or employed.

### Most Qualified Test Participant Attrition

A provider may allow or require participants to take part in a succession of periods or series of a succession of periods in order to achieve a suitable or manageable pool of most qualified participants to select from to receive an award or consideration. When a test is comprised of a plurality of phases or periods, each phase or period may result in a number of winning or most qualified participants as a result of each phase or period that qualify to win or receive a prize, award, consideration, and etc. Each successive phase or period prize, award, consideration, etc. may be of a higher value than a previous phase or period. As each phase, period, or series results in or achieves a lesser number of winning or most qualified participants and will eventually result in a desired or manageable number of winning or most qualified participants.

For example, a primary test and an ancillary test associated with the primary elements of the primary test may exist. In an embodiment, the two tests may each utilize one observation platform. Primary test participants are allowed to participate in the ancillary test. Therefore, primary and ancillary test participants utilize the same observation platform. In an embodiment, the primary test participants with a lowest point total as a result of each period of a series of periods are disqualified from participating in a subsequent period. In an embodiment, the ancillary test allows random period participation whereas participants with a highest point total for each period and all periods combined qualify to receive or qualify to be selected to receive consideration. Therefore, participants disqualified from the primary test prior to a final period will still have an incentive to remain viewers of the observation platform by remaining ancillary test participants or becoming new ancillary test participants.

Although the number of primary test participants has been reduced throughout the series, the number of viewers of the observation platform may remain constant.

### Test Tie Breakers or Attrition Methods

Sweepstakes

Drawings

Additional Game/Tests

Revenue Providers

When a test licensee engages a revenue provider with an ability to reach consumers, the revenue provider may not only promote the test they are part of but also promote the one or more consumables resulting from the test. For example, a test provider allows a restaurant to become a revenue provider. The restaurant may directly or indirectly provide revenues. The restaurant may directly provide revenues by paying a sponsorship fee, The restaurant may indirectly provide revenues by advertising the one or more consumables within the test in each of their stores. For example, if the restaurant is a large international chain restaurant, over 20 million customers everyday may be exposed to in-restaurant advertising. During a period of one week, providing each customer visits the restaurant only once a week, the restaurant may have the ability to advertise a tests and related consumables to over 140 million potential test element consumer and test participants. If one percent of the restaurant's weekly customer base (e.g., 14 million) registers to become a test participant as a result of the restaurant advertising the test, another revenue provider, such as a shoe company, may now provide revenues based on a number of participants (14 million) from which to capture data to element response options incorporated into the test by the shoe company. Therefore, the restaurant is an indirect provider of revenues and the shoe company is a direct provider of revenues. In essence a synergy has been created between two revenue providers and consumers.

Television Programming with Embedded Element Controllers

Producers and providers of Television programming with elements receiving a response by and element controller within the programming (think reality show where competitors compete to be hired) may provide viewers with a test wherein the test provider may designate an element controller other than the controller within the programming which may result in a set of one or more winning elements when the controller within the programming and the controller designated by the test provider both determine winning elements.

### Example

A provider of a reality program series based on an element controller determining a regressive number of winning element finalists during each period of the series prior to broadcasting each period may allow viewers to participate in a test with an element controller other than the element controller the series is based on in order to eliminate a chance of fraud.

Current Types of Events and Series with Imbedded Element Response Options and Element Controllers

Currently, several Television series exist are based one allowing an element controller to provide responses to element response options to elements within the program series. These programs allow viewers to observe an imbedded element controller within the program to determine which elements within the program are most qualified with respect to at least one program objective. Many of these programs finish taping prior to allowing viewers to observe the program, wherein viewers are observing an response session that has already been completed. If viewers were allowed to respond to elements within the program after the element controller, some viewers would have the privilege of knowing the element controllers response prior to the broadcast of the program. Therefore, these programs are not capable of allowing viewers to participate in an element response game based on matching the imbedded element controller's responses to elements but are capable of providing other types of element response tests. For example, each existing and future program with an imbedded element controller and element response options may allow viewers to participate in element response tests by designating one or more other element controllers to provide one or more responses to element response options within each program. One of the one or more other element controllers may be comprised of a majority of viewers. For example, a reality television program can allow viewers to participate as if they were the judges. The television network or existing judges may designate a majority of American viewers as an element controller. In an embodiment, the element controller and test participants vote out their least favorite or the least qualified competitor each week. During the broadcast program each week the judges vote out their least favorite competitor. Viewers that are in sync with the majority of other viewers, i.e. the element controller, assign themselves or are assigned a point value for matching the element controller's response. One or more test participants with a highest point total, i.e., in sync with the element controller, at the conclusion of the series, may be selected or qualify to be selected to participate in a future production as a representative of the majority of American viewers.

Utilizing Element from Past Events and Series as Element Response Options for Future Tests

Elements within or inserted into past events and series may be utilized as element response options or response elements for future tests. For example, the owner for the rights to “I Love Lucy” may license an element response test system, method, and format. In an embodiment, the licensee may then extract element response options from one or a series of episodes. In an embodiment, the licensee may then designate an element controller for extracted elements. Participant may then win prizes and awards for responding to extracted elements from past “I Love Lucy” episodes in a manner that is at least similar to the element controller.

### Test System and Element Downloading

Test participants utilizing various observation and response platforms including, but not limited to, ITV, Internet, and Web connected DVD and CD, may be allowed to download test systems and/or element response options.

### Game Show Concept

An element response test/game show may require element controllers to respond to elements while connected to a lie detector.

### Test Levels

Test participants identified as most qualified from one test may be required to participate in a subsequent or series of subsequent tests in order to achieve a manageable number of most qualified participants.

### Response Platform Response Capacity

Prior to a response platforms response capacity is exceeded registering participants may be directed to one or more other response platforms,

Tests with Multiple Audio Platforms

Tests with Multiple Audio and Visual Platforms

Tests with Multiple Visual Platforms

A test utilizing a plurality of observation platforms may have revenue providers incorporating elements into all or specific observation platforms.

An observation platform may afford participants with a code or indicia to allow a participant to identify them self as observer of one or more observation platforms. For example, participants viewing one or more observation platforms may be allowed or required to input a code into a response platform which identifies the observation platform(s) utilized by the participant's. A participant utilizing a specific observation platform, such as DVD, may qualify as a higher or lower level participant with prizes and awards of a higher or lesser value.

Participants proving they utilize a plurality of observation platforms may qualify to receive consideration of a higher value than participants who utilize fewer observation platforms.

Various observation platforms may have one or more coordinated response platforms. A revenue provider may wish to identify a number of participants utilizing an observation platform to which the revenue provider is associated.

One or more response platforms may incorporate one or more element response options unique to the one or more response platforms.

One or more response platforms may be associated with revenue providers unique to the one or more response platforms.

One or more test observation platforms may have a plurality of response platforms each with a different administrator.

### Example

An observation platform may be network Television. Participants may be afforded a choice of available response platforms, In an embodiment, the response platforms are ITV and Internet. The ITV response platform has two specific revenue providers. The two ITV revenue providers are allowed incorporate element response options into the response platform for participants to respond to in conjunction with the element response options presented on network Television. In an embodiment, the Internet response platform has one revenue provider other than the one of the two ITV revenue providers.

Generally, a test observation platform presents elements that satisfy one or more primary objectives. When a plurality of response platforms are available, each platform will generally allow element controllers and participants to provide a predetermined required one or more types of responses to a predetermined required number of elements in order to satisfy the one or more primary objectives. Primary objectives may be determined by one or more businesses or entities associated with the test. One or more response platform incorporating element response options not available on other response platforms may allow participants to receive prizes or awards associated with the elements unique to the one or more platforms. In essence, each response platform may provide a unique test. Participants may be incentivized to seek as many response platforms as possible in order to qualify to win prizes and awards associated with each platform.

### Companion Test

Individuals seeking a companion, mate, or date may wish to participate in companion test. A companion test provider may utilize one or more observation platforms and a plurality of element response platforms to identify participants most in sync with a companion test element controller. Generally the provider will maintain a companion test element controller a mystery in order to ensure participants provide subjective responses to elements Sometime after a response submission deadline one or more mystery controllers are revealed. Participants with a highest point total with respect to being in sync with one or more controllers are presented to the one or more controllers for companion consideration.

### Example

A companion search test provider presents a plurality of element categories and within each category are a plurality of element response options. Element categories include apparel, cloths washing methods, hygiene methods and frequencies, jewelry, child rearing methods, automobiles, shoes, and vacation destinations. In an embodiment the provider designates a plurality of qualified females and qualified males seeking a companion as mystery controllers for elements within each category. In an embodiment, the provider affords a plurality of individuals an opportunity to become companion search test participants. Various criteria are established to identify most suitable companion search test participants for each controller. In an embodiment, the criterion is a fee and background check. Designated mystery controllers and qualified participants are afforded access to one or more test systems. Controllers and participants submit a required type of responses to a required number of elements prior to an element response submission deadline. Each mystery controller and their respective responses to elements are revealed to test participants sometime after the response submission deadline. Controllers are afforded an opportunity to contact participants in sync with their responses.

In an embodiment, the companion test provider may also incorporate element response options into a plurality of tests for individuals and teams not qualified or interested in becoming companion search test participants.

### Mate Search

A example function of an element response game/test is allow an element response game/test provider or administrator to identify participants most qualified to assist, represent, escort, date, marry, or receive recognition or certification for being qualified to assist, represent, escort, date, or marry one or more element controllers of the game/test or one those who are similar to the one or more element controllers.

### Response Cards

Two Part Element Response Cards

An element response test may utilize two part response cards. In an embodiment, the response cards may be purchased at a retail outlet or incorporated into a publication.

In an embodiment, the response cards consist of card A and Card B. Card A and card B are similar. Both card A and card B allow participants to input responses to element response options. In an embodiment, the element response options are presented on one or more Medias.

Card B also allows participants to input a controllers responses to elements and to calculate self assigned point values.

Upon evaluating element response options participants input responses to element into card A and then transfer responses from card A to card B. Participants purchase an element response test ticket with card A prior to a card A response submission deadline. Sometime after the deadline a controllers responses to elements and a qualifying point total are revealed. Participants input the element controller responses into card B. Each participant utilizes the response point calculation system on card B to assign themselves a response point total. If a participants assigned point total meets or exceeds a qualifying point total the participants submits their ticket to receive or qualify to receive consideration.

Participants may be required to accumulate a plurality of qualifying tickets to receive or qualify to receive consideration.

### Test Card Method

Members of one or more societies are afforded access to a two card response system. In an embodiment, the two card response system may be printed or electronic. Each card, card A and card B, provides an area representing a plurality of elements associated with an ERG/T. Participants utilizing the two card system and method are required to mark areas on card A representing a required number and type of responses to a required number of elements. Participants are then required to record responses made on card A onto card B, Participants are required to submit card A to the ERG/T provider prior to a card A submission deadline.

In an embodiment, the provider receives responses from at least one controller and identifies A cards that meet or exceed a qualifying number of matches or point total.

In an embodiment, the provider affords participants access to the at least one element controller's responses and informs participants of the qualifying number of matches or response point total.

Participants compare the controller's responses to the responses they recorded on card B which is identical to their responses submitted to the provider on card A.

Participants with a qualifying number of matches or point total are required to submit card B or communicate their qualifying number of match or point total prior to a deadline,

In an embodiment, the provider compares submitted B cards or communicated match or point total with qualified A cards. Winning or most qualified participants are contacted or posted.

In an embodiment, the two card response system and method may have a code or key.

### Response Card Test

A response card test may include both a response test and a lottery type game, wherein participants may be required to have a qualifying test score to win the lottery or may be required to win the lottery to receive test consideration.

### Card Test Data

Data captured from an element response card test may allow a test provider to designate a majority of card participants as an element controller for the card test and/or one or more other types of tests to which the card test is associated.

### Lotto Card Type Games

Lotto type games allow an element response period provider or associated element response game administrators to utilize elements presented during the period as lotto type game elements. In an embodiment, the provider utilizes one or more observation platforms to present a plurality of elements from one or more categories to viewers. Generally, observation platforms may be Television, video (DVD, CD, etc.), or printed material. Viewers are afforded electronic or printed material to respond to a required number of presented elements. An example of an electronic platform may be interactive Television. An example of printed material may be a publication and a card picked up at a retail outlet or received by mail. A viewer may or may not be required to register to become a participant.

In an embodiment, the following is an example of an element response lotto type game not requiring participant to register.

An element response game provider presents a plurality element response options on printed material at a multiplicity of retail outlets. In an embodiment, the printed material also identifies each element by a number. In an embodiment, the printed material also identifies an element controller. A lotto type card with numbers corresponding to each element on the printed material is attached to the printed material or is made available at the retail outlet location. Participation instructions are placed on the printed material and/or the card. Participants are instructed to rank (respond) a required number of elements and each time a ranking matches the element controllers ranking the participant is awarded a point value. Each time a ranking for an element is one rank off from the controller the participant receives a point value less than a matching point value. Each time a ranking for an element is two ranks of from the controller the participant receives a point value less than a one rank off point value. A date and time the element controllers responses will be revealed is provided. A date and time of a response submission deadline is provided. In an embodiment, the printed material and/or card utilize an element response point calculation system. The system allows a participant to determine a point value based ranking that are matching, one rank off, or two ranks off from the controllers responses. A participant with a perfect score receives a prize or award of a highest value. A participant with a less than perfect score receives a prize or award of a lesser value than a perfect score. A plurality of prize or award levels may exist. (see lotto type card FIGS. 15A thru 17 F.)

The above example may also utilize various observation platform with or without printed material. For example, element response period available on Television or video may allow viewers to evaluate element response option more effectively than one or more images of each element presented on printed material.

In an embodiment, the provider also affords access to one or more to type cards with numbers representing or corresponding to the elements presented on the printed material. A viewer of the elements on the material is afforded the opportunity to respond to a required number of the elements before a response deadline.

### Test Requiring Element Matching or Pairing

A test may require one or more element controllers and participants to match or pair elements. Each time a participant matches or pairs one or more elements to one or more other elements in a manner that is at least similar to an element controller the participant may be assigned a point value.

### Response Platform

An element response platform may have a limited participation capacity. A response platform may afford priority to targeted participants. A number of participants targeted or not, may exceed a response platform participation capacity. A predetermined number of participants may be allowed to register when registration is required or necessary. When the predetermined number is met those who wish to become participants may be directed to one or more alternate response platforms.

Viewers desiring to utilize a specific response platform may be directed to one or more alternate response platforms when the desired platform has reached a registration capacity.

A response platform targeted at specific viewers/consumers may provide a registration period prior to allowing non targeted viewers/consumers to register.

Generally, at least one response platform is utilized by a provider for element controllers to utilize when at least one element controller is a percentage of participants or a percentage of a segment/graphic of participants.

Generally, a test provider will garner the use of at least one high response capacity response platform for at least one element controller. When the at least one element controller is a percentage of participants or a percentage of a segment of participants the provider may afford future controllers a time period in which to register. Once the time period has expired, non targeted viewers/consumers may be afforded the opportunity to register if the response platform registration capacity has not been exceeded.

### Initial Response Resubmission/Communication Method

A qualifying score may be announced during a final phase of a test period or a final phase of a series of test periods. Participants with a qualifying score may be required to communicate their score to an a provider or administrator in order to receive consideration.

Element response test participant may be required to submit or communicate a predetermined one or more types of responses to a predetermined number of elements multiple times.

First participants are generally required to submit initial responses to elements prior to a response submission deadline. When

By requiring qualified participants to communicate a qualifying score, participants must have access to the controller's responses or the controllers response information subsequent to the controllers response submission deadline and must calculate response point totals.

This method of first submitting responses prior to a response submission deadline and communicating qualifying point totals requires participants to interact with elements on a deeper level than simply submitting responses and waiting to receive consideration when consideration is warranted. This method not only allows participants to identify themselves as being in sync with one or more element controllers but identifies participants who are willing to perform a series of required tasks which may be required by participants selected to assist or represent one or more element controllers of which they are in sync.

### Additional Task Requirement

In an embodiment, the test provider may or may allow participants to assign themselves point values or assign point values to participants for submitting correct responses. Participants who identify themselves as most qualified to receive consideration may be required to perform one or more tasks before consideration is offered. In an embodiment, the one or more tasks may be to respond to a plurality of elements, which may or may not be the same elements utilized in the test but may be controlled by the same one or more element controllers the participant claims to be in sync with. When products or consumables or elements of products or consumables are utilized as test elements, participants required to communicate a qualifying score may achieve a deeper level of element knowledge and attachment which may also result in higher percentage of element attraction and potential consumption.

The above method may be utilized when a test allows a high number of participants to be recognized as qualified to be selected to receive consideration. Participants qualified to be selected to receive consideration may be required to perform one or more additional tasks or participate in or more addition tests that identify consideration recipients.

### Initial (Redundant) Response Resubmission Method

An ERG/T provider may require participants to submit responses to elements on a plurality of element response platforms. By requiring response submissions on a plurality of element response platforms the provider and participants are afforded a built in back up in case of technical difficulties on one platform.

A test provider may allow or require test participants to provide responses to elements prior to an initial element response submission deadline and prior to an initial element response re-submission deadline when the participants initial response submission qualifies the participant to receive consideration. In an embodiment, the provider is not required to identify participants initial response(s) as either correct or incorrect until a participants re-submits the first response based-on the participant identifying the first response as correct.

### Example 1

Ten million tests participants submit responses to elements. A test provider or administrator would normally identify which of the ten million participants submitted a number of correct responses in order for participants to receive or qualify to receive consideration. By requiring participants to re submit their responses only if their responses are determined by themselves to be correct or within a correct range, the administrator is not required to labor with initial responses from the ten million participants but a number which may be far less. In essence, this method of redundant response submissions requires participants to do a percentage of work the administrator would usually be required to perform when utilizing conventional response submission methods.

### Example 2

Members of one or more segments of one or more societies are afforded an opportunity to participate in an element response test. Members are afforded access (Fee or free?) to one or more registration platforms. Registered and non registered participants are afforded access (Fee or free?) to at least one element response recording and response point calculation system. A test provider/administrator presents a plurality of element response options on one or more Medias (Free or fee?). Participants are instructed to record one or more types of responses to a number of elements. Participants are instructed to visit one or more response submission platforms (Free or fee?) to submit responses prior to a response submission deadline A and re visit the one or more response submission platforms (Free or fee?) to re submit responses prior to a response re submission deadline B when a qualifying response point total is calculated. In an embodiment, the one or more response submission platform administrators receive participant's response submissions prior to the response submission deadline A. In an embodiment, the one or more administrators store participant's submitted responses. Provider announces/posts correct responses and one or more qualifying point totals on one or more Medias. Participants calculate response points to identify a qualifying point total. Participants with a qualifying point total re visit one or more response submission platforms (Free or fee?) to re submit responses prior to the response re submission deadline B. An administrator identifies participants re submitted responses as either qualified or unqualified. Administrator compares each participant's qualified re submitted responses with the participants previously submitted responses. Participants are identified as qualified to receive consideration or qualify to be selected to receive consideration when qualifying re submitted responses match previously submitted responses,

When a plurality of response combinations are possible to achieve a qualifying primary, alternate, or ancillary game or test score the game or test provider or administrator may not be able to effectively post or announce the possible combinations of responses that may achieve a qualifying score. In an embodiment, the provider or administrator may allow or required game and/or test participants to utilize response point calculation systems one, two, or three in order for each participant to determine when a qualifying point total is achieved.

A provider or administrator may be directly or indirectly associated with an element response period with no primary game or test. An administrator may be a friend, school mate, or office co-worker.

### Example

An element response period is made available on network Television. Viewers are afforded access to one or more response point calculation systems. A percentage of viewers organize ancillary tests associated with the period. Participants of each test elect or allow an administrator to receive responses to elements prior to the element response period element controller's response submission deadline. In an embodiment, the administrator stores each initially submitted response. When the element controller's responses are revealed each participant calculates response point totals and re-submits their initial responses and the calculated point totals to their respective administrators.

In an embodiment, the administrator identifies participants with a self assigned highest point total attached to re-submitted initial responses. The administrator recalculates each re-submitted response with a highest point total. When each participant's re-submitted responses with a highest point total are determined by the administrator to be calculated correctly, the administrator compares the participants correctly calculated highest point total re-submitted responses with the participant's stored initially submitted responses. When a participant's re-submitted responses with a highest point total match stored initially submitted responses the participant is determined to be most qualified compared to all other participants with a lower point total.

### Honor Response Submission Method

Afford viewers and participants access to honor response and point calculation systems (printed and electronic). Winning participants may be asked to present their archived data during a documentary production showing their chosen method of recording responses and point data which may promote the use of honor response and point calculation systems. These systems when compared to response data capture may be utilized by participants to present to employers or business partners to show their innate ability to match responses with one or more element controllers.

Initial Response Re-Submission Method (added Sep. 18, 2004)

A plurality of at home test participants re-submitting self determined consideration qualifying initial response submissions are selected for initial response re-submission consideration qualification verification. A plurality of selected test participant's response re-submissions verified as consideration qualified are selected for initial response comparison verification. Test participants satisfying the initial response comparison verification receive or qualify to be selected to receive consideration:

### Viewer Interactive Commercial or Advertisement

A test provider may present a plurality of elements available to be incorporated into a commercial/advertisement as test elements. In an embodiment, the test elements may be provided by a commercial element provider. In an embodiment, the commercial element provider may also be a provider of test revenues. In an embodiment, the test provider or element provider may designate one or more commercial element controllers comprised of a majority of viewers or participants or a majority of one or more segments of viewers or participants. In an embodiment, the one or more controllers may be instructed to select one or more of the commercial elements from the plurality commercial elements that are most suitable to be incorporated into a commercial production based in part upon one or more defined commercial objectives.

Therefore, when an element controller of elements incorporated into a commercial is comprised of viewers or element response test participants the commercial is “Viewer Interactive.”

When one or more test participants in sync with one or more of the above commercial element controllers are selected to participate in a pre production of a future test to represent the viewers or participants they are proven to be in sync with as commercial element casting directors for the test and one or more designated commercial element controllers of the elements cast by selected viewers is comprised of viewers the future commercial may be referred to as a “Viewer Controlled” commercial.

In an embodiment, the term commercial and infomercial may be synonymous.

### Compelling Response Tests

Incorporate elements into a game/test to attract a highest number of viewers and participants.

Designate a majority of participants as an element controller.

Designate a celebrity as an element controller.

Television and Film Audition and Casting Game

An element response game/test may incorporate audition elements. Main audition elements may be entertainers or entertainer hopefuls. Secondary audition elements may be actions, activities, scenarios, or situations for entertainers or entertainer hopefuls to perform during an audition. Secondary elements may also be a sponsor's products or services for entertainers to interact with during an audition.

In an embodiment, the main audition elements, entertainers and entertainer hopefuls for example, may be single session multi response elements.

In an embodiment, the audition element may be multi session multi response elements.

Element Response Game/Test Board

Viewers of element response periods and viewers and participants of element response tests may be afforded an opportunity to access a game/test board or element response board game. In an embodiment, the board may be similar to a monopoly board whereas the board is packaged with a plurality of board pieces. In an embodiment, the board pieces may represent each board player. Board players position pieces according to responses provided elements presented on a period or test observation platform.

Playing or testing pieces representing each participants and an element controller may be utilized. In an embodiment, the board may be used by a group of viewers or test participants to arrive at a group response consensus.

### Response Wagering/Gaming or Element Response Wagering

Ancillary wagering game platforms associated with element response periods may include, but are not limited to:

Telephone

ITV

SMS

Internet

Single Event Retail Response Card Combination lottery

Multiple Event Retail Response Card Combination Lottery

Single Event Retail Keno

Multiple Event Retail Keno

Single Event Sweepstakes (printed and electronic)

Multiple Event Sweepstakes (printed and electronic)

Single Event Pool (printed and electronic)

Multiple Event Pool (printed and electronic)

Printed Element Response Test Systems

A printed element response test system may be made available in magazines, newspapers, periodicals, cards, printed from the Internet, and printed from ITV.

Combining Phase 1 and Phase 2 into One Session

A three phase element response period or test begins with a period initiation phase and ends with a period result or objective accomplishment phase.

Generally, during phase one, the period initiation phase, a plurality of single and multi response session elements are presented. At least one element controller and game participants (ancillary game participants when the primary element response period has no game) submit a predetermined one or more types of responses to a predetermined number of elements prior to an element response submission deadline.

During phase two the element controller's one or more responses to a number of elements are revealed.

In an embodiment, the controller's responses to phase one elements directly or indirectly determine one elements at least one phase two element response option.

Generally, the at least one phase two element response option is a multi response session element from phase 1 made available by the element controller to receive one or more responses during another response session, hence the term “multi response session element.” In an embodiment, the at least one element response session element presented during phase two may or may not be attached to a single response session element from phase one.

When the at least one phase 2 element response option is attached to one or more single session element response option from phase one or attached to one or more other elements presented during phase two the attached elements will generally influence the number and type of responses the at least one multi response session element will receive during phase two.

The above example requires a provider to coordinate at least one multi response session element from phase one to be available to receive at least one response during phase two.

Phase one and phase two may be combined allowing the phase one multi response session elements to receive two sessions of one or more responses during one sitting.

This is accomplished by videoing or taping all phase one multi response session elements being influenced by all phase one multi response session elements. Participants would be required to provide an initial response to a plurality of multi response session elements without single response session element influence. Participants would then be required to identify their plurality of multi response session elements being influenced by the attached single response session elements. Participants would then be required to submit initial responses to multi response session elements and subsequent responses to initially responded to elements prior to a single sitting multi response session element response deadline.

### Example of a Single Sitting Multi Response Session.

Sitting One—Session One

A plurality of single and multi response session elements are presented.

An element controller and game participants record a required number and type of responses to a required number of elements.

Sitting One—Session Two

All multi response session elements are presented with attached single response session elements from phase 1, and/or one or more new attached elements.

In an embodiment, the controller and participants refer to their session one record and make a session two record in relationship to the elements they may or may not of responded to during session one.

If session one required controllers and participants to respond positively to a required number of multi response session elements during session one, the elements receiving the positive session one response will generally be the elements they will respond to during session two.

If session one required controllers and participants to respond negatively to a required number of elements during session one, the elements receiving no negative response will be the elements they are required to provide a response during session two.

Therefore, when a controller and participants are required to record a negative response to a required number of elements during session one, the elements may not be referred to as multi response session elements due to the fact that a negative response to an element during session one by an element controller may exclude the element from receiving a response during a subsequent session.

A provider may also utilize a live broadcast to combine phase 1 and phase 2 into one sitting by making all element response options from phase 1 available to be incorporated into phase 2.

### Example

A plurality of element response options are presented during phase one of a live or live to tape broadcast.

Controllers and participants are instructed submit a required number and type of responses to a required number of elements after each element is presented during the broadcast.

Controllers and participants are required to submit their responses to elements before a response submission deadline during the broadcast.

When the required response is a positive, the elements receiving the positive response from the element controller will become element response options during phase 2 during the live broadcast.

When the required response is negative or eliminating, the elements receiving the negative response from the element controller will be excluded from becoming an element response option during phase 2 and the elements not receiving the negative or eliminating response will become element response options during phase 2.

Keep in mind, elements indirectly made available by an element controller to become element response options during a subsequent phase/session within a period may only be referred to as multi response session elements when another phase/session is incorporated into the period where elements receiving a positive response and not eliminated from the period are made available during the subsequent phase/session to receive a response.

### Innate Skill

An example element response game/test objective is to identify participants with cognitive or innate skill to identify elements the element controller finds most appealing or suitable for a particular function, objective, or criterion.

A participant with the ability to respond to a plurality of elements during one phase in a manner at least similar to an element controller, when the participant's responses are made without considering the element controller, has what may be considered as an innate response ability.

A participant with the ability to respond to a plurality of elements during a plurality of phases in a manner at least similar to an element controller, when the participant's responses are made without considering the element controller, has what may be considered a higher level of innate response ability when compared to a participants with the innate ability for one phase.

### Innate Skill

A test participant with an ability to match responses with an element controller over a period of time is considered to have an innate skill.

In an embodiment, the odds of a participant being in sync with an element controller over a period of time are contradictory to a game of chance.

### Skill Versus Chance

An element response game/test participant providing random responses to elements may be considered a participant in a game of chance.

### Innate

### Cognitive

An element response game is a game of skill based on an innate or learned skill. Participants may inquire to entities comprising an element controller when the element controller is a segment of a plurality of entities accessible to the participant. In an embodiment, the participants may be provided information based upon the element controller. Participants may be provided or seek out past responses by an element controller or entities

An element response game or a category or sub category within a game may have a secret or mystery element controller. A participant is left with no information to base responses to elements. In an embodiment, the participant may provide subjective responses to elements. A participant receiving a highest point total may have inherent responding to elements that match or are at least similar to the mystery controller. May have inherent response instincts

Participants receiving a highest match or point total of a plurality of periods within an element response game have a proven ability

Element response options for an element response period within an element response game may be limited to a number not sufficient to allow the most qualified participants to rise above other participants. A segment or a majority of participants may achieve a highest point total for a period. But, when a plurality or a series of periods exist the number of participants with a high accumulative point total will lesson with each period. Therefore, when the number of element response options for a period are limited to a number insufficient to identify the most qualified participants a series of period may be most suitable.

### Example

An element response period within an element response game presents 10 element response options available to receive one or more evaluation response based on one or more evaluation criterion and a ranking response based on a combined evaluation total. An element controller and participants are required to evaluate each element one a 1.0 to 10 scale and rank 5 elements based on evaluations. In an example, the total number of responses is 15, 10 evaluation responses and 5 ranking responses. In an embodiment, the number of participants is 10 million. Out of 10 million participants an estimated 100,000 participants may provide responses that match the element controller. The 100,000 participants may be entered into a sweepstakes or drawing. The 100,000 participants may receive an award. The 100,000 participants

During a subsequent period another 100,000 participants may receive a highest point total with 50,000 participants receiving a highest point total for the two periods combined. At the end of 10 periods and by decreasing the number of most qualified participants by 50% after each period

Generally, an element response game provider may awards one or more all participants with a highest point total

One or more additional game/test may be administered to participants from each period or a series of period with a highest point total until a number of most qualified participants is achieved that is suitable to the provider.

In the UK a particular type of wagering game pays out to the highest number of participants ever.

A gaming platform more technically advanced than other platform may be a main game platform offering element controller and element response game participant to interact

### Example

An element response period is broadcast on FOX cable Television. One or more element controllers and element response game participants are

Participants may utilize DirecTV, Internet, Telephone, SMS, or future response platforms. The DirecTV participant may receive a higher value award than participants utilizing other response platforms.

Therefore, participants utilizing other platforms are incentivized to subscribe to DirecTV not only to win higher value awards than other platforms but to participate as element controllers, casting directors, and judges.

### Consensus

When a game controller (element controller) is accessible, such as a majority of game participants, participants may approach a number of participants to receive a majority consensus.

Imagine you are approached by a person at a grocery store asking you to respond to a number of elements posted on a printed element response test system. You may be one of a plurality of individuals the person is approaching to acquire a consensus regarding test elements.

Subsequent Product Participation and/or Interaction

Embodiments provide viewers and consumers of entertainment products an opportunity to receive consideration for participating in the casting and auditioning and casting processes for the products and at times may enable the viewers and consumers an opportunity to participate in and/or interact with the product they helped to create (Think Video, TV, Film, Print, etc.

### Most Qualified Test Participant Re-Testing

Test participants with a highest score from one test or test series may be required to participate in another test or test series in order for the test provider to determine most qualified test participants or to achieve a more manageable number of qualified test participants when the number of qualified test participants is unmanageable.

### Revenues

Category or Sub Category Space Sales

Category or sub category space may be sold or leased to businesses wishing to gather marketing data and build one to one relationships with consumers from all segments of domestic and international societies.

Test participants may be offered an opportunity to enter preferences into a preference survey or enter answers into a questionnaire within one or more categories that may constitute a different game level offering a higher or lower value award which may be more or less desirable for different segments of a society. Participants may be required to provide information not related to a game but may be related to a business associated with the game.

Test participants may have a duel role when an element controller is a segment of test participants or a percentage of a segment of test participants.

### Test Data Backup

When a primary test provider allows one or more ancillary tests to exist the provider may announce winners, most qualified participants, or a highest point total from the primary test and at least one of the one or more ancillary tests. When technical and/or production difficulties arise with respect to the primary test or one or more of the ancillary tests the provider is able to announce or post winners, most qualified participants, or a highest point of one or more of the tests without technical or production difficulties.

When technical or production difficulties occur a provider may distribute points equally amongst participants. In an embodiment, the provider may allow ancillary test participants to carry over points from one platform to another when the one platform is not functioning properly. Therefore, participants are provided a method of backing up points and data.

Information from Outline

Element Response Game/Test Participant Consideration

Sweepstakes/Drawing Entering

Employment Opportunities

Contestant Opportunities

Celebrity Judge Opportunities

Producer

Casting Director

Awards

Prizes

Certification

Recognition

Acknowledgement

Controller Assistants

Consumer Assistants

Controller Representatives

Consumer Representatives

Becoming a Controller

Replacing a Controller

Element Response Period Provider

Contract

Employment

Production Participation

Production Preparation Participation

Element Response Game/Test Provider

Contract

Employment

Production Participation

Production Preparation Participation

Revenue Provider

Contract

Employment

Production Participation

Production Preparation Participation

Industry Employment

Business Employment

Frame

Fortune

Frame and Fortune

Element Response Game/Test Points

Match Response Points

One Off Response Points

Two Off Response Points

More Than Two Off Points

Match First Place Element Points

A higher number of elements are determined to be qualified to receive a first place response than a response less than first place.

Match Less Than First Place and Higher Than Last Place Element Points

A higher number of elements are determined to be qualified to receive a second or lower place response but higher than a last place response.

Match Last Place Element Points

A higher number of elements are determined to be qualified to receive a last place response than a response higher than last place.

Single Level [Phase] Participation Points

Single Phase Participation

No Revenue Provider's Element Responses

With Revenue Provider's Element Responses

Multi Level [Phase] Participation Points

Free Points

Captive Points

Response Methods

Entity or Entities Comprising Element Controller

### Preferred Embodiments

### Response Game/Test Elements

In an embodiment, the phrases element response options, response elements and the term elements may be synonymous and generally identify elements made available to receive one or more types of responses from:

Element controllers during element response periods with no primary game or test;

Participants of ancillary element response games and tests associated with the element response period;

Element controllers during primary element response games and tests; Participants of primary element response games and tests;

Element controllers of alternate or secondary element response games and tests; Participants of alternate or secondary element response games and tests;

Element controllers of ancillary element response games and tests; and Participants of ancillary element response games and tests.

An element is anything within the universe that can receive a response or be responded to. In an embodiment, the types of element response options incorporated into an ERP or ERG/T are generally determined by an ERP or ERG/T provider according to one or more objectives of the period or game/test. A period or game/test revenue provider may also incorporate elements into the period or game/test of which may be directly or indirectly generated. In an embodiment, the elements a revenue provider incorporates into a period or game/test may or may not be consistent with the period or game/test provider's objectives.

Generally, during a period or game/test a plurality of elements made available prior to the period or game/test are presented Period element controllers and game/test element controllers and participants are instructed to provide one or more types of responses to a number of elements presented prior to an element response submission deadline. In an embodiment, the instructions may require element controllers and participants to provide a response to all or less than all elements presented. In an embodiment, the number of elements required to receive a response is generally predicated by the period or game/test provider or a period or game/test revenue provider.

When a period exists with no game/test the responses to elements are received by one or more element controllers only. Therefore the element controller is instructed to provide responses to elements.

When a period is associated with one or more ancillary game/tests the participants of the ancillary game/test receive the same response instructions by the provider of the period or administrator of the game/test as the element controller receives. Entities comprising an element controller and game/test participants may be one in the same. When entities comprising an element controller and game/test participants are the same, element controllers and participants will receive the same response instructions. In an embodiment, the instructions are the same due to the fact that participants assign themselves or are assigned by a game/test provider or administrator a point value each time a response to an element matches or is at least similar to a response received a percentage of entities or a percentage of one or more segments of entities comprising an element controller.

Ancillary game/tests administrators may be allowed by a primary game/test provider or period provider to incorporate additional elements into the ancillary game/test which may allow the ancillary game/test administrator ancillary game/test revenue provider to achieve one or more objectives. When an ancillary administrator is allowed to incorporate elements for ancillary participants to respond to, the ancillary elements may or may not have a designated controller. When the elements have no controller the ancillary administrator may require ancillary participants to provide one or more types of responses to a number of elements with no controller in order to the participants to qualify to be assigned points for correctly responding to elements with a controller. An ancillary administrator may be allowed to designate at least one controller for the incorporated elements which may allow ancillary participants to assign themselves or be assigned a point value each time a response to an administrator incorporated element matches or is at least similar to an ancillary administrator designated element controller. In an embodiment, the ancillary administrator may also provide various other types of games or tests in conjunction with the element response period. In an embodiment, the above methods may also be utilized by ancillary game/test administrators associated with primary element response game/tests.

The following are examples of, but not limited to, types of elements an element response period, game, or test provider and revenue providers to each may incorporate into an element response period, game, or test respectfully.

Surveys

Polls

Questionnaires

Most Preferred Type

Least Preferred Type

Advertising Related

Marketing Related

Names

Titles

Designs

Logos

Slogans

Audio Type

Visual Type

Audio and Visual Type

Audio/Visual Type

Touchable

Tangible

Sensory

Sixth Sense?

Music

Lyrics

Beats

Instruments

Lyrical compositions

Poetry

Artwork

Revenue Related

Current Element Replacement Options

Television programs

Scenes or Elements within a Television Program

Films

Scenes or Elements with a Film

Video

Games

Print

Commercials

Advertisements

Music

Statistics

Sociology

Psychology

Research

Element Response Options

An element response option response element may be anything that can be incorporated into an element response period, game, or test. Generally, the term element response option refers to one of a plurality of elements made available to receive a response and a response element may refer to an element made available to receive a response. The terms “element response option” and “response element” described herein may be synonymous. Elements incorporated into a period, game, or test, may be referred period, game, or test elements respectfully.

Element response options or response elements may also be responses.

For example, an element response period provider may presents to entities comprising an element controller a plurality of response options or response types to a method of, a way, or how one or more elements were integrated into or responded to with respect to integration into a production. Therefore, the period element is a response that may require a response.

Element response options may be tangible, visual, and/or audible. Element response options may be types of thoughts, opinions, and/or evaluations. An element response option may be a response to a response. An element response option may be a response to a response or a method.

The following are but a few types of elements that may be incorporated into an element response period, game, or test.

### Event Elements

Products

Product accessories

Product designs

Product accessory designs

Services

Service variations

Competition Elements

Contestant options (add confidence level)

Persons

Characters

Character designs

Products

Product designs

Future products

Future product designs

Services

Service supports

Future services

Future service supports

Activity options

Action options

Scenario options

Scene options

Set options

Product options for integration

Product integration options

Responses to product integration

Product options for placement

Product placement options

Responses to product placement

Product options for interaction

Product interaction options

Responses to product interaction

Services options for integration

Service integration options

Responses to service integration

Service options for placement

Service placement options

Responses to service placement

Service options for interaction

Service interaction options

Responses to service interaction

Evaluate selected contestants

Persons

Characters

Character designs

Products

Product designs

Future products

Future product designs

### Services

Service supports

Future services

Future service supports

Rank selected contestants

Persons

Characters

Character designs

### Products

Product designs

Future products

Future product designs

### Services

Service supports

Future services

Future service supports

Evaluate selected activities

Rank selected activities

Evaluate selected actions

Rank selected actions

Evaluate selected scenario(s)

Rank selected scenario(s)

Evaluate selected scene(s)

Rank selected scene(s)

Evaluate selected set(s)

Rank selected set(s)

Evaluate selected (interactive) products

Rank selected (interactive) products

Evaluate selected (placement) products

Rank selected (placement) products

Evaluate selected (interactive) services

Rank selected (interactive) services

Evaluate selected (placement) services

Rank selected (placement) services

Evaluate sponsor's selected (interactive) products

Rank sponsor's selected (interactive) products

Evaluate sponsor's selected (placement) products

Rank sponsor's selected (placement) products

Evaluate sponsor's selected (interactive) services

Rank sponsor's selected (interactive) services

Evaluate sponsor's selected (placement) services

Rank sponsor's selected (placement) services

Audition elements

Evaluation elements

Award show elements

Game show elements

Political elements

Corporate elements

Business elements

Economic elements

Manufacturers elements

### Products

Product designs

Survey Questions

Survey Question options

Answers to Survey Questions

Responses to Survey Answers

Element Responses Options (ERO)

Multi Response Elements

Single Response Elements

Contestant options

Contestants

Character options

Characters

Activity options

Activities

Product options

Products to be interacted with

Products to be placed

Products to be embedded

Service options

Services to be interacted with

Services to be placed

Services to be embedded

Award nominee options

Award nominees

Applicant options

Applicants

Political issue options

Political issues

Political proposition options

Political propositions

Political resolution options.

Political resolutions.

Political propositions

Propositions.

Business Tasks

Sets

Scenes

Scenarios

Situations

### Element Interaction/Consumption

A game/test may allow or require participants to view in person, interact with, or purchase elements for evaluation and subsequent response.

Element viewing in person, interaction, or purchasing may be a prerequisite to a higher level of participation when compared to viewing still images or element videos made available on one or more element evaluation or observation platforms. This method of a higher level of participation may require a participant to prove an element was viewed in person, interacted with, or purchased. A game/test may require participants to obtain or access one or more categories of element response options. An ERG/T may allow a participant to advance to a higher level of participation when the participant proves one or more obtainable or accessible elements have been obtained or accessed.

A required number of elements may require one or more responses according to one or a combination of senses.

One or more elements from a plurality of elements may require one or more responses according to how the elements look, feel, smell, sound, and/or taste when a controller and participants are afforded reasonable access to see, touch, smell, hear, and/or taste the plurality of elements. In essence, element response options or response elements may be things that require a controller or entities comprising a controller and participants to utilize one more senses in order to provide one or more required responses to a required number of the plurality of elements

When accessing or obtaining each of a plurality of elements is unaffordable for all members of a society, member that can afford to access or obtain each element or prove they accessed or obtained each element may qualify to participate in an ERG/T at a different or higher level than other participants.

Participants may be allowed or required to form teams which may make accessing or obtaining a plurality of elements more affordable or reasonable.

Elements required to be seen, touched, heard, smelled, or tasted may be made available for purchase or for free at an accessible location or destination.

As humans become more advanced other senses not currently or commonly utilized may be incorporated into a future ERG/T.

### Terms

In an embodiment, the terms rank, grade, and evaluate may be synonymous.

### Corporate Elements

### Example

Coke-Cola prepares to replace 50% of its board members. Shareholders are allowed to select two or more future board member hopefuls from a plurality of future board member hopeful options that qualify to compete to fill one or more board member seats. Shareholders are then allowed to choose one or more elements (activities) for their selected board member hopefuls to perform, discuss, or debate in order for share holders to determine which selected board member hopefuls qualify to fill the one or more available board member seats.

### Element Categories

When a plurality of secondary elements are required to influence or satisfy a primary element evaluation criterion one or more categories of a plurality of secondary evaluation elements are generally needed for one or more controllers to choose from in order to determine which are most suitable according to the primary element evaluation criterion

### Element Preparation

An ERP or ERG/T may incorporate elements requiring preparation or production. In an embodiment, the elements may be entirely or partially prepared or produced in order for a controller and participants to provide a sufficient response according to an ERP or ERG/T objective. A provider of elements requiring preparation or production will generally dictate whether a product determined by an element controller to be a most suitable element from a plurality of elements may be produced and ready for distribution prior to being presented to receive a response. For example, an ERG/T licensor utilizing music elements may designate an element controller for the music elements to be a music performer. In an embodiment, the music performer will generally complete one or more songs. In an embodiment, the performer may produce variables to the one or more completed songs as element response options. Although the performer has already decided which elements from the variables are within the completed songs. Participants are then presented with the music variables or options. Participants that choose the same elements for the songs that the performer/controller has already incorporated into the produced songs or final product are identified as most in sync with the performer/controller. In an embodiment, the songs are then released to the public for consumption within a shortest time possible. A percentage if not all participants in sync with the performer/controller as well as music consumers that may or may not have participated in the event and may or may not be somewhat in sync with the performer/controller may also consume the performer's/controller's product.

When a designated controller for the songs elements is a majority of all participants or a majority of a segment of participants the performer may prepare or produce elements to be incorporated into the songs according to the desires of the controller. In an embodiment, the final songs may be partially completed and may take more time to release than when the songs are completed but less time than when the songs are not partially completed and ready to become completed songs.

As stated within this document/application, these methods of pre-producing songs and song options are suitable for simultaneous World wide release of music according to the desires of element controllers around the world.

These methods of pre-produced products and product options may be applied to all types and themes of productions, including but not limited to; Television, film, video, video games, publications, products, productions etc.

A product may include an entity or a plurality of entities.

An element controller may determine which elements from a plurality of elements that will become game/test elements.

A example game/test objective is to allow an element controller to determine one or more element response options from a plurality of element response options are to be incorporated into a product or become a product ready for consumption as a result of a game/test period or game/test series.

A product may be manufactured or produced prior to a game/test utilizing elements comprising the product a game/test element response options when the product manufacturer or producer, or associate of the manufacturer or producer, are predetermined to be designated as the element controller of the element response options comprising the product.

### Phrase/Sentence Insertions or Completions

Game/test participants may be required to insert a word or phrase into an uncompleted phrase or sentence, provide answers, opinions, and/or solutions.

### Element Category Themes

During each phase prior to a final phase of an element response period or an element response test period a plurality of elements made available to receive at least one response each are presented. In an embodiment, the plurality of elements may consist of various themes. Theme elements may be placed into element categories or sub categories with respect to a theme.

### Examples

A plurality of an element response test revenue provider's placement product options may be incorporated into a revenue provider's product placement category.

A plurality of contestant options may be placed into a contestant category.

A plurality of contestant activity options may be placed into a contestant or competition activity category.

A plurality of a sponsor's interactive product options may be placed into a sub category of a competition activity category whereas the interactive products are made available for an element controller to select one or more of the products for contestants to interact with during a competition.

Free Point Element Responses

When a plurality of free point elements are incorporated into an element response test participants may or may not be required to provide a response to one or more of the free point elements.

When participants are required to respond to free point elements the response may allow participants to acquire or receive point values for correct responses to element controlled by an element controller. In an embodiment, the free points and correct response points may be added to achieve a point total.

When participants are not required to respond to free point elements the participants may be entered into a higher level of test participation for responding to a number of free point elements. A participant may even be entered into yet an even higher level of test participation for responding to a highest number free point elements.

Various elements may or may not require participants to provide a response but when responded to may allow a participant to acquire or receive point values for correct responses to elements controlled by an element controller.

When elements such as surveys or questionnaires incorporated into a test by a revenue provider the test provider's elements may be free point elements, higher level elements, or captive elements. Captive elements are elements a test participant is required to respond to have order to acquire or receive point values for correct responses.

Various types of element response options may be incorporated into a test which afford participants an opportunity receive consideration or consideration of a higher value.

### Single Response Session Elements

One or more phase one single response session elements may be a revenue provider's products or services. At least one of the revenue provider's products or services receiving a positive response from the element controller or not receiving a negative response from the element controller may be integrated into phase two.

Single response session elements may be part of a revenue provider's survey or questionnaire.

New single response session elements may be presented during phase two. In an embodiment, the new single response session elements may also be a revenue provider's products, services, or survey questions. Newly introduced single response session element may be incorporated into phase three.

When a revenue provider's elements are integrated into an element response test the revenue provider may utilize the same or a different controller for the revenue provider's elements. Participants in sync with the revenue provider's controller may receive consideration directly from the revenue provider. Participants in sync with both the test provider's element controller and the revenue provider's element controller may receive consideration based on being in sync with both controllers.

Viewers most in sync with the test provider's or revenue provider's element controller may be selected or qualify to be selected to assist or represent the element controller in a future production or pre production.

In an embodiment, the future production may be a future test production. Participants selected to participate in a future production may represent or assist an element controller they are most in sync with as a celebrity judge of elements presented during the future test.

In an embodiment, the future pre production may be a pre production of a future test. Participants selected to participate in the future test pre production may represent or assist an element controller they are most in sync with as a production executive or casting director.

Participants most in sync with an element controller may participate in a future test as test elements.

### Free Point Elements

During phase one and phase two of an element response test the provider may present a plurality of free point elements to which test participants may provide a response. Free point elements may be incorporated into a test by a revenue provider to allow participants to increase their overall point total.

### Entertainment and Consumption Elements

An element response period begins with an element controller and a plurality of elements. In an embodiment, the element controller responds to one or more elements whereby the one or more responses directly or indirectly determine which one or more elements from the plurality of elements the public is provided for entertainment or consumption.

### Example 1

A product/element is provided to the public for consumption. In an embodiment, the element is a result of an element response period whereby an element controller is presented with a plurality of elements. In an embodiment, the controller determines which element from the plurality of elements is most suitable for public consumption. In essence, the controller is more often than not a self appointed consumer representative.

### Example 2

An entertainer/element is presented to the public for entertainment. In an embodiment, the element is a result of an element response period whereby an element controller is presented with a plurality of elements. In an embodiment, the controller determines which element form the plurality of elements is most suitable or appealing for entertainment purposes. Therefore, the controller is a viewer representative.

### Example 3

Contestants/elements are provided to the public for interactive entertainment. In an embodiment, the elements are a result of an element response period whereby an element controller is presented with a plurality of elements. In an embodiment, the controller determines one or more elements form the plurality of elements that most suitable for viewer interaction. In an embodiment, the element controller is viewer representative.

Every so often a consumer or viewer representative may get it right, which is truly unacceptable.

Therefore, a need exists for businesses to engage viewer and consumer representatives with an innate ability to consistently identify elements that are most appealing and suitable to viewers and consumers.

### Multi and Single Response Session Elements

A 3 phase element response period or game/test begins with a period initiation phase (phase 1) and ends with a period ending phase (phase 3). Generally, during phase 1 a plurality of single and multi response session elements are presented. At least one element controller and game participants (ancillary game participants when the primary element response period has no game) submit a required number and type of responses to a required number of elements prior to an element response submission deadline. During phase 2 the element controller's required number and type of responses to a required number of elements are revealed. In an embodiment, the controller's responses to phase 1 one or more phase 1 elements directly or indirectly determines at least one phase 2 element response option. Generally, the at least one phase 2 element response option is a multi response session element from phase I made available by the element controller to receive one or more responses during another response session, hence the term “multi response session element.” In an embodiment, the at least one element response session element presented during phase 2 may or may not be attached to a single response session element from phase 1. When the at least one phase 2 element response option is attached to one or more single response session element response options from phase I or attached to one or more other elements during phase 2 the attached elements will generally influence the number and type of responses the at least one multi response session element will receive during phase 2.

The above example requires a provider to coordinate at least one multi response session element from phase 1 to be available to receive at least one response during phase 2. Generally, this is how phase 1 and phase 2 of a 3 phase element response period is executed.

### Single Sitting Multi Response Session

However, phase 1 and phase 2 may be combined allowing the phase 1 multi response session elements to receive two sessions of one or more responses during one sitting.

This is accomplished by videoing/taping all phase 1 multi response session elements as if they were directly or indirectly responded to by an element controller and making the record available during a single sitting.

### Example

### Sitting One—Session One

A plurality of single and multi response session elements are presented. An element controller and game participants record a required number and type of responses to a required number of elements.

### Sitting One—Session Two

All multi response session elements are presented with attached single response session elements from phase 1, and/or one or more new attached elements. The controller and participants refer to their session one record and make a session two record in relationship to the elements they may or may not of responded to during session one. If session one required controllers and participants to respond positively to a required number of multi response session elements during session one, the elements receiving the positive session one response will generally be the elements they will respond to during session two. If session one required controllers and participants to respond negatively to a required number of elements during session one, the element receiving no negative response will generally be the elements they will respond to during session two. Therefore, when a controller and participants are required to record a negative response to a required number of elements during session one, the elements may not be referred to as multi response session elements due to the fact that a negative response to an element during session one by an element controller may exclude the element from receiving a response during a subsequent session.

A provider may also utilize a live broadcast to combine phase 1 and phase 2 into one sitting by making all element response options from phase 1 available to be incorporated into phase 2.

### Example

A plurality of element response options are presented during phase 1 of a live broadcast. Controllers and participants are instructed submit a required number and type of responses to a required number of elements after each element is presented during the broadcast. Controllers and participants are required to submit their responses to elements before a response submission deadline during the broadcast. When the required response is positive, the elements receiving the positive response from the element controller will become element response options during phase 2 during the live broadcast.

When the required response is negative or eliminating, the elements receiving the negative response from the element controller will be excluded from becoming an element response option during phase 2 and the elements not receiving the negative response will become element response options during phase 2. Keep in mind, elements indirectly made available by an element controller to become element response options during a subsequent phase/session within a period may only be referred to as multi response session elements when another phase/session is incorporated into the period where elements receiving a positive response and not eliminated from the period are made available during the subsequent phase/session to receive a response.

### Element Response Options

Element response options are a primary factor in the functionality of element response periods and element response games and tests. Generally, the types of element response options incorporated into an element response period, game, or test are determined by one or more of the period, game, or test themes and objectives. An element response period, game, or test may have a plurality of themes and objectives.

An element response period, game, or test provider or administrator may incorporate element of one or more themes into the period, game, or test to attract fans or consumers of the themes.

A period, game, or test theme may have a plurality of dimensions or categories. Themes with a plurality of dimensions or categories may include, but are not limited to: entertainment, political, business, corporate, economics, scholastic, and manufacturing, to name a few.

For example, an element response game provider may target fans or consumers of video games by providing a search for a favorite video game character. Therefore, the element response options of a video game character search may be, but are not limited to: animated or three dimensional characters, character activities/actions, character supporting elements such as sets, scenes, and apparatus, and character interaction elements such as products or props.

In essence an element response period or game provider may utilize an almost unlimited number of genres and themes of elements to attract viewers, fans, or consumers to the period, game, or test. All demographics of our World's societies may find one or more genres or themes of elements compelling to view, interact with, or consume.

In an embodiment, the primary objective of an element response period, with or without incorporating an element response game, is to allow an element controller to respond to one or more element response options to determine one or more element semi finalists, element finalists or winning elements for the period. An element controller's response to an element may be, but are not limited to a: positive response, evaluating response, ranking/placing response, or negative response. An element controller's response to an element may be subjective, partially subjective, objective, or partially objective.

During an element response period, the element controller's responses to elements are subjective. During an element controllers element response game an element controller's responses to elements may be objective. This is due to the fact that an element controller's element response game allows an entity or entities within a segment of a plurality of entities comprising an element controller to receive a match or point value each time the entity's response to an element is at least similar to another entity or a segment of a plurality of entities.

Elements may be categorized according to a one or more types and number of responses each element in a category an element controller is instructed to provide to the elements within the category.

Elements within an element response period or game may be categorized as main elements or secondary elements. Generally, main elements are elements an element controller may determine to be element semi finalists, element finalists or winning elements for a period or a series of periods. Secondary elements are generally elements that may be independent or dependant on main elements. An element that is independent of main elements may be an element an element response period or element response game/test provider requires a response to for data capture.

An element that is dependent on main elements may be an element that is available to be attached to a main element. By attaching a secondary element to a main element the main element may receive one or more additional response during a response session or during a subsequent or future response session.

### Example 1

A plurality of contestants and activities are presented during an element response period. In an embodiment, the contestants are main elements and the activities are secondary elements. An element controller may select one or more contestants (main elements) to perform one or more activities (secondary elements). Therefore, secondary elements are attached to main elements.

### Example 2

A plurality of sponsor's products and contestants are presented during an element response period. In an embodiment, the sponsor's products are main elements and the contestants are secondary elements. An element controller may select one or more sponsor's products (main elements) to be interacted with by one or more contestants (secondary elements). Therefore, the secondary elements are attached to main elements.

### Example 3

A plurality of manufacturer's products and product accessories are presented during an element response period. In an embodiment, the manufacturers products are main elements and product accessories are secondary elements. An element controller may select one or more manufacturer's products (main elements) to be displayed with one or more product accessories (secondary elements). Therefore, the secondary elements are attached to main elements.

Generally, a main element may receive an additional response influenced by one or more attached secondary elements. Secondary element may be referred to as single response elements. Main elements may be referred to as multi response elements when the main element is available to receive one or more additional responses during a same or subsequent response session.

### Element Response Options

Element response options may be categorized according to the number of responses each element may receive during an element response period. Elements available to receive a single response during a single response session of a period may be referred to as single session single response elements. Elements available to receive multiple responses during a single response session of a period may be referred to as single session multi response elements. Elements available to receive a single response during two or more response sessions of a period may be referred to as multi session single response elements. Elements available to receive one or more responses during two or more response sessions of a period may be referred to as multi session multi response elements.

### Element Types:

Type A—Single Session Single Response

Type B—Single Session Multi Response

Type C—Multi Session Single Response

Type D—Multi Session Multi Response

Type E—Multi Session Single and Multi Response

Generally, a type A element, a single session single response element, may receive a single response during a single response session or phase within an element response period.

A type B element, a single session multi response element, may receive a plurality of responses during a single response session or phase within an element response period.

A type C element, a multi session single response element, may receive a single response during a plurality of response sessions or phases within an element response period.

A type D element, a multi session multi response element, may receive a plurality of responses during a plurality of response sessions or phases within an element response period.

A type E element, a multi session single and multi response element, may receive a single response during one or more response sessions and a plurality of responses during one or more response sessions within an element response period.

Type A and B elements may be referred to as single session response elements.

Type C, D, and E elements may be referred to as multi session response elements.

Generally, when a plurality of element categories or sub categories exist each category or sub category will contains the same element response types.

### Example

A plurality of entertainers, audition activities, and sponsor's interactive products are presented as element response options. In an embodiment, the entertainers may be grouped into category 1. In an embodiment, the audition activities and sponsors interactive products may be grouped into category 2. In an embodiment, the audition activities may be grouped into sub category 2A and the sponsor's products may be grouped into sub category 2B.

All entertainers are taped performing each audition activity and interacting with each sponsor's interactive product.

An element controller selects one or more entertainers from element category 1 to perform one or more activities from element category 2A and interact with one or more sponsor's products from element category 2B. At this point, the controller has made a single response to one or more elements from category 1, 2A, and 2B.

In an embodiment, the selected entertainers are now available to receive a response for performing selected audition activities and interacting with selected sponsor's products.

In order for the entertainers to receive additional responses during the session, the entertainers will have to perform during a single live broadcast or would be required to be taped, in advance of the session, performing every activity and interacting with each product.

Entertainers (category 1 elements) selected by the element controller are transferred to a selected entertainer category (category 3). Element category 3 allows the element controller to respond to selected entertainers according to how well they performed the one or more selected activities and interacted with the one or more products. In an embodiment, the element controller rates each entertainers activity performance and product interaction. Therefore, the element controller has responded to main elements one or more times subsequent to an initial response. Therefore, the entertainers are single session multi response elements and the activities and products are single session single response elements.

An initial response to a multi response element may be a high level response and one or more additional response to the multi response element may be low level responses, allowing progressive main element response knowledge and intimacy.

Therefore, a single response element attached to a multi response element generally results in the multi response element receiving a subsequent response influenced by the attached single response element.

Single response elements may be one or more sponsor's products or services available to be placed by a controller into the production of an element response period phase. In an embodiment, the products may be placed into a live or taped period or a subsequent or future period.

Multi session multi response elements may be options of element response options during one session and elements during a subsequent session.

In an embodiment, the following is an example of how one or more element controllers may respond to elements multiple times during a plurality of sessions.

A plurality of options of award nominee options are presented during response session one as multi response elements. An element controller selects (initial response) the most talented or qualified award nominee options.

In an embodiment, the award nominee options selected by the element controller are presented during response session two. In an embodiment, the element controller selects (second response) a plurality of the most talented award nominees.

In an embodiment, the award nominees selected by the element controller are presented as element response options during session three. In an embodiment, the element controller selects (third response) at least one award winner.

In an embodiment, the one or more award winners selected by the element controller are presented during a final phase of the period.

Therefore, the multi session multi response elements (award show elements) received a single response during a plurality of sessions.

An element response period, game, or test may consists of element response options within two categories wherein one category is a primary element category and another category is a supporting or attachment element category. In an embodiment, the primary element category may contain elements that will ultimately be determined by an element controller to become winning elements for the period. In an embodiment, the supporting or attachment element category may contain elements available to be selected by an element controller to support or be attached to primary elements selected by the same or different element controller during a subsequent phase or response session. A period, game, or test supporting element attached to a primary element allows a controller to evaluate and/or respond to the primary element during a subsequent phase or response session in a subsequent progression response from the initial response.

### Element Categorization

During an element response period or element response game a plurality of element response options are presented. Elements may be grouped into categories or sub categories according to a period theme or objective. Elements may be categorized according to a match or point value a participant assigns themselves or is assigned for providing a correct response to the one or more elements within the category.

### Free Point Elements

Element response game and test elements may be free point elements. A free point element may be an element a participant responds to in order to assign themselves or receive one or more free points. A participant's response to a free point element may be a subjective response. A subjective response to elements may be required by a game or test provider or revenue provider when the element response options are within a questionnaire or survey category.

An element response option may receive an objective or subjective response during an element response period, game, or test according to one or more objectives determined by the period, game, or test provider or revenue provider.

### Casting Elements

Element response options incorporated into an element response period, game, or test may be cast by the period, game, or test provider or a person, group, or business directly or indirectly associated with the period, game, or test provider.

Element response options incorporated into an element response period, game, or test may be cast by the period, game, or test revenue provider or a person, group, or business directly or indirectly associated with the period, game, or test revenue provider.

### Element Casting Directors

Element response options are generally cast according to suitability or appeal to the target audience demographic or participant demographic determined by conventional casting directors and casting methods.

A example period, game, or test provider's objective is to allow an element controller to cast elements for a subsequent event or series. In an embodiment, the subsequent event or series may be a film, Television program, video game, or publication. In an embodiment, the provider may designate a majority of viewers as an element controller. Therefore, the majority of viewers become entities comprising the casting director for the subsequent event or series. In an embodiment, the subsequent event or series will then present viewers with the most appealing or qualified elements according to the viewers. A limitation may exist by the types of elements the viewers are presented with to control. In an embodiment, the elements cast for the element controller to select from are generally cast by individuals, groups, or businesses directly or indirectly associated with the provider. In an embodiment, the individuals, groups, or businesses may or may not be qualified whereas the later is generally the consensus. In order to provider viewers with the most appealing or qualified elements to select from the provider may allow qualified viewer representative to cast the most appealing or qualified elements.

Viewers representative are identified when a majority of viewers are designated as an element controller of elements presented during an element response test. Test participants (viewers) receive a point value each time a response to a test element matches or is at least similar to an element controllers (a majority of viewers) response to the same element. Test participants with a highest point total for a period or series of periods are identified as viewers in sync with the majority of viewers. One or more viewers in sync with the majority of viewers (element controller) are selected or qualify to be selected to represent the majority of viewers as casting directors during a future test production. This way the elements cast for the future production are cast by the most qualified viewer representatives. During the future test a majority of viewer may again be designated as an element controller. In an embodiment, the future test objective is to allow an element controller to cast elements for a subsequent event or series. Therefore, the casting process for the subsequent event or series is viewer controlled. This method assures the provider the most appealing or qualified elements are cast for the subsequent event or series when compared to conventional or current methods. When a test provider targets a segment of viewers the segment may be designated as an element controller which may allow viewers most in sync with the segment to cast element for a future test with the segment designated again as element controllers resulting in the future test becoming controlled by the segment.

### Revenue Provider's Element Categories

A period, game, or test provider may allow a revenue provider, such as a sponsor or advertiser, to incorporate elements the period, game, or test. In an embodiment, the revenue provider may be presented by a provider to viewers comprising a period element controller, viewers comprising a game or test element controller and game or test participants as a provider of prizes and awards and at times fame and fortune.

Ancillary game/test participants associated with a period and primary game/test participants may be allowed or required to respond to elements the revenue provider brought to the game/test. In an embodiment, the provider will generally designate at least one mystery controller to determine the fate elements. Participants assign themselves or are assigned point value in a manner that is at least similar to when they respond to elements of the game or test. In essence a revenue provider's elements become elements of the game or test. In an embodiment, the revenue provider's objectives are to identify one or more participants in sync with the controller of the revenue provider's elements. In an embodiment, the revenue provider may select one or more participants in sync with the controller to become a controller representative or assistant or to receive a type of consideration consistent with being in sync with the controller. This method creates a never before offered synergy between viewers/participants/consumers and the revenue provider.

### Period/Game/Test Revenue Provider's Elements

### “Partially Viewer Controlled” Commercial Presentations

An element response game/test provider may allow a revenue provider to incorporate commercial production elements into the game/test with an objective of allowing a majority of viewers (element controller) to determine which elements are most suitable to be placed into a future commercial produced by the revenue provider. Therefore, the primary elements within the future commercial production are “partially viewer controlled”

### “Viewer Controlled” Commercial Presentations

One or more game/test participants/viewers most in sync with the above element controller (majority of viewers) may be selected to participate in the production of a future game/test to cast elements for a subsequent game/test utilizing commercial production elements for yet another future commercial. In an embodiment, the revenue provider may again designate a majority of viewers as an element controller of the commercial production elements. Therefore, the primary elements within the future commercial production are Totally Viewer Controlled.”

Contestants—

Activities—

Judges—

Sponsors

Person—

Place—

Thing

Animated Film Characters—

Cartoon Characters—

Comic Book Characters—

Video Game Characters—

TV Game Show Contestants—

Realty TV Contestants—

Beauty & Talent Contestants—

Theme Contestants—

Genre Contestants—

Actors & Actresses (auditioning for roles/parts for stage, TV, film, video)—

Political Candidates (State, local & federal)—

Corporate Board Members—

individuals Seeking Employment—

Groups Seeking Employment—

Economic Proposals—

Services

Manufactures Products—

Consumable Products—

Product Designs—

Product Designers—

Vacation Destinations-Real Estate

Element Response Options

Lyrics, Beats, Music, Poetry, Logos or elements relating to music, music production, and music promotion.

Element Response Options

Product Prices

Prices of products resulting form an ERG/T. For example, viewers may be allowed to select the price, from a plurality of price options, a product will be sold for. When participants are proud of the product they helped to produce they may set a higher market price for the product and subsequently be compelled to pay the price they set.

### Multi and Single Response Session Elements

A plurality of element response options presented during an element response period may be referred to as multi response session elements when the elements are available to receive one or more responses during two or more response sessions generally during a same period. Elements presented during an element response period may be referred to as single response session elements when the elements are made available to receive one or more responses during one response session of a period.

A 3 phase element response period may also incorporate single response elements. A single session response session element is an element that is allowed to receive one or more responses during or after a single phase or response session during a 2 or 3 phase period.

A single response session element is generally integrated into phase 1 of a 2 phase period or phase 1 or 2 of a 3 phase element response period.

A plurality of single response session elements may incorporated into one or more phases of a multi phase element response period (two or more phases) to compliment or be placed into a subsequent phase or period.

A plurality of single response session elements may be integrated into an element response period with the objective of allowing an element controller to attach one or more of the single response session elements to one or more multi response session elements during a subsequent period.

An element controller may be allowed to determine one or more single response session elements from a plurality of single response session elements that are most suitable to be placed into a subsequent phase or period, whereas the plurality of single response session elements may anything that can be placed into a phase or period, such as, but not limited to persons, products or consumables.

An element controller may be allowed to determine one or more single response session element from a plurality of single response session elements that are most suitable for a multi response session element to perform during a subsequent phase or period, whereas the plurality of single response session elements may be anything that can be performed by a multi response session element, such as, but not limited to: actions, activities, and scenarios.

An element controller may be allowed to determine one or more single response session element from a plurality of single response session elements that are most suitable for a multi response session element to interact with during a subsequent phase or period, whereas the plurality of single response session elements may be anything that can be interacted with by a multi response session element, such as, but not limited to: persons, products, or consumables.

A single response session element may add to the content of a subsequent phase or period or may influence an element controller's response to a multi response session element subsequent to the element controller's first response to the multi response session element.

Information from Outline Element Response Options/Response Elements

Single Response Elements

Multi Response Elements

Single Response Session Elements

Multi Response Session Elements

Single Controller Elements

Multi Controller Elements

Single Phase Elements

Multi Phase Elements

Single Period Elements

Multi Period Elements

Single Series Elements

Multi Series Elements

Single Game Elements

Multi Game Elements

Single Test Elements

Multi Test Elements

Single Observation Platform Elements

Multi Observation Platform Elements

Single Listening Platform Elements

Multi Listening Platform Elements

Audio Elements

Visual Elements

Audio and Visual Elements

Audiovisual Elements

Single Response Type Elements

Multi Response Type Elements

Element Response Point Captive Release Elements

Free Point Elements

Textual/Numerical Input Response Elements

Placement Elements

Placement Element Options

Responses to Placement Element(s)

Responses to Element Placement

Response to Element(s) Utilized for Placement

Suggestions for Placement Elements

Suggestions for Element Placement

Integration Elements

Integration Element Options

Responses to Integration Element(s)

Responses to Element Integration

Responses to Element(s) Utilized for Integration

Suggestion for Integration Elements

Suggestion for Element Integration

Interaction Elements

Interaction Element Options

Responses to Interaction Element(s)

Responses to Element Interaction

Responses to Element(s) Utilized for Interaction

Suggestions for Interaction Elements

Suggestions for Element Interaction

Placement Methods

Placement Method Options

Responses to Placement Method(s)

Responses to Method(s) of Placement

Responses to Method(s) Utilized for Placement

Suggestions for Placement Methods

Suggestion for Methods of Placement

Integration Methods

Integration Method Options

Responses to Integration Method(s)

Responses to Method(s) of Integration

Responses to Method(s) Utilized for Integration

Suggestions for Integration Methods

Suggestion for Methods of Integration

Interaction Methods

Interaction Method Options

Responses to Interaction Method(s)

Responses to Method(s) of Integration

Responses to Method(s) Utilized for Integration

Suggestions for Interaction Methods

Suggestion for Methods of Integration

Attachment Elements

Attachment Element Options

Responses to Attachment Element(s)

Responses to Element Attachment

Response to Element(s) Utilized for Attachment

Suggestions for Attachment Elements

Suggestions for Element Attachment

Tailored Attachment Elements

Tailored Attachment Element Options

Responses to Tailored Attachment Element(s)

Responses to Element Attachment Tailoring

Response to Element(s) Utilized for Tailored

Attachment

Suggestions for Tailored Attachment Elements

Suggestions for Tailored Element

Attachment

Influence Elements

Influence Element Options

Responses to Influence Element(s)

Responses to Element Influence

Response to Element(s) Utilized for Influencing

Suggestions for Influence Elements

Suggestions for Element Influencing

Tailored Influence Elements

Tailored Influence Element Options

Responses to Tailored Influence Element(s)

Responses to Element Influence Tailoring

Response to Element(s) Utilized for Tailored

Influencing

Suggestions for Tailored Influence Elements

Suggestions for Tailored Element

Influencing

Tailored Elements

Tailored Element Options

Responses to Tailored Element(s)

Responses to Element Tailoring

Response to Element(s) Utilized for Placement

Suggestions for Placement Elements

Suggestions for Element Placement

Responses to Responses to Elements

Response Types

Positive

Negative

Evaluating

Ranking

Multi Response [Rate'n Rank, etc.]

Subjective

Partially Subjective

Objective

Partially Objective

Innate

Skill

Chance

Predictive

Suggestive

Provider of Elements

Element Response Period Provider's Elements

Element Response Period Associate's Elements

Element Response Period Revenue Provider's Elements

Primary Game/Test Provider's Elements

Primary Game/Test Revenue Provider's Elements

Ancillary Game/Test Provider's Elements

Ancillary Game/Test Revenue Provider's Elements

Listener's Elements

Viewer's Elements

Participant's Elements

Period, Game, and Test Participation Methods

Single Controller Single Response Column Elements

Single Controller Multi Response Column Elements

Multi Controller Single Response Column per Controller

Multi Controller Multi Response Column per Controller

Viewer Interactive

Partially “Viewer Controlled”

Totally “Viewer Controlled”

Listener Interactive

Partially “Listener Controlled”

Totally “Listener Controlled”

Viewer and Listener Interactive

Partially “Viewer and Listener Controlled”

Totally “Viewer and Listener Controlled”

Viewer/Listener Interactive

Partially “Viewer/Listener Controlled”

Totally “Viewer/Listener Controlled”

Single Controller

Multi-Controller

Primary ERG/T [One or More Primary Controllers]

Secondary ERG/T [One or More Secondary Controllers]

Alternate ERG/T [One or More Alternate Controllers]

Ancillary ERG/T [One or More Ancillary Controllers]

Mystery ERG/T [One or More Mystery Controllers]

### Preferred Embodiments

### Response Point Controllers

An element controller may be anything capable of providing at least one response to one or more elements within an element response period or element response test.

An element response test provider generally requires a known, assumed, or mystery element controller and element response test participants to provide a same one or more types of responses to one or more of a plurality of elements within a test or one or more test element categories, based at least in part on one or more objectives with respect to the test or test element categories. Test participants may be allowed or required to assign themselves and/or are assigned by a test provider or an administrator associated with the test provider a match or similar point value each time a participant's response to an element matches or is at least similar to an element controller's response to the same element.

An element controller's one or more responses to one or more elements within a test or test element category may directly or indirectly determine the fate or future of each element within the test or test element category when elements are capable of being controlled or having a future. An element controller's response to an element may be determined by a test provider or test revenue provider a correct response to the element with respect to the test.

An element controller's response to an element is generally a correct response to the element and an element the element controller does not response to is generally determined to be an incorrect response.

An element controller may be one or more persons, places, or things, or a percentage of a plurality of persons or things. An element controller may be animate or inanimate. An element controller may be designated or selected at random. An element controller may be designated by, but not limited to, a test provider, a test revenue provider, other element controllers, test viewers, Ancillary test participants, or primary test participants. An element controller may be selected as a result of a testing or qualification process. An element controller may be pre designated or designated through conventional processes. An element controller may be designated through unconventional or future types of testing, qualifying, or selecting processes. An element controller may be designated by means other than the means described herein.

### Element Controller Information/Data

Element response test participants may be allowed or required to seek information on an element controller in order to provide

An element controller may include, but in not limited to the following:

An Entity

A Plurality of Entities with One Voice

A Segment of a Plurality of Entities with One Voice

A Sub Segment of a Segment of a Plurality of Entities with One Voice and so on.

A Percentage of a Plurality of Entities

A Percentage of a Segment of a Plurality of Entities

A Percentage of a Sub Segment of a Segment of a Plurality of Entities and so on.

A Random or Calculated Response Machine, Apparatus, Generator, and Etc. (The machine, apparatus, or random response generator may be similar to what one may see utilized within a random indicia selection machine or apparatus or during a random drawing event or casino game.)

A Calculated Response Method

A Random Response Method

An element controller may be comprised of one or more viewers, game participants, or consumers. An element response game/test provider allowing test participants to utilize a specific response platform may designate one or more non participants/viewers or participants of one or more other response platforms as an element controller.

An element controller may be a percentage of consumers, wherein consumer purchases or responses may determine a correct response to elements.

### Element Controller (6-19)

Generally, a test element controller determines correct responses to test elements and if applicable controls the fate or future of test elements. An element receiving a response submitted by the controller may be identified as a response point assignment element. A response point assignment element is an element a test participant must submit a response to in order to be assigned and/or assign themselves a response point value. An element response test provider may determine a most suitable element controller to be a majority of test participants. When the majority of test participants submit a response to an element, that element is identified as receiving a response from the element control and subsequently becomes a response point assignment element. In an embodiment, the element response test may require the element controller to designate a plurality of test elements to become response point assignment elements. Although a majority of test participants is referred to as “The Element Controller”, the majority of participants determining each of the plurality of response point assignment elements will in all probability not be the same majority from one response point element to the next.

A test participant correctly responding to the plurality of test elements is in essence a participant that is in sync with a plurality of a majority of test participants referred to as “The Element Controller.”

### Revenue Element Categories

A period or test provider may designate one or more elements categories for one or more sponsors, advertisers, marketers, retailers, wholesalers, manufacturers, researchers, or other types of revenue providers to incorporate elements in order to capture response data from entities comprising an element controller and/or test participants.

When a revenue provider is also a commercial producer or advertiser the revenue provider may incorporate products or aspects of a commercial into a test in order to garner data from entities and/or participants as to which aspects or products are most suitable or appealing and should or should not become commercial advertisement elements.

### Synergy Between Consumer and Revenue Provider

A commercial or advertisement may be referred to as viewer interactive or partially viewer controlled when elements incorporated into the commercial or advertisement are utilized as a result of period or test data received by viewers and/or test participants.

When an element controller for elements within a revenue provider's element categories is comprised of a percentage of all test participants or a percentage of a segment of test participants and one or more test participants most in sync with the element controller are selected to participate in a future commercial or advertisement production the future production may become or referred to as viewer controlled. This method facilitates a new type of consumer to revenue provider synergy and subsequent revenue provider brand awareness.

When a plurality of segments of a society are designated as test element controllers test participants belonging to a segment may be required to respond to elements controlled by another element controller. In an embodiment, the other element controller may be part of the same or a different test.

A segment of a plurality of test participants may comprise test element controller A and all test participants may comprise test element controller B. Test participants identified as being most in sync with test element controller A may receive or qualify to receive consideration with respect to test element controller A. Test participants identified as being most in sync with test element controller B may receive or qualify to receive consideration with respect to test element controller B. Test participants identified as being most in sync with both test element controller A and B may receive or qualify to receive consideration with respect to both test element controller A and B.

### Multi Controller Test

A plurality of test element controllers may be utilized to control elements within a multi controller test. A multi controller test may have a plurality of element controllers. Each element controller may directly or indirectly determine the future of the same or different elements. Each element controller may determine correct and incorrect responses to test elements. Therefore, an element may have a positive future with respect to one element controller and a negative future with respect to another element controller. And, an element may be a correct element to respond to with respect to one element controller and the element may be an incorrect element to respond to with respect to another element controller. Each element controller may be comprised of a different segment of test participants. Each test participant within an element controlling segment may be required to respond to elements controlled by their segment. In an embodiment, the element controller with respect to a segment of which a participant belongs may be determined to be a participant's primary controller. In an embodiment, the element controller with respect to a segment of which the participant does not belong may be determined to be the participant's secondary controller. Test participants may be allowed or required to provide responses to elements with respect to a primary controller and may be allowed or required to provide responses to elements with respect to one or more secondary controllers. Therefore, an element response test may be comprised of a plurality of tests within a test.

A test participant may receive primary points with respect to their primary controller and may receive secondary points with respect to one or more secondary controllers. Participants may receive an award or consideration based on a number of primary points combined with a number of secondary points.

Participants with a highest combined point total may be referred to as participants most qualified to receive an award/consideration based at least in part on being in sync with multiple controllers.

When an element response test utilizes only one controller and the controller is comprised of a segment of participants, participants belonging to the controlling segment may be the test provider's primary target for element response data capture.

A test provider may designate members of one or more societies or a segment of members of one or more societies to become entities comprising one or more element controllers who may not wish to or be allowed to receive consideration or become test participants (primary or ancillary). For example, viewers participating as entities comprising an element controller in the voting process for events such as singing competitions and reality shows based on survival may not wish or be allowed to become test participants whereas other members may wish to or be allowed to become test participants with an opportunity to receive consideration based on being in sync with the members not wishing to or allowed to become test participants.

Participants, players, test subjects, applicants, voting viewers, or related terms may be synonymous. Although terms such as player and applicant may be synonymous they are generally not used in the same context. In an embodiment, the term player may refer to an entity/person seeking to win a prize and an applicant or participant may be referred to an entity/person seeking to receive an award or consideration such as employment whereas employment may consist of participation in a subsequent or future production. In an embodiment, the employment may allow participants to assist or represent one or more element controllers the participant is identified as being in sync with as an element controller assistant or representative.

Members of a segment of a society designated as entities comprising an element controller may have an advantage as participants over participating member of other segments of the society which are not designated as entities comprising an element controller when a majority of the designated controlling entities responses to elements are determined to be correct responses to elements and point values and subsequent prizes and awards are provided based at least upon assigned point values.

To provide members of non-controlling segments a level playing field with members of the controlling segment the provider may require controlling members to control designated elements in order to participant and respond to elements controlled by other controllers. Although a provider's objectives may not be consistent with or allow a level playing field for controlling and non-controlling members.

### Element Controller Information/Data

An element response period or test provider may offer viewers and participants access to information/data or directions to garner information/data with respect to an element controller. Viewers and test participants may wish to seek information on an element controller in order to provide more objective responses to test elements.

An element response period or test element controller may provide responses to elements based upon period viewer's or test participant's responses when viewer's or participant's responses to elements are accessible to the controller prior to an element controller's response submission deadline.

### Viewer/Participant Designated Element Controller

Generally an element response period or test provider or period or test revenue provider designates one or more element controllers based upon one or more objectives or goals. A period, test, or revenue provider may allow viewers or test participants to designate one or more element controllers when a plurality of potential element controllers exists.

### Example 1

A plurality of element controller options for one or more element categories within one or more future element response periods or series of periods may be presented to members of one or more societies prior to the period or series of periods. Unregistered or registered members of the one or more societies may be allowed to select one or more element controllers from the plurality of element controller options for the one or more element categories within the one or more periods or series of periods that are most suitable or appealing. One or more elements controllers selected by a majority of members of each or all societies for the one or more element categories of the one or more future periods or series of periods may become viewer determined element controllers.

### Example 2

Two or more test element controller options for a plurality of test element categories are presented during an element response test registration process. Each registered participant is required to select one or more element controllers for one or more of their specific test element categories. A test participant's one or more selected element controllers control elements for them specifically. In an embodiment, the participant's are then required to respond to elements in a manner that is at least similar to their one or more selected element controllers. Participants identified to be in sync with their selected element controllers may selected or qualify to be selected to receive consideration based at least in part on being in sync with their one or more controllers.

A test provider may designate a primary element controller and present a plurality of alternate element controller options. Participants may be allowed or required to select one or more alternate element controllers. Participants may then be required to respond to elements controlled by the primary element controller and to elements they selected as an alternate element controller.

When more than one element controller exists within a test, and participants are allowed or required to respond to elements controlled by more than one element controller, each element controller may represent a sub test within a primary test. Each sub test may provide prizes and awards to participants with respect to a participant being in sync with each element controller. In an embodiment, the primary test may provide prizes and awards to participants with respect to a participant being in sync with a highest number or all element controllers. In an embodiment, the primary test prizes and awards may be of a higher value than each sub test.

Supreme Element Controllers (“Supreme Team”)

Test participants may be offered a chance to become a member of a group or a team of entities comprising a supreme element controller. In an embodiment, the team may be comprised of participants that meet one or more qualifications or criterions. In an example, one of the criterions is to consistently receive a highest point total or a range of points for one or more test periods or series. In an embodiment, the point total or range may be with respect to points received for being in sync with an element controller comprised of a majority of entities/participants from one or more societies or one or more segments of one or more societies. In an embodiment, the team may be thought of as judges who may have ultimate or supreme powers similar to Supreme Court Judges in terms of making executive decisions for tests. In an embodiment, the team may be referred to as the “Supreme Team.” In an embodiment, the Supreme Team may held in a higher regard than all other element controllers designated by a provider.

The “Supreme Team” may receive a salary or may be paid as independent contractors. The Supreme Team may or may not be required to star on Television as representatives of the controller(s) for which they are most in sync. For example, The “Supreme Team” with a highest esteem may be a group of participants that have proven they have their finger on the pulse of a nation. A “Supreme Team”, but with less esteem, may be a group of participants that have their fingers on the pulse of a segment of a nation.

Imagine if you will a team consisting of members of one or more societies that when asked they have the ability to determine elements that are most suitable or appealing to a majority of members of one or more societies or a majority of one or more segments of one or more societies. Members of the Supreme Team will most likely be approached by corporations and businesses through out the world to become members of their team. This is why the Supreme Team may be required, by a licensing agreement, to be compensated in such a way to ensure their tenure is without disruption.

Mystery Controller

A mystery controller is generally an element controller that is not revealed until some time after a test participants element response submission deadline. When an element controller is presented prior to a participants response submission deadline the element controller may influence the participant's responses to elements. In an embodiment, the participants influenced responses may be referred to as objective responses. When an element controller is unknown or a mystery the participants' responses to elements are referred to as subjective or from the heart responses.

When a mystery controller is utilized for a plurality phases, period, or series a participant's assigned point points may be revealed to the participant during each phase, period, or series, or a participants points may be accumulated and kept secret or inaccessible by the participant until the mystery controller is revealed.

A test provider may designate a plurality of mystery controllers for an element category and require teams to consist of the same number of team members as the number of mystery controllers. Therefore, each participant may provide subjective responses to elements. In an embodiment, the test may require each team member to be in sync with a controller in order for the team to qualify to receive consideration.

In an embodiment, the test provider may allow each member of a team in sync with a controller to receive consideration with respect to the controller the member is in sync with.

In an embodiment, the mystery controller may be revealed at the conclusion of a response phase or period wherein the mystery controller is no longer utilized or is no longer utilized for the same element category. When one or more mystery controllers are utilized for a plurality of periods the mystery controller may only be revealed during a final period of the plurality of periods unless the controller is randomly designated to control elements within other element categories.

An element controller may provides responses to elements based at least in part on participant's responses to elements when participant's responses to elements are accessible to the element controller prior to the element controller's response submission deadline.

Seek and Find Element Controller

A test provider may provide clues to participants with respect to one or more element controllers of which the provider may utilize. In an embodiment, the effects of this method may be similar to a provider utilizing a mystery controller.

A test provider may designate one or more element controllers for one or more element categories sometime before or after a test participant's response submission deadline.

Test participants may be allowed to select one or more element controllers for one or more element categories before or after a response submission deadline but prior to a predetermined time when controller's responses are revealed.

Multi-Controller

When multiple element controllers exist participants may be allowed or required to respond to elements controlled by two or more element controllers.

An element response test provider, a test provider's partners or associates, or revenue providers may designate one or a plurality of element controllers to control elements and/or determine correct responses to elements within one or a plurality of element categories assigned to the test provider, the test provider's partners or associates, or the revenue provider.

Generally an element response test provider will designate one or more element controllers to control elements and/or provide correct responses to elements within the test providers one or more element categories or assigned one or more element categories when other categories are allocated or assigned to the test one or more associates or one or more revenue providers.

A test provider's one or more partners or associates may designate one or more element controllers to control elements and/or provide correct responses to elements within the one or more associate's one or more assigned element categories when the test provider allows one or more partners or associates to incorporate elements into the test.

One or more of the one or more associates may incorporate one or more elements into a test provider's one or more element categories or one or more assigned element categories. Therefore, the one or more associates may or may not designate an element controller or assist in designating an element controller for elements within the providers one or more element categories or one or more assigned element categories to which the one or more associates incorporated the one or more elements.

A test provider's one or more revenue providers may designate one or more element controllers to control elements and/or provide correct responses to elements within the one or more revenue provider's one or more assigned element categories when the test provider allows the one or more revenue providers to incorporate elements into a test. One or more of the one or more revenue providers may incorporate one or more elements into a test provider's one or more element categories or one or more assigned element categories or into one or more of the test provider's associates one or more assigned element categories. Therefore, the one or more revenue providers may or may not designate an element controller or assist in designating an element controller for elements within the test providers one or more element categories or one or more assigned element categories or one or more associates one or more assigned element categories to which the one or more revenue providers incorporated the one or more elements.

A test provider may allow or require test participants to respond to one or more elements within one or a plurality of element categories wherein the elements within the one or each of the plurality of categories may be controlled by one or a plurality of element controllers.

Element Controlling Socieities and Society Segments

When a test provider designates a percentage of all participants or interactive viewers from one or more societies, a percentage of a segment of participants or interactive viewers from one or more societies, or a percentage of a segment of a segment of participants or interactive viewers from one or more societies, etc. as an element controller, the participants or viewers within the one or more societies or the one or more segments of the one or more societies comprising an element controller may have a response advantage over participants within other societies or segments. A provider may require those comprising an element controller (segment, etc.) to respond to elements that are controlled by one or more other element controllers. In an embodiment, the other element controllers may be within the same or other test.

### Polled Controller

Element controller element response data may be captured by means of polling surveys, questionnaires, or other similar means or means to achieve response data from a designated controller when an entity or entities comprising a controller are accessible to provide data. This method of designating an element controller may be similar to how the Nielson rating are garnered.

Imagine a retail or lottery type of test with element controllers responses to elements garnered from a survey similar to the survey information presented on a Television game show such as Family Feud. Imagine the host presenting correct responses to elements with the phrase, Controller Said . . . versus the family feud phrase “Survey Said”

### Element Controller

During an element response period one or more element controllers designated to directly or indirectly controller the fate or future of one or more elements or provide correct responses to one or more elements within the period are generally required to provide one or more predetermined types of responses to a predetermined number of elements presented during the period prior to an element response submission deadline.

When a plurality of potential element controllers are providing a predetermined one or more types of responses to a predetermined number of elements within an element response period one or more of the potential element controllers may be designated sometime before, during, or after a response submission deadline. One of the one or more potential element controllers may be designated at a time consistent with, same as, or after a response submission deadline for ancillary test participants.

An element controller of one or more elements within an element response period may not be revealed or remain a mystery until a same time, a time consistent with, or after an ancillary test participant's element response submission deadline.

### Celebrity Element Controller

A test provider may announce that an element controller of elements within one or more element categories is a celebrity. In an embodiment, the celebrity may be presented prior to a participant's response submission deadline or may remain a mystery until after the participant's response submission deadline. By affording test participants an opportunity to qualify to assist or represent the celebrity in a future production or pre production a number of viewers may enroll to become test participants who would normally not enroll when other types of element controllers are utilized.

### Element Controllers

An element controller may be anything that can respond to an element. An element controller may be, but in not limited to:

An individual

A segment of individuals from a group

A segment of individual from a group may be a majority of individual, a demographic of individuals, a psycho graphic of individuals, to name a few.

A designated group with one controlling voice

A segment of a group wherein the segment is the controlling voice

A segment of viewers

A segment of viewers may be a majority of viewers, a demographic of viewers, a psycho graphic of viewers, to name a few.

A segment of game participants

A segment of game participants may be a majority of game participants, a demographic of game participants, a psycho graphic of game participants, to name a few

One or more element controller designated to controller elements within one or more element categories of an ERP or ERG/T phase may or may not be designated to controller elements within the same or different element categories during a subsequent or future phase or period. Therefore, an element controller may or may not remain throughout a plurality of phases within a period or throughout a series of periods.

### Example 1

An individual may be designated to control an element category containing a plurality of contestants and a segment of voting viewers may be designated to control elements within a category containing a plurality of survey preference options.

### Example 2

During one period a council may be pre-designated to control an element category containing award nominee options and a segment of a plurality of registered ERG/T participants may be designated to control an element category containing survey questions.

### Example 3

A segment of voting viewers may be designated to control elements within one or more element categories for a plurality of periods and an individual may be designated to control elements within the same one or more element categories for a period subsequent to the plurality of periods.

### Example 4

A plurality of segments of voting viewers, a majority of voting viewers, and a plurality of individuals may be designated to control elements within one or more element categories for a plurality of periods

When one or a plurality of element controllers are available to be designated to controller elements within one or more element categories an ERP or ERG/T provider or revenue provider or administrator may secretly designate one or a plurality of element controllers to control elements within the one or more elements categories before or after a response submission deadline for ancillary ERG/T participants or primary ERG/T participants. An element controller kept secret from participants and viewers may be referred to as a mystery controller. A mystery controller may be revealed during a period, a period during a series of periods, or a final period of a series of periods.

### Example 5

A majority of ERG/T participants may be designated to controller an element category containing a plurality of animated characters and a plurality of mystery controllers (celebrities) may be designated to controller an element category containing a plurality of product (e.g., Shoes) design options.

### Types of Responses

Generally element controller are instructed or required to provide one or more types of responses to a required number of elements within their designated element categories. In an embodiment, the required one or more types of responses to the required number of elements is generally determine by an ERP or ERG/T provider or revenue provider prior to the ERP or ERG/T according to one or more period or game/test objectives. In an embodiment, the one or more types of responses may be positive, negative, evaluating/rating, ranking, etc.

When an element controller is required to provide a positive response to one or more elements but less than all elements during a period phase prior to a final phase of the period, the one or more elements receiving the positive response may become element semi-finalists, element finalists, or winning elements for the period.

When an element controller is required to provide a negative response to one or more elements but less than all elements during a period phase prior to a final phase of the period, the one or more elements receiving the negative response may become losing elements for the period or dismissed from the series when a plurality of periods exist.

When an element controller is required to provide an evaluating or rating response to one or more elements the element controller is generally also required to provide a positive response to one or more highest rated elements, a negative response to one or more lowest rated elements, a positive ranking response to a plurality of highest rated elements, or a negative ranking response to a plurality of lowest rated elements.

An element controller may be required to provide two or more of evaluating responses to a required number of elements. Each evaluating response is generally based on an evaluation criterion. In an embodiment, the two or more evaluating responses to each element are generally combined to determine an overall evaluation. Evaluation responses may be weighted with respect to the evaluation criterion.

### Points

An element controller's response to an element is determined to be a correct response to an element with respect to an ERG/T. Generally, both element controllers and participants are instructed/required to provide/submit one or more types of responses to a number of elements within one or more element categories prior to a deadline. Each time a participant provide a response to an element that is at least similar to a controller's response to the same element the participant assigns themselves or is assigned a point value.

Innate Ability to Respond In Sync with an Element Controller

ERG/T participants may be able to match responses to elements with an element controller a plurality of times. A example game/test objective is to identify and engage participants with an innate ability to match responses with an element controller more time than a high percentage of other participants. Participants with an innate ability to match responses with an element controller may be identified as being in sync with the element controller.

Weighted Elements with Respect to Points

Element response options within one element category or sub category may have a higher or lower point value than element with another element category or sub category.

### Response Sweepstakes

Sweepstakes participants may be required to match a required number of a controller's responses to be entered into the sweepstakes

### Casting Director Employment as a Prize

In an embodiment, the game may award most qualified participants with an employment opportunity versus a game wherein something of tangible value changes hands. In essence, a game that provides nothing tangible as a prize may be scrutinized less by local and federal gaming restrictions.

### Future Participation as a Prize

### Skill

Show how a participant's ability to identify and respond to elements in a manner at least similar to an element controller constitutes a participant skill level especially when a participant responds to elements in a manner at least similar to an element controller over a plurality of response sessions.

### Element Controllers

An element response period may have a plurality of objectives. Each objective may be weighted according to the desires of the period provider. In an embodiment, the period may have one or more element controllers. Generally, when a period has a plurality of element controllers, one element controller is a primary controller and one or more other element controllers are alternate element controllers. In an embodiment, the function of a primary controller is to determine the fate of primary objective elements and the function of an alternate element controller may be to determine the fate of alternate or less weighted objective elements.

An element response period may have a plurality of primary element controllers, each with a designated element category or element sub category.

Generally, an element controller responds to element response options with subjectivity. In an example, one of the objectives of the period is to gather subjective response data from entities comprising an element controller.

When famous celebrities are designated by themselves or others to control the fate of element response options within one or more element categories during an element response period or game the objective of the period or game may be determined by the celebrities.

One or more element categories within an element response period or game may be incorporated into the period or game for reasons other than contributing to a primary objective of the period or game. In an embodiment, the reasons is to gather response data from one or more designated controllers to the elements within the one or more categories.

### Element Controller

An element controller is one of the primary factors in the functionality of element response periods and element response periods with element response games and/or element response tests. In an embodiment, the element controller may be anything that is capable of responding to an element. In an embodiment, the element controller's response to an element may directly or indirectly control the fate or future of elements, when the fate or future of elements are controllable, presented before or during an element response period or element response game or test. In an embodiment, the element controller's response to an element may be determined to be a correct response to the element for element response game or test participants.

An element controller may be identifiable, partially identifiable, or assumed. An identifiable element controller may be an entity or a plurality of entities with one voice. A partially identifiable or assumed element controller may be a percentage (majority) of a plurality of entities, a percentage of a segment (demographic) of a plurality of entities, a segment of a segment of a plurality of entities, a segment of a segment of a segment of a plurality of entities, etc.

An element controller may be revealed before or during an element response session.

An element controller may be kept secret during an element response session and revealed sometime after a response submission deadline.

When an element controller is revealed before or during a response session, participants may be provided with ample time to obtain information regarding the element controller in order to provide an educated or objective response to element response options.

When an element controller is kept secret (mystery controller) participants may provide subjective responses to element response options.

When an element controller is a percentage of a plurality of entities, or a percentage of a segment of a plurality of entities the controller may be assumed or partially identifiable. When an element controller is assumed or partially identifiable participants may provide partially objective or partially subjective responses to element response options.

For example, when an element controller is a majority of a plurality of entities, the majority is unknown before the plurality has submitted or made known their responses. Therefore, an element response game participant may inquire to a number of entities (3 or more) to generate or compile a majority. By allowing participants to gather consensus data the participant is in essence interacting socially.

### Example

A majority of ERG/T participants from an accessible society are identified as an element controller of a plurality of elements within an ERG/T. Participants are assigned a point value each time a response to an element matches or is at least similar to the majority of participant's responses to the same element. A participant may present the plurality of elements posted on printed material to 3 or more participants or entities of the society. In an embodiment, the participants may inquire to the 3 or more entities which elements are most suitable to respond to. By garnering response information from a number of 3 or more participants the inquiring participant may determine the elements to which a majority will respond. In an embodiment, the inquiring participant may then utilize the obtained knowledge in order to make an educated response to element response options.

In an embodiment, the participant or entity providing response information to the inquiring participant may then receive the inquiring participants response information. In essence, the information provider and recipient both become information recipients.

In an embodiment, the participant may then respond to specific elements in a manner that is at least similar to an assumed element controller.

In an embodiment, the inquiring participant then determines which elements a majority of participants inquired to will respond to a specific element.

In an embodiment, the results of an element response game/test may determine if an entity is qualified to participate in a subsequent element response game as an element controller.

An element controller game/test may identity an entity or entities qualification level with respect to remaining an element controller for a subsequent phase, period, or series of periods.

Entities participating in an element controller game/test may be unqualified and wish to qualify to participate in subsequent or future element response game/test period or a game/test series of periods as qualified element controllers.

Element controller game/test participants may be viewers attempting to qualify to become element controllers during a subsequent or future element response period or a series of periods

An element controller may be enrolled before or during an element response period.

An element controller may be predetermined by other means prior or during an element response period.

In an embodiment, the element response period may be dedicated to an element controller. An example is how the academy is dedicated to the academy awards or how Mr. Hefner is dedicated to the playmate of the month or playmate of the year searches.

One or more participants with a highest point total with respect to one or more element controllers may be recognized as the most qualified to represent or assist the one or more element controllers.

Entities comprising an element controller may be required to participate in an element controller game/test. In an embodiment, the element controller game/test may identify entities most qualified to remain entities comprising the element controller during a present or future phase, period or series of periods.

An element controllers ERG/T may be a primary, alternate, or ancillary ERG/T.

During an ERG/T a match or point value is assigned to a participant each time the participant's response to an element is at least similar to an element controller's response to the element. Therefore, a participant with the ability (objective or subjective) to identify and respond to elements in a manner that is at least similar to an element controller more times than other participants may qualify to represent or assist the element controller.

### Objective Responses

Before or during an ERG/T an element controller's identity may be revealed to participants. When the element controller is known, the participant's responses to elements may be objective.

Before or during an ERG/T an element controller's identity may be partially revealed. This may be due to the fact that when an element controller is a segment of a plurality of entities (individuals/groups) the segment may be partially known prior to the submission of responses by all entities. When an element controller is partially known, the participant's responses to elements may be partially objective or partially subjective.

During an element response game an element controller's identity may be kept secret until after participants submit responses to elements. When the element controller is kept secret, the participant's responses to elements are subjective.

In an embodiment, the element controller's responses to elements may be subjective or objective. Generally, an element controller's responses to elements are subjective. When an element response period has three or more element controllers or three or more element categories each controlled by a different element controller an element controller game/test may be incorporated into the period. An element controller game/test determines the one or more most qualified element controllers.

An element controller's game/test criterion may require an element controller or entities comprising an element controller to respond to elements in manner that is at least similar to a segment (majority) of element controllers or a segment of a plurality of entities.

An element controller game/test criterion may require an element controller to respond to elements in a manner that is at least similar to a segment of viewers or a segment of ERG/T participants.

An element controller may respond to elements in an objective manner during an element controller game/test.

An element controller game/test may allow element controllers to receive a match or point value each time a response to an element is at least similar to a segment of element controller's responses to the element.

An element controller game/test may allow element controllers to receive a match or point value each time a response to an element is at least similar to a majority of viewers or a segment of element response game participants. When no element controller game/test exists, the element controller's responses to elements are subjective.

An element controller may determine the fate of elements from one or more element categories or element sub categories when a plurality of element categories or element sub categories exist during an element response period or game.

When a plurality of element controllers are utilized, one element controller may be a primary element controller and one or more other element controllers may be alternate element controllers.

A primary element controller may a segment of a plurality of entities comprising the primary element controller. In an embodiment, the one or more other or alternate element controllers may be one or more sub segments of the plurality of entities.

A primary element controller may be comprised of a segment of a plurality of entities comprising the primary element controller. In an embodiment, the segment may not be known until the plurality of entities submits responses to elements.

An alternate element controller may be comprised of a segment or demographic of a plurality of entities.

A plurality of element controller's aggregated responses may determine the fate of elements within one or more element categories or an element sub categories.

When more than one element controller exists during an element response period or element response game, one element controller is a generally a primary element controller and one or more other element controllers are generally alternate element controllers. A primary element controller may be comprised of a segment of a plurality of entities. The segment of the plurality of entities comprising the element controller may be a majority or a demographic of entities to which the element response period theme/genre or element response game theme/genre is targeted.

An element controller may determine elements that will be available to receive a response during a subsequent or future element response period or element response game.

An element controller may be, but is not limited to:

An entity (individual or group)

A segment of a plurality of entities (individuals, groups, or sub groups)

A segment of a plurality of viewers (individuals or teams)

A segment of a plurality of element response game participants

An entity with one voice

A segment of a plurality of entities

A segment of a plurality of individuals comprising an entity

A segment of a plurality of groups comprising an entity

A plurality of individuals

A group of individuals

A segment of a plurality of individuals

A majority of a plurality of individuals

A majority of individuals from a group

A sub group of a group of individuals

A group

An entity

A group of a sub group

A committee

A council

An assemblage

A character

A group of characters

A sub group of a group of characters

A majority of viewers from a group

A majority of a plurality of element response game participants

A segment of a plurality of element response game participants

A segment of a plurality of element response game participants from a group

A segment of element response game participants

A segment of a segment of element response game participants

A segment of a plurality of society members

A segment of a nation

A nation

A segment of audience members

A majority of audience members

A segment of viewers

A segment of a segment of viewers

A majority of viewers

A segment of consumers

A majority of consumers

A segment of a plurality of consumers

A segment of consumers from a group

A majority of consumers from a group

A majority of viewers from a specific demographic

A majority of element response game participants from a specific demographic

A majority of all viewers

A majority of all element response game participants

The Electoral College

Electorates from a specific geographic

A segment of element response game participants (viewers) from a specific nation

A segment of element response game participants (viewers) from a specific group of nations

An intelligent machine

A machine that provides random responses to elements

A machine that selects elements based on a criterion

The term segment may refer to:

A percentage

A part

A piece

A majority

Less than a majority

A demographic

A geographic

A psycho graphic

A group of entities within a group

A segment within a group or segment

12-22 New

A game/test to test cognitive element responses

1-18

In an example, an ERP or ERG/T provider's primary objective is to capture data from a specific or targeted segment of society by incorporating a theme of element response options into the ERP or ERG/T known or assumed to attract the segment. A provider's alternate objective may be to target or attract a different segment of the society by incorporating another theme of element response options known or assumed to attract the other segments. An element category may incorporate elements with themes to target a plurality of segments of the society.

An primary or alternate objective of an ERP or ERG/T provider may be to gather data from a range of participants not generally interested in a theme of element response options.

### Element Controller Examples

In an embodiment, the grade or score an element receives from an element controller determines the elements level of performance, level of suitability, or level of appeal when compared to other elements.

In an embodiment, the element may receive an evaluation response from the element controller for a plurality of element evaluation categories. Each evaluation category may subject an element to a specific demand or performance requirement. A plurality of evaluation responses, ratings or scores, when combined to achieve a response total, may provide the necessary data to determine the element as a winning element, an element finalist, an element semi-finalist, a losing element, an eliminated element, to name a few.

One or more elements determined by an element controller to be a winning element, an element finalist, or an element semi-finalist for a period may become an element response option during a subsequent or future period or event.

A response to an element considered to be similar may be a ranking response whereas the element controller may rank an element as 1st and the participants may rank the element as 2nd or 3rd Therefore, the participants responded to the same element with a response considered to be similar.

In an embodiment, the participant with the ability to review/study an element controllers background, history, demographic, or psycho graphic information, to name a few, may be considered to have an ability that qualifies the participant become a representative of the element controller or a representative of a future element controller that may be related or similar to the element controller.

### Providing No Element Controller Information

When a participant responds to an element in a exact manner or in a manner that is at least similar to an element controller, and the participant was not presented with information regarding the element controller or no element controller information was available or the element controller was not identified prior to the participant executing a response, the participants may be considered to have an innate ability to identify and respond to elements an element controller will find or has found to be most suitable, appealing or most qualified.

In an embodiment, the participant's innate ability may qualify the participant to represent, assist, or work with the element controller in the future.

When a participant, with or without element controller information, consistently responds to elements during a plurality of phases or periods in an exact manner or in a manner at least similar to an element controller, the participant may be considered to be highly qualified to work with, for, or represent the element controller in any type of event where an element controller representative deemed necessary or desired by the powers to be or the element controller.

One or more participants with the ability (innate, learned/skilled) to respond to elements in a manner that is at least similar to an element controller may qualify to represent the element controller or a similar element controller by staring in a future period or event as an element judge.

One or more participants with the ability (innate, learned/skilled) to respond to elements in a manner that is at least similar to an element controller may qualify to represent the element controller or a similar element controller in the production of a future period or event as an element casting director.

### Element Controller

An element controller is one of the major factors in the functionality of an element response periods, element response games, and element response tests.

An element controller may be anything with the ability to respond to elements within an element response period or element response game. Element controllers may or may not be qualified.

An element response game/test may determine if an entity is qualified to participate in a subsequent element response game as an element controller.

An element controller game/test may identity an entities level of qualification.

Element controller game/test participants may be unqualified element controllers attempting to qualify to participate in subsequent or future element response game/test period or a game/test series of periods as element controllers.

Element controller game/test participants may be viewers attempting to qualify to become element controllers during a subsequent or future element response period or a series of periods

An element controller may be enrolled before or during an element response period.

An element controller may be predetermined by other means prior or during an element response period.

In an embodiment, the element response period may be dedicated to an element controller. An example is how the academy is dedicated to the academy awards or how Mr. Hefner is dedicated to the playmate of the month or playmate of the year.

During an element response game/test, a participant may receive a match or point value each time the participant's response to an element is at least similar to an element controller's response to the same element.

One or more participants with a highest point total with respect to one or more element controllers may be recognized as the most qualified to represent or assist the one or more element controllers.

Entities comprising an element controller may be required to participate in an element controller game/test. In an embodiment, the element controller game/test may identify entities most qualified to remain as an element controller during a future phase, period, or series of periods.

An element controller's game may allow an entity or entities comprising an element controller to receive a match or point value each time an entity responds to an element in a manner that is at least similar to a percentage of a plurality of participants or interactive viewers or a percentage of one or more segments of a plurality of participants or interactive viewers.

An element controller game/test may identify an entity or entities most qualified to represent a plurality of participants or viewers or one or more segments of a plurality of participants or viewers in a future game/test.

An element controller game may provide a match or point value to an entity or entities comprising the element controller each time the entity or an entity responds to an element in a manner that is at least similar to a majority of other entities comprising the element controller when the element controller is comprised of three or more entities.

An element controller game/test may allow entities comprising the element controller to receive a match or point value each time an entity's response to an element is at least similar to the element controller's response to the same element.

An element controller game/test may allow element controllers to receive a match or point value each time a response to an element is at least similar to a majority (or segment) of voting viewers or a segment of element response game participants. When no element controller game/test exists, the element controller's responses may be subjective.

An element controller may determine the fate of elements from one or more element categories or element sub categories when a plurality of element categories or sub-categories exist during an element response period.

A primary element controller may be comprised of a majority of a plurality of entities. An alternate element controller may be comprised of a segment or demographic of a plurality of entities.

When more than one element controller exists during an element response period or element response game, one element controller is a generally a primary element controller and one or more other element controllers are generally alternate element controllers. A primary element controller may be a segment of entities comprising an element controller. In an embodiment, the segment of entities comprising the element controller may be a majority or a demographic of entities to which the element response period theme/genre or element response game theme/genre is targeted.

A plurality of element controllers may be combined to determine the fate of all element response options within a period or a series of periods or elements within one or more element categories or sub categories within a period or a series of periods.

An element controller may be, but is not limited to:

An intelligent machine

A machine that randomly responds to elements

A machine that selects elements based on a criterion

An individual

An entity with one voice

A segment of a plurality of entities

A segment of a plurality of individuals comprising an entity

A segment of a plurality of groups comprising an entity

A plurality of individuals

A group of individuals

A segment of a plurality of individuals

A majority of a plurality of individuals

A majority of individuals from a group

A sub group of a group of individuals

A group

An entity

A group of a sub group

A committee

A council

An assemblage

A character

A group of characters

A sub group of a group of characters

A majority of viewers from a group

A majority of a plurality of element response game participants

A segment of a plurality of element response game participants

A segment of a plurality of element response game participants from a group

A segment of element response game participants

A segment of a segment of element response game participants

A segment of a plurality of society members

A segment of a nation

A nation

A segment of audience members

A majority of audience members

A segment of viewers

A segment of a segment of viewers

A majority of viewers

A segment of consumers

A majority of consumers

A segment of a plurality of consumers

A segment of consumers from a group

A majority of consumers from a group

A majority of viewers from a specific demographic

A majority of element response game participants from a specific demographic

A majority of all viewers

A majority of all element response game participants

The Electoral College

Electorates from a specific geographic

A segment of element response game participants (viewers) from a specific nation

A segment of element response game participants (viewers) from a specific group of a nations demographic.

Element Controller

When the one or more objectives are determined by an element controller, the controller may establish the type of responses elements will receive.

### Element Controller

Element controllers may be a machine, an entity, or a segment of a plurality of entities. Generally, one or more element controllers are determined according to a period objective.

### Element Controller

A network such as the NTN network (Buzztime) may be designated to determine an element controller or allow Buzztime participant to comprise an element controller.

Element Controller Determined Responses

When a period or test objectives are determined by an element controller, the element controller may also determines the types of responses entities comprising the element controller, entities comprising another element controller, or game or test participants will be required to provide element response options.

### Mystery Controller

A primary element controller of one or more elements within an element response test may not be revealed or remain a mystery until a same time, a time consistent with, or after a primary element response test participant's element response submission deadline.

Information From Outline Element Controller Types

Revealed

Identified to Participants prior to Element Presentations

Partially Identified to Participants prior to Element Presentations

Identified to Participants prior to a Response Submission Deadline

Partially Identified to Participants prior to a Response Submission Deadline

Mystery

Partially Identified to Participants prior to Element Presentations

Partially Identified to Participants after Element Presentations

Revealed to Participants after a Response Submission Deadline

Identified to Participants after a series of Response Submission Deadlines

Identifiable to a Provider Prior to Element Presentations

Identifiable to a Provider Prior to a Response Submission Deadline

Identifiable to a Provider after a Response Submission Deadline

An Entity

A Plurality of Entities with One Voice

A Segment of a Plurality of Entities with One Voice

A Sub Segment of a Plurality of Entities with One Voice

A Percentage of a Plurality of Entities

A Percentage of a Segment of a Plurality of Entities

A Percentage of a Sub Segment of a Segment of a Plurality of Entities

A Machine

An Apparatus

A Random Response Generator

A Poll or Survey Result (Think Neilson)

Period Provider Designated

Period Revenue Provider Designated

Period Viewer Designated

Primary Game/Test Provider Designated

Primary Game/Test Participant Designated

Primary Game/Test Viewer Designated

Secondary Game/Test Participant Designated

Alternate Game/Test Participant Designated

Ancillary Game/Test Provider Designated

Ancillary Game/Test Participant Designated

Ancillary Game/Test Viewer Designated

### Example Embodiments

### Segmenting

A segment graphic may be a demographic, biographic, psychographic or an identifiable or non identifiable percentage of a segment of period, game, or test participants or entities comprising one or more element controllers of elements within a period, game, or test

Entities comprising one or more element controllers and game and test participants may be grouped or segmented according to a response or interpretation of one or more elements.

During an element response period if participants comprise one or more element controllers the participants may be required to provide sufficient data as to segment or group participants in order to identify each participant (or team of participants) as a member of one or more segments.

When each participant submits a response to an element the response may be categorized according to a respective segment. Element s receiving responses from each segment are grouped with respect to the segment. After an element response submission deadline, one or more categorized elements receiving a highest number or type of responses are identified. In an embodiment, the identified elements from each segment are revealed during a next phase or period as an element semi-finalists, element finalist, winning element, dismissed or rejected element, etc. determined by each segment of participants.

### Grouping Participants and Controllers

When an element response period or game provider determines a majority of viewers or participants comprises an element controller, viewers or participants may or may not be required to provide information to identify the participants as members of a particular segment of participants.

When a provider determines or designates one or more segments of viewers or participants other than a majority of viewers or participants comprises one or more element controllers, viewers or participants are generally required to provide sufficient identifying data in order for the provider to segment or group participants.

A segment and demographic may be synonymous.

An element response period with no primary game may refer to viewers that respond to elements as participants.

Participants (period and/or game) may be grouped according to a how they respond to a plurality of elements rather than personal information they provide during a registration process.

### Example 1

A green and blue element is presented during a registration process. Participants may be asked to provide a response to each element according to an appeal factor. Participants that submit the blue element as most appealing may placed in a blue group. Participants that submit the green element as most appealing may be placed in a green group.

### Example 2

A plurality of hair colors such as blond, brunette, silver, and pink are presented. Registering participants may be asked to select and submit the hair color that is most appealing. Participants may then segmented according to an element response demographic.

Participants may also be grouped initially according to various types of standard or considered standard demographic information and then sub grouped according to other type of submitted information such as responses or interpretations of elements.

Responses to elements may be similar to the above two examples. Element interpretations may be similar to an psychological ink blot test where a subject is asked to reveal what comes to mind when an ink blot is presented.

### Example

Participants making two hundred to two hundred and fifty thousand dollars year may be grouped according to their responses to specific elements. Therefore the two hundred to two hundred and fifty demographic may have a plurality of response demographics or sub demographics.

Participants providing false information may not qualify to receive an award and may not be permitted to be period or game participants.

Segmenting ERG/T Participants

Members of a controlling segment of one or more societies or nations may have an advantage over members of non-controlling segments when a response to an element from the controlling segment is a correct response to the element and point values are given to members and non-members for the correct response. To provide members of the non-controlling segment and controlling segment a level playing field the following methods may be applied. Although these methods may not always be utilized by a provider due to the providers objectives which may not be consistent with providing a level playing field for the controlling members and non-controlling members.

When an ERG/T provider utilizes a single element controller for all elements within a designated game/test and the controller consists of members of a segment of at least one society, the members may be required, by the provider, to respond to a number of elements within their designated game/test in order to participant in of one or more other games/tests with controllers other than their respective social segment. This method allows a provider to differentiate a controller and participants while capturing a higher percentage of response data when compared to response data captured by participants that are also member of a controlling segment.

### Multiple Primary Controllers

An ERG/T may have a plurality of primary element controllers consisting of members of various segments of at least one society. Members of each social segment may be required to respond to elements they control as controllers and be allowed to respond to elements controlled by member of other segments of the society as participants. In an embodiment, the elements they control and elements controlled by others may be the same elements within the same game/test. Therefore, if the term participant can be defined as either controlling members of an ERG/T or ERG/T participants, this method would allow a provider, at times, to capture more than one response to each element by each participant. “At times” means that an element may be seen by a member of a controlling segment as requiring a same response for their controlling segment as well as another controlling segment.

### Primary & Alternate Controllers

An ERG/T may have at least one primary element controller and one or more alternate element controllers. In an embodiment, the one primary element controller may consist of a members of a segment of at least one society and the one or more alternate element controllers may consist of members of at least one society other than or overlapping the controlling segment.

Therefore, participating members of other segments of the society may qualify to receive an award for being in-sync with members of the controlling segment. When this method of qualifying only to represent other segments of a society is utilized no member of a segment may represent their segment but only other segments. In essence, participants/controllers will provide data for two or more ERG/Ts resulting in as least 100% more data capture than other types of participation requirements.

This method results in members of a segment of a society representing other segments of the society.

When the award is becoming a controller representative, participants of this type of ERG/T may represent

Therefore, member of the society participating in the ERG/T they controller may qualify to receive an award for being in-sync with

When an ERG/T provider utilizes a plurality of element controllers and each element controller consists of a different segment of participants, members of each segment may be required to participate in their segment as controllers and one or more other segments as ERG/T participants. Members of the controlling segment may not be allowed to receive an award for being in-sync with one segment unless they participate as controllers of their segment.

### Segmenting Participants

The terms segment and graphic may be synonymous when referring to ERG/T viewers, participants, or element controllers.

Generally, members of a society are segmented to benefit those who are targeting a specific group within the society.

Currently people are categorized by age, sex, race, income, location, political party affiliation, to name a few.

Segmenting or categorizing may be achieved during a registration process wherein those who register provide various types of personal information.

### Response Graphic

A new method of categorizing people is by collecting various types of responses to a diverse or closely related series of elements. For example, individuals that response positively to red and negatively to green may be categorized into a +RED, −GREEN category. Certain individuals may rank red hair a 10 on a 1 to 10 scale and auburn hair a 5 one a 1 to 10 scale.

Members of a society may be identified or categorized by the way each member responds to various elements. Members provided one or more responses to various elements may be segmented or categorized into a “Response Graphic.”

Members may be categorized according to their ability to be in sync with one or more element controllers.

Members may be categorized according to time taken to submit responses or a type or number response platforms utilized.

Members may be categorized according to a fee paid or bid offered to participate.

Members may be categorized according to a number of points received or accumulated.

Members that choose to organize a team may be categorized according to a number of team members, average team member's scores, or team member social diversity.

### Segmenting Element Controllers

An element response period provider may designate one or a plurality of element controllers to determine the fate or future of elements within the period and correct responses to elements for ancillary element response test participation. A period provider may designate a plurality of element controllers each comprised of a different segment of a society. For example, a period provider may designate the ten segments of a society to control elements.

Element Controller Segment 1: Girls 12-17

Element Controller Segment 2: Women 18-34

Element Controller Segment 3: Women 35-49

Element Controller Segment 4: Women 55-64

Element Controller Segment 5: Women 65+

Element Controller Segment 6: Boys 12-17

Element Controller Segment 7: Men 18-34

Element Controller Segment 8: Men 34-49

Element Controller Segment 9: Men 50-64

Element Controller Segment 10: Men 65+

Each segment may determine which elements for their segment are most suitable for entertainment or consumption when elements are available to entertain or be consumed.

Ancillary test participants may be allowed or required to choose one or more segments to determine correct responses for their test whereby each segment represents test.

When a period provider designates an element controller comprised of a majority of viewers and the majority is made up of a specific segment of viewers, ancillary test administrators may register fewer participants than when the period provider designates a plurality of element controllers each comprised of a majority of a segment of viewers.

An ancillary test provider may register a higher number of test participants when a plurality of segments of a society are designated as ancillary test element controllers.

### Specific Segment Period Participation

Specific segment period or test participation is accomplished by affording test participants are afforded an opportunity to register to participate with and/or against participants from specific Segments.

Up to now, interactive competitions and games only allow participants to receive points for participating with and/or against participants from all Segments combined.

Participants may now receive points for participating in game play or tests with and/or against participants form specific Segments.

Element Controller Segment 1: Girls 12-17

Element Controller Segment 2: Women 18-34

Element Controller Segment 3: Women 35-49

Element Controller Segment 4: Women 55-64

Element Controller Segment 5: Women 65+

Element Controller Segment 6: Boys 12-17

Element Controller Segment 7: Men 18-34

Element Controller Segment 8: Men 34-49

Element Controller Segment 9: Men 50-64

Element Controller Segment 10: Men 65+

### Example 1

### “American Idol” Game Play

The largest Segment for American Idol may be Women 18-34 (Segment 2.)

A male viewer of “American Idol” age 50 (Segment 9) may not register to play with and/or against the largest Segment of American Idol players, Women 18-34 (Segment 2). If male viewers from Segment 9 could register to play with and/or against other players for Segment 9, viewers from Segment 9 would be empowered and enticed to register and play.

### Example 2

### “United we SCORE” in the Search for “America's Host”

The largest Segment for “America's Host” may be Men 34-49 (Segment 8)

A female viewer of “America's Host” age 34 (Segment 3) may not wish to register to play against the largest Segment of “America's Host” players, Men 34-49 (Segment 2). If female viewers from

Segment 3 could register to play with and/or against other players from Segment 3, viewers from Segment 3 would be empowered and enticed to register and play.

Viewers that register to play with and/or against players from all Segments combined may win cash and prizes of higher value than viewers that register to play with and/or against players from a specific Segment.

Therefore, viewers are empowered and enticed to register to play with and/or against players from all Segments combined as well as registering to play with and/or against players from specific Segments. This greatly increases the number of registering participants and a player's odds of winning cash and prizes.

### Embodiments

### Social Benefits

In an embodiment, the present invention is directed to systems and methods for providing members of one or more society's an opportunity to receive consideration with respect to providing responses to primary theme and revenue providing elements.

In an embodiment, the systems and methods of the present inventions serve to enable period and test providers and associated businesses to capture data from viewers of an unlimited number of element response period and test themes.

In an embodiment, the data and/or information obtained from the present inventions may be utilized in order to provide analysis across demographic, geographic, biographic, and response graphic societies and society segments.

### Social Benefits

Social Integration

An element response test provider may designate two or more test element controllers each comprised of a different segment of a society. In order for the test provider to achieve social integration the provider may allow or require test participants to form team with at least one team member belonging to each of the different segments of the society. Socially integrated teams may be offered prizes and awards of a higher value than individual participants or non-socially integrated teams.

Team Participation

Teams may be allowed or required to respond to elements controlled by two or more controllers. A team's qualifying score may be determined by combining point totals with respect to the team being in sync with two or more controllers.

Individual Participation

Individuals may be allowed or required to respond to elements controlled by a plurality of controllers. An individual's qualifying score may be determined by combining point totals with respect to the individual being in sync with a plurality of controllers.

Teams and individuals registering to respond to elements controlled by a plurality of controllers may be grouped on a multi-controller level of participation.

Participants in sync with a highest number of element controllers may qualify to receive prizes or awards of a higher value than participants in sync with less than a highest number of controllers.

Entities comprising a plurality of element controllers and test participants may have a socially positive experience by knowing a society or segment of a society directly or indirectly benefited by the test experience.

Social Awareness

Social awareness is achieved by presenting various segments of a society (psychographic, demographic, geographic, response graphic, etc.) that may be utilized as an element controller of one or more element categories within an element response period or test.

Social Interaction

Test participants may respond to elements based on inquiries to members of a society or a segment of society when member of the society or segment of the society are designated to control elements with a test.

Social Learning

Social learning is achieved when a designated element controller is a segment of one or more societies and responses to elements receive from the one or more segments is revealed.

Social Consideration

Viewers and participants of, element response period and tests are provided an opportunity to understand how various societies or segments of societies evaluate and respond to elements within and around the societies or segments. Element response test viewers and participants belonging to one society or segment may begin to see elements as if they belonged to another society or segment.

In essence, viewers and participants will see and think of elements with objectivity resulting in consideration for members of various societies as well as elements within various societies.

Social Interaction

When one or more element response test element controllers is comprised of accessible entities test participants may enquire to the accessible entities or similar entities which elements within the test they would provide one or more responses with respect to one or more response required by the test provider.

When a test award is representing or assisting an element controller and a plurality of element controllers are presented for a participant to choose from, the participant may select a controller that is most desirable to represent or assist.

### Collaboration Points

An element response test may provide a means for social interaction when an element controller is comprised of members of an accessible society.

When an element controller is known prior to a test and prior to a presentation of test elements test potential test participants may present assumed test elements to entities or assumed entities comprising the element controller to form a consensus on which type of elements the controller would respond to during the test.

Viewers may receive interaction points for submitting an interaction submitted by a majority of viewers. A strategy viewers may implement is to inquire to as many viewers and non-viewers whether or not an interaction is correct according to the majority of viewers asked. Therefore, each viewer that approaches others may in effect create a viral marketing effect for the event by providing knowledge of the event to others. Therefore, the systems may effectively creates a multi million viewer focus group.

In an embodiment, the system enables viewers to participate with and against viewers from specific demographics

An embodiment allows viewers to receive points for choosing which products form a plurality of products that are most suitable to be interacted with by contestants and placed in the competition.

In an embodiment, the system enables audition and competition sponsor's to build relationships with viewers/consumers by provide them with prizes, gift certificates, product coupons and discounted product purchases them with points for interacting with sponsor's products and surveys. Sponsor's gift certificates are then given to viewers/consumers with the highest point total

Interaction with Subsequent Event

In an embodiment, the system psychologically attaches viewers to subsequent game shows that also allows viewers to interact with the series

### Commercial Free Programming

In an embodiment, the system allows sponsor's to promote products and capture product and survey date within events such as pay-per-view and video on demand. Viewers with commercial skipping technology will not be able to escape sponsor's products and surveys.

### Sub Systems

In an embodiment, the system incorporates multiple sub systems

### Specific Demographic Datacapture

In an embodiment, the system allows administrator to capture data from a specific demographic. In an embodiment, the system entices viewers to participate in the demographic they are most accustomed to interacting with.

### Viral Effects

In an embodiment, the system motivates viewers to ask friends, class mates and co-workers of their opinions on interaction before an interaction submission deadline. This creates a viral marketing effect of the elements of the event, the sponsor's products and survey integrated into the event and the subsequent events staring the winning contestants.

Encouraging Sponsor and Viewer Participation

### Most Qualified or Suitable Established

This Method and Performance Feedback System eliminates these deficiencies by exposing successful actions and collaboration patterns. It provides a means to compare the contributions of team members with functionally different roles on the team, thereby making each team member accountable for his contribution to team achievement. This value relationship serves as a simple guide for individual team members to guide their choice of actions and collaborations to maximize their personal reward. In the Basketball example, the reduced set of player action-types filters out most player actions and exposes the critical few actions that directly contribute to winning. This exposure identifies winning behavior and enables team members to quickly learn from past successes; and enables team members to emulate winning behavior in future action.

### Frame & Fortune

### Social Research

When an element response test provider designates members of one or more societies or one or more segment of one or more societies the test may provide valuable social research and testing information.

In an embodiment, the utility of an element response game/test is multifaceted and provides a plurality of positive social benefits, such as social interaction, social learning, and ultimately social consciousness.

In an embodiment, the most qualified element response game participants, at the very least, receive social recognition. Participants may receive:

Titles

Awards

Employment

Social Status

Frame

Fortune

Socially Diverse Team Participation

An element response test provider may allow or require participants to form teams. Teams may be required to consist of members that can prove they are most qualified to represent various segments of a society when the segments of societies are or have comprised of element controllers.

In each of the previous embodiments, an entity or entities comprising one or more element controller's and test participants responses to elements are transferred to a server. In an embodiment, the responses from the controllers, the test participants, or the controllers and test participants may be employed to produce a report of various statistics including number of entities comprising element controllers and test participants, distribution of demographics of entities,

Other metrics may be employed to assess audience characteristics and to select future element response options tailored to a particular society or segment of a society.

### Method 12900

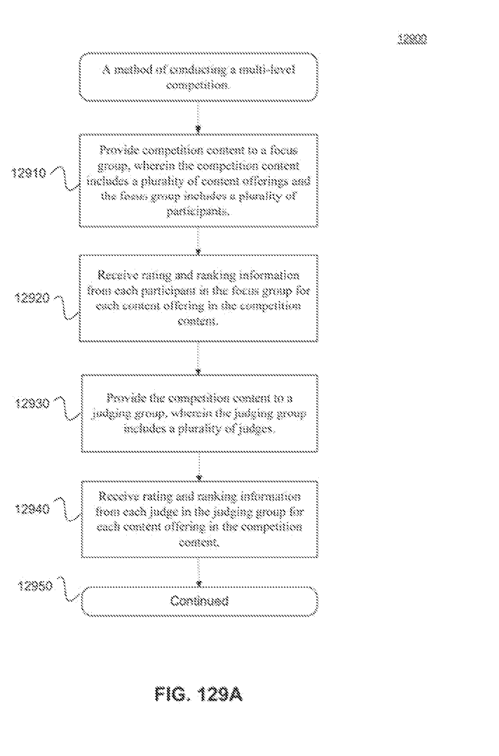

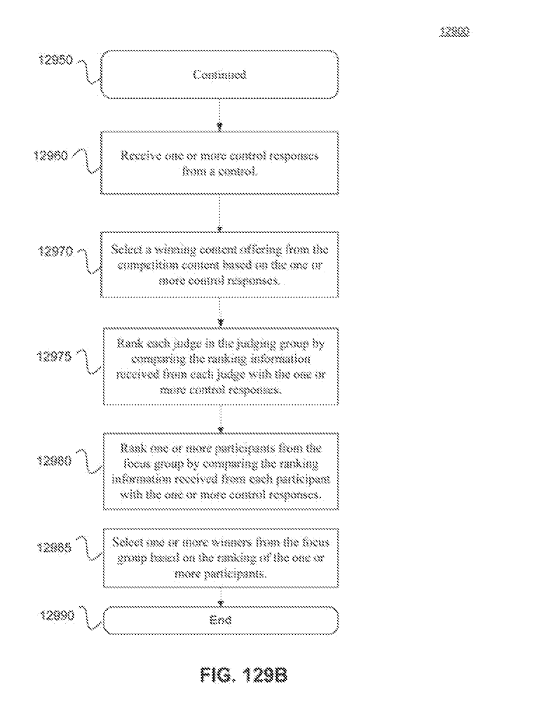

FIGS. 129A-B present an exemplary method 12900 of conducting a multi-level competition.

As shown in FIG. 129A, an embodiment of method 12900 begins at step 12910 where competition content is provided to a focus group, the competition content including a plurality of content offerings and the focus group including a plurality of participants. In an embodiment, competition content, for example, the automobile advertisement described with reference to FIG. 108, is provided to a focus group, for example, the participants described with FIG. 108, the competition content including a plurality of content offerings and the focus group including a plurality of participants. Described with reference to FIG. 110, several automobile advertisements are presented to multiple participants using an interactive website. Once step 12910 is complete, method 12900 proceeds to step 12920.

At step 12920, rating and ranking information for each content offering in the competition content is received from each participant in the focus group for each content offering in the competition content. In an embodiment, rating ranking information for each content offering in the competition content is received from each participant. For example, the participant described with reference to FIG. 3 rates and ranks each content item in the presented competition content. Once step 12920 is complete, method 12900 proceeds to step 12930.

At step 12930, the competition content is provided to a judging group, the judging group including a plurality of judges. For example, the judges described with reference to FIG. 119 view competition content including music videos, automobile advertisements and video game villains. Once step 12930 is complete, method 12900 proceeds to step 12940.

At step 12940, rating and ranking information is received from each judge in the judging group for each content offering in the competition content. For example, judges described with reference to FIG. 119 rate and rank each content item in the competition content including music videos, automobile advertisements and video game villains. Once step 12940 is complete, method 12900 proceeds to step 12950. At step 12950, method 12900 proceeds to step 12960 on FIG. 129B.

At step 12960, one or more control responses are received from a control. For example, as described with reference to FIG. 62, a control group, for example “America's SCORR,” reviews competition content and provides control responses. Once step 12960 is complete, method 12900 proceeds to step 12970.

At step 12970, a winning content offering is selected from the competition content based on the one or more control responses. As described with reference to FIGS. 62 and 72, for example, the “Walk of Fame” automobile advertisement, is selected from the competition content based on the one or more control responses. Once step 12970 is complete, method 12900 proceeds to step 12975.

At step 12975, each judge in the judging group is ranked by comparing the ranking information received from each judge with the one or more control responses. In an embodiment, as described with reference to FIG. 81-87, each judge's rank of an automobile advertisement is compared to a control response, and judges are ranked based on their similarity to the control responses. Once step 12975 is complete, method 12900 proceeds to step 12980.

At step 12980, one or more participants from the focus group are ranked by comparing the ranking information received from each participant with the one or more control responses. As described with reference to FIGS. 74-87, a participant is awarded points based on how “in sync” the participant is with the control's rankings/ratings. As discussed with reference to FIG. 90, the participants can be ranked based on the awarded points. Once step 12980 is complete, method 12900 proceeds to step 12985.

At step 12985, one or more winners are selected from the focus group based on the ranking of the one or more participants. As described with reference to FIG. 90, in an embodiment, a winner is selected from the focus group based on the ranking of the one or more participants, for example one participant, e.g., Carmen from FIG. 90, is the most “in-sync” with the control group, and thus is selected to win the grand prize. Once step 12985 is complete, method 12900 proceeds to step 12990, where method 12900 ends.

### Example Computer System Implementation

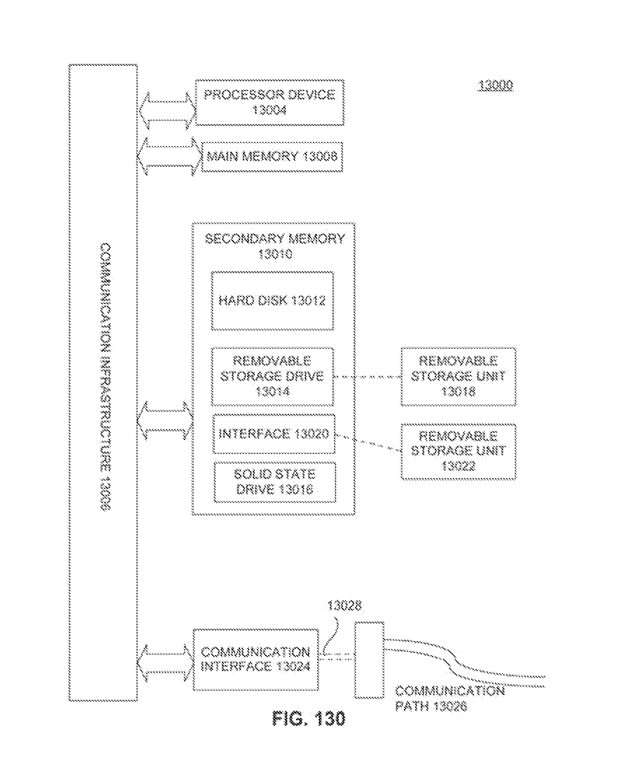

FIG. 130 illustrates an example computer system 13000 in which embodiments of the present invention, or portions thereof, may be implemented. For example, portions of systems or methods illustrated in FIGS. 1-129A-B may be implemented in computer system 13000 using hardware, software, firmware, tangible computer readable media having instructions stored thereon, or a combination thereof and may be implemented in one or more computer systems or other processing systems. The mobile interface unit, mobile device, mobile phone and tablet PC discussed with reference to FIGS. 109 and 110 can also be implemented using components of computer system 13000. Computer system 13000 may be implemented in a variety of device configurations, including smartphones, cell phones, mobile phones, tablet PCs, multi-core multiprocessor systems, minicomputers, mainframe computers, and computers linked or clustered with distributed functions, as well as pervasive or miniature computers that may be embedded into a device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 13000. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 13004 may be a single processor in a multi-core/multiprocessor system, such system operating alone, or in a cluster of computing devices operating in a cluster or server farm. Processor device 13004 is connected to a communication infrastructure 13006, for example, a bus, message queue, network or multi-core message-passing scheme.

Computer system 13000 also includes a main memory 13008, for example, random access memory (RAM), and may also include a secondary memory 13010. Secondary memory 13010 may include, for example, a hard disk drive 13012, removable storage drive 13014 and solid state drive 13016. Removable storage drive 13014 may include a floppy disk drive, a magnetic tape drive, an optical disk drive, a flash memory, or the like. The removable storage drive 13014 reads from and/or writes to a removable storage unit 13018 in a well known manner. Removable storage unit 13018 may include a floppy disk, magnetic tape, optical disk, etc. which is read by and written to by removable storage drive 13014. As will be appreciated by persons skilled in the relevant art, removable storage unit 13018 includes a computer usable storage medium having stored therein computer software and/or data.

In alternative implementations, secondary memory 13010 may include other similar means for allowing computer programs or other instructions to be loaded into computer system 13000. Such means may include, for example, a removable storage unit 13022 and an interface 13020. Examples of such means may include a program cartridge and cartridge interface (such as that found in video game devices), a removable memory chip (such as an EPROM, or PROM) and associated socket, and other removable storage units 13022 and interfaces 13020 which allow software and data to be transferred from the removable storage unit 13022 to computer system 13000.

Computer system 13000 may also include a communications interface 13024. Communications interface 13024 allows software and data to be transferred between computer system 13000 and external devices. Communications interface 13024 may include a modem, a network interface (such as an Ethernet card), a communications port, a PCMCIA slot and card, or the like. Software and data transferred via communications interface 13024 may be in electronic, electromagnetic, optical, or other forms capable of being received by communications interface 13024. This data may be provided to communications interface 13024 via a communications path 13026. Communications path 13026 carries the data and may be implemented using wire or cable, fiber optics, a phone line, a cellular phone link, an RF link or other communications channels.

In this document, the terms “computer program medium” and “computer readable medium” are used to generally refer to media such as removable storage unit 13018, removable storage unit 13022, and a hard disk installed in hard disk drive 13012. Computer program medium and computer readable medium may also refer to memories, such as main memory 13008 and secondary memory 13010, which may be memory semiconductors (e.g., DRAMs, etc.).

Computer programs (also called computer control logic) may be stored in main memory 13008 and/or secondary memory 13010. Computer programs may also be received via communications interface 13024. Such computer programs, when executed, enable computer system 13000 to implement the present invention as discussed herein. In particular, the computer programs, when executed, enable processor device 13004 to implement the processes of the present invention, such as the stages in the method illustrated by flowchart 12900 of FIGS. 129A-B discussed above. Accordingly, such computer programs represent controllers of the computer system 13000. Where the invention is implemented using software, the software may be stored in a computer program product and loaded into computer system 13000 using removable storage drive 13014, interface 13020, hard disk drive 13012 or communications interface 13024.

Embodiments of the invention also may be directed to computer program products comprising software stored on any computer readable medium. Such software, when executed in one or more data processing devices, causes a data processing device(s) to operate as described herein. Embodiments of the invention employ any computer useable or readable medium. Examples of computer readable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

Aspects or variations of methods and systems herein may be combined and combined with other present or future methods, systems, and apparatus to without departing from the spirit of embodiments described herein.

While the present inventions have been described and illustrated in various embodiments, such descriptions and illustrations are not to be construed to be limitations thereof. Accordingly, the present inventions encompass any variations, modifications, and/or alternate embodiments with the scope of the present inventions being limited only by the claims, which will be included in the forthcoming application.

A plurality of embodiments have been described herein. Nevertheless, it may be understood that various modifications may be made without departing from the spirit and scope of the invention. Accordingly, other embodiments are within the scope of the following claims.

What is claimed is:

1. A method of conducting a multi-level competition, comprising:
providing competition content to a focus group, wherein the competition content includes a plurality of content offerings and the focus group includes a plurality of participants;
receiving rating and ranking information from each participant in the focus group for each content offering in the competition content;
providing the competition content to a judging group, wherein the judging group includes a plurality of judges;
receiving rating and ranking information from each judge in the judging group for each content offering in the competition content;
receiving one or more control responses from a control;
selecting a winning content offering from the competition content based on the one or more control responses;
ranking each judge in the judging group by comparing the ranking information received from each judge with the one or more control responses;
ranking one or more participants from the focus group by comparing the ranking information received from each participant with the one or more control responses; and
selecting one or more winners from the focus group based on the ranking of the one or more participants.

2. The method of claim 1, further comprising:
selecting the judge having the highest ranking as a winning judge.

3. The method of claim 1, further comprising:
ranking the one or more participants by comparing the rating information received from each participant with the one or more control responses.

4. The method of claim 1, wherein ranking the one or more participants comprises:
assigning a point value to each participant based on a similarity between the participant's ranking information and the one or more control responses; and
ranking one or more participants based on the point values for each participant.

5. The method of claim 1, wherein ranking the one or more participants further comprises:
awarding a point value to each participant based on a similarity between the participant's ranking information and the one or more control responses;
awarding a further point value to each participant based on a similarity between the participant's rating information and the one or more control responses; and
ranking one or more participants based on the point values awarded to each participant.

6. The method of claim 1, further comprising:
selecting the participant having the highest ranking as a grand prize winner.

7. The method of claim 1, wherein the control includes a plurality of control members, and a control response is the content offering having the highest rank from a largest percentage of control members.

8. The method of claim 1, wherein the control includes a plurality of control members, and a control response is an average control rating determined by averaging the rating information received from the control members for a content offering.

9. The method of claim 1, wherein the control is a target demographic.

10. The method of claim 1, wherein the competition content is provided to a focus group via an interactive website.

11. The method of claim 1, wherein the rating and ranking information from at least one participant is received via an interactive website.

12. The method of claim 1, wherein the competition content is provided to a focus group via a mobile interface unit.

13. The method of claim 12, wherein the mobile interface unit is a mobile telephone.

14. The method of claim 12, wherein the mobile interface unit is a wi-fi accessible unit.

15. The method of claim 1, wherein the rating and ranking information from at least one participant is received via a mobile interface unit.

16. The method of claim 1, wherein the competition content includes a first plurality of content offerings and a second plurality of content offerings, the first plurality of content offerings including attraction content and the second plurality of content offerings including advertising content.

17. The method of claim 1, wherein the plurality of content offerings includes different but related content offerings

18. The method of claim 1, wherein the competition content includes a plurality of performances by one or more contestants.

19. The method of claim 1, wherein receiving rating and ranking information from each participant comprises receiving information identifying the ranking of competition content from a participant's most favorite to least favorite content offering within the competition content.

20. The method of claim 1, wherein receiving rating and ranking information from each participant comprises receiving a numerical assignment for each content offering from each participant.

21. The method of claim 1, wherein the one or more control responses are not revealed until after a participant rating and ranking submission deadline has passed.

22. The method of claim 1, wherein the competition content is provided to a judging group after a participant rating and ranking submission deadline has passed.

23. The method of claim 1, wherein the control is a subset of the plurality of participants.

24. The method of claim 1, wherein the control is selected by an advertiser associated with one or more of the content offerings in the competition content.

25. A system for conducting a multi-level competition, comprising:
a web server configured to provide competition content to a focus group over an electronic network and receive rating and ranking information over the electronic network from each participant in the focus group for each content offering in the competition content, wherein the competition content includes a plurality of content offerings and the focus group includes a plurality of participants;
a viewing apparatus configured to provide the competition content to a judging group, wherein the judging group includes a plurality of judges; and
a scoring module configured to:
receive rating and ranking information from each judge in the judging group for each content offering in the competition content;
receive one or more control responses from a control;
receive the rating and ranking information from each participant in the focus group from the web server;
select a winning content offering from the competition content based on the one or more control responses;
rank each judge in the judging group by comparing the ranking information received from each judge with the one or more control responses;
rank one or more participants from the focus group by comparing the ranking information received from each participant with the one or more control responses; and
a selection module configured to select one or more winners from the focus group based on the ranking of the one or more participants.

26. A system for conducting a multi-level competition, comprising:
an interactive website configured to provide competition content to a focus group over an electronic network and receive scoring information over the electronic network from each participant in the focus group, wherein the competition content includes a plurality of content offerings and the focus group includes a plurality of participants;
a scoring apparatus configured to receive scoring information for each content offering from a set of judges and the plurality of participants, receive one or more control responses from a control, and compare the one or more control responses with the scoring information to produce a set of judge scores and a set of participant scores; and
a selection apparatus configured to select a winning content offering from the competition content based on the one or more control responses, rank each judge in the judging group based on the judge scores, and rank one or more participants from the focus group.

27. A multi-level competition, comprising:
a focus group element wherein a plurality of participants receive competition content and rank content offerings within the competition content;
a judging element-wherein a plurality of judges receive the competition content and rank the content offerings; and
a reveal element, wherein:
a winner among the content offerings is determined based on a selection made by a control;
a winner among the plurality of judges is determined based on a comparison of each judge's rank of the content offerings to the selection made by the control; and
a winner among the plurality of participants is determined based on a comparison of each participant's rank of the content offerings to the selection made by the control.

28. A multi-level competition, comprising:
a focus group element wherein a plurality of participants receive competition content and rank content offerings within the competition content;
a judging element wherein a plurality of judges receive the competition content and rank the content offerings; and
a reveal element, wherein control answers determined by a control group are revealed and compared with the rankings from the plurality of participants and the rankings from the plurality of judges,

29. A multi-level reality television production, comprising:
a content competition among a plurality of competition content offerings;
a judging competition among a plurality of judges receiving the plurality of competition content offerings; and
a participant competition among a plurality of participants receiving the plurality of competition content offerings.

30. The production of claim 29, wherein:
a winner in the judging competition is a judge in the plurality of judges who makes a content offering selection similar to a content offering selection made by a control.

31. The production of claim 29, wherein a winner in the participant competition is a participant in the plurality of participants who makes a content offering selection similar to a content offering selection made by a control.

32. A method of advertising, comprising:
providing a plurality of competition content sets to a plurality of participants in a focus group, wherein the plurality of competition content sets includes an attraction content set and an advertisement content set;
receiving ranking information from each participant in the focus group, wherein the ranking information from each participant includes a ranking of each attraction in the attraction content set and a rating of each advertisement in the advertisement content set;
receiving a control ranking for each attraction in the attraction content set and for each advertisement in the advertisement content set;
providing the plurality of competition content sets to a plurality of judges;
receiving ranking information from each judge, wherein the ranking information from each judge includes a ranking of each attraction in the attraction content set and a rating of each advertisement in the advertisement content set;
comparing the ranking information from each judge with the control rankings to determine one or more winning judges; and
comparing the ranking information from each participant with the control rankings to determine one or more winning participants.

33. A method of conducting a multi-level competition, comprising:
providing one or more content sets to a plurality of participants, each content set including a plurality of related content offerings;
selecting, by each participant in the plurality of participants, a favorite content offering in each content set;
providing the one or more content sets to a plurality of judges;
selecting, by each judge in the plurality of judges, a favorite content offering in each content set;
receiving, from a control, the control's favorite content offering in each content set;
awarding points to each participant in the plurality of participants based on how well the participant's favorite content offering in each content set matches the control's favorite content offering in each content set;
awarding points to each judge in the plurality of judges based on how well the judge's favorite content offering in each content set matches the control's favorite content offering in each content set;
identifying one or more winning judges based on the points awarded to each judge;
identifying one or more winning participants in the plurality of participants based on the points awarded to each participant; and
identifying one or more winning content offerings in one or more of the content sets based on the control's favorite content offering in the content set.

34. A method of enabling an advertiser to pilot test content, comprising:
providing a set of advertisements from the advertiser to a plurality of participants in a focus group;
receiving ranking information from each participant in the focus group, wherein the ranking information from each participant identifies the participant's favorite advertisement in the set of advertisements;
receiving ranking information from a control for each advertisement in the set of advertisements, wherein the control is a target selected by the advertiser and the ranking information identifies the control's favorite advertisement in the set of advertisements;
providing the set of advertisements to a plurality of judges;
receiving ranking information from each judge, wherein the ranking information from each judge identifies the judge's favorite advertisement in the set of advertisements;
comparing the ranking information from each judge with the ranking information from the control to determine one or more winning judges; and
comparing the ranking information from each participant with the control rankings to determine one or more winning participants.

35. The method of claim 34, wherein the control is a subset of the plurality of participants in the focus group.

36. The method of claim 34, wherein the control is a plurality of individuals in a target demographic selected by the advertiser.

37. The method of claim 34, further comprising:
receiving rating information from each participant in the focus group, wherein the rating information from each participant assigns a numerical rating to each advertisement in the set of advertisements; and
receiving rating information from a control for each advertisement in the set of advertisements, wherein the rating information from the control assigns a numerical rating to each advertisement in the set of advertisements.

38. The method of claim 34, further comprising:
providing feedback to the advertiser regarding the control's favorite advertisement in the set of advertisements.

39. A method of conducting a multi-level competition, comprising;
providing a first set of competition content to users of social media sites, wherein each user is identified as associated with a particular social media site and the first set of competition content includes a plurality of content offerings;
receiving rating and ranking information from each user for each content offering in the first set of competition content;
receiving one or more control responses from a control; and
selecting a user from each social media site whose rating and ranking information is most similar to the one or more control responses from the control to be a judge in a multi-level competition.

40. The method of claim 39, further comprising:
providing the competition content to the judges selected in the selecting step, wherein each judge represents a different social media site;
receiving rating and ranking information from each judge for each content offering in a second set of competition content;
receiving one or more control responses from a control;
selecting a winning content offering from the second set of competition content based on the one or more control responses;
ranking each judge by comparing the ranking information received from each judge with the one or more control responses; and
selecting a winning judge based on the ranking of each judge.

41. A method of conducting a multi-level competition, comprising;
providing, using a computer, competition content to a participant group, wherein the competition content includes a plurality of content offerings and the participant group includes a plurality of participants;
receiving rating information from each participant in the participant group for each content offering in the competition content;
providing the competition content to a judging group, wherein the judging group includes a plurality of judges;
receiving rating information from each judge in the judging group for each content offering in the competition content;
receiving rating information from a control for each content offering in the competition content;
ranking each content offering from the competition content based on a portion of the received rating information;
ranking each judge in the judging group based on a portion of the received rating information; and
ranking one or more participants from the participant group based on a portion of the received rating information.
